(19) United States
(12) Patent Application Publication
(10) Pub. No.: US 2006/0190391 A1
(43) Pub. Date: Aug. 24, 2006

(54) Project work change in plan/scope administrative and business information synergy system and method

(76) Inventors: Andrew A. Cullen III, Succasunna, NJ (US); Steven A. Shaw, New York, NY (US); Leonid Zilberman, Brooklyn, NY (US)

Correspondence Address: JENKENS & GILCHRIST, PC, 1445 ROSS AVENUE, SUITE 3200, DALLAS, TX, 75202, US

(21) Appl. No.: 11/351,835

(22) Filed: Feb. 10, 2006

Related U.S. Application Data
(60) Provisional application No. 60/652,270, filed on Feb. 11, 2005.

(51) Int. Cl. G06Q 40/00

(52) U.S. Cl. 705/37

(57) ABSTRACT

A project-work administrative management method includes receiving, from a buyer, project-administration configurations, storing transactional project work data relating to project work to be performed for the buyer by a supplier, receiving, from the buyer, configuration of project statement-of-work (SOW) records, processing a project change in plan/scope record set of the buyer, processing a project change in plan/scope record set of the supplier, and creating an integrated project change in plan/scope record set using the record set of the buyer and the record set of the supplier.

### CROSS-REFERENCE TO RELATED APPLICATIONS

This patent application claims priority from and incorporates by reference the entire disclosure of U.S. Provisional Patent Application No. 60/652,270 (Attorney Docket No. 67737-001012USPL), filed on Feb. 11, 2005. This patent application also incorporates by reference the entire disclosure of U.S. patent application Ser. No. 10/412,096 (Attorney Docket No. 67737-00532USP1), filed on Apr. 10, 2003, and U.S. patent application Ser. No. 10/797,556, filed on Mar. 10, 2004 (Attorney Docket No. 67737-00532USP2).

### BACKGROUND OF THE INVENTION

1. Technical Field of the Invention

The present invention relates to a computer system and method for electronically facilitating enterprise administration, data processing, workflow collaboration and management relative to changes in plan or scope pertinent to project work.

2. Description of Related Art

The quotation and subsequent administration of project work can be an extremely complex process even when all statement of work (SOW) and project planning activities proceed as originally slated. Oftentimes, however, there are delays and or schedule beaters that represent changes in plan (CIP) that necessitate administrative activities. In, addition, sometimes there is a need for major change-in-scope (CIS) activities that are defined upon the commencement of a project. These CIP and CIS activities can have significant impacts not just on project-planning functions, but on procurement, supplier management, accounting, shipping & receiving, and in some cases, the total enterprise.

These CIP and CIS activities can have broad impacts to the project, such as but not limited to, project Cost/Budget, Project Timing/Scheduling, Project Deliverables/Outputs, Project Statement Of Work, Utilization Of Project Suppliers, Availability Of Project Human Resources, Delivery Of Project Equipment, Contract Terms & Conditions, and Release of Supplier Payments. There is therefore a need for a system and method by which these CIP and CIS activities can be defined, administered, and managed within a single application processing environment, thereby providing visibility, decision support, administrative data processing capability, and synergy across all impacted project work parties dealing with the project work life cycle elements of: Bid Management, Purchase Order Processing, Human Resource Management, Asset Management, SOW Provisioning, Voucher Processing, Quality Assurance, Supplier Management, Shipping/Receiving, Budgeting, Accounting, Auditing, and other specific functional roles that the enterprise needs to deploy within their collaborative work environment.

### SUMMARY OF THE INVENTION

A project-work administrative management method includes receiving, from a buyer, project-administration configurations, storing transactional project work data relating to project work to be performed for the buyer by a supplier, receiving, from the buyer, configuration of project statement-of-work (SOW) records, processing a project change in plan/scope record set of the buyer, processing a project change in plan/scope record set of the supplier, and creating an integrated project change in plan/scope record set using the record set of the buyer and the record set of the supplier.

A project-portfolio record-creation method includes creating a project group record adapted to store project-group-attribute, buyer-organization, and business-ownership responsibility data, creating at least one project master record adapted to store buyer-project data, storing an association between the project group record and the at least one project master record, storing applicable dependency relationships among the at least one project master record, and storing default buyer organizational and business-ownership data applicable to the project group.

A method of configuring project deliverable records includes associating non-deliverable project-work-activity purchase-order line items with at least one purchase order deliverable line item of a purchase-order deliverable record, specifying attribute data relative to the purchase-order deliverable record, creating at least one project work phasing record, specifying attribute data relative to the at least one project phasing record, configuring purchase-order deliverable record dependencies, and configuring purchase-order deliverable record affiliations to master data records.

A method of assessing a project change in plan/scope includes performing a project-deliverable dependency and master-record affiliation analysis in response to buyer disposition of supplier-submitted project-work acknowledgement vouchers, identifying purchase-order deliverable records that are out of compliance relative to a scheduled completion date, receiving selection of at least one out-of-compliance deliverable record, generating a project at-risk communications session, broadcasting a project at-risk communications package, receiving a project at-risk communications package response, and processing the project at-risk communications package response.

A method of processing of a project change in plan/scope includes creating a project change in plan/scope acceptance package, broadcasting the project change in plan/scope acceptance package, processing the broadcasted project change in plan/scope acceptance package to completion, and providing the completed broadcasted project change in plan/scope acceptance package.

A method of creating an integrated project change in plan/scope record set includes creating at least one project change in plan/scope change order, processing the at least one project change in plan/scope change order, processing at least one master data record responsive to approval of the at least one project change in plan/scope change order, and updating at least one processed master data record.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 is a high-level functional view of the project work bid process involved in the present invention;

FIG. 2A is a network diagram of the computer system of the present invention;

FIG. 2B is an alternate network diagram of the computer system of the present invention implemented at the buyer network;

FIGS. 3A and 3B illustrate the physical network architecture of the computer system of the present invention;

FIGS. 4A-4D are exemplary home web pages associated with each of the user modules shown in FIGS. 2A and 2B;

FIG. 5 is a flowchart illustrating exemplary steps for engaging in a project work bid process, in accordance with embodiments of the present invention;

FIG. 6 illustrates the electronic facilitation of a vendor qualification process for defining the type of project work a vendor provides and/or a buyer requires and qualifying vendors for buyers, in accordance with embodiments of the present invention;

FIG. 7 is a flow chart illustrating exemplary steps for qualifying a vendor for a buyer, in accordance with embodiments of the present invention;

FIG. 8 illustrates sample information processing involved in responding to a bid request and various user roles responsible for the information processing;

FIG. 9 is a flowchart illustrating exemplary steps for defining and assigning the various resources involved in the project work process, in accordance with embodiments of the present invention;

FIG. 10 is a database table view illustrating the definition and assignment of user roles, in accordance with embodiments of the present invention;

FIG. 11 is an exemplary screen shot of the assignment of resources to user roles;

FIG. 12 is a flowchart illustrating exemplary steps for defining and assigning user roles during a bid or project transaction, in accordance with embodiments of the present invention;

FIGS. 13A and 13B are flowcharts illustrating exemplary steps for managing workflow pertaining to a bid or project transaction based on user roles, in accordance with embodiments of the present invention;

FIG. 14 is a flowchart illustrating exemplary steps for modifying user role assignments, in accordance with embodiments of the present invention;

FIG. 15 a data flow diagram illustrating a bid template creation tool and bid request creation tool for generating a bid request for a particular project, in accordance with embodiments of the present invention;

FIGS. 16A-16D are flowcharts illustrating exemplary steps for creating a bid template, a bid request from the bid template and a bid response from the bid request;

FIG. 17 is a database table view illustrating a hierarchical bid item list from which bid templates can be created

FIG. 18 is a flowchart illustrating exemplary steps for accessing the hierarchical bid item list to create a bid template;

FIG. 19 is a screen shot illustrating the creation of a bid template;

FIG. 20 is a flow chart illustrating exemplary steps for generating a bid request utilizing a bid template, in accordance with embodiments of the present invention;

FIGS. 21-22 are screen shots illustrating various types of bid items associated with the particular bid template that can be selected from to include in a bid of the bid template type;

FIG. 23 is a flowchart illustrating exemplary steps for administering the communication of a bid request to qualified vendors;

FIG. 24 is a screen shot illustrating the selection of qualified vendors to receive the bid request;

FIG. 25 is a flowchart illustrating exemplary steps in a vendor bid response process, in accordance with embodiments of the present invention;

FIGS. 26-28 are screen shots illustrating the vendor bid response process;

FIG. 29 is a database table view illustrating the interrelation between the bid request and vendor bid response data, in accordance with embodiments of the present invention;

FIG. 30 is a screen shot illustrating the various bid processing features provided to a buyer;

FIG. 31 is a data flow diagram illustrating the electronic facilitation of vendor bid response grading, in accordance with embodiments of the present invention;

FIGS. 32 and 33 are flowcharts illustrating exemplary steps for grading vendor bid responses, in accordance with embodiments of the present invention;

FIGS. 34A-34E are screen shots illustrating a sample bid response grading process;

FIG. 35 is a database table views illustrating the interrelation between the bid request, vendor bid responses and grading of vendor bid responses, in accordance with embodiments of the present invention;

FIG. 36 is a flowchart illustrating a vendor re-quotation process based upon the vendor bid response grading, in accordance with embodiments of the present invention;

FIG. 37 is a flowchart illustrating exemplary steps in a project administration setup process, in which the project is awarded to a vendor and the terms and conditions of the project are finalized and entered into the computer system to track milestones and deliverables, in accordance with embodiments of the present invention;

FIG. 38 is a flowchart illustrating exemplary steps for approval of assigned resources to a project, in accordance with embodiments of the present invention;

FIG. 39A is a screen shot illustrating exemplary buyer project administration features;

FIG. 39B is a screen shot illustrating exemplary vendor project administration features;

FIG. 40A is a screen shot illustrating an interface for entering exemplary project taxation information;

FIG. 40B is a screen shot illustrating exemplary requisition information including entered project taxation information;

FIG. 40C is a flowchart illustrating exemplary steps for entering and processing project taxation information;

FIG. 41 is a database table view illustrating various project administration components handled by the computer system of the present invention;

FIG. 42 is a screen shot illustrating the types of liability issues that can be managed by the computer system of the present invention;

FIG. 43 is a flowchart illustrating exemplary steps for entering contractor time for a project, in accordance with embodiments of the present invention;

FIGS. 44-46 are screen shots illustrating a sample time keeping process;

FIG. 47 is a database table view illustrating the tracking of project deliverables and vouchering, in accordance with embodiments of the present invention;

FIG. 48 illustrates the electronic facilitation of a payment vouchering process for submitting and approving payment vouchers and creating a payment voucher, in accordance with embodiments of the present invention;

FIG. 49 is a flowchart illustrating a voucher payment process, in accordance with embodiments of the present invention;

FIG. 50 is a database table view illustrating the generation of payable vouchers, in accordance with embodiments of the present invention;

FIG. 51 is a screen shot illustrating project financial data;

FIG. 52 is a flow diagram illustrating the information exchange between the buyer, vendor and system to facilitate analysis of the information;

FIG. 53 illustrates exemplary functionality for entering project performance data related to the performance of projects into the system, in accordance with embodiments of the present invention;

FIGS. 54-56 are flow charts illustrating exemplary steps for entering project performance data;

FIG. 57 is a database table view illustrating the storage of project performance data, in accordance with embodiments of the present invention;

FIG. 58 illustrates exemplary transactional data related to the bid/project process stored within the database system of the present invention;

FIG. 59 illustrates an exemplary transfer of the transactional data from multiple buyer databases to a central database;

FIG. 60 illustrates the electronic facilitation of analysis and reporting of transactional data, in accordance with embodiments of the present invention;

FIGS. 61-67 are flow charts illustrating exemplary steps for analyzing the transactional data and providing analytical data, in accordance with embodiments of the present invention;

FIG. 68 illustrates the electronic facilitation of a filtering process for filtering the transactional data to provide analytical data related to the filtered transactional data, in accordance with embodiments of the present invention;

FIG. 69 is a flow chart illustrating exemplary steps for filtering the transactional data and generating analytical data from the filtered transactional data, in accordance with embodiments of the present invention;

FIG. 70 is a screen shot illustrating exemplary project reporting types for generating and displaying the analytical data;

FIGS. 71-88 are screen shots illustrating exemplary project reporting views, each containing analytical data;

FIG. 89 is a view of a complex enterprise business dynamic associated with project work and applicable changes to plans or scope;

FIG. 90 is a diagram depicting a business application processing environment;

FIG. 91 is a flow chart illustrating exemplary steps for engaging in a project work administrative management process;

FIG. 92 is a flow chart illustrating exemplary steps for engaging in PCIP/S solution without dependence upon requisite procurement functionality;

FIG. 93 is a process flow diagram representing an overall PCIP/S business methodology employed within various embodiments of the invention;

FIG. 94A is a process flow diagram depicting creation of a project group record;

FIG. 94B is a process flow diagram depicting creation of a project master record;

FIG. 95A is a process flow diagram depicting creation of a budget group record;

FIG. 95B is a process flow diagram depicting creation of a budget master record;

FIG. 96A is a process flow diagram depicting creation of a asset group record;

FIG. 96B is a process flow diagram depicting creation of a asset master record;

FIG. 97 is a process flow diagram depicting creation of a contract master record;

FIG. 98 is a process flow diagram depicting creation of a business event record;

FIG. 99 is a process flow diagram depicting mapping of a project master record to the other master data components;

FIG. 100 illustrates an exemplary project administration home page user interface for a buyer user;

FIG. 101 illustrates an exemplary enabling database schema that supports pre-procurement data acquisition, storage, and configuration activities;

FIG. 102 is a modified process work flow whereby project master record integration to an RFx bid process takes place;

FIG. 103 is a modified database schema supporting project master record integration to project work transactional data;

FIG. 104 is a diagram of a statement of work (SOW) dynamic in the context of principles of the invention;

FIG. 105 is an exemplary buyer user project master web page accessed from the project administration home page via user navigation and record selection;

FIG. 106 is an exemplary process work flow diagram depicting project work affiliation with deliverable/SOW records;

FIG. 107 is an exemplary process flow diagram depicting creation of project phasing records;

FIG. 108 is an exemplary process flow diagram depicting affiliation/mapping of purchase order SOW records to project phasing records;

FIG. 109 is an exemplary process flow diagram depicting SOW record to SOW record affiliation and dependency configuration;

FIG. 110 is an exemplary process flow diagram depicting SOW record to budget record affiliation;

FIG. 111 is an exemplary process flow diagram depicting SOW record to asset record affiliation;

FIG. 112 is an exemplary process flow diagram depicting SOW record to contract record affiliation;

FIG. 113 is an exemplary process flow diagram depicting SOW record to business event record affiliation;

FIG. 114 is an exemplary user interface web page depicting a reporting summary for project groups and project master records;

FIG. 115 is an exemplary database schema that supports SOW record configuration;

FIG. 116 is exemplary process flow diagram by which transactional project work data processing and tracking data is used to report output pertinent to at-risk dependent SOW and affiliated master data records;

FIGS. 117-119 are exemplary process work flow diagrams depicting a PCIP/S risk communications session;

FIG. 120 is an exemplary database schema that supports the PCIP/S risk communications session;

FIGS. 121-122 are exemplary process work flow diagrams depicting a PCIP/S supplier acceptance package; and

FIG. 123 is an expanded view of FIG. 120 to which the supporting database schema for the PCIP/S supplier acceptance package has been integrated.

FIG. 124 illustrates a PCIP/S record approval and integration session process flow.

### BRIEF DESCRIPTION OF THE TABLES

In addition to database Tables 1-112, various embodiments of the invention will be described with reference to the accompanying database tables, wherein:

Table 113 is an exemplary storage table housing the identity of and general business data for Project Groups utilized by a Buyer Entity;

Table 114 is an exemplary storage table housing the identity of and general business data for a Project Master Records utilized by a Buyer Entity;

Table 114A is an exemplary storage table housing the relationship between projects contained within a Project Group;

Table 115 is an exemplary storage table housing the respective values used to define the relationships between Projects within a Project group;

Table 116 is an exemplary storage table housing the identity and basic attributes applicable to Cost Centers, a.k.a. Departments utilized within a Buyer Entity;

Table 117 is an exemplary storage table housing the mapping relationship between Cost Centers and Projects;

Table 118 is an exemplary storage table housing the identity of and general business data for Budget Groups utilized by a Buyer Entity;

Table 119 is an exemplary storage table housing the identity of and general business data for Budget Master Records utilized by a Buyer Entity;

Table 120 is an exemplary storage table housing the affiliation relationship between Projects and Budgets;

Table 121 is an exemplary storage table housing the identity of and general business data for Business Events utilized by a Buyer Entity;

Table 122 is an exemplary storage table housing the affiliation relationship between Projects and Business Events;

Table 123 is an exemplary storage table housing the identity of and general business data for Contract records utilized by a Buyer Entity;

Table 124 is an exemplary storage table housing the affiliation relationship between Projects and Contracts;

Table 125 is an exemplary storage table housing the identity of and general business data for Asset Groups utilized by a Buyer Entity;

Table 126 is an exemplary storage table housing the identity of and general business data for Asset Master Records utilized by a Buyer Entity;

Table 127 is an exemplary storage table housing the affiliation relationship between Projects and Assets;

Table 128 is an exemplary storage table housing the mapping relationship between Projects and RFx Bids;

Table 129 is an exemplary storage table housing the mapping relationship between Projects and Purchase Order Requisitions;

Table 130 is an exemplary storage table housing the identity and attributes associated with a Supplier Purchase Order;

Table 131 is an exemplary storage table housing the identity and basic attributes associated with a Buyer Purchase Order;

Table 132 is an exemplary storage table housing the identity and basic attributes associated with a Buyer Purchase Order Line;

Table 133 is an exemplary storage table housing the identity and attributes associated with project work activities contained on a Buyer Purchase Order Line;

Table 134 is an exemplary storage table housing the identity and attributes associated with a Buyer PO Statement Of Work (SOW) record;

Table 135 is an exemplary storage table housing the mapping relationship between project work activities contained on Purchase Orders and SOW records;

Table 136 is an exemplary storage table housing the identity and attributes associated with a Project Phasing record;

Table 137 is an exemplary storage table housing the mapping relationship between Project Phasing records and SOW records;

Table 138 is an exemplary storage table housing the applicable dependency mapping relationships between SOW records;

Table 139 is an exemplary storage table housing the values of SOW to SOW record dependency types utilized;

Table 140 is an exemplary storage table housing the mapping relationship between SOW records and Budgets;

Table 141 is an exemplary storage table housing the mapping relationship between SOW records and Assets;

Table 142 is an exemplary storage table housing the mapping relationship between SOW records and Contracts;

Table 143 is an exemplary storage table housing the mapping relationship between SOW records and Business Events;

Table 144 is an exemplary storage table housing the identity and attributes associated with a Buyer PCIP/S Risk Session;

Table 145 is an exemplary storage table housing the values applicable to PCIP/S Risk Session Status Codes utilized;

Table 146 is an exemplary storage table housing the values applicable to PCIP/S Risk Session Type Codes utilized;

Table 147 is an exemplary storage table housing the identity and attributes applicable to SOW records contained within a PCIP/S session;

Table 148 is an exemplary storage table housing the values applicable to Buyer User response status codes during a PICP/S session;

Table 149 is an exemplary storage table housing the condition or variable data modifications made to project work purchase order activity records during a PICP/S session;

Table 150 is an exemplary storage table housing the identity and attributes applicable to new project work activities created during a PICP/S session;

Table 151 is an exemplary storage table housing the values defining the project work activity variable data field modification types utilized;

Table 152 is an exemplary storage table housing the values defining the variable data field modification actions utilized;

Table 153 is an exemplary storage table housing the variable data modifications made to Master Data records during a PICP/S session;

Table 154 is an exemplary storage table housing the values defining the Master Data variable data field modification types utilized;

Table 155 is an exemplary storage table housing the values defining the Master Data variable data field modification actions utilized;

Table 156 is an exemplary storage table housing the identity and attributes associated with a Buyer PCIP/S Supplier Acceptance Package Session;

Table 157 is an exemplary storage table housing the values applicable to PCIP/S Supplier Acceptance Package Session Status Codes utilized;

Table 158 is an exemplary storage table housing the identity and attributes applicable to a Supplier Broadcast/Posting record affiliated with a PCIP/S Supplier Acceptance Package Session;

Table 159 is an exemplary storage table housing the values applicable to PCIP/S Supplier Acceptance Package Session Response Status Codes utilized;

Table 160 is an exemplary storage table housing the Supplier data verification and taxation assessment responses pertinent to records processed during a PCIP/S Supplier Acceptance Package Session; and

Table 161 is an exemplary storage table housing the Supplier data provision, data verification and taxation assessment responses pertinent to new activity records processed during a PCIP/S Supplier Acceptance Package Session.

### DETAILED DESCRIPTION OF EXEMPLARY EMBODIMENTS

The numerous innovative teachings of the present application will be described with particular reference to exemplary embodiments. However, it should be understood that these embodiments provide only a few examples of the many advantageous uses of the innovative teachings herein. In general, statements made in the specification of the present application do not necessarily delimit any of the various claimed inventions. Moreover, some statements may apply to some inventive features, but not to others. In accordance with embodiments of the present invention, a vendor is any provider of goods and/or services, a buyer is any purchaser of goods and/or services, a contractor is a resource employed by a vendor for project work and an administrator is a third-party system administrator or buyer-employed project administrator. Buyers can solicit bids from vendors for a particular good and/or service (hereinafter referred to as a project) in a form specified by the buyer using a bid request generated from a pre-established list of bid items related to the project type. Therefore, the bid responses submitted from vendors all have the same form, enabling efficient and effective evaluation of the bid responses. Embodiments of the present invention further combine the bid process with project management to enable the buyer, vendor, contractor and administrator to track the performance of the project after the bid is awarded.

A computer enabled system and method in accordance with principles of the invention is provided to integrate activities of project work with other enterprise business organizations and personnel even when the business organizations are not participants in the project itself. Project change in plan/scope (PCIP/S) administrative management functionality is provided that permits the enterprise to limit risks applicable to changes in plan/scope and optimize data processing and business administration endeavors through Statement Of Work (SOW) dependency modeling and collaborative work flow processing.

A typical embodiment includes processes for the following: 1) project administration configuration; 2) acquisition and storage of transactional project work data; 3) SOW record configuration; 4) PCIP/S impact modeling; 5) risk communications session; 6) PCIP/S acceptance package session; and 7) PCIP/S record modification administration

Various processes of the typical embodiment may be supported via the following application components and functions:
a) a project administrative management schema and application tool component that permits a buyer entity to perform one or more of the following: 1) create project group records; 2) create project master records; 3) associate project master records with a project group; 4) define relationships between projects within a project group (a project hierarchy); 5) associate various business attributes to both project groups and projects; 6) create SOW records; 7) associate SOW records with projects; 8) associate SOW records with each other; 9) define relationships between associated SOWs; 10) create records relative to business events within the buyer entity; 11) associate business event records to projects; 12) associate business event records to SOWs; 13) create budget group records; 14) create budget master records; 15) associate budget master records to budget group records; 16) associate budget master records with project record(s); 17) associate budget master records with SOW record(s); 18) create contract records; 19) associate contract records to project record(s); 20) associate contract records to SOW record(s); 21) create asset group records; 22) create asset master records; 23) associate asset master records to asset group records; and 24) associate asset master records to SOW records.
b) application functionality linking the project administrative management schema to project work solution life cycle processes via an SOW sub-module: 1) RFx Bid, bid response, bid award; 2) purchase requisition (SOW elements); 3) purchase order (SOW elements); 4) voucher (supplier requests to have buyer approve/verify that SOW element(s) have been completed); 5) invoice (systematically extracted voucher details applicable to buyer entity approved vouchers); 6) payment; and 7) reporting.
c) An administrative management schema and application tool enabling a buyer entity to: 1) administer/configure records within the project administrative management module; 2) view dependency identification/reporting output function for related/dependent projects, related/dependent SOW elements, and related/dependent business records; 3) select specific SOW record(s) and modify the condition or attribute data of the record(s), such as, for example, a status or expected completion date, to generate a system diagnostic risk report indicating, based upon prior user configuration, the impact to related business records, the diagnostic risk report output typically providing views into impacted deliverables, service units, goods/shipments, project phasing, human resource assignments, purchase orders/cash flow planning, budgeting/accruals, related business events, contracts, asset management, suppliers, and users; 4) create a communications session whereby impacted project work parties can be provided information applicable to at risk SOW elements and projects, wherein the communications can be broadcast in, for example, macro or micro modes dependent upon user configuration and specific broadcasted records configured in such a manner as to enable bi-directional data processing capabilities applicable to an at risk SOW element; 5) process mutually agreed upon communications session records in a manner that systematically updates application SOW element, purchase order and other related records while maintaining a history of the communications records as well as superseded SOW element, purchase order and other related records; 6) systematically initiate global/macro condition/status code changes of a record set premised upon a presumed SOW record condition/status type change; 7) systematically initiate global/macro record attribute changes of a record set premised upon a presumed condition/status type change; 8) send notifications to impacted parties upon systematic record updating modification; 9) systematically generate a report consisting of pertinent RFx bid response records applicable to an at risk SOW element; 10) systematically utilize RFx bid item elements as well as RFx bid response item elements to create a new RFx bid that can be broadcasted while retaining a database record thread back to the original SOW element and relationships; 11) systematically receive, review, analyze a supplier bid response and award a new purchase order while retaining a database record thread back to the original SOW element and relationships; 12) systematically inherit upon integration of purchase order SOW elements via the statement of work sub-module all prior associations and dependencies applicable to the failed/original SOW element which RFx record details were utilized to process a new RFx; and 13) enable buyer user edit/modification capability for those SOW records that inherited dependencies and relationships through the PCIP/S administrative tool.

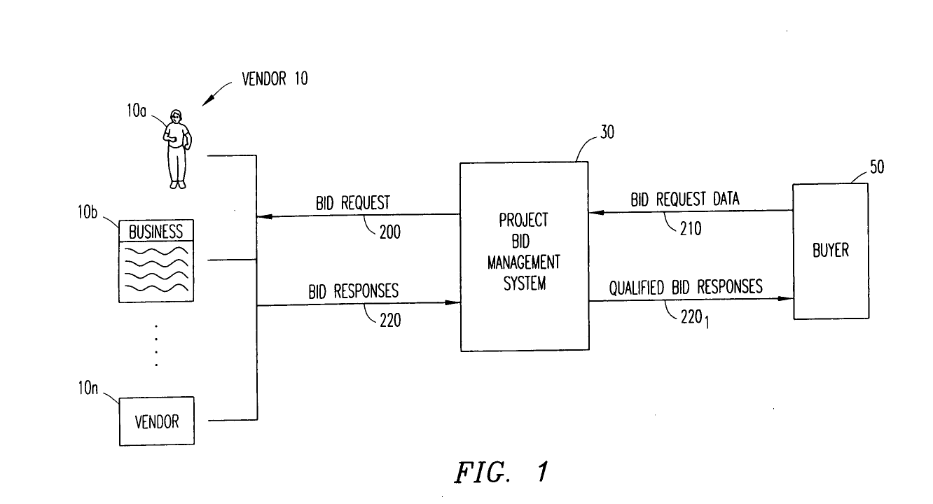

Referring now to the FIGURES, FIG. 1 is a high-level functional view of the bid process involved in the present invention. Bid request data 210 associated with a particular bid request 200 is provided from a buyer 50 to a project bid management system 30. The buyer 50 can be an individual, business entity or any other type of buyer 50 that requires performance of a project. The bid request data 210 received at the project bid management system 30 is in a form pre-designated by the buyer 50. For example, the form can include one or more bid items selected from a configurable pre-established list of bid items for the particular project type, and the bid request data 210 can be related to one or more of these selected bid items.

The bid request data 210 is formatted by the project bid management system 30 and transmitted as a bid request 200 to one or more vendors 10a . . . 10n for solicitation of respective bid responses 220. For example, the vendor 10 can be an individual 10a, business entity 10b or any other vendor 10n that is capable of performing the requested project. Bid responses 220 are submitted from the vendors 10 to the project bid management system 30 for review prior to forwarding qualified bid responses 220, to the buyer 50. For example, the project bid management system 30 may be pre-configured to force vendor completion of required bid response items in a specific data format to enable the system 30 to perform some filtering of vendor bid responses 220. In this way, the system 30 can ensure that the buyer 50 only receives the bid responses 220 that have the necessary data for bid evaluation.

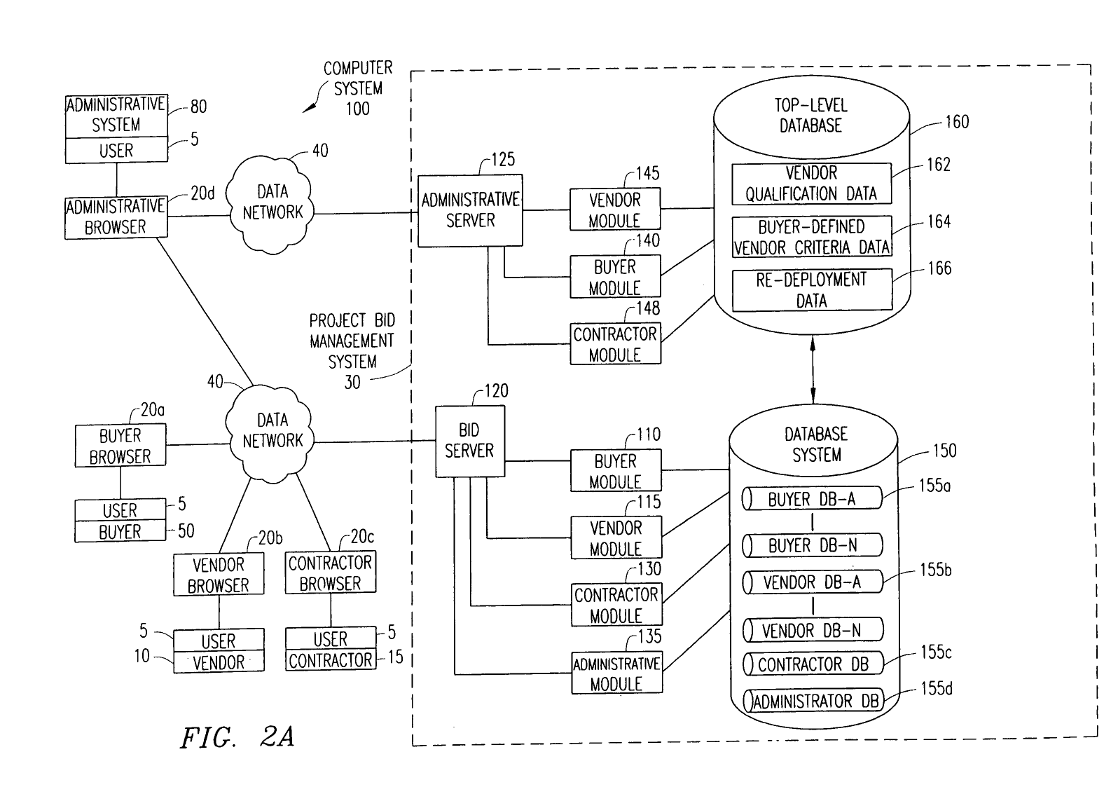

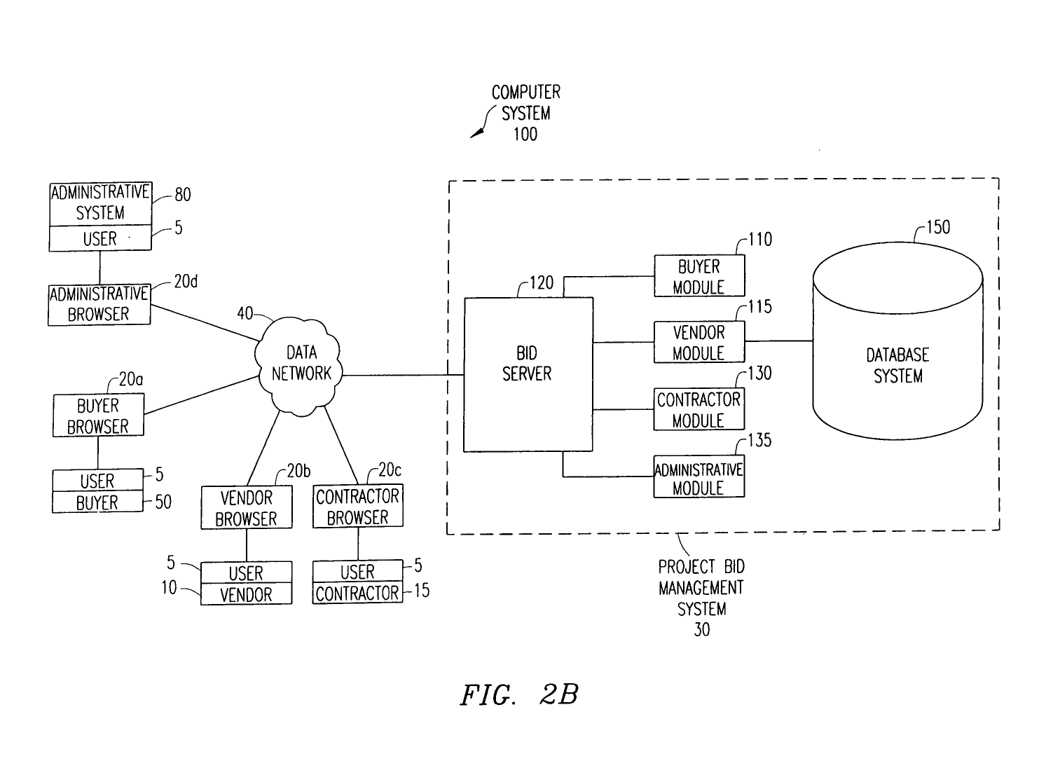

In accordance with embodiments of the present invention, the project bid management system 30 can be implemented within a computer system 100, as is shown in FIG. 2A. A user 5 enters the computer system 100 through a data network 40 via a web browser 20. A user 5 includes any person associated with a vendor 10, buyer 50, administrator 80 (e.g., a third-party or buyer-employed administrator) or contractor 15 assigned to a project. By way of example, but not limitation, the data network 40 can be the Internet or an Intranet and the web browser 20 can be any available web browser or any type of Internet Service Provider (ISP) connection that provides access to the data network 40. Vendor users 5 access the computer system through a vendor browser 20b, buyer users 5 access the computer system via a buyer browser 20a, contractor users 5 access the computer system via a contractor browser 20c and administrative users 5 access the computer system through an administrative browser 20d. The users 5 access the computer system 100 through a web server 120 or 125 capable of pushing web pages to the vendor browser 20a, buyer browser 20b, contractor browser 20c and administrative browser 20d, respectively.

A bid web server 120 enables vendors 10, buyers 50, contractors 15 and administrators 80 to interface to a database system 150 maintaining data related to the vendors 10, buyers 50, contractors 15 and administrators 80. The data related to each of the vendors 10, buyers 50, contractors 15 and administrators 80 can be stored in a single database 155, in multiple shared databases 155 or in separate databases 155 within the database server 150 for security and convenience purposes, the latter being illustrated. For example, the database system 150 can be distributed throughout one or more locations, depending on the location and preference of the buyers 50, vendors 10, administrators 80 and contractors 15.

The user interface to the vendor users 5 is provided by the bid web server 120 through a vendor module 115. For example, the vendor module 115 can populate web pages pushed to the vendor browser 20b using the data stored in the particular vendor database 155b. The user interface to the buyer users 5 is provided by the bid web server 120 through a buyer module 110. For example, the buyer module 110 can populate web pages pushed to the buyer browser 20a using the data stored in the particular buyer database 155a. The user interface to the contractor users 5 is provided by the web server 120 through a contractor module 130. For example, the contractor module 130 can populate web pages pushed to the contractor browser 20c using the data stored in the contractor database 155c. The user interface to the administrative users 5 is provided by the bid web server 120 through an administrative module 135. For example, the administrative module 135 can populate web pages pushed to the administrative browser 20d using the data stored in the administrator database 155d. It should be noted that the vendor module 115, buyer module 110, contractor module 130 and administrative module 135 can each include any hardware, software and/or firmware required to perform the functions of the vendor module 115, buyer module 110, contractor module 130 and administrative module 135, and can be implemented as part of the bid web server 120, or within an additional server (not shown).

The computer system 100 further provides an additional user interface to administrative users 5 through an administrative web server 125. The administrative web server 125 enables administrators 80 to interface to a top-level database 160 maintaining data related to the vendors 10, buyers 50 and contractors 15 registered with the computer system 100. For example, the top-level database 160 can maintain vendor qualification data 162, buyer-defined vendor criteria data 164 and contractor re-deployment data 166.

To access information related to vendors 10, the administrative web server 125 uses a vendor module 145 to push web pages to the administrative browser 20d related to vendors 10. For example, the vendor module 145 can access vendor qualification information 162 to qualify vendors 10 for a particular buyer 50 or for a particular industry. Likewise, the administrative web server 125 can push web pages to the administrative browser 20d related to the buyer-defined vendor criteria information 164 through a buyer module 140 in order to qualify vendors 10 for a particular buyer 50. A contractor module 148 enables administrators 80 to access contractor re-deployment data 166 entered by contractors 15 through the bid server 120 and retrieved into the top-level database 160 from a contractor database 155. The re-deployment data 166 can include, for example, an indication of the mobility of the contractor, desired geographical areas, contractor skills, desired pay and other contractor information that can be used to assist administrators 80 in qualifying vendors 10 for buyers 50.

In another embodiment, as shown in FIG. 2B, the computer system 100 can be implemented solely at the buyer network. In FIG. 2B, vendor users 5 enter the computer system 100 via a data network 40 through a vendor browser 20b, as in FIG. 2A. However, the web server 120 in FIG. 2B is a buyer web server controlled and operated by a single buyer. The database system 150 stores only the buyer data related to that particular buyer and only the vendor, contractor and administrator data pertinent to that particular buyer. For example, the vendor qualification data for only those vendors that are qualified by the buyer is stored in the database system 150.

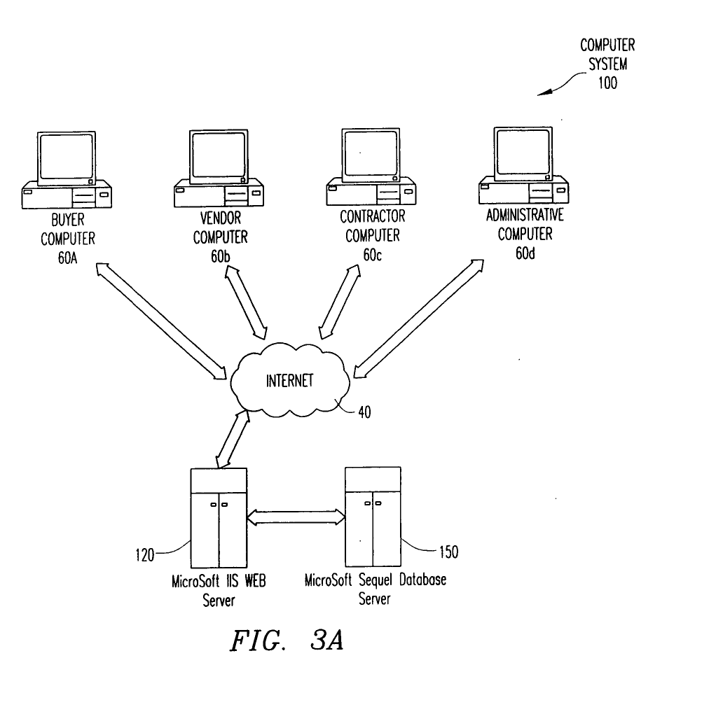

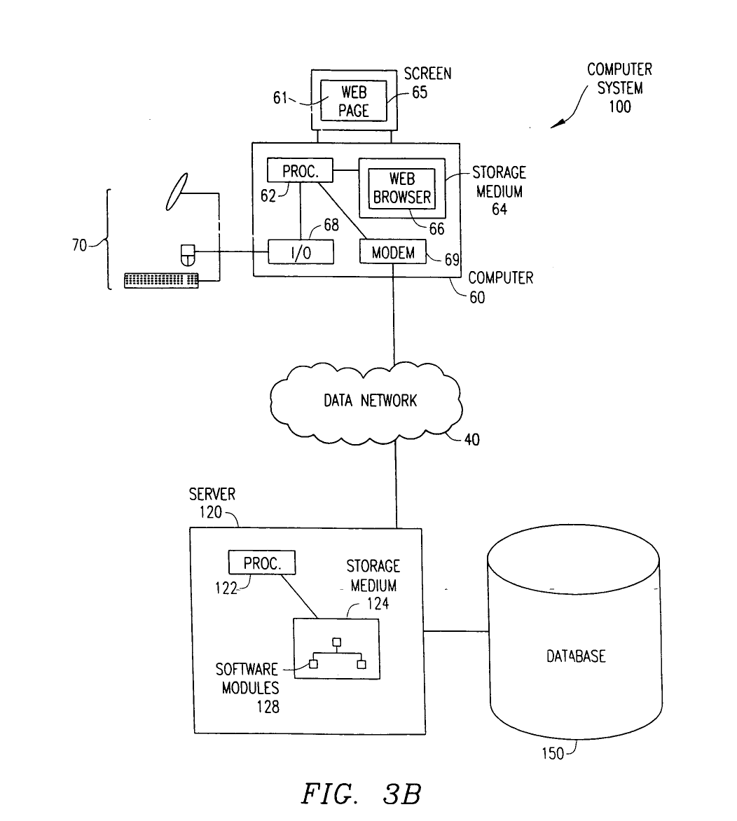

Referring now to FIG. 3A, exemplary physical network equipment for implementing the computer system 100 is shown. A vendor user, a buyer user, contractor user or an administrative user accesses the web server 120 of the computer system 100 by connecting a computer 60a, 60b, 60c or 60d, respectively, to a data network 40. Each computer 60a-60d can be, for example, a personal computer, a laptop computer, a computer connected to a wireless device for remote access to the data network, a handheld wireless device providing a web browser capable of accessing the data network or other type of machine implementing a web browser. The web server 120 can be, for example, a Microsoft Internet Information Services (IIS) server. The web server 120 connects to an appropriate database system 150, depending on the type of user. The database system 150 can be implemented in, for example, one or more SQL servers.

Turning now to FIG. 3B, exemplary functionality implemented in the physical network equipment of the computer system 100 is shown. A user computer 60 can access the data network 40 using a web browser 66 resident within a storage medium 64 of the computer. For example, the storage medium can be a disk drive, random access memory (RAM), read-only memory (ROM), compact disk, floppy disk, tape drive or any other type of storage medium. A processor 62 (e.g., a microprocessor or microcontroller) within the computer 60 loads and runs the web browser 66 to access the data network 40.

Upon entering the Uniform Resource Locator (URL) of the web server 120 into a computer, a connection between the computer 60 and the web server 120 is created. The web server 120 pushes web pages 61 to the computer 60 for viewing by the user on a user interface device 65. In one embodiment, the user interface device 65 is a computer screen 15 connected to the computer 60. For example, once a user has been validated (e.g., by entering a user name and password), the user can view one or more web pages 61 on the computer screen 65, each containing prompts for the user to enter various information into the computer system 100. The user can enter the information into the computer 60 for transmission via the data network 40 to the web server 120 via an I/O interface 68 and any type of input device 70, such as, for example, a mouse, keyboard, light pen, touch screen (not shown) or voice recognition software (not shown).

At the web server 120, a processor (e.g., a microprocessor or microcontroller) loads and executes computer instructions resident in software modules 128 stored within a storage medium 124, which can be any type of storage medium, as discussed above in connection with storage medium 64. The computer instructions can be created using any type of programming technique, including object-oriented programming techniques. For example, the software modules 128 may contain the computer instructions for the vendor modules, buyer modules, contractor modules and administrative modules (shown in FIGS. 2A and 2B) for populating web pages 61 for vendor users, buyer users, contractor users and administrative users, respectively. Based on the computer user log-in to the web server 120, the processor 122 accesses the appropriate software module 128 to determine the database system 150 associated with the computer user and retrieves the data related to the computer user for population in web pages 61 for display on the computer screen 65 of the computer 60. In addition, the software modules 128 may further be configured to store data received from the computer user within the database system 150.

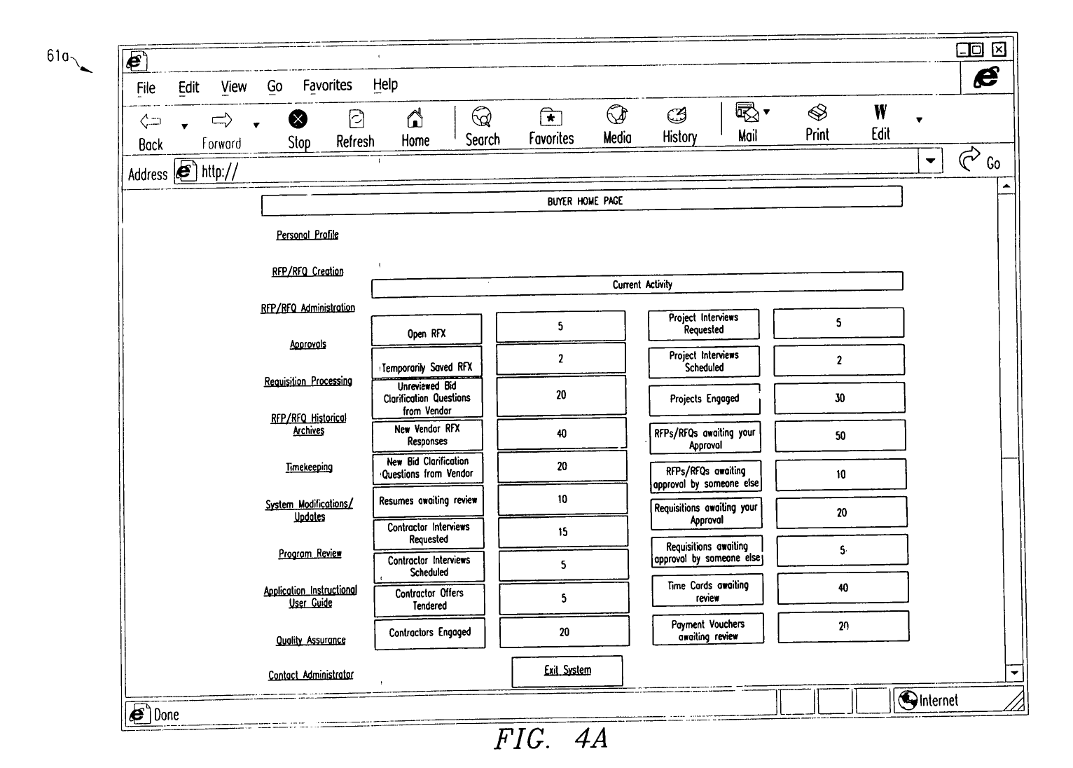

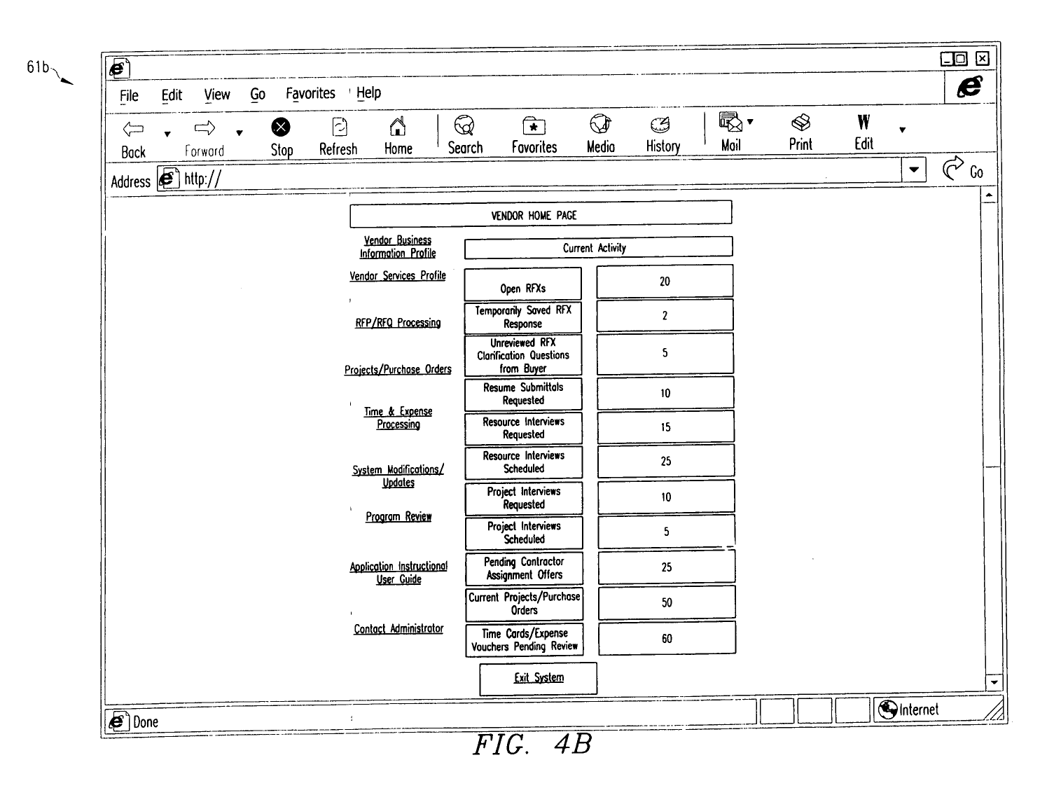

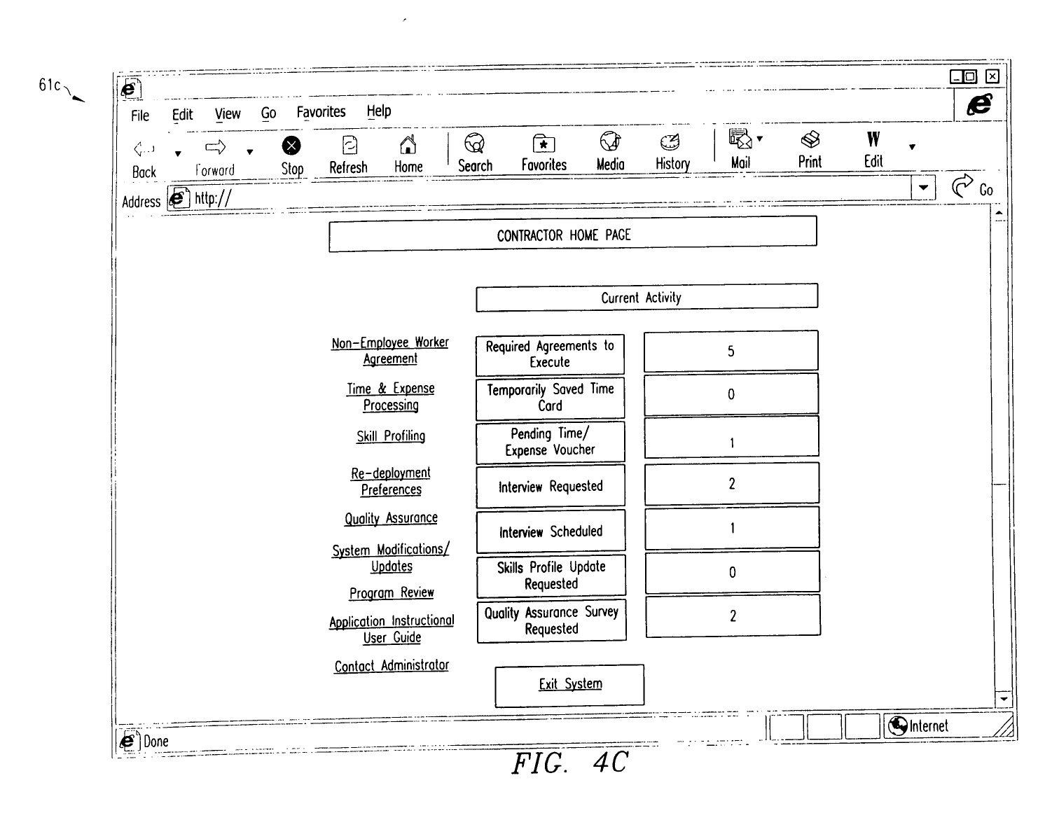

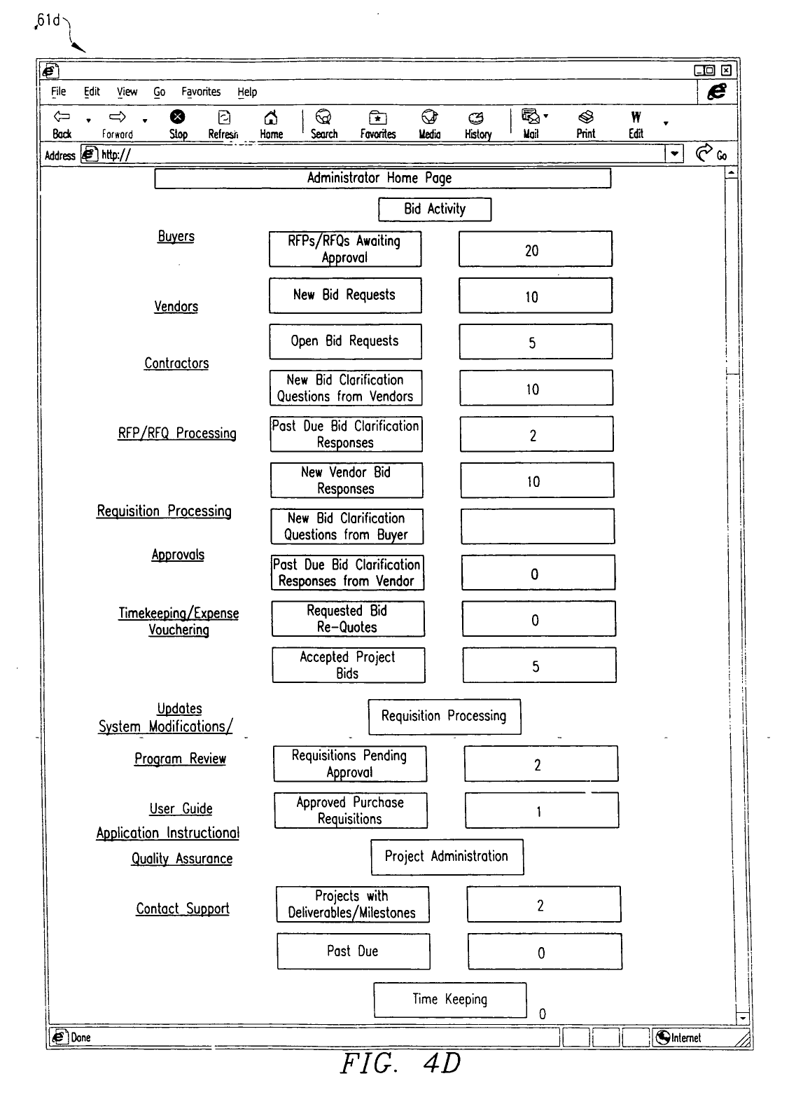

Examples of web pages 61 displayed to buyer users, vendor users, contractor users and administrative users are shown in FIGS. 4A-4D, respectively. FIG. 4A illustrates a sample buyer home page 61a displayed to a buyer user upon log-in and authentication (e.g., a challenge and response authentication) of the buyer user. As can be seen in FIG. 4A, there are a number of system features available to the buyer user at the buyer home page 61a. For example, the buyer user can be provided links to update their personal profile in the system, create an RFP/RFQ (referred to herein as a bid request), administer current bid requests, approve a vendor bid response to award the bid (project) to a particular vendor, process a current project, view historical bid requests or access a voucher processing system to view various project related event tracking requests, such as contractor time cards. The buyer user can further remain updated as to system modifications, receive instructions on how to maneuver through the system and contact a system administrator (e.g., a third-party administrator or buyer-employed administrator) for assistance through the buyer home page 61a.

In FIG. 4A, the buyer user is further provided with the current status of pending bids and projects at the home page 61a. However, it should be understood that the current activities can be displayed in subsequent web pages, instead of at the home page 61a. For example, the buyer user can be provided with the number of open bid requests (submitted bid requests) and the number of temporarily saved bid requests (created but not yet submitted bid requests). By clicking on the open bid request button, the buyer user can be linked to another web page displaying a list of the open bid requests with subsequent links to web pages that contain the actual open bid requests. Therefore, from the buyer home page 61a, the buyer user can link to any information pertaining to bids or projects that the buyer user has access to.

FIG. 4B illustrates a sample vendor home page 61b containing a number of system features available to the vendor user. For example, the vendor home page 61b can provide links to update the vendor profile (e.g., the types of goods and/or services the vendor provides), respond to received bid requests, process current projects or access a voucher processing system to view existing project event completion requests or process new project event completion requests. In FIG. 4B, the vendor user is also provided with the current status of pending bids and projects. For example, the vendor user can determine the number of bid requests that the vendor needs to respond to and the number of temporarily saved bid responses that the vendor has not yet completed. From the vendor home page 61b, the vendor user can link to additional web pages to complete vendor bid responses or access a newly received bid request to begin the vendor bid response.

FIG. 4C illustrates a sample contractor home page 61c containing a number of system features available to the contractor. For example, the first time a contractor user enters the contractor home page 61c, the contractor user may be directed to agree to various non-employee worker agreements before accessing any other information in the system. Each of the non-employee worker agreements can be displayed to the contractor user, and the contractor user can be prompted to agree to or otherwise accept the terms of the agreements before continuing. Once the contractor user has completed all of the agreements, the contractor user can access the time keeping system to enter contractor time, update their skills profile or provide re-deployment preferences. In addition, current activities associated with the contractor user may also be displayed to the contractor user at the contractor home page 61c, such as the number of interviews requested or interviews scheduled for additional projects.

FIG. 4D illustrates a sample administrator home page 61d containing a number of features available to an administrative user. For example, the administrative user can access information on buyers, vendors or contractors, link to web pages containing bid requests that need to be approved, approve a bid response to award the bid to a particular vendor, process a current project or access a voucher processing system to view existing vendor/contractor requests for project activity approval, such as contractor time cards. In addition, the current activities of the administrative user can also be displayed on the administrator home page 61d. For example, the number of bid requests awaiting approval, the number of new bid requests and the number of new vendor responses can be displayed to the administrative user. From the administrator home page 61d, the administrative user can link to any information pertaining to the bid process or project management that the administrative user has access to. For example, if the administrative user is a third-party administrator, the administrative user may have access to the bids and projects of all buyers and vendors registered with the system. However, if the administrative user is a buyer-employed administrator, the administrative user may only have access to bids and projects associated with the particular buyer.

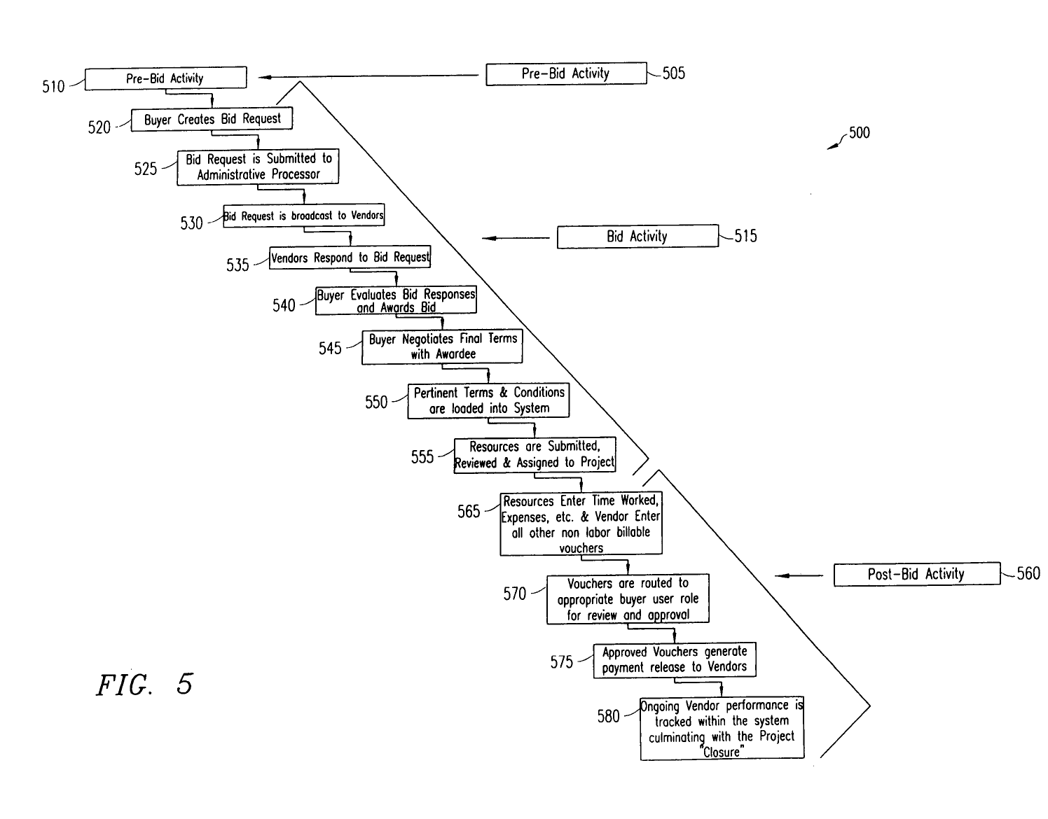

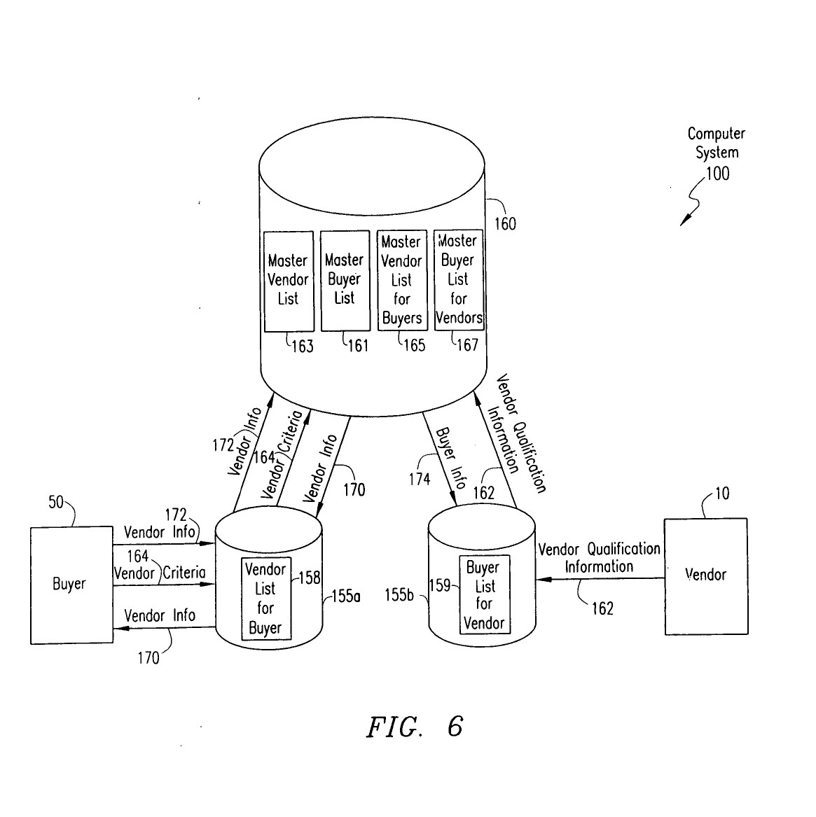

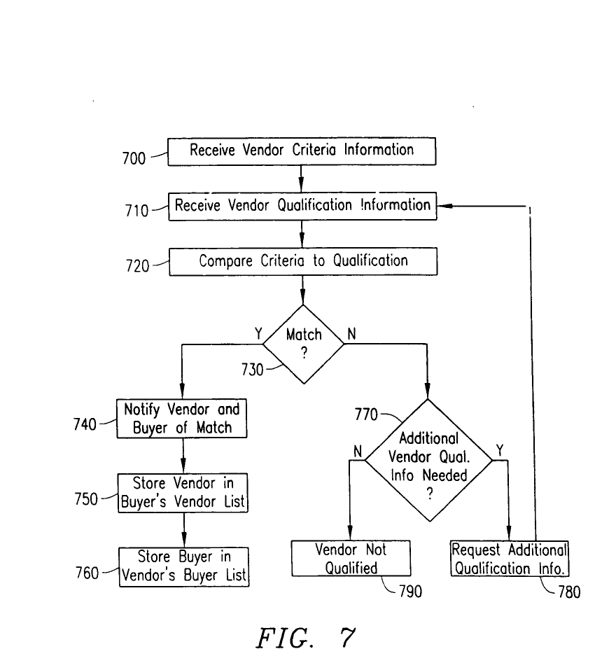

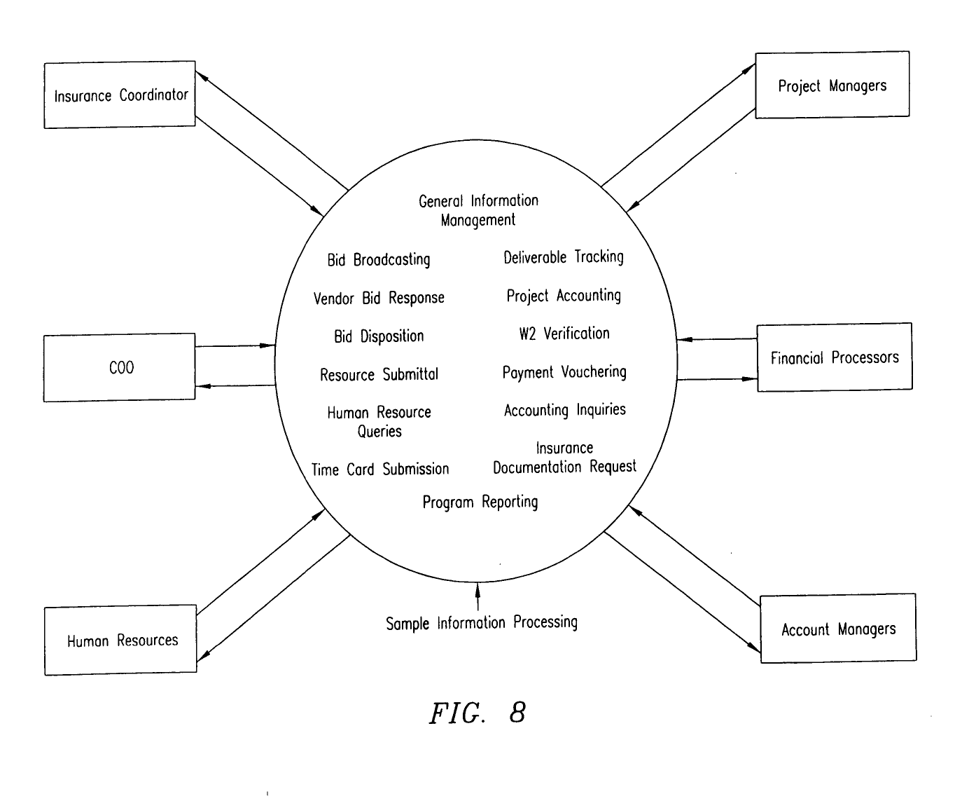

Exemplary steps in the bid/project process 500 handled by the project bid management system of the present invention are shown in FIG. 5. There are several aspects of the bid/project process that are handled prior to any bid requests being submitted (step 505). For example, a buyer may want to create a list of qualified vendors for particular bid requests types to reduce processing time during bid solicitation, as will be described in more detail below in connection with FIGS. 6 and 7. As another example, buyers, vendors and administrators may want to designate particular personnel to handle different components of the bid/project process for efficient routing of messages and information during the bid/project process, as will be described in more detail below in connection with FIGS. 8-14.

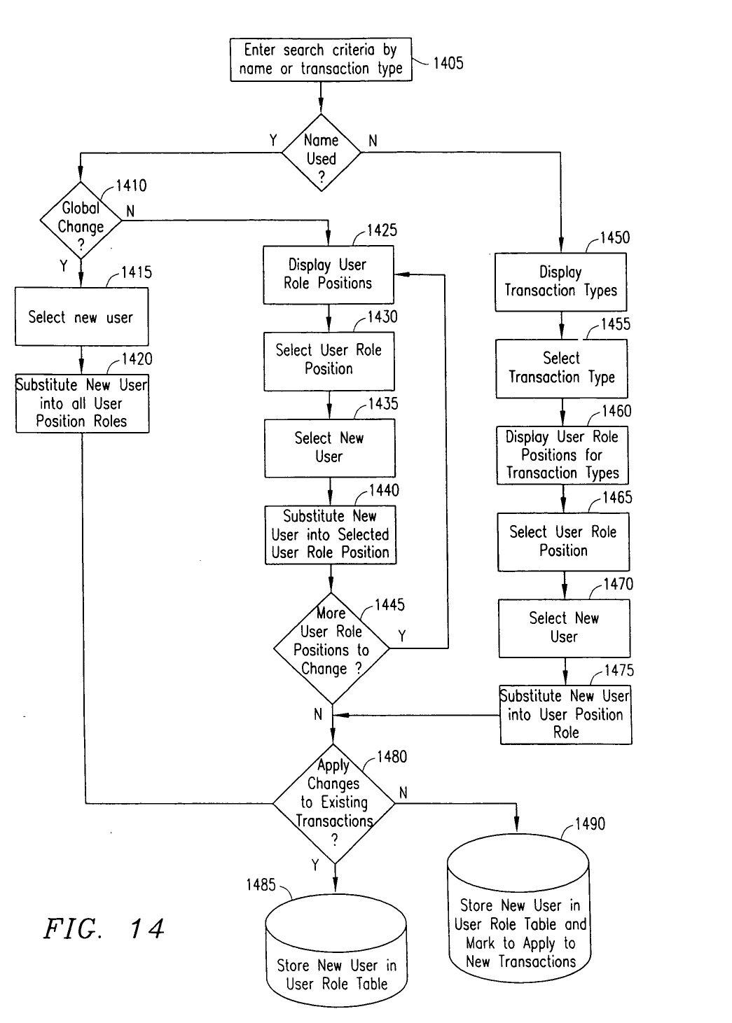

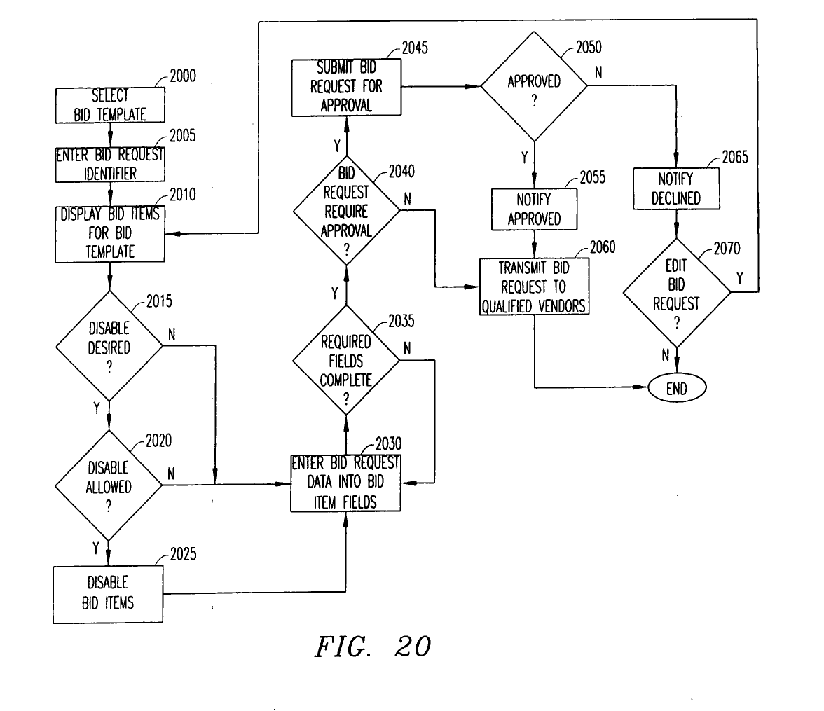

Once all of the pre-bid activity is completed (step 510), a buyer can create a bid request for a project (step 520), as will be described in more detail below in connection with FIGS. 15-29, and submit the bid request to an administrator for approval (step 525), if necessary, as will be described in more detail below in connection with FIG. 20. Most companies require approval of bid requests for budgetary purposes. However, if the buyer is an individual or small business, the buyer user creating the bid request may not need approval from any other party to submit the bid request.

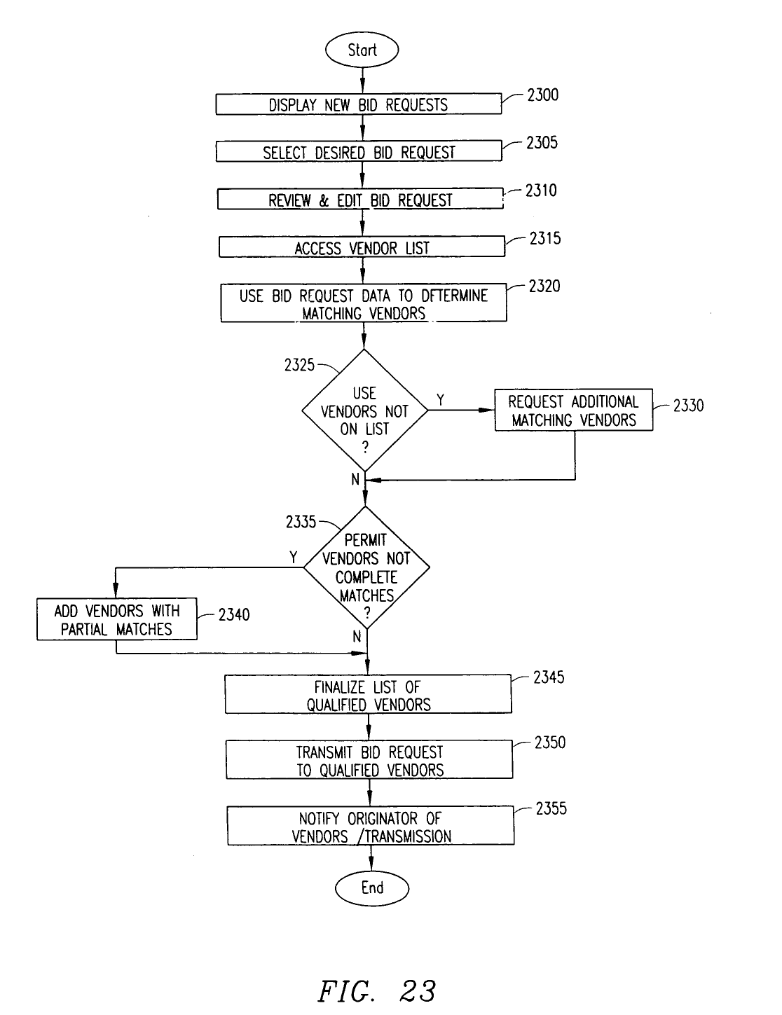

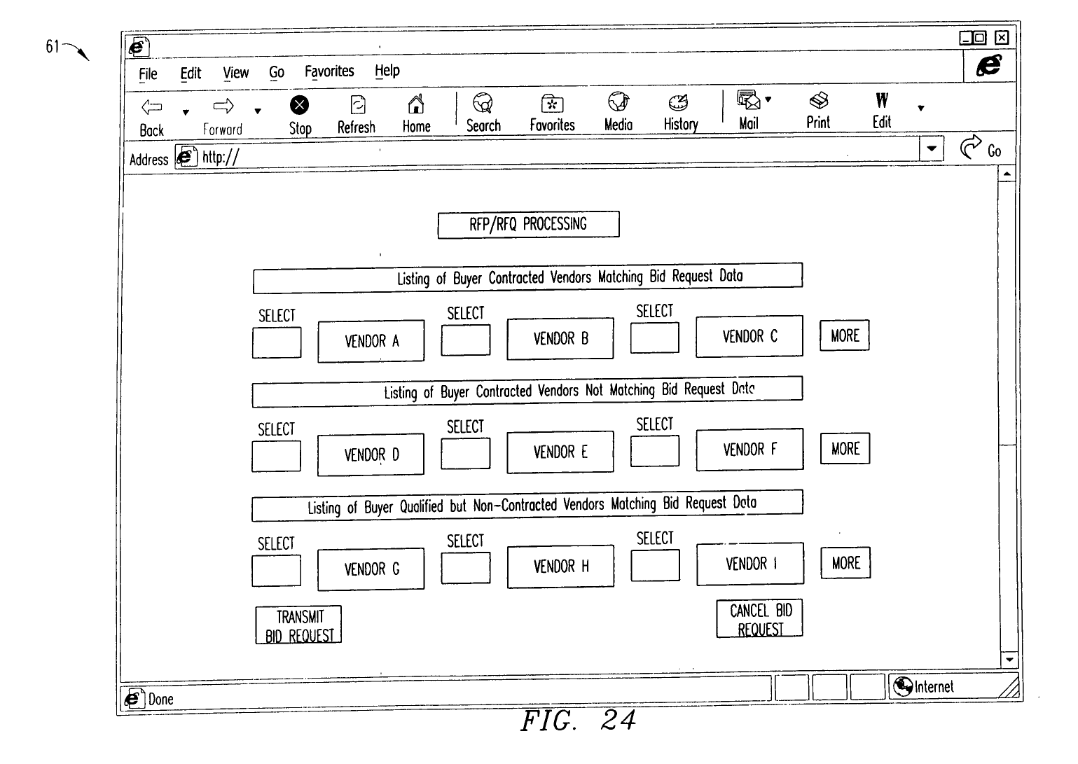

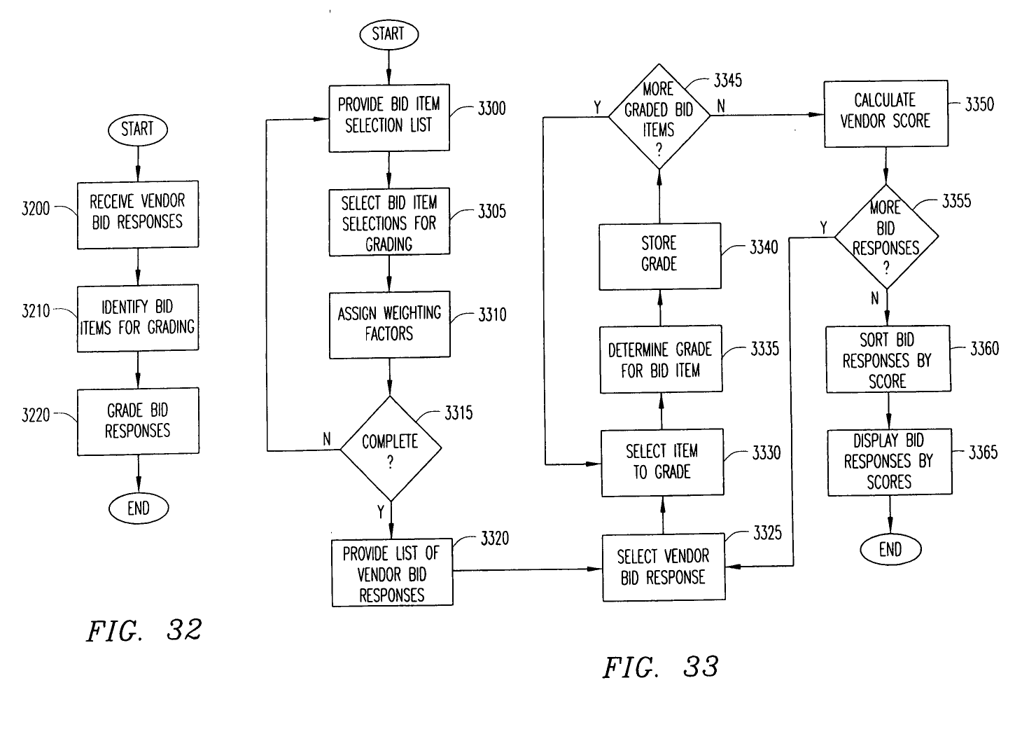

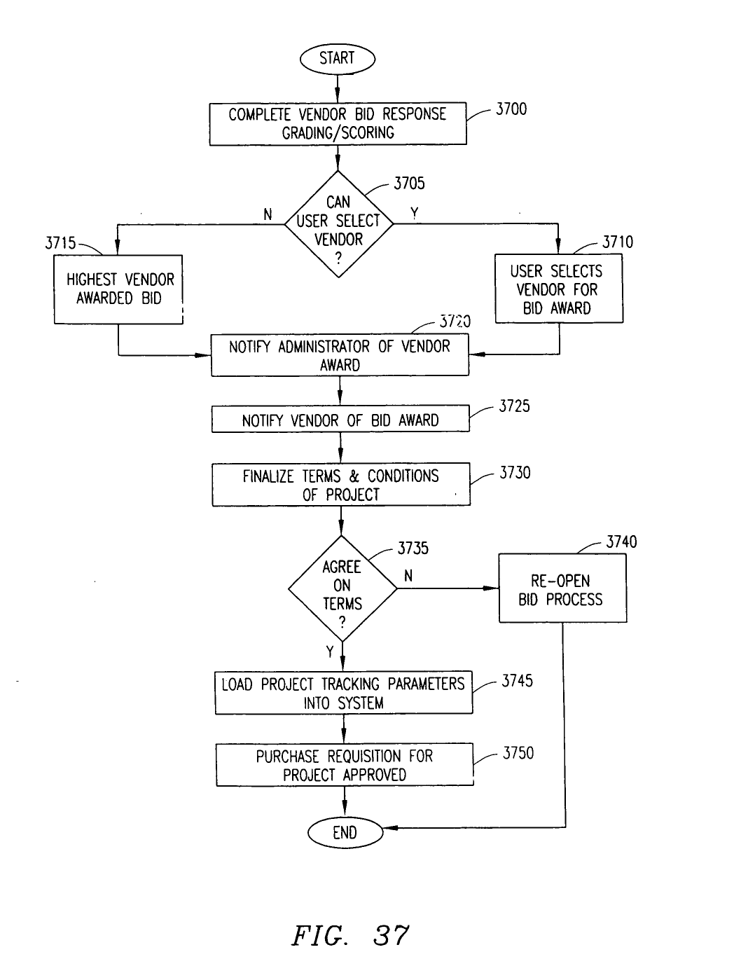

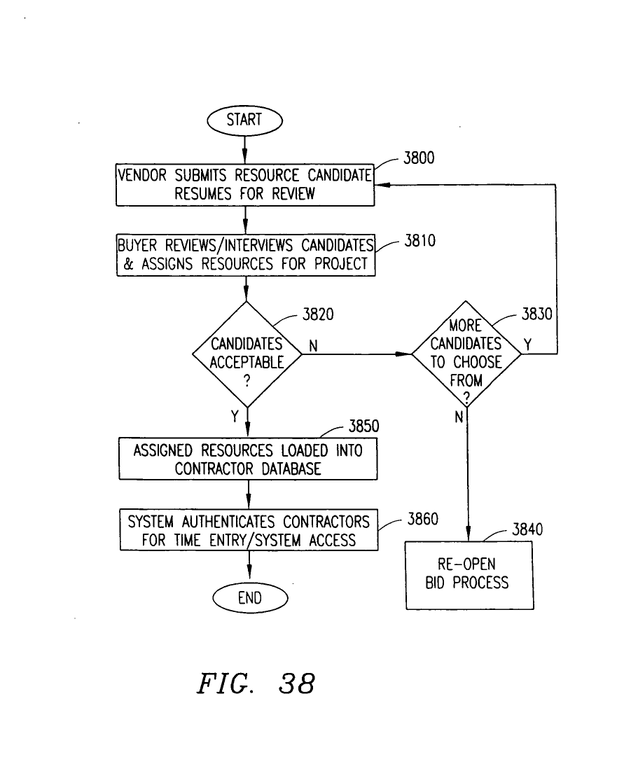

Once the bid request has been approved, the bid request is broadcast (e.g., made available to vendors via the system with optional notification via electronic mail) to qualified vendors (step 530), as will be described in more detail below in connection with FIG. 23, to solicit a bid response from the vendors (step 535). Each of the bid responses is evaluated by the buyer, as will be described in more detail below in connection with FIGS. 32 and 33, to determine which vendor bid response is the most qualified (step 540). After the buyer selects a particular vendor for the project, the buyer and vendor negotiate the final terms and conditions of the contract (step 545) and these terms and conditions can be loaded into the system for project tracking purposes (step 550), as will be described in more detail below in connection with FIG. 37. Thereafter, the vendor selects the specific resources (contractors) for the project, and if the terms of the project require buyer approval of resources, the buyer approves all of the assigned resources before the project ensues (step 555), as will be described in more detail below in connection with FIG. 38.

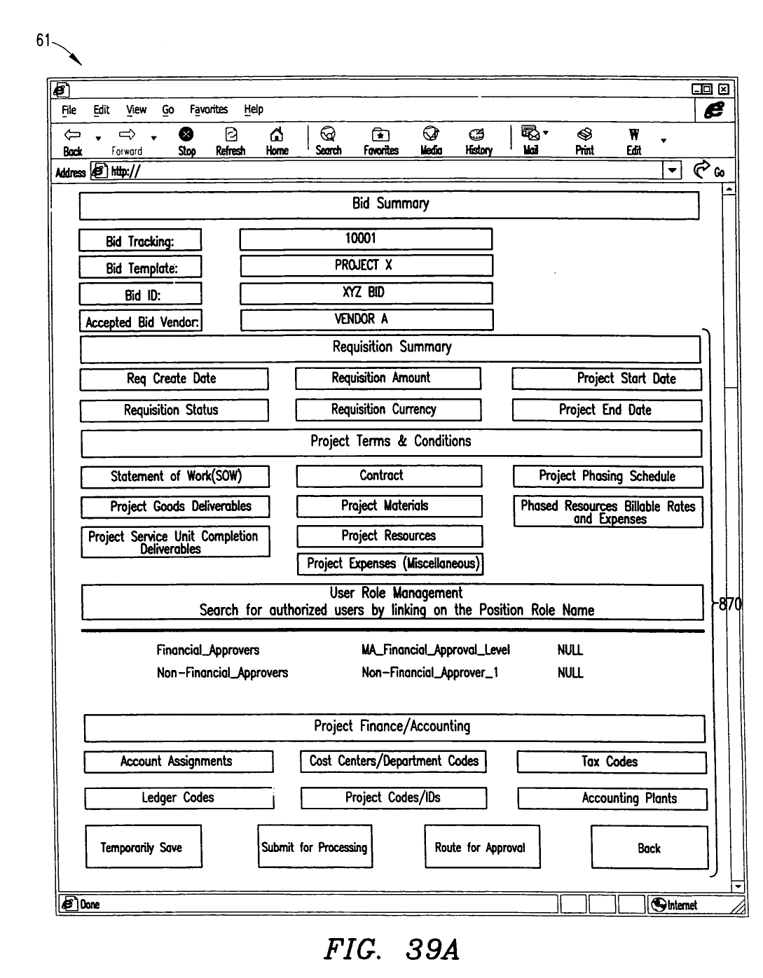

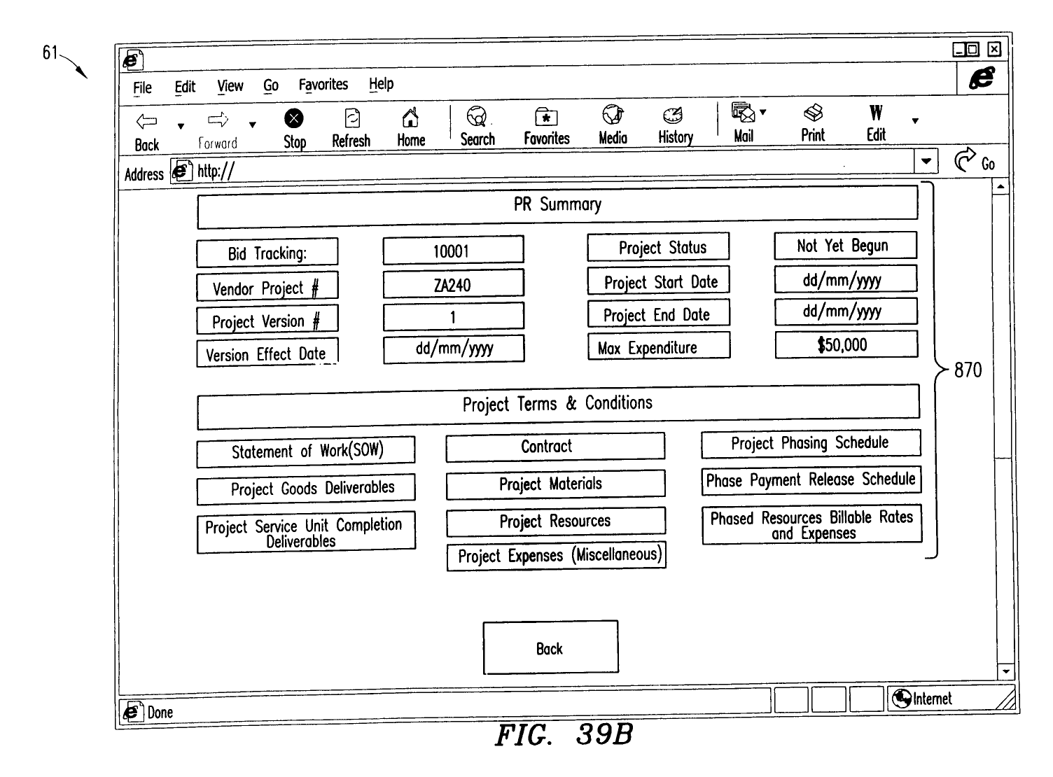

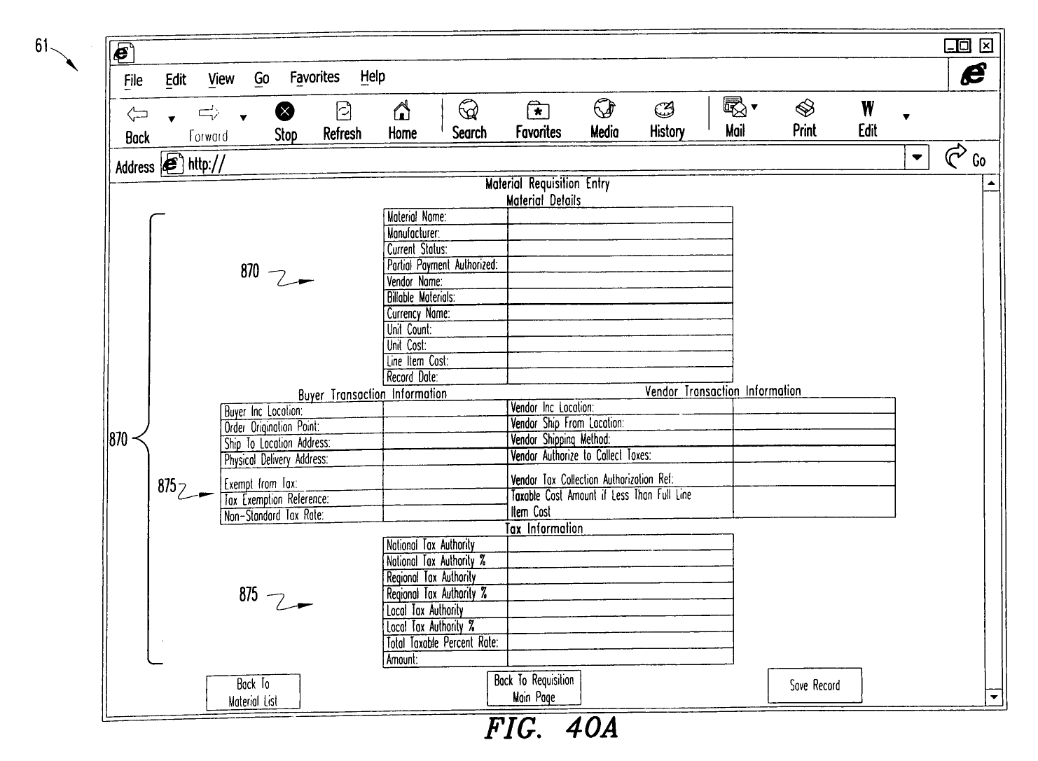

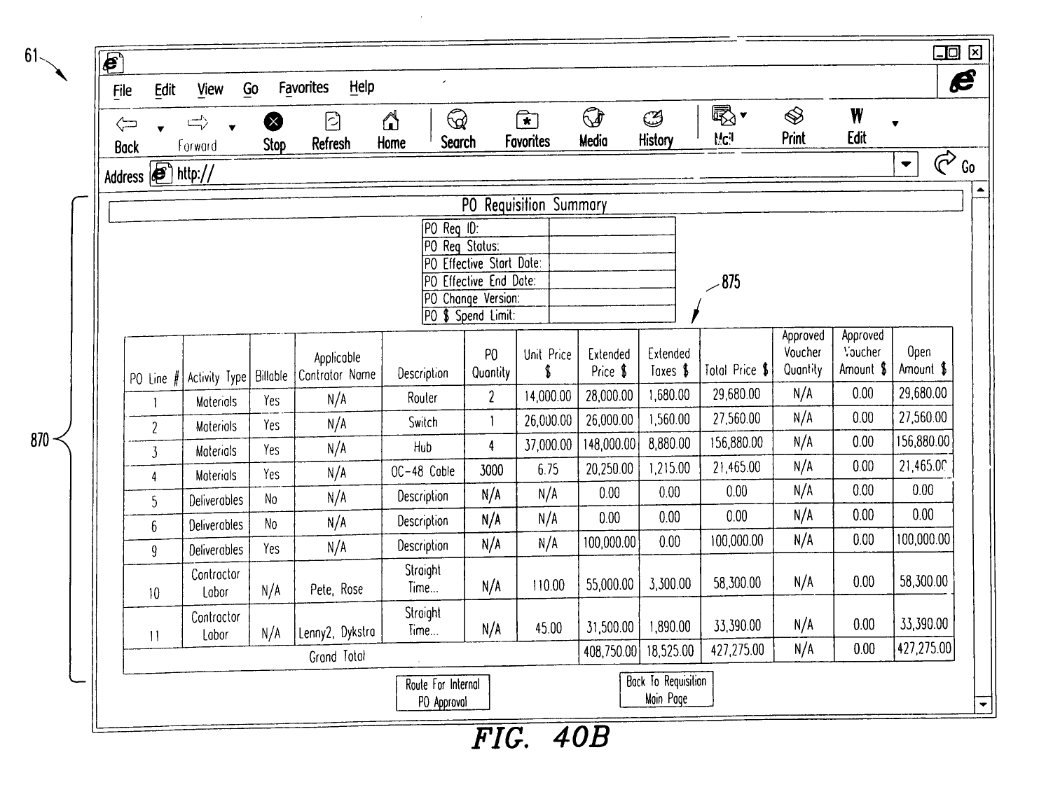

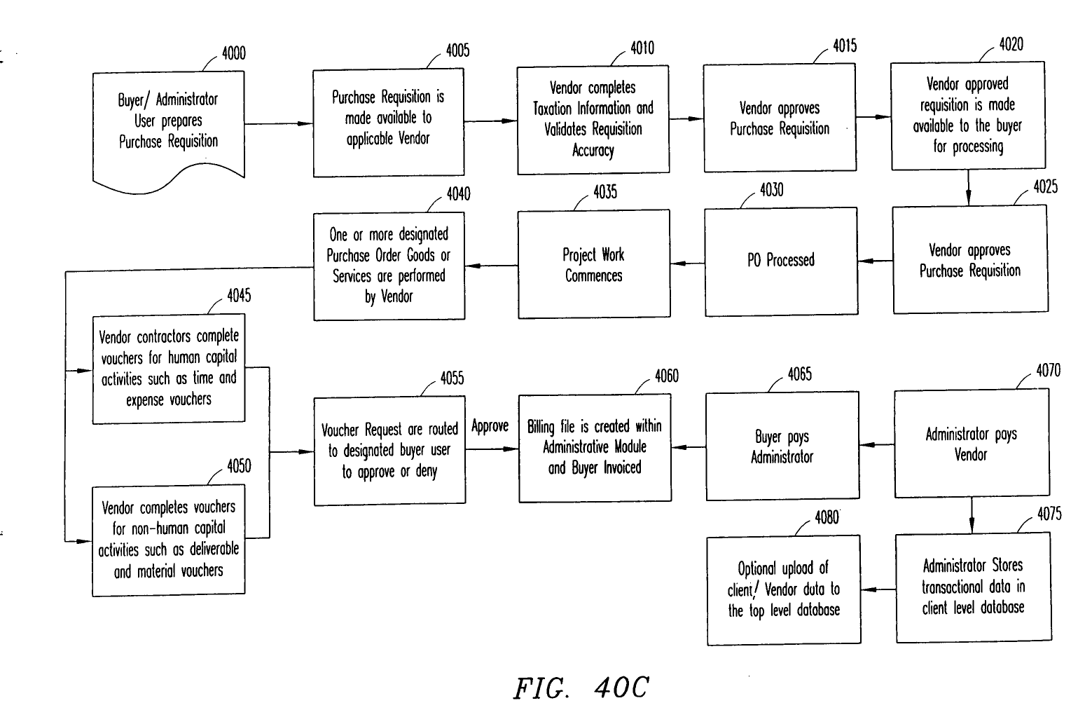

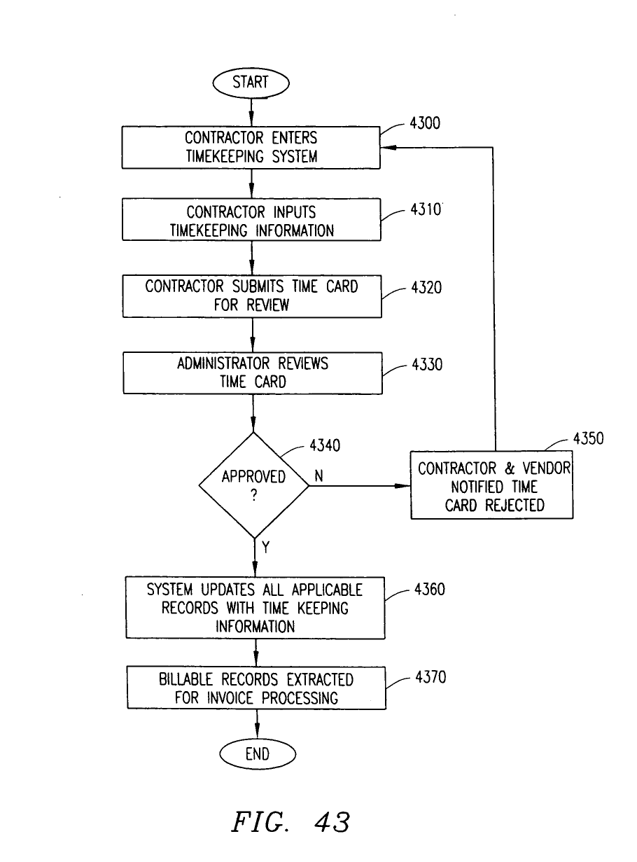

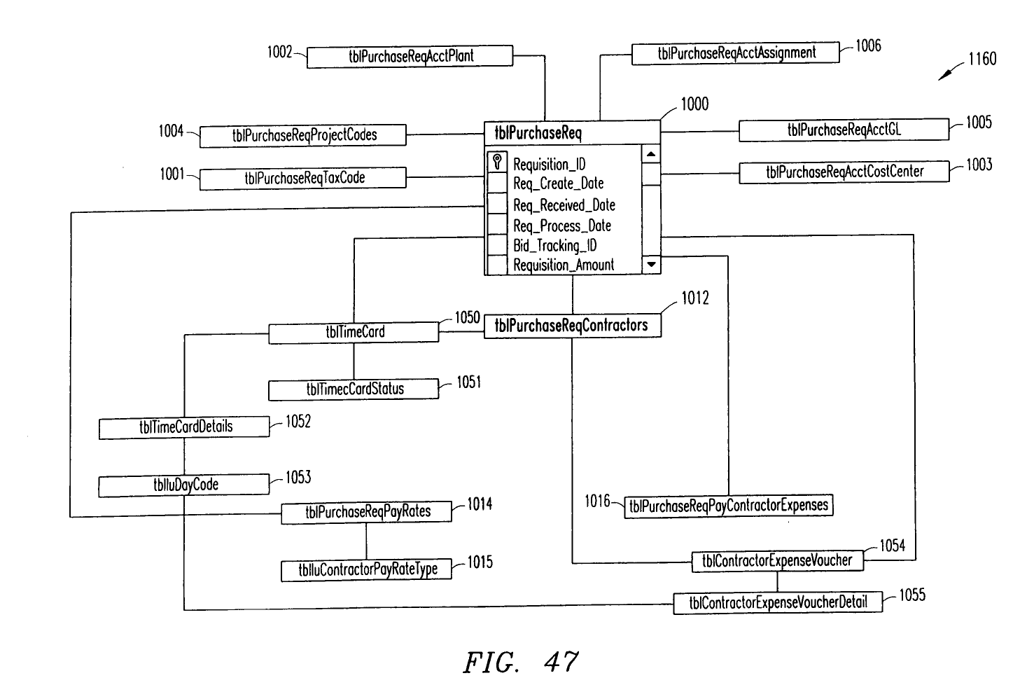

Once all of the bid activity is completed (step 515), the system is further capable of handling post-bid activity (step 560) to track the performance of the project and payment of vouchers during the course of the project. For example, the vendor and contractors assigned to the project can enter time worked and expenses into the system (step 565) for the generation of payable vouchers to be submitted to the buyer through the system, as will be described in more detail below in connection with FIG. 43. Upon receipt of the vouchers, the buyer and/or administrator can review and approve the vouchers for payment to the vendor (steps 570 and 575), as will be described in more detail below in connection with FIG. 49. Other project tracking parameters can also be entered into the system to track the performance of the vendor through project closure (step 580), as will be described in more detail below in connection with FIGS. 39 and 40. Each of the main components of the bid/project process (pre-bid activity, bid activity and post-bid activity) will now be discussed separately hereinbelow. Additionally, analysis and reporting of the data collected during the bid/project process will be discussed separately hereinbelow.

Pre-Bid Activity

As discussed above, a buyer 50 may want to pre-qualify vendors 10 for particular project types to reduce the amount of processing required for each bid request submitted. Referring now to FIG. 6, to facilitate vendor qualification for buyers, the computer system 100 can enable buyers 50 to establish buyer-defined vendor criteria data 164 for vendors and store the buyer-defined vendor criteria data 164 within the top-level database 160 in a master buyer list 161. The computer system 100 can further acquire pertinent vendor qualification data 162 from vendors 10 and store the vendor qualification data 162 in the top-level database 160 in a master vendor list 163.

For example, the vendor qualification data 162 can identify the specific goods and/or services that the vendor 10 provides and the specific geographical areas that the vendor 10 is capable of supplying these goods and/or services, along with other vendor information, such as the size of the vendor, whether the vendor has insurance, whether the vendor is certified in certain industries, etc. The buyer-defined vendor criteria data 164 can identify the specific goods and/or services that the buyer 50 desires, the specific geographical areas that the buyer 50 wants the goods and/or services and other buyer constraints, such as the preferred size of the vendor, requisite vendor insurance needs, requisite vendor certifications, etc.

Based on the vendor qualification data 162 and buyer-defined vendor criteria data 164, the computer system 100 can determine which vendors 10 have the requisite qualifications for buyers 50 and provide qualified vendor information 170 (e.g., name, address, and any other vendor information that the buyer needs) to the buyer 50 for review. If the buyer 50 or optionally the administrator 80 approves of the vendor 10, the buyer 50 can add the vendor information 170 to a vendor list 158, which is stored in the buyer database 155a. In addition, vendor information 172 for those vendors 10 that the buyer 50 previously qualified can also be stored in the vendor list 158. Furthermore, a master copy of the vendor list 158 (i.e., Master Vendor List for Buyers 165) can be stored in the top-level database 160 for redundancy and updating purposes.

Buyer information 174 (e.g., name, address and other information that the buyer agrees to provide) can also be downloaded to the vendor database 155b for storage in a buyer list 159 therein. In addition, a master copy of the buyer list 159 (i.e., Master Buyer List for Vendors 167) can be stored in the top-level database 160 for redundancy and updating purposes. However, it should be understood that if the computer system 100 is implemented solely at the buyer network, the top-level database 160 would not store master copies 165 and 167, and the buyer 50 would perform vendor qualification using only the vendor information 172 known to the buyer 50 or provided directly to the buyer 50 by the vendor 10. For a complete discussion of qualifying vendors 10 for buyers 50 based on vendor qualification data 162 and buyer-defined vendor criteria data 164, reference is made to co-pending and commonly-assigned U.S. patent application Ser. No. 10/141,801, which is hereby incorporated by reference in its entirety herein.

Exemplary steps for qualifying vendors for buyers are shown in FIG. 7. Once the buyer-defined vendor criteria information is established (step 700) and vendor qualification information from a vendor is received (step 710), the buyer-defined vendor criteria information is compared to the vendor qualification information (step 720) to determine whether the vendor qualification information matches the buyer-defined vendor criteria information (step 730). If so, the vendor and buyer are notified of the match (step 740), and if the buyer approves of the vendor, the vendor information associated with the vendor is stored in the buyer's vendor list for later use in preparing bid requests (step 750). In addition, the buyer information can be stored in the vendor's buyer list for reference when receiving bid requests and preparing bid responses (step 760).

However, if the vendor qualification information does not match the buyer-defined vendor criteria information (step 730), the system determines whether additional vendor qualification information is needed to qualify the vendor for the buyer (step 770). If so, the vendor is requested to provide this additional vendor qualification information (step 780) to qualify the vendor for the buyer (step 710). If not, the vendor is not qualified for the buyer (step 790), and the vendor is not added to the buyer list.

In addition to qualifying vendors for buyers, vendors, buyers and administrators may want to designate certain personnel to handle various aspects of the bid/project process to synchronize communications, data and transaction processing across multiple user platforms. For example, referring now to FIG. 8, the bid/project process typically requires the inclusion of a broad spectrum of information processing and functional departments to facilitate the administration and management of the bid/project process. Such information processing can include, for example, bid request broadcasting, vendor bid responses, bid disposition (evaluation and award), resource submittal, time card submission, deliverables tracking and payment vouchering. Each of these information processing components may be handled by one or more different individuals or departments, such as the COO, Human Resources department, Project User and Financial Processor. To meet this functional need, the computer system of the present invention can enable a shared work environment, where the buyer, vendor and/or administrator can specify multiple custom user roles that need to participate in the bid/project process and designate personnel (resources) to each of the user roles for all bid/projects or for particular bid/projects.

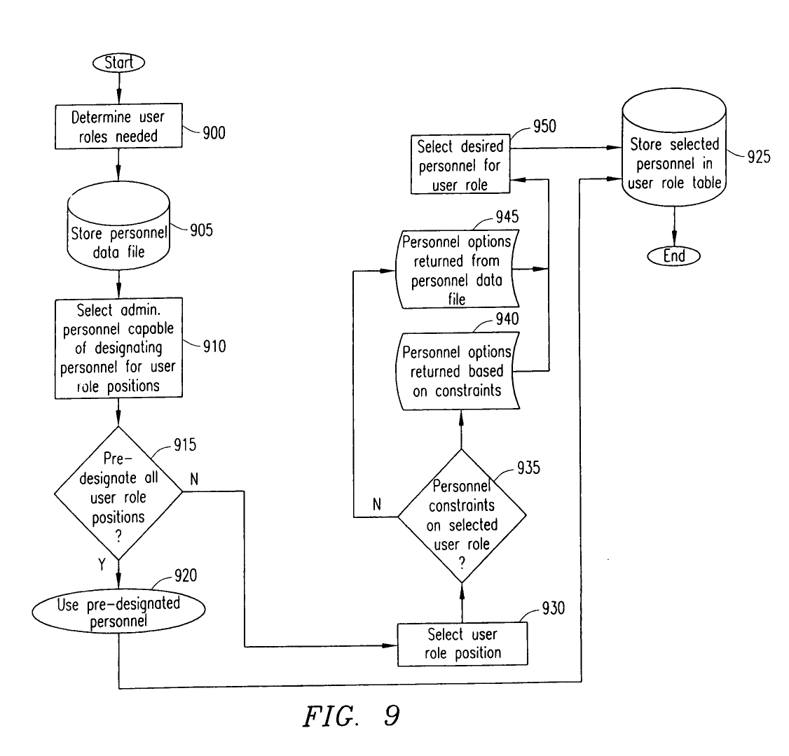

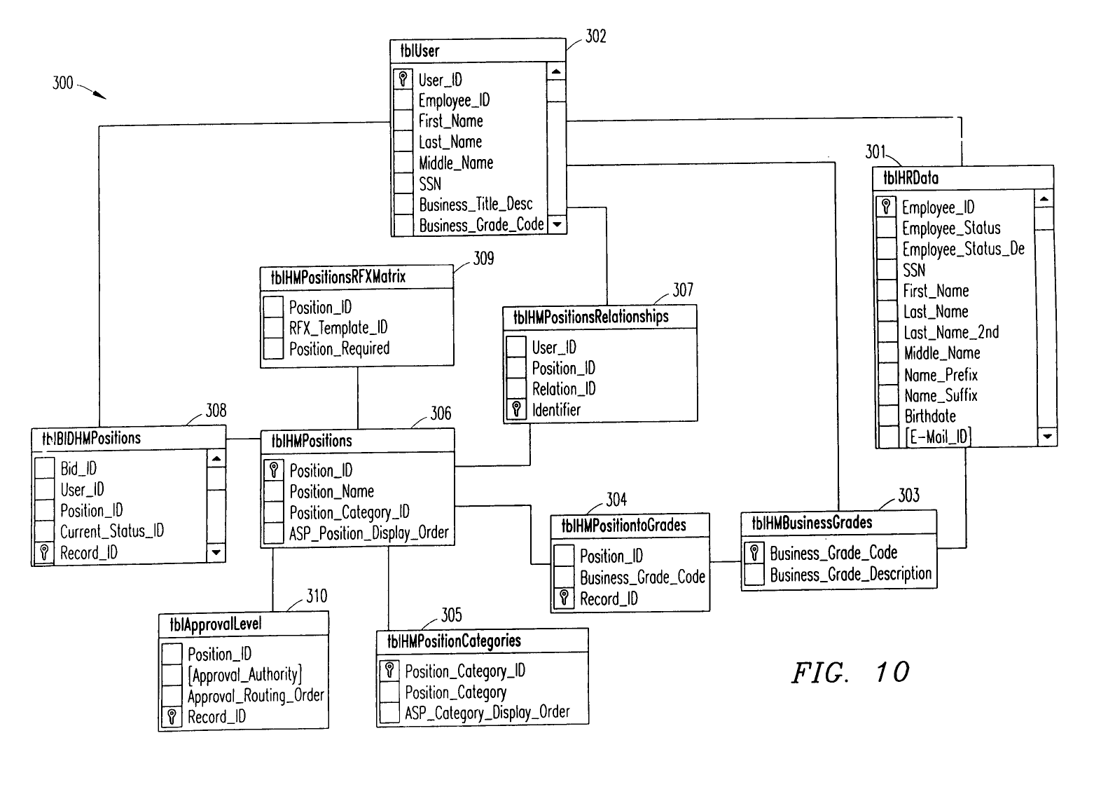

Referring now to FIG. 9, there is illustrated exemplary steps for specifying user role positions and assigning personnel to the user role positions for a vendor, buyer or administrator. Initially, the vendor, buyer or administrator determine the specific user role positions that are needed for the bid/project process (step 900). For example, as shown in the sample buyer web page of FIG. 11, the buyer may determine that there is a need for several different user role categories, such as financial approvers, non-financial approvers, time card reviewers, administrate delegates, project milestone administrators, financial coordinators and human resource partners during the project/bid process. The vendor, buyer or administrator may further determine that multiple user role positions within one or more of the user role categories are needed for the bid/project process. For example, as shown in FIG. 11, the buyer may determine that there is a need for six financial approvers and two non-financial approvers.

Referring again to FIG. 9, once the user role positions are determined, a data file for the pertinent personnel of the vendor, buyer or administrator is stored for use in selecting appropriate personnel for each of the user role positions (step 905). One or more key personnel of the vendor, buyer or administrator (e.g., the COO, Project User, etc.) can be selected to designate the particular personnel to be assigned to each of the user role positions (step 910), or alternatively, the system can assign personnel to user role positions based on the information contained in the personnel data file. In some companies, user role positions are pre-designated (step 915), and in this case, the pre-designated personnel can be loaded into the system (step 920) and stored in a user role table (step 925). For example, for most vendors, personnel is pre-assigned to various user role positions for all projects. In other companies, one or more of the user role positions may not be pre-designated at all or not pre-designated for a particular project (step 915), and in this case, the selected key personnel or the system can assign specific personnel to the user role positions.

To assign specific personnel to user role positions, the specific user role position is selected (step 930), and a list of personnel that can be assigned to that user role position, depending upon user role constraints, is determined from the personnel data file (steps 935, 940 and 945). For example, if a user role position requires a particular level user, only those personnel at the particular user level or higher are included on the list. From the list of personnel for the user role position, one of the personnel is selected for the particular user role position (step 950) and the selected personnel is stored in the user role table (step 925). For example, as shown in FIG. 11, upon selecting a particular user role position (e.g., clicking on a user role position), the system can search for qualified personnel for the user role position, and after a selection has been made, the selected personnel for the user role position can be displayed.

Examples of data structures for selecting and assigning user role positions for a buyer are shown in Tables 1-9 hereinbelow. The data structures are illustrated for simplicity as being organized in a table format, with each table including all of the fields necessary for defining and assigning user role positions for the buyer. The tables are related in a hierarchical and/or relational manner, so that all of the necessary information for user role positions can be accurately stored and accessed, as will be described hereinbelow in connection with the exemplary database table structure 300 of FIG. 10. However, it should be understood that other buyer user role configurations can be included, and the system is not limited to the specific buyer user role configurations listed in Tables 1-9 or FIG. 10.

Tables 1 and 2 below illustrate sample user role categories and user role positions within each of the user role categories, respectively, which can be stored in the database in tables tblHMPositionCategories 305 and tblHMPositions 306, respectively, as shown in FIG. 10. In Table 1, each user role category is assigned an identification number and a display order for display on a web page. The user role category identification numbers are used within the user role positions table (Table 2) to correlate the user role positions with the specific user role categories. However, it should be understood that there could be numerous additional categories and positions, depending on the needs of the buyer. When initially selecting the user role positions, the user role categories can be displayed for the user to select from, with links to the specific user role positions within each of the categories. After all user role positions have been selected for the particular buyer, the selected user role positions and assigned personnel can be displayed as in FIG. 11.

TABLE 1

| Position_{—} | | ASP_Category_{—} |
|---|---|---|
| Category_ID | Position_Category_Name | Display_Order |
| 1 | Financial_Approvers | 1 |
| 2 | Non-Financial_Approvers | 2 |
| 3 | Timecard_Reviewers | 3 |
| 4 | Administrative_Delegates | 4 |
| 5 | Project_Milestone_Administrators | 5 |
| 6 | Financial_Coordinators | 6 |
| 7 | Human_Resource_Partners | 7 |
| 8 | Security_Partners | 8 |
| 9 | Regulatory_Compliance_Partners | 9 |

TABLE 2
Exemplary User Role Positions (tblHMPositions)

| | | Position_{—} |
|---|---|---|
| Position_ID | Position_Name | Category_ID |
| 1 | MA_Financial_Approval_Level | 1 |
| 2 | MB_Financial_Approval_Level | 1 |
| 3 | MC_Financial_Approval_Level | 1 |
| 4 | MD_Financial_Approval_Level | 1 |
| 5 | ME_Financial_Approval_Level | 1 |
| 6 | MF_Financial_Approval_Level | 1 |
| 7 | Non-Financial_Approver_1 | 2 |
| 8 | Non-Financial_Approver_2 | 2 |
| 9 | Timecard_Reviewer_1 | 3 |
| 10 | Timecard_Reviewer_2 | 3 |
| 11 | Administrative_Delegate_1 | 4 |
| 12 | Administrative_Delegate_2 | 5 |
| 13 | Project_Milestone_Administrator_1 | 5 |
| 14 | Project_Milestone_Administrator_2 | 5 |
| 15 | Financial_Coordinator_1 | 6 |
| 16 | Financial_Coordinator_2 | 6 |
| 17 | Human_Resource_Partner_1 | 7 |
| 18 | Human_Resource_Partner_2 | 7 |
| 19 | Project_Bid_Originator | 4 |
| 20 | Security_Administrator | 8 |
| 21 | Regulatory_Compliance_Administrator | 9 |

Table 3 below illustrates sample data stored within the personnel date file for each user of the system, which can be stored in the database in table tblUser 302, as shown in FIG. 10. From this user data, the qualified personnel for each user role position can be determined, and the requisite information for each assigned user for each user role position can be ascertained. One of the fields within Table 3 is the business grade assigned to the particular user. The business grade indicates the particular level of the user in the business system. For example, the user may be a level 3 user, and this information would be stored in the user table. The available business grades can be mapped to the user role positions, as shown in Tables 4 and 5 below to indicate the business grade required for the user assigned to each user role position which can be stored in the database in tables tblHMBusinessGrades 303 and tblHMPositiontoGradeMap 304, as shown in FIG. 10.

TABLE 3
Base System User Table (tblUser)

| Column | Data Type | Length |
|---|---|---|
| User_ID | int | 4 |
| Employee_ID | nvarchar | 10 |
| First_Name | nvarchar | 50 |
| Last_Name | nvarchar | 50 |
| Last_Name_2^{nd} | nvarchar | 50 |
| Middle_Name | nvarchar | 10 |
| SSN | nvarchar | 50 |
| Business_Title_Description | nvarchar | 50 |
| Business_Grade_Code | nvarchar | 10 |
| Business_Grade_Description | nvarchar | 50 |
| Financial_Approval_Level | int | 4 |
| Birthdate | datetime | 8 |
| Business_Unit_Name | nvarchar | 100 |
| [Dept/Cost_Center] | nvarchar | 10 |
| Dept_Name | nvarchar | 50 |
| Work_Location_Code | numeric | 9 |
| Location_Type | nvarchar | 50 |
| Location_Address1 | nvarchar | 50 |
| Location_Address2 | nvarchar | 50 |
| Location_City | nvarchar | 50 |
| Location_State | nvarchar | 50 |
| Location_Country | nvarchar | 50 |
| Location_Zip | nvarchar | 4 |
| Country_ID | int | 4 |
| Work_Phone_Number | nvarchar | 50 |
| Fax_Number | nvarchar | 50 |
| [E-Mail] | nvarchar | 50 |
| User_Name | nvarchar | 50 |
| Password | nvarchar | 50 |
| Active | bit | 1 |
| Last_Logged_In | datetime | 8 |
| Date_Updated | datetime | 8 |
| US_Date_Format | bit | 1 |
| Currency_ID | int | 4 |

TABLE 4
Base Business Grade Table (tblHMBusinessGrades)

| Column Name | Data Type | Length |
|---|---|---|
| Business_Grade_Code | nvarchar | 10 |
| Business_Grade_Description | nvarchar | 50 |

TABLE 5
User Role to Business Grade Mapping Table
(tblHMPositiontoGradeMap)

| Column Name | Data Type | Length |
|---|---|---|
| Position_ID | int | 4 |
| Business_Grade_Code | nvarchar | 10 |
| Record_ID | int | 4 |

Tables 6-9 below will be described in more detail hereinbelow in connection with FIG. 10.

TABLE 6
Position/Role to Bid Template Mapping Table
(tblHMPositionsRFXMatrix)

| Column Name | Data Type | Length |
|---|---|---|
| Position_ID | int | 4 |
| RFX_Template_ID | int | 4 |
| Position_Required | char | 1 |

TABLE 7
Default User Role Mapping Table (tblHMPositionsRelationships)

| Column Name | Data Type | Length |
|---|---|---|
| User_ID | int | 4 |
| Position_ID | int | 4 |
| Relation_ID | int | 4 |
| Identifier | int | 4 |

TABLE 8
User Role to Bid Request Mapping Table (tblBidHMPositions)

| Column Name | Data Type | Length |
|---|---|---|
| Bid_Tracking_ID | int | 4 |
| User_ID | int | 4 |
| Position_ID | int | 4 |
| Relation_ID | int | 4 |
| Current_Status_ID | int | 4 |
| Record_ID | int | 4 |

TABLE 9
User Position/Role to Approval Level and Hierarchy Mapping
(tblApprovalLevel)

| Column Name | Data Type | Length |
|---|---|---|
| Position_ID | int | 4 |
| [Approval_Authority] | money | 8 |
| Approval_Routing_Order | numeric | 9 |
| Record_ID | int | 4 |

As can be seen in FIG. 10, there is a concise relationship between all the fields necessary to enable configurable work sharing and specific workflow components for the buyer. The database structure 300 is scalable and configurable, so that even when operating within a less sophisticated database environment, the functionality still exists as long as user role positions are specified and a personnel data file is available. It should be understood that similar database table structures are available to the vendor and administrator, which will be discussed in more detail hereinbelow.

The database table structure 300 for the buyer takes as input personnel data (tblHRdata 301) from the buyer and creates a personnel data file (tblUser 302) including the specific personnel that may be involved in the shared work environment. The personnel data is shown as table tblHRdata 301 for simplicity purposes. However, it should be understood that the personnel data may be in any form, depending on the buyer database system. Periodic downloads from the table tblHRdata 301 to the table tblUser 302 can be performed to update the system as to the current employees of the buyer to ensure that user role positions are properly assigned. The various business grades designated by the buyer can also be stored in table tblHMBusinessGrades 303 and mapped to table tblUser 302 for individual assignment of business grades, as discussed above in connection with Tables 3 and 4. In addition, the business grades can be mapped to the selected user roles in table tblHMPositiontoGrade 304, as discussed above in connection with Tables 4 and 5.

The user role categories table (tblHMPositionCategories 305) and user role positions table (tblHMPositions 306), and their interrelation to the position grades and assigned personnel are also shown in FIG. 10. For example, table tblHMPositionsRelationship 307 includes the user ID of the assigned personnel to each user role position. If user role positions are associated with specific bid template types (as described in more detail hereinbelow in connection with FIG. 15), the user role positions for each bid template type can be stored in table tblHMPositionsRFXMatrix 309. Furthermore, if user role positions are assigned specific to each bid transaction, the user ID of the assigned personnel to each user role position for a specific transaction can be stored in table tblBidHMPositions 308.

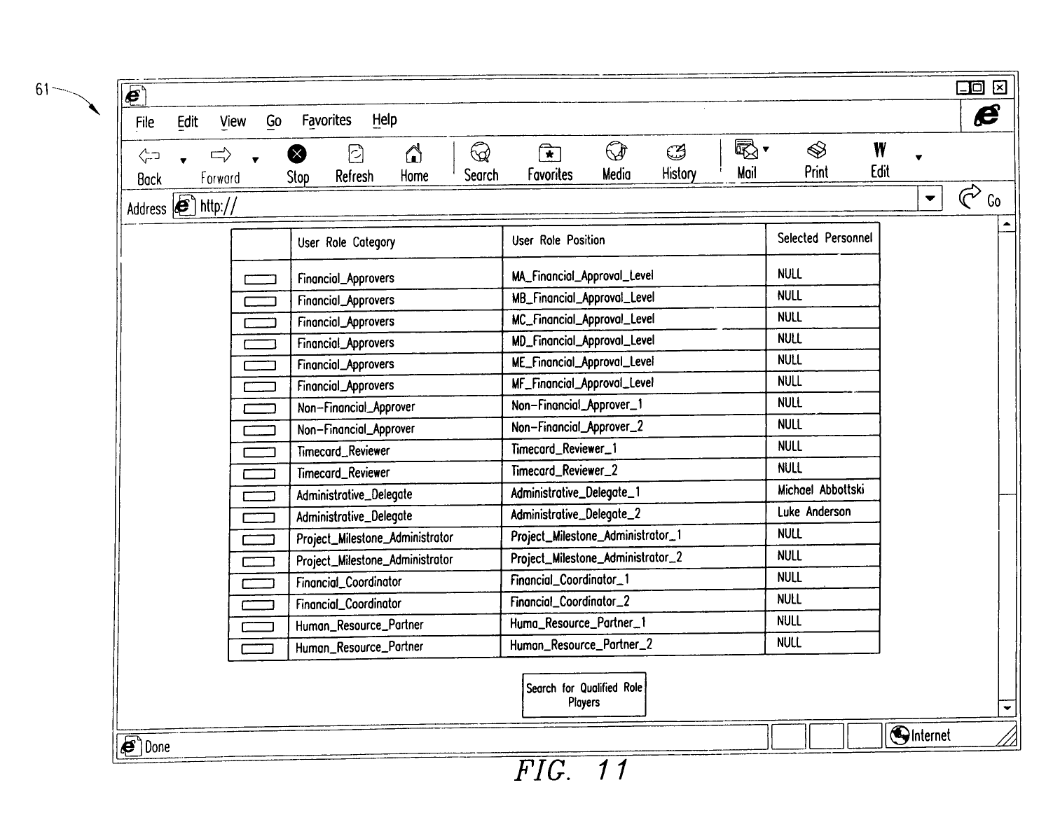

Exemplary steps for a buyer to assign personnel to user role positions during a transaction are shown in FIG. 12. Upon initiation of a transaction (step 1200) (e.g., creation of a bid template or bid request, broadcasting of the bid request, receipt of bid response, evaluation of bid response, awarding of bid, payment of voucher, etc.), the system and/or key personnel determines whether all of the required user role positions for the transaction have been defined (step 1205). If not, the system and/or key personnel define the user role positions necessary for the transaction (step 1210).

Once the user role positions have been ascertained, the system and/or key personnel determines whether specific personnel (also referred to herein as users) have been pre-designated for the user role positions (step 1215) and whether any of the pre-designated users need to be changed for the transaction (step 1220). If one or more user role positions do not have a pre-designated user or if one or more pre-designated users should be changed, the system and/or key personnel designates the appropriate user for all user role positions (step 1225) and stores the identity of the designated users for the user role positions in the user role table (step 1230) (e.g., tblBidHMPositions in FIG. 10). If all users are pre-designated, the system stores the pre-designated personnel (step 1230), and if applicable, notifies the appropriate personnel of the transaction (step 1240).

Referring again to FIG. 10, in addition to assigning users to specific user role positions for a bid/project process, the database table structure 300 further provides the ability to designate transactions that require approving and specific approvers for a variety of reasons. Therefore, within a table tblApprovalLevel 310, certain user role positions can be classified as approval positions, and for each approval position, the routing order for approval can be specified. For example, a user role position approver (Approver A) can be designated to approve all transactions generated by another user role position (User B), so that the system automatically routes all transactions from User B to Approver A.

In addition, each user can be provided access rights to view and modify data within the system. For example, one user role position may have the authority to modify or enter data in the system through a first web page, while another user role position may only have the authority to view the data through a second web page. Thus, although the information displayed on the web page may be the same to both users, the actual web pages are different, depending on the approval level of the user role position. When a user logs in to the system, the system determines the approval level of the user and pushes the appropriate web pages to the user. An example of a data structure implementing user role to web page access mapping is shown below in Table 10.

TABLE 10
User Role to Web Page Access Mapping Table

| Column Name | Data Type | Length |
|---|---|---|
| ASP_Object_ID | int | 4 |
| Position_ID | int | 4 |
| Read_Access | char | 1 |
| Write_Access | char | 1 |
| Record_ID | int | 4 |

In order to maintain the relationship between user role positions, internal personnel and specific transactions in an ongoing manner, the system of the present invention is further designed to account for shifts in organizational personnel and the business level and user authority of personnel. Referring now to FIG. 14, there is illustrated exemplary steps for modifying user role position assignments, in accordance with embodiments of the present invention. A user role position can be re-assigned based on the user name or the transaction type (step 1400). If the modification is made based on the user name (step 1405), the change can be made globally to all user role positions held by the user or to only specific user role positions held by the user. For global changes (step 1410), a new user is selected (step 1415) and the new user is substituted for the previous user for all user role positions held by the previous user (step 1420). This type of global change is necessary, for example, when an employee leaves the company, and a new employee takes the exiting employee's position within the company.

For specific user role position changes (step 1410), all of the user role positions held by the user can be displayed (step 1425), and one of the user role positions can be selected for changes (step 1430). A new user is chosen for that selected user role position (step 1435) and the new user is substituted for the previous user for that selected user role position (step 1440). This process can be repeated for each user role position that requires a change (step 1445). Specific user role position changes may occur for a number of reasons, such as promotion, reorganization, employee status changes (e.g. full-time to part-time), etc.

If the modification is made based on the transaction type (step 1405), a listing of all transaction types (e.g., bid request creation, bid request broadcasting, bid request receipt, bid response generation, bid response receipt, bid evaluation, bid award, time keeping, vouchering payment, etc.) can be displayed (step 1450), and a particular transaction type is selected (step 1455). All of the user role positions associated with that particular transaction type can be displayed (step 1460) and the particular user role position to be modified is selected (step 1465). A new user is chosen for that selected user role position (step 1470), and the new user is substituted for the previous user for that selected user role position (step 1475). Transaction type modifications may be beneficial, for example, when the particular user for a user role position is unknown, but a change is required due to customer complaints.

The user role position modifications can be applied to existing transactions or only to new transactions (step 1480), depending on the reason for the modification and the need for continuity in existing transactions. If the modification is to be applied to existing transactions, the user role table is updated with the new user and the previous user record is modified to outdated (step 1485). However, if the modification is only to be applied to new transactions, the user role table is updated with the new user, but the previous user is not deleted, and the new user is marked for new transactions only (step 1490).

For the vendor, user role positions are typically pre-designated to limit access to qualified personnel. Examples of data structures implementing vendor user roles are shown in Tables 11-13 hereinbelow. As can be seen, the vendor personnel can be assigned a vendor contact type, which can be mapped to access rights to view and modify data within the system, similar to that described above for the buyer in connection with Table 10. However, it should be understood that other vendor user role configurations can be included, and the system is not limited to the specific configurations listed in Tables 11-13.

TABLE 11
Exemplary Vendor Roles (tblVendorRoles)

| | | ASP |
|---|---|---|
| VendorContactTypeID | Description | Display Order |
| 1 | CEO | 1 |
| 2 | CFO | 2 |
| 3 | COO | 3 |
| 4 | Financial Processing Supervisor | 6 |
| 5 | Staffing Personnel | 7 |
| 6 | Account User | 5 |
| 7 | Project User | 8 |
| 8 | Chief Counsel | 4 |

TABLE 12
Exemplary Vendor Contacts (tblVendorContacts)

| Column Name | Data Type | Length |
|---|---|---|
| VendorContactID | int | 4 |
| vcVendorContactGUID | uniqueidentifier | 16 |
| vcPermissionLevel | int | 4 |
| vcContactTypeID | int | 4 |
| vcFirstName | varchar | 50 |
| vcLastName | varchar | 50 |
| vcPositionTitle | varchar | 100 |
| vcSalutation | varchar | 50 |
| vcAddress1 | varchar | 50 |
| vcAddress2 | varchar | 50 |
| vcCity | varchar | 50 |
| vcState | varchar | 50 |
| vcCountryID | varchar | 50 |
| vcPostalCode | varchar | 20 |
| vcEmail | varchar | 50 |
| vcVendorID | int | 4 |
| vcLoginName | varchar | 50 |
| vcPassword | varchar | 50 |
| vcStatusID | int | 4 |
| vcDateExpire | datetime | 8 |
| vcInternationalFlag | varchar | 50 |

TABLE 13
Exemplary Vendor Roles Permissions (tblVendorRolePermissions)

| Column Name | Data Type | Length |
|---|---|---|
| ASP_Object_ID | int | 4 |
| VendorContactTypeID | int | 4 |
| Write_Access | char | 1 |
| Read_Access | char | 1 |
| Current_Status_ID | int | 4 |
| Record_ID | int | 4 |

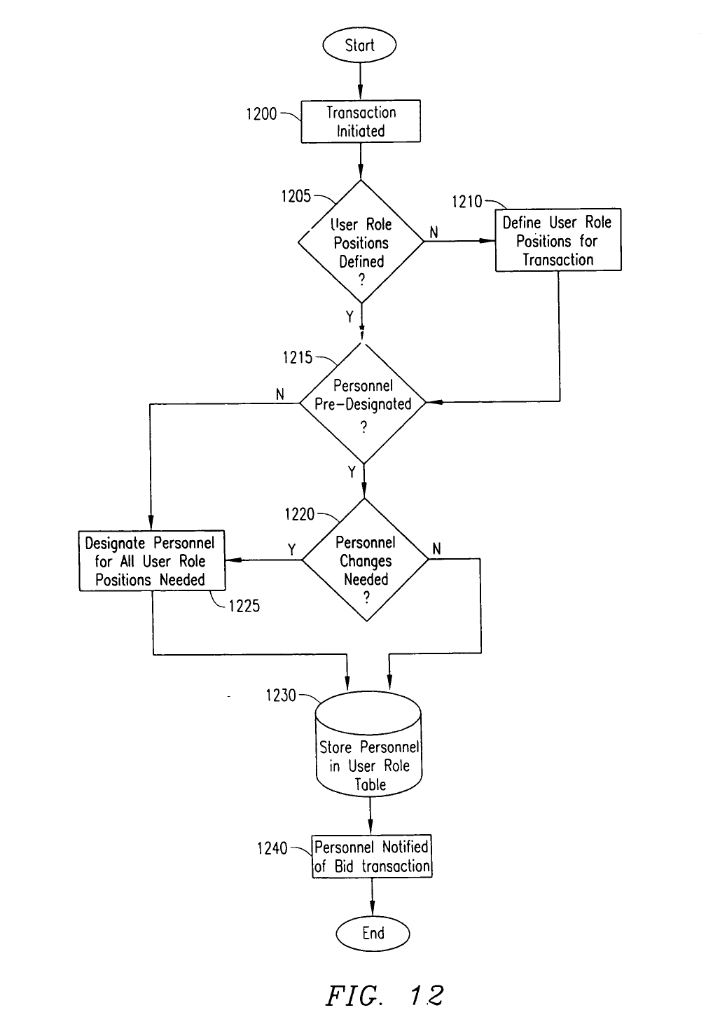

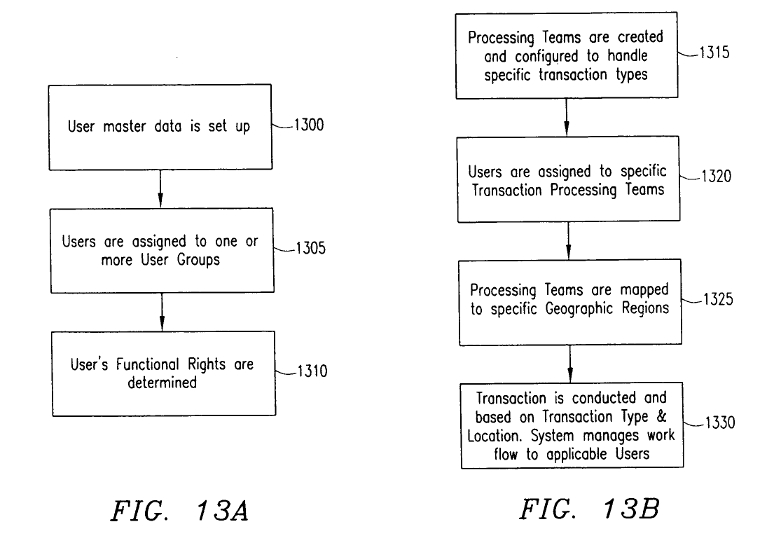

For the administrator, user role positions can be defined to enable entire processing teams and team members to be specified in order to administer transactional activity associated with specific bid types and for specific locations. Referring now to FIGS. 13A-13B, exemplary steps for implementing an administrative processing team are shown. Initially, an administrative user table for the administrator is established containing administrative user master data (step 1300). From the user table, various users can be assigned to one or more user groups and the mapping of users to user groups can be stored in a user group mapping table (step 1305). The user groups can be associated with business units within a company or transaction types or both. For each of the user groups, the functional rights and responsibilities of each user within the user group can be defined in a user group rights table (step 1310). For example, each user can be assigned access rights (as discussed above in connection with FIG. 10) for the user group. Examples of data structures implementing user groups and user group rights for the administrator are shown in Tables 14-19 hereinbelow. However, it should be understood that other administrator user role configurations can be included, and the system is not limited to the specific administrator user role configurations listed in Tables 14-19.

TABLE 14
Exemplary Administrative User Table

| Column Name | Data Type | Length |
|---|---|---|
| Administrative_ID | int | 4 |
| mLastName | varchar | 50 |
| mFirstName | varchar | 50 |
| Middle_Initial | varchar | 50 |
| Job_Title_ID | int | 4 |
| mloginName | varchar | 10 |
| mPassword | varchar | 10 |
| Permission | varchar | 50 |
| Phone | varchar | 50 |
| Fax | varchar | 50 |
| mEmail | varchar | 50 |
| Home_Address1 | varchar | 50 |
| Home_Address2 | varchar | 50 |
| City | varchar | 50 |
| State | varchar | 50 |
| Zip | varchar | 20 |
| Home_Phone | varchar | 50 |
| Mobile_Phone | varchar | 50 |
| Location_ID | int | 4 |
| Date_of_Birth | smalldatetime | 4 |
| Social_Security_No | varchar | 20 |
| Date_Start_with_Administrator | smalldatetime | 4 |
| Date_Start_with_Buyer | smalldatetime | 4 |
| Schooling_ID | int | 4 |
| Technical_Certifications | varchar | 50 |
| Primary_Language_ID | int | 4 |
| Secondary_Language_ID | int | 4 |
| MS_Excel_Proficiency | int | 4 |
| MS_Access_Proficiency | int | 4 |
| MS_Word_Proficiency | int | 4 |
| MS_PowerPoint_Proficiency | int | 4 |
| Application_Efficiency | int | 4 |
| Communication_Skills_ID | int | 4 |
| mActive | char | 1 |
| Supervisor | int | 4 |
| Last_Eval_Date | smalldatetime | 4 |
| Next_Eval_Date | smalldatetime | 4 |
| Employee_Type_ID | int | 4 |

TABLE 15
Exemplary Administrative User Group Table Values

| Admin_User_Group_ID | Admin_User_Group_Name |
|---|---|
| 1 | General_Administration |
| 2 | Business_Support |
| 3 | Customer_Service |
| 4 | Requisition_Transaction_Processors |
| 5 | Staff_Management |
| 6 | Staff_Professional |
| 7 | Supplier_Management |
| 8 | Systems_Admin |
| 9 | Application_Support |
| 10 | Financial_Processors |
| 12 | RFX_Transaction_Processors |

TABLE 16
Exemplary Administrative User to User Group Mapping Table

| Column Name | Data Type | Length |
|---|---|---|
| Administrative_ID | Int | 4 |
| User_Group_ID | Int | 4 |
| Record_ID | int | 4 |
| Date_Created | datetime | 8 |
| Creator_ID | int | 4 |
| Current_Status_ID | int | 4 |
| Last_Edit_Date | datetime | 8 |
| Last_Edited_By | int | 4 |

TABLE 17
Exemplary Administrative User Group Rights Table

| Column Name | Data Type | Length |
|---|---|---|
| ASP_Page_ID | int | 4 |
| User_Group_ID | int | 4 |
| Record_ID | int | 4 |
| Read_Access | char | 1 |
| Write_Access | char | 1 |

Once the user groups have been ascertained, as shown in FIG. 13B, processing teams can be created within the user groups to handle specific transaction types (step 1315). All of the users within a particular user group can be mapped to specific processing teams and assigned a routing order for the particular transaction type (step 1320). Exemplary data structures for creating and mapping users to processing teams are shown in Tables 18 and 19 hereinbelow.

TABLE 18
Exemplary Administrative Processing Teams Table

| Column Name | Data Type | Length |
|---|---|---|
| Team_ID | int | 4 |
| Team_Name | varchar | 50 |
| Staff_Supplementation | char | 1 |
| Project_Work | char | 1 |
| RFX_Processing | char | 1 |
| Requisition_Processing | char | 1 |
| Invoice_Processing | Char | 1 |
| Help_Desk_Processing | Char | 1 |
| Quality_Assurance_Processing | Char | 1 |
| Created_By | Int | 4 |
| Last_Edited_By | Int | 4 |
| Last_Edit_Date | Datetime | 8 |
| Current_Status_ID | Int | 4 |

TABLE 19
Exemplary Administrative Processing Teams to User Mapping Table

| Column Name | Data Type | Length |
|---|---|---|
| Administrative_ID | Int | 4 |
| Team_ID | int | 4 |
| Date_Created | datetime | 8 |
| Record_ID | int | 4 |
| Created_By | int | 4 |
| Current_Status_ID | int | 4 |
| Last_Edited_By | int | 4 |
| Last_Edit_Date | datetime | 8 |

In addition, processing teams can be mapped to specific geographic regions, so that different processing teams can handle the same type of transaction in different regions (step 1325). Therefore, when a particular type of transaction is conducted in a particular location, the system can manage the workflow to the appropriate users based on the transaction type and location (step 1330). For example, the appropriate users can be notified of the transaction via an e-mail and/or dashboard update.

Thus, the user role management supported by the system of the present invention provides a flexible, scalable and robust work-sharing environment for the entire bid/project process from bid creation to project completion. In addition, the system enables secure communications and transaction processing based upon user roles, which enables users to interface with the correct personnel at the right times while insuring that data view and access rights are limited to those users that have a functional need for the access.

Bid Activity

After the pre-bid activity is completed, a buyer can create and transmit a bid request to one or more vendors to solicit a bid response from the vendors for a particular project. To facilitate the bid process in the context of a complete bid/project process, bid templates can be used for specific project types to solicit the requisite information from vendors for the specific project type in a uniform and comprehensive manner to enable efficient and effective evaluation of bid responses.

Exemplary functionality for creating a bid request utilizing a bid template is shown in FIG. 15. A bid template creation tool 180 and bid request creation tool 185 are illustrated in FIG. 15 for the creation of bid templates 240 and bid requests 200 from the bid templates 240, respectively, in accordance with embodiments of the present invention. The bid template creation tool 180 and bid request creation tool 185 can include any hardware, software and/or firmware required to perform the functions of the tools, and can be implemented within the web server 120 or an additional server (not shown). Each buyer can create one or more bid templates 240, depending on the nature of project work outsourced by the buyer. For example, if the buyer has a need for staff supplementation in only one department, the buyer may create only one bid template 240 to handle the staff supplementation bid requests 200.

To create a bid template 240, the bid template creation tool 180 accesses the buyer database 155a to retrieve bid items 230 within a bid item list 194 and provides the buyer with the bid item list 230 via the buyer module 110, web server 120, data network 40 and buyer browser 20a for the buyer to choose from. The bid items 230 are associated with specific types of information to be solicited from the buyer, vendor or both. From the list of bid items 230, the buyer selects and provides one or more bid item selections 235 for inclusion in a bid template 240. Depending on buyer configurations, one or more of the bid items 230 may be mandatory for the bid template 240, such as the name of the buyer, location of the work to be performed and type of project work requested. For one or more of the mandatory bid items 230, in addition to including the mandatory bid items 230 in the bid template 240, the specific information associated with each of the mandatory bid items 230 can also be included in fields associated with the mandatory bid items 230 within the bid template 240. For example, the buyer name and project work type can be stored in the bid template 240 for that project work type. Each bid template 240 created by the buyer is stored in the buyer database 155a within a bid template list 190 for later use in creating a bid request 200.

To create a bid request 200, the bid request creation tool 185 accesses the buyer database 155a to retrieve the bid templates 240 stored within the bid template list 190 and provides a list of bid templates 240 to the buyer via the buyer module 110, web server 120, data network 40 and buyer browser 20a for the buyer to choose from. Upon selecting an appropriate bid template 240, the buyer provides bid request data 210 to the bid request creation tool 185 for inclusion in a bid request 200 of the bid template 240 type. For example, the buyer can enter bid request data 210 into provided fields for each bid item selection 235 that requires information from the buyer within the bid template 240. By way of example, but not limitation, the bid request data 210 could include the location of work to be performed, the timing of the project and the specific vendor qualifications necessary for the project.

The bid request creation tool 185 further interfaces with the buyer database 155a to access the vendor list 158 for the buyer and determine the appropriate vendors to receive the bid request. The appropriate vendors can be selected based on the bid template 240 type and any other vendor qualifications included within the bid request 200 itself. Thus, the vendor list 158 can be separated into pre-qualified vendors for bid template 240 types to further reduce processing time when submitting bid requests 200. The bid request creation tool 185 further uses vendor contact information 250 associated with the selected vendors to broadcast (transmit) the bid request 200 to the appropriate vendors (as shown in FIGS. 1 and 2) via the vendor module 115, web server 120, data network 40 and vendor browser 20b, and stores the submitted bid request 200 in a bid request list 196 for the buyer.

Vendor bid responses 220 received from solicited vendors (as shown in FIGS. 1 and 2) can further be stored in the buyer database 155a in a bid response list 198 for later use in comparing and grading vendor bid responses 220. The vendor bid responses 220 are generated from the bid items included in the bid request 200. Specifically, the vendor populates data associated with the vendor and the bid response in data fields within enabled bid items in the bid request 200. Vendors access the bid request 200 via the vendor module 115 to view the bid request and complete the vendor response and submit completed bid responses 220 via the vendor module 115 for storage in the buyer database 155a via the buyer module 110 (step not shown). The bid response 220 can include data retrieved from a vendor database 115b (not shown) and can be stored in the vendor database 155b during and after the bid response creation.

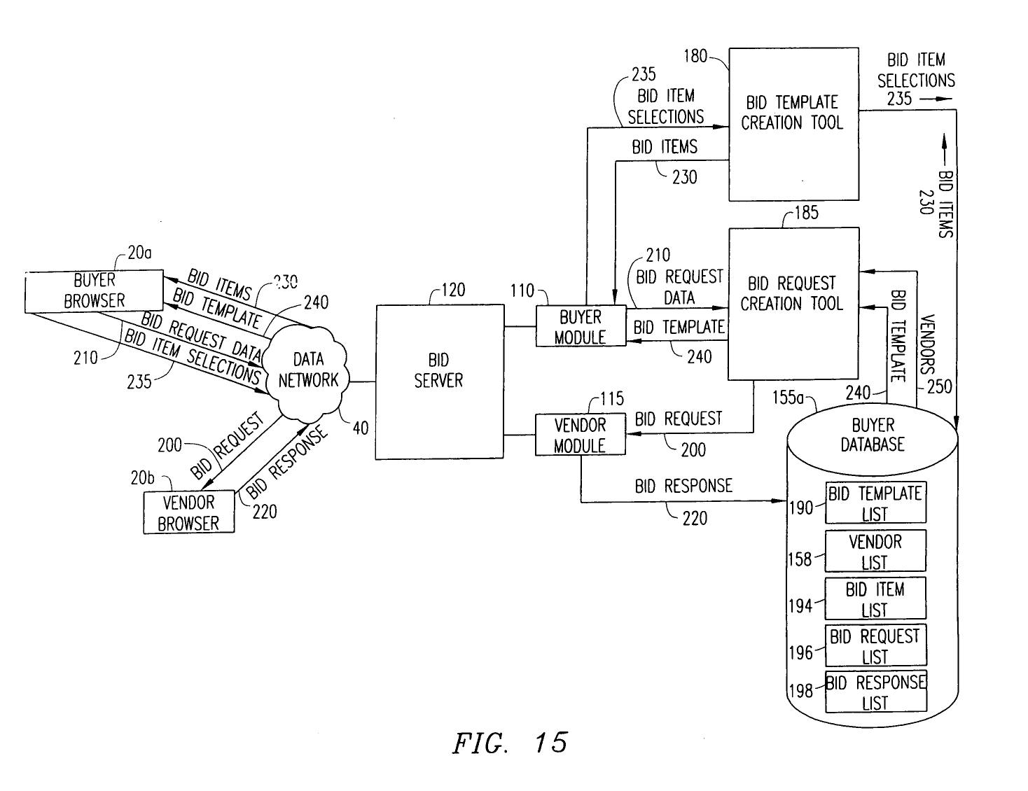

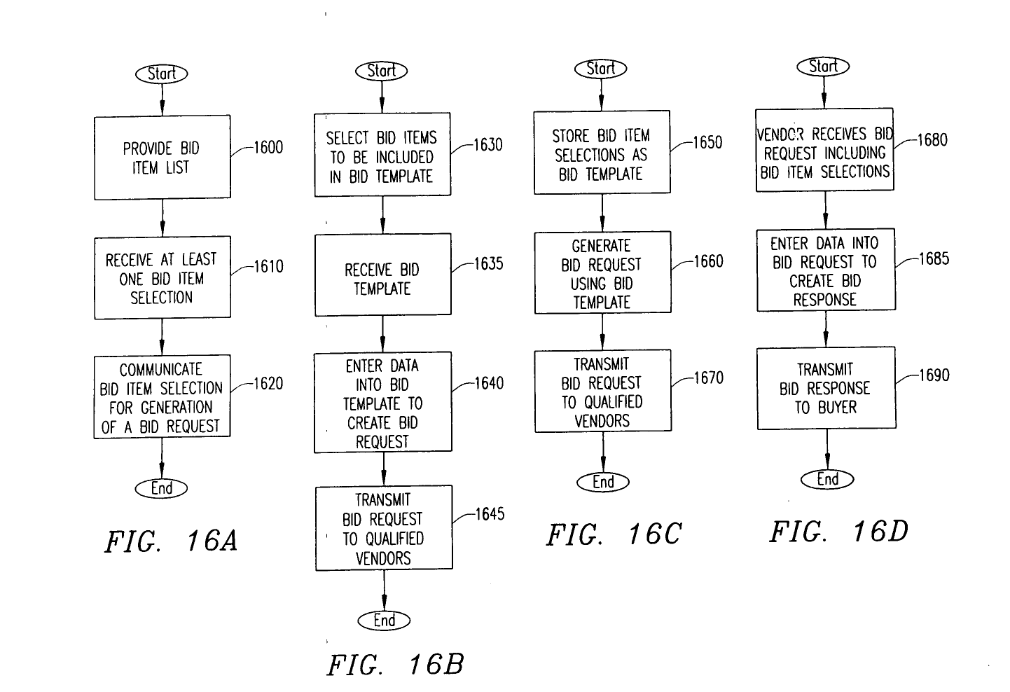

Exemplary steps for creating a bid template, a bid request from the bid template and a bid response from the bid request from various system perspectives are shown in FIGS. 16A-16D. The main processing steps performed at the system for bid template creation are shown in FIG. 16A. The system creates a bid template by providing a buyer user a list of predetermined bid items (step 1600). In response thereto, the system receives one or more bid item selections from the bid item list for inclusion within a bid template stored within the system (step 1610). To create a bid request from the bid template, the system communicates the bid item selections within the bid template to the buyer user for generation of the bid request using the bid item selections (step 1620).

In FIG. 16B, at the buyer side, upon receipt of the bid item list, to create the bid template, the buyer user selects one or more bid items to be included in the bid template (step 1630). For subsequent generation of a bid request, the buyer user receives the bid template including the bid item selections (step 1635) and enters bid request data into fields associated with the bid item selections in the bid template to create the bid request (step 1640). After all applicable bid item selection fields have been completed by the buyer user, the bid request is transmitted to the system for broadcasting to qualified vendors (step 1645).

The main processing steps performed by the system for bid request generation and broadcasting are shown in FIG. 16C. After the creation of a bid template and the storage of the bid item selections for the bid template (step 1650), the system generates a bid request using bid request data entered by the buyer user for the bid request of the bid template type (step 1660). Thereafter, the system transmits the generated bid request to qualified vendors for solicitation of a bid response of the bid template type (step 1670).

In FIG. 16D, at the vendor side, the vendor receives the bid request including the enabled bid item selections selected by the buyer (step 1680). To create a bid response, a vendor user enters bid response data into fields associated with the bid item selections included in the bid request (step 1685) to create the bid response. After all applicable bid item selection fields have been completed by the vendor user, the bid response is transmitted to the system for forwarding to the buyer (step 1690).

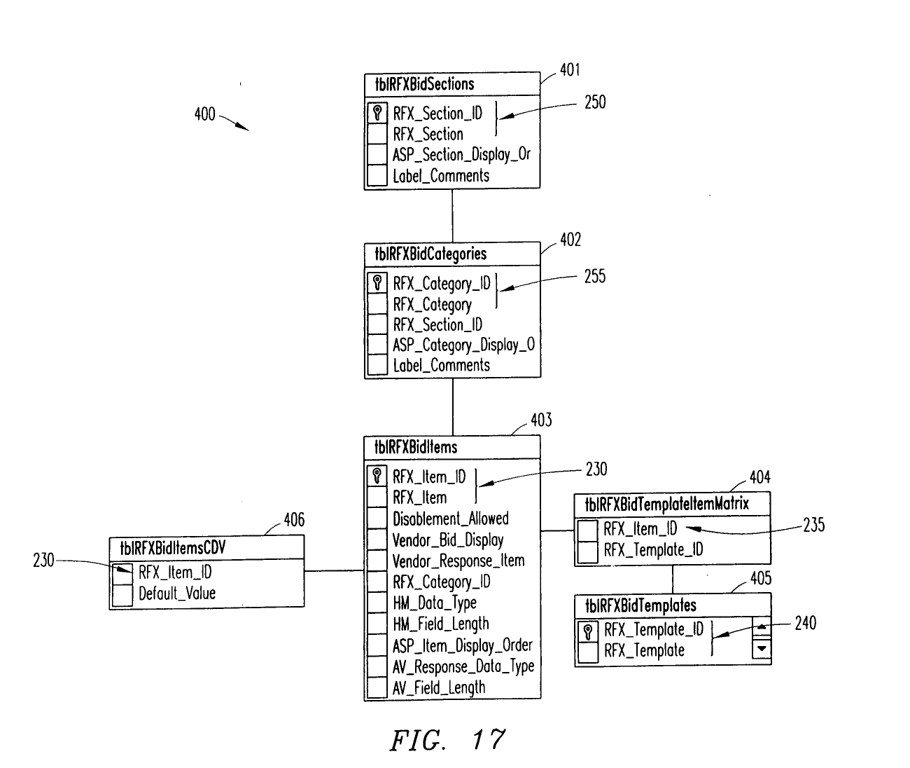

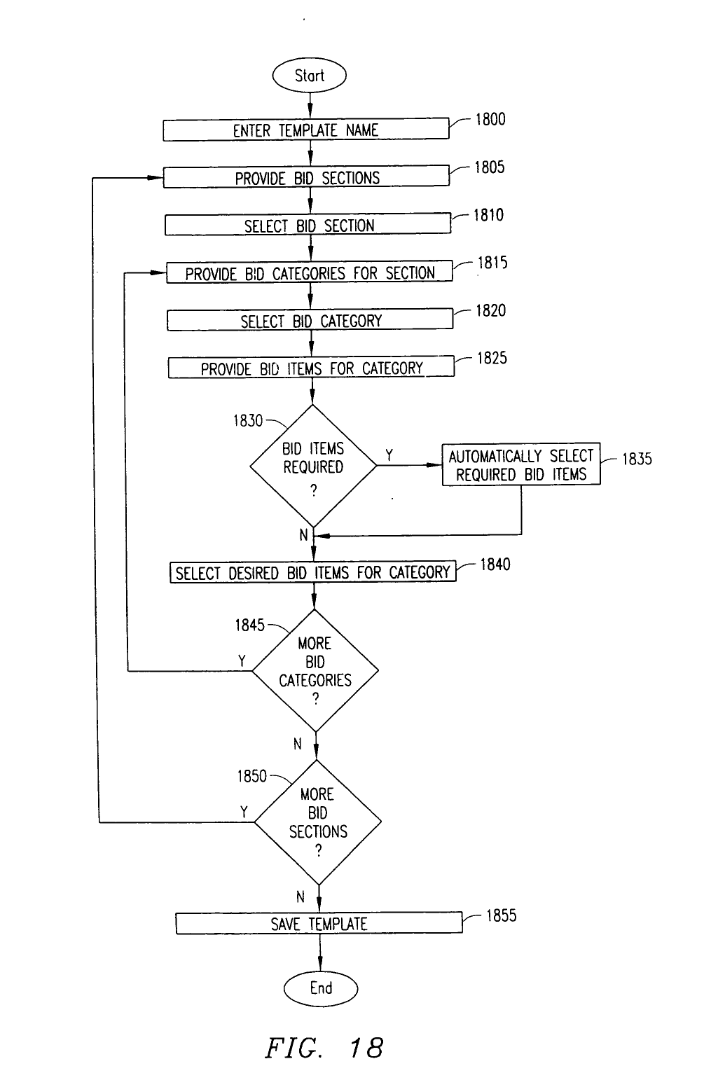

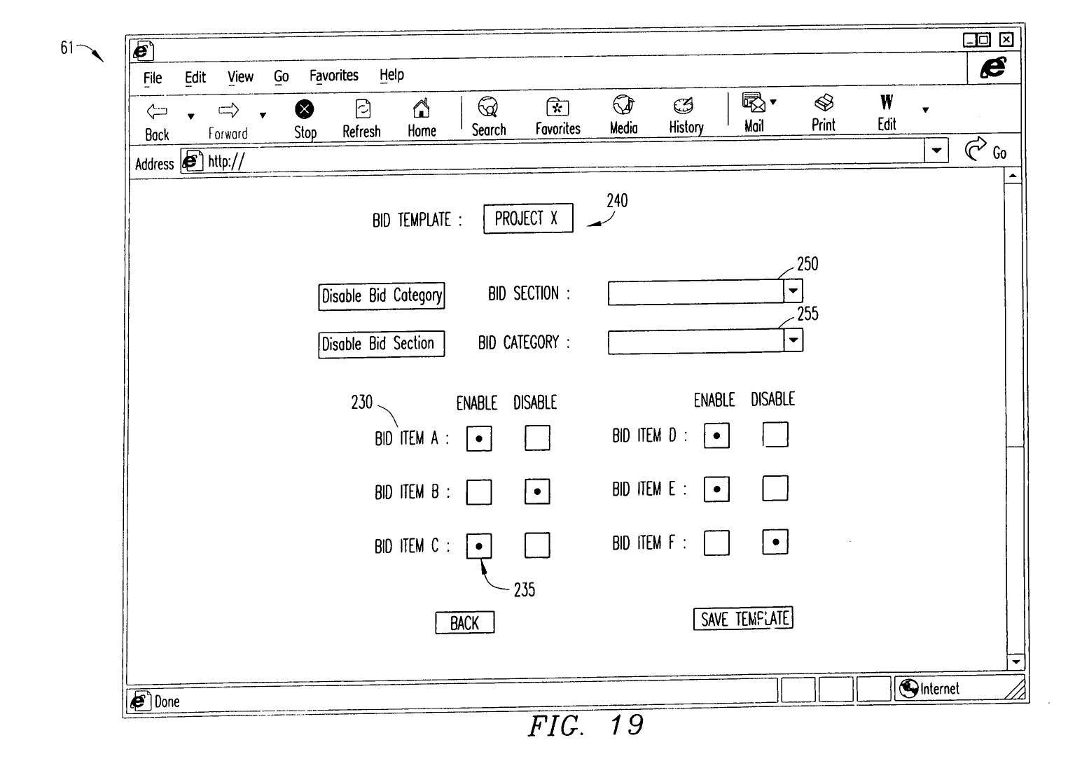

Examples of data structures used for creating the bid templates are shown in Tables 20-25 hereinbelow. The data structures are illustrated for simplicity as being organized in a table format, with each table including all of the fields necessary for displaying bid items to the buyer user to select from and storing bid item selections for bid templates. The tables are related in a hierarchical and relational manner, as will be described hereinbelow in connection with FIG. 17. However, it should be understood that other bid template configurations can be included, and the system is not limited to the specific bid template configuration shown in Tables 20-25 and FIG. 17.

TABLE 20
Base Bid Items Section Table (tblRFXBidSections)

| Column Name | Data Type | Length |
|---|---|---|
| RFX_Section_ID | Int | 4 |
| RFX_Section | Varchar | 255 |
| ASP_Section_Display_Order | Numeric | 9 |
| Label_Comments | Varchar | 1000 |

TABLE 21
Base Bid Items Category Table (tblRFXBidCategories)

| Column Name | Data Type | Length |
|---|---|---|
| RFX_Category_ID | Int | 4 |
| RFX_Category | Varchar | 255 |
| RFX_Section_ID | Int | 4 |
| ASP_Category_Display_Order | Numeric | 9 |
| Label_Comments | Varchar | 1000 |

TABLE 22
Base Bid Items Table (tblRFXBidItems)

| Column Name | Data Type | Length |
|---|---|---|
| RFX_Item_ID | Int | 4 |
| RFX_Item | Varchar | 255 |
| Disablement_Allowed | Char | 1 |
| Supplier_Bid_Display | Char | 1 |
| Supplier_Response_Item | Char | 1 |
| RFX_Category_ID | Int | 4 |
| HM_Data_Type | Varchar | 255 |
| HM_Field_Length | Varchar | 255 |
| ASP_Item_Display_Order | Numeric | 9 |
| AV_Response_Data_Type | Varchar | 255 |
| AV_Field_Length | Varchar | 255 |

TABLE 23
Base Bid Template Type Table (tblRFXBidTemplates)

| RFX_Template_ID | RFX_Template |
|---|---|
| 1 | Project_RFP |
| 2 | Project_RFQ |
| 3 | Bulk_Staffing_RFQ |
| 4 | Regular_Staff_Supplementation |

TABLE 24
Base Bid Template To Bid Items Mapping Table
(tblFRXTemplateItemMatrix)

| Column Name | Data Type | Length |
|---|---|---|
| RFX_Item_ID | Int | 4 |
| RFX_Template_ID | int | 4 |

TABLE 25
Base Client Bid Item Default Values Table (tblRFXBidItemsCDV)

| Column Name | Data Type | Length |
|---|---|---|
| RFX_Item_ID | int | 4 |
| Client_Default_Value | varchar | 7500 |

Referring now to FIG. 17, a database table structure 400 illustrating the interrelation between each of the above Tables 20-25 is shown. The bid items 230 are shown organized into bid sections and bid categories for convenience and logical business information processing segmentation when creating the bid templates 240. Thus, the buyer user is presented with bid sections 250, from which the buyer user can select a bid category 255 to display the bid items 230 associated with that bid category 255. Breaking the bid items 230 down into bid categories 255 and bid sections 250 fosters a compartmentalized format that is easily understood by the buyer user, thereby enabling a more efficient and effective bid template creation process.

The table tblRFXBidSections 401, which has the form of Table 20 above, includes the bid section name and identification of each section 250 of bid items 230, along with an indication of the display order for each bid section 250 on a web page and any comments to be included with the bid section 250 on the web page. Each bid section 250 can be stored as a separate record in table tblRFXBidSections 401, with each record having the form of Table 20. Within each bid section 250 are one or more bid categories 255. The table tblRFXBidCategories 402, which has the form of Table 21 above, includes the category name, the identification number of each bid category 255 and the associated bid section 250 for each bid category 255. In addition, the table tblRFxBidCategories 402 further includes the display order for each bid category 255 on a web page and any comments to be included with the bid category 255 on the web page. Each bid category 255 can be stored as a separate record in table tblRFXBidCategories 402, with each record having the form of Table 21.

Each bid category 255 further includes one or more bid items 230 associated with the bid category 255. Therefore, the table tblRFXBidItems 403, which has the form of Table 22 above, includes the bid item name and identification number, along with the bid category 255 associated with the bid item 230. A separate record for each bid item 230 can be stored in table tblRFXBidItems 403, with each record having the form of Table 22 above. The table tblRFXBidItems 403 further includes additional information pertaining to the bid item 230, such as whether or not disablement of the bid item 230 is allowed, whether the bid item 230 is displayed to the vendor, whether the bid item 230 requires a vendor response, the type of data entered by the buyer for the bid item 230, the field length for the data entered by the buyer for the bid item 230, the type of data entered by the vendor for the bid item 230 and the field length for the data entered by the vendor for the bid item 230. For example, the following Table 26 illustrates sample bid items 230 in the table tblRFXBidItem 403 making up a bid item list 194, as shown in FIG. 15.

TABLE 26

| RFX_{—} | | | | |
|---|---|---|---|---|
| Item_ID | RFX_Item | Disablement_Allowed | Vendor_Bid_Display | Vendor_Response_Item |
| 1 | Company/Organization_Information | N | Y | N |
| 2 | Purpose_of_the_RFP | N | Y | N |
| 3 | Business_Strategy/Objectives | N | Y | N |
| 4 | Business_Infrastructure | Y | Y | N |
| 5 | Business_Proceses | Y | Y | N |
| 6 | Business_Systems | Y | Y | N |
| 7 | Internal/External_Clients | Y | Y | N |
| 8 | Affected_Departments | Y | Y | N |
| 9 | Project_Ownership/ | N | Y | N |
| | Management_Considerations | | | |
| 10 | Product_Ownership/ | N | Y | N |
| | Licensing_Considerations | | | |
| 11 | Project_Work_Location_Considerations | N | Y | N |
| 12 | Project_Phasing_Consdierations | Y | Y | N |
| 13 | Project_Phasing_Schedule | Y | Y | N |
| 14 | Project_Resource_Considerations | Y | Y | N |
| 15 | HM_Staffing_Resource_Profiles | N | Y | N |
| 16 | Resource_Backfill_Considerations/ | N | Y | N |
| | Requirements | | | |
| 17 | Project_Resource_Travel_Considerations | N | Y | N |
| 18 | Handling_Of_Project_Resource_Expenses_Considerations | N | Y | N |
| 19 | Regulatory/Industry_Standards_Compliance_Considerations | Y | Y | N |
| 20 | Specific_Equipment/ | Y | Y | N |
| | Tooling_Considerations | | | |
| 21 | Specific_Economic_Considerations | Y | Y | N |
| 22 | Statement_Of_Work | N | Y | N |
| 23 | Non-Deliverable_Penalties | N | Y | N |
| 24 | Supplier_Incentive_Bonus | Y | Y | N |
| 25 | Statement_of_Confidentiality | N | Y | N |
| 26 | RFP_Organization/Contacts | Y | Y | N |
| 27 | RFP_Response_Requirements | N | Y | N |
| 28 | RFP_Supplier_Issuance_Date | N | Y | N |
| 29 | Supplier_Acknowledgment_of_Confidentiality_Date | N | Y | N |
| 30 | Supplier_Acknowledgment_of_Response_Intent_Date | Y | Y | N |
| 31 | Supplier_Submission_of_RFX_Questions_Date | Y | Y | N |
| 32 | Client_Posting_of_Answers_Date | Y | Y | N |
| 33 | Supplier_Submission_of_Completed_RFP_Response_Date | N | Y | N |
| 34 | Client_Submission_of_RFP_Response_Questions_Date | Y | Y | N |
| 35 | Supplier_Posting_of_Answers_Date | Y | Y | N |
| 36 | Client_RFX_Evaluation_Completion_Date | N | Y | N |
| 37 | Client_Disposition_to_Suppliers_Date | N | Y | N |
| 38 | RFX_Instructions | N | Y | N |
| 39 | Company_History | Y | Y | Y |
| 40 | Competitive_Analysis | Y | Y | Y |
| 41 | Product/Services_Heritage_Review | Y | Y | Y |
| 42 | Product/Services_Strategy | Y | Y | Y |
| 43 | Technology_Vision | Y | Y | Y |
| 44 | Strategic_Technology_Partners | Y | Y | Y |
| 45 | Track_Record | Y | Y | Y |
| 46 | Project_Management_Philosophy | Y | Y | Y |
| 47 | PMI_Certified_FTEs | Y | Y | Y |
| 48 | Customer_References | Y | Y | Y |
| 49 | Proposal_Narrative | N | Y | Y |
| 50 | Project_Planning/Strategy | N | Y | Y |
| 51 | Project_Phasing | N | Y | Y |
| 52 | Resource_Model | N | Y | Y |
| 53 | Knowledge_Transfer_Plan | Y | Y | Y |
| 54 | Deployment_Plan | N | Y | Y |
| 55 | Customer_Acceptance_Model | N | Y | Y |
| 56 | Resource_Labor_Pricing | N | Y | Y |
| 57 | Resource_Labor_Pricing_Amount | N | Y | Y |
| 58 | Equipment/Tooling_Pricing_Comments | N | Y | Y |
| 59 | Equipment/Tooling_Pricing_Amount | N | Y | Y |
| 60 | Physical_Site_Pricing_Comments | N | Y | Y |
| 61 | Physical_Site_Pricing_Amount | N | Y | Y |
| 62 | Project_Management_Premium_Comments | N | Y | Y |
| 63 | Project_Management_Premium_Amount | N | Y | Y |
| 64 | Intellectual_Property_Premium_Comments | N | Y | Y |
| 65 | Intellectual_Property_Premium_Amount | N | Y | Y |
| 66 | Miscellaneous_Project_Expenses_Comments | N | Y | Y |
| 67 | Miscellaneous_Project_Expenses_Amount | N | Y | Y |
| 68 | Anticipated_Margin | N | Y | Y |
| 69 | Total_Bid_Price | N | Y | Y |
| 70 | Resource_Travel_Expenses_Comments | N | Y | Y |
| 71 | Resource_Living_Expenses_Comments | N | Y | Y |
| 72 | Resource_Per_Diem_Comments | N | Y | Y |
| 73 | Resource_Mileage_Expense_Comments | N | Y | Y |
| 74 | Reimbersable_Miscellaneous_Expense_Comments | N | Y | Y |
| 75 | Capital_Risk_Model_Comments | N | Y | Y |
| 76 | Capital_Risk_Model_Amount | N | Y | Y |
| 77 | Rebate_Model_for_non- | N | Y | Y |
| | deployed_investment | | | |
| 78 | Supplier_Payment_Release_Schedule | N | Y | Y |
| 79 | Notes_to_MSP | Y | N | N |
| 80 | Notes_to_Supplier | Y | Y | N |
| 81 | Project_Phasing_Acceptance | N | Y | Y |
| 82 | Statement_Of_Work_Acceptance | N | Y | Y |
| 83 | Statement_Of_Work_Proposed_Changes | N | Y | Y |
| 84 | Non-Deliverable_Penalties_Acceptance | Y | Y | Y |
| 85 | Non-Deliverable_Penalties_Proposed_Changes | Y | Y | Y |
| 86 | Customer_Acceptance_Model_Agreement | Y | Y | Y |
| 87 | Customer_Acceptance_Model_Proposed_Changes | Y | Y | Y |
| 88 | Preferred_Customer_Acceptance_Model | Y | Y | N |
| 89 | Agree_To_Confidentiality_Terms | N | Y | Y |
| 90 | Intent_To_Respond | N | Y | Y |
| 91 | Materials_List | Y | Y | Y |
| 92 | Materials_Cost | Y | Y | Y |
| 93 | Desired_Assignment_Start_Date | N | Y | N |
| 94 | Desired_Assignment_End_Date | N | Y | N |

| RFX_{—} | | | | | | |
|---|---|---|---|---|---|---|
| Item_ID | RFX_Category_ID | HM_Data_Type | HM_Field_Length | Item_Display_Order | AV_Response_Data_Type | AV_Field_Length |
| 1 | 1 | LongText | 5000 | 5 | | |
| 2 | 2 | LongText | 5000 | 5 | | |
| 3 | 3 | LongText | 5000 | 5 | | |
| 4 | 4 | LongText | 5000 | 5 | | |
| 5 | 4 | LongText | 5000 | 10 | | |
| 6 | 4 | LongText | 5000 | 15 | | |
| 7 | 4 | LongText | 5000 | 20 | | |
| 8 | 4 | LongText | 5000 | 25 | | |
| 9 | 5 | LongText | 5000 | 5 | | |
| 10 | 5 | LongText | 5000 | 10 | | |
| 11 | 5 | LongText | 5000 | 15 | | |
| 12 | 5 | LongText | 5000 | 20 | | |
| | | HM | | | | |
| | | Hyperlink | | | | |
| | | to Sub- | | | | |
| | | Table | | | | |
| 13 | 5 | ASP | | 25 | | |
| 14 | 5 | Long Text | 5000 | 30 | | |
| | | HM | | | | |
| | | Hyperlink | | | | |
| | | to Sub- | | | | |
| | | Table | | | | |
| 15 | 5 | ASP | | 35 | | |
| 16 | 5 | Text | 1000 | 40 | | |
| 17 | 5 | Text | 1000 | 45 | | |
| 18 | 5 | LongText | 5000 | 50 | | |
| 19 | 5 | LongText | 5000 | 55 | | |
| 20 | 5 | LongText | 5000 | 60 | | |
| 21 | 5 | LongText | 5000 | 5 | | |
| 22 | 6 | LongText | 5000 | 5 | | |
| 23 | 7 | LongText | 5000 | 5 | | |
| 24 | 8 | LongText | 5000 | 5 | | |
| 25 | 9 | LongText | 5000 | 5 | | |
| 26 | 10 | LongText | 5000 | 5 | | |
| 27 | 11 | LongText | 5000 | 5 | | |
| 28 | 12 | date | | 5 | | |
| | | time | | | | |
| 29 | 12 | date time | | 10 | | |
| 30 | 12 | date time | | 15 | | |
| 31 | 12 | date time | | 20 | | |
| 32 | 12 | date time | | 25 | | |
| 33 | 12 | date time | | 30 | | |
| 34 | 12 | date time | | 35 | | |
| 35 | 12 | date time | | 40 | | |
| 36 | 12 | date time | | 45 | | |
| 37 | 12 | date time | | 50 | | |
| 38 | 13 | LongText | 5000 | 5 | | |
| 39 | 14 | Text | 1000 | 5 | Long | 5000 |
| | | | | | Text | |
| 40 | 14 | Text | 1000 | 10 | Long | 5000 |
| | | | | | Text | |
| 41 | 14 | Text | 1000 | 15 | Long | 5000 |
| | | | | | Text | |
| 42 | 14 | Text | 1000 | 20 | Long | 5000 |
| | | | | | Text | |
| 43 | 14 | Text | 1000 | 25 | Long | 5000 |
| | | | | | Text | |
| 44 | 14 | Text | 1000 | 30 | AV | |
| | | | | | Hyperlink | |
| | | | | | to | |
| | | | | | Sub- | |
| | | | | | Table | |
| | | | | | ASP | |
| 45 | 14 | Text | 1000 | 35 | AV | |
| | | | | | Hyperlink | |
| | | | | | to | |
| | | | | | Sub- | |
| | | | | | Table | |
| | | | | | ASP | |
| 46 | 14 | Text | 1000 | 40 | Long | 5000 |
| | | | | | Text | |
| 47 | 14 | Text | 1000 | 45 | Long | 5000 |
| | | | | | Text | |
| 48 | 14 | Text | 1000 | 50 | AV | |
| | | | | | Hyperlink | |
| | | | | | to | |
| | | | | | Sub- | |
| | | | | | Table | |
| | | | | | ASP | |
| 49 | 15 | Text | 1000 | 5 | Long | 5000 |
| | | | | | Text | |
| 50 | 15 | Text | 1000 | 10 | Long | 5000 |
| | | | | | Text | |
| 51 | 15 | Text | 1000 | 15 | AV | |
| | | | | | Hyperlink | |
| | | | | | to | |
| | | | | | Sub- | |
| | | | | | Table | |
| | | | | | ASP | |
| 52 | 15 | Text | 1000 | 20 | AV | |
| | | | | | Hyperlink | |
| | | | | | to | |
| | | | | | Sub- | |
| | | | | | Table | |
| | | | | | ASP | |
| 53 | 15 | Text | 1000 | 25 | Long | 5000 |
| | | | | | Text | |
| 54 | 15 | Text | 1000 | 30 | Long | 5000 |
| | | | | | Text | |
| 55 | 15 | Text | 1000 | 35 | Long | 5000 |
| | | | | | Text | |
| 56 | 16 | Text | 1000 | 5 | AV | |
| | | | | | Hyperlink | |
| | | | | | to | |
| | | | | | Sub- | |
| | | | | | Table | |
| | | | | | ASP | |
| 57 | 16 | Text | 1000 | 10 | Currency | |
| 58 | 16 | Text | 1000 | 15 | Long | 5000 |
| | | | | | Text | |
| 59 | 16 | Text | 1000 | 20 | Currency | |
| 60 | 16 | Text | 1000 | 25 | Long | 5000 |
| | | | | | Text | |
| 61 | 16 | Currency | | 30 | Currency | |
| 62 | 16 | Text | 1000 | 35 | Long | 5000 |
| | | | | | Text | |
| 63 | 16 | Currency | | 40 | Currency | |
| 64 | 16 | Text | 1000 | 45 | Long | 5000 |
| | | | | | Text | |
| 65 | 16 | Currency | | 50 | Currency | |
| 66 | 16 | Text | 1000 | 55 | Long | 5000 |
| | | | | | Text | |
| 67 | 16 | Text | | 60 | Currency | |
| 68 | 16 | Text | 1000 | 65 | Currency | |
| 69 | 16 | Text | 1000 | 70 | Currency | |
| 70 | 17 | Text | 1000 | 5 | Long | 5000 |
| | | | | | Text | |
| 71 | 17 | Text | 1000 | 10 | Long | 5000 |
| | | | | | Text | |
| 72 | 17 | Text | 1000 | 15 | Long | 5000 |
| | | | | | Text | |
| 73 | 17 | Text | 1000 | 20 | Long | 5000 |
| | | | | | Text | |
| 74 | 17 | Text | 1000 | 25 | Long | 5000 |
| | | | | | Text | |
| 75 | 18 | Long Text | 5000 | 5 | Long | 5000 |
| | | | | | Text | |
| 76 | 18 | | | 10 | Currency | |
| 77 | 19 | | | 5 | Long | 5000 |
| | | | | | Text | |
| 78 | 20 | Text | 1000 | 5 | Long | 5000 |
| | | | | | Text | |
| 79 | 21 | Long Text | 5000 | 5 | | |
| 80 | 22 | Long Text | 5000 | 5 | | |
| 81 | 15 | | | 16 | Char | 1 |
| 82 | 15 | | | 11 | Char | 1 |
| 83 | 15 | | | 12 | Long | 5000 |
| | | | | | Text | |
| 84 | 15 | | | 40 | Char | 1 |
| 85 | 15 | Long Text | 5000 | 45 | Long | 5000 |
| | | | | | Text | |
| 86 | 15 | | | 36 | Char | 1 |
| 87 | 15 | Long Text | 5000 | 37 | Long | 5000 |
| | | | | | Text | |
| 88 | 6 | Long Text | 5000 | 6 | Long | 5000 |
| | | | | | Text | |
| 89 | 14 | Text | 1000 | 1 | Char | 1 |
| 90 | 14 | Text | 1000 | 2 | Char | 1 |
| 91 | 16 | Text | 1000 | 16 | AV | |
| | | | | | Hyperlink | |
| | | | | | to | |
| | | | | | Sub- | |
| | | | | | Table | |
| | | | | | ASP | |
| 92 | 16 | Text | 1000 | 17 | Currency | |
| 93 | 12 | date time | | 51 | | |
| 94 | 12 | date time | | 52 | | |

Referring again to FIG. 17, each of the bid items 230 can be disabled or enabled for a particular bid template 240, depending on the type of project work that the bid template 240 is created for. However, as discussed above in connection with FIG. 15, there may be some bid items 230 that are required to be included in one or more bid template 240 types. Therefore, for the required bid items 230, disablement is not allowed. If an entire bid section 250 or bid category 255 is not applicable to a particular bid template 240, the database table structure 400 can be configured to allow the bid items 230 within entire bid sections 250 or bid categories 255 to be disabled, if all of the bid items 230 within that bid section 250 or bid category 255 can be disabled.

Once all of the bid items 230 have been disabled or enabled (bid item selections 235 are enabled bid items) for a particular bid template 240, the bid template 240 and associated bid item selections 235 can be stored in the database table structure 400. The table tblRFXBidTemplates 405, which has the form of Table 23 above, includes the bid template name and bid template identification number for use in associating bid item selections 235 with the bid template 240 in the table tblRFXTemplateItemMatrix 404, which has the form of Table 24 above. A separate record for each bid template 240 can be stored in table tblRFXBidTemplates 405, with each record having the from of Table 23. In addition, a separate record for each bid item selection 235 included within a particular bid template 240 can be stored in table tblRFXTemplateItemMatrix 404, with each record having the form of Table 24.

If there are specific bid items 230 that have a default value applicable to all bid templates 240, such as the buyer name, the default value for that particular bid item 230 can be stored in the table tblRFXBidItemsCDV 406, which has the form of Table 25. A separate record for each default value associated with each bid item 230 can be stored in table tblRFXBidItemsCDV 406, with each record having the form of Table 25. By providing selectable bid items in a structured, configurable and scalable format, any bid item 230 can be added or removed at any time depending on the specific needs of the buyer.

Exemplary steps for creating a bid template using the hierarchical and relational database table structure are illustrated in FIG. 18. To create a bid template, a buyer user enters a name for the template to create a record for the template in the database table structure (step 1800). Thereafter, the buyer user selects a particular bid section from a list of bid sections (steps 1805 and 1810) and a particular bid category from a list of bid categories (steps 1815 and 1820) to begin the process of selecting bid items for inclusion in the bid template (step 1825).

If one or more of the bid items in the selected bid category are required (step 1830), the required bid selections are automatically included in the bid template (step 1835). Other bid items are selected based on the needs of the buyer user for the particular type of bid template (step 1840). This process is repeated for each bid category within the selected bid section (step 1845) and for each bid section within the list of bid sections (step 1850), until all bid items have been reviewed and either enabled (selected) or disabled for the bid template. As discussed above, in other embodiments, all bid items within a bid section or bid category may be able to be disabled without individual bid item review if disablement of all of those bid items is allowed. Once the bid item selections have been made for the bid template, the bid template is stored in the bid template list (step 1855) for later use in creating a bid request.

A screen shot of an exemplary web page for creating a bid template is shown in FIG. 19. Using one or more web pages (only one of which is shown), the buyer user can enter the bid template name 240, select a bid section 250 and select a bid category 255 to display specific bid items 230 within the bid category 255 that may be included in the bid template 240. For each bid item 230 within a displayed bid category 255, the buyer user can select to either enable or disable that bid item 230. However, if a particular bid item 230 cannot be disabled, the disable button is ghosted to prevent the buyer user from disabling the bid item 230. In addition, if the option is available, the buyer user may also be allowed to disable all bid items 230 within a particular bid section 250 or bid category 255 by clicking on a disable button next to the bid section 250 or bid category 255 currently displayed. Once all of the bid items 230 have been enabled or disabled for the bid template 240, the buyer user can save the bid template 240. In some embodiments, the buyer user may be able to temporarily save the bid template 240 if all bid items selections 235 have not yet been completed. In other embodiments, the save button is ghosted until all bid items 230 have been enabled or disabled.

FIG. 20 illustrates exemplary steps for creating a bid request from a bid template, as shown in FIG. 15, using bid items organized in a hierarchical and relational format, as shown in FIG. 17. Initially, a bid template is selected by a buyer user from the bid template list for the bid request (step 2000). It should be understood that the bid template can be created immediately prior to generation of the bid request or the bid template can be created well in advance of the bid request. After the particular bid template for the bid request is selected, the buyer user enters a bid request identifier for the bid request (step 2005), such as a bid request name or number. In addition, the system will assign a bid tracking number to refer to the bid as it applies throughout the system to the vendor, buyer, contractor and administrator.

All of the bid item selections in the bid template are displayed by bid section and bid category to the buyer user for review (step 2010). If one or more of the bid item selections in the bid template are not applicable to the particular bid request (step 2015), and the undesired bid item selections can be disabled (step 2020), the buyer user can disable those bid item selections that are not needed for the particular bid request (step 2025). Thereafter, the buyer user enters the requisite bid request data into appropriate fields for the bid item selections enabled in the bid request (step 2030). For example, one or more bid item selections may contain a field for the buyer to enter data, such as the location of the work to be performed or the type of project work. These fields can be variable type data fields, such as text-entry fields or selectable options fields with links to other web pages containing the selectable option.

An example of a selectable option field that may be displayed involves the selection of a particular type of project work for the bid request from a number of pre-established project types. To implement the project type selection process, a configurable and scalable database structure can be provided that enables the buyer's specific project work business requirements to be classified in a non-prose fashion. By selecting from pre-established project work types, the buyer can ensure that vendor bid responses are synchronous with the buyer's project work requirements. The project work types can also be selected by the vendor when completing vendor qualification data (shown in FIG. 2) for selecting of vendors to receive the bid request. Examples of data structures used for selecting the project work type are shown in Tables 27-29 hereinbelow. The data structures are illustrated for simplicity as being organized in a table format, with each table including all of the fields necessary for displaying the project work types to the buyer user to select from and storing the selected project work type within the field of the associated bid item selection of the bid request. The tables are related in a hierarchical and relational manner, such that the tables are accessed in a particular order for displaying the project work types to the buyer user.

Table 27 below illustrates sample project services types, such as consulting, staff supplementation and other project services. Within each of the project services types may be one or more project sectors, as shown in Table 28, and within each of the project sectors may be one or more project families, as shown in Table 29. Therefore, to select a particular project work type (project family) for the bid request, the buyer user can select a project services type and project sector type to display a list of project families to select from. It should be understood that other configurations and project types can be included and the system is not limited to the specific configurations and information listed in Tables 27-29.

TABLE 27
Project Services Type Table

| Project_Work_Type_{—} | | |
|---|---|---|
| Name | Services_Type_ID | ASP_Display_Order |
| Consulting | 1 | 2 |
| Staff_Supplementation | 2 | 3 |
| Project_Services | 3 | 1 |

TABLE 28
Project Sector Type Table

| Project_Section_ID | Project_Sector_Name | ASP_Display_Order | Project_Services_ID |
|---|---|---|---|
| 1 | Consulting/Professional Services | 2 | 1 |
| 2 | Engineering/Construction | 3 | 1 |
| 3 | Technology | 1 | 1 |

TABLE 29
Project Family Type Table

| Project_Family_ID | Project_Family_Name | ASP_Display_Order | Project_Sector_ID |
|---|---|---|---|
| 7 | Enterprise_Resource_Solutions | 5 | 3 |
| 8 | E-Business_Solutions | 10 | 3 |
| 9 | Telecommunications_Solutions | 15 | 3 |
| 10 | Technical_Integration_Solutions | 15 | 3 |
| 11 | Network_Management_Solutions | 25 | 3 |
| 12 | Custom_Software_Development/Engineering | 30 | 3 |
| 13 | Business_Strategy/Planning_Solutions | 5 | 1 |
| 14 | Human_Resource_Solutions | 10 | 1 |
| 15 | Audit/Assurance_Solutions | 15 | 1 |
| 16 | Financial_Advisory_Solutions | 20 | 1 |
| 17 | Tax_Solutions | 25 | 1 |
| 18 | Risk_Management_Solutions | 30 | 1 |
| 19 | Real_Estate_Services | 35 | 1 |
| 20 | Legal_Services | 40 | 1 |
| 21 | Engineering_Services | 5 | 2 |
| 22 | Building/Construction_Services | 10 | 2 |
| 23 | Product_Development | 15 | 2 |

Referring again to FIG. 20, once the buyer user has entered the bid request data into all of the required bid item fields (step 2035), the bid request is complete. It should be understood that not all of the bid item fields require the user to enter bid request data. For example, one or more of the bid item selections may be a vendor bid response bid item selection that only the vendor responds to. For the vendor bid response bid item selections, the buyer user can enable or disable that bid item selection, and does not enter any data into the field for that bid item selection except data that may assist the vendor in completing the bid response for that bid item. For bid request completeness, every enabled bid item selection where the buyer user can enter bid request data is preferably filled out by the buyer user before the bid request is submitted.

In many companies, bid requests must be approved prior to transmission to vendors. Therefore, if the bid request requires approval (step 2040), the originator of the bid request submits the bid request to the appropriate approvers (step 2045). In exemplary embodiments, as discussed above in connection with FIGS. 9-14, the approval user role positions are pre-designated for all bid requests or for the particular bid request, so that the bid request is automatically routed to the appropriate approver. If the bid request is approved (step 2050), the originator is informed of the bid request approval (step 2055), and the bid request is transmitted to qualified vendors (step 2060). However, if the bid request is not approved (step 2050), the originator is notified of the bid request declination (step 2065), and provided the opportunity to edit the bid request (step 2070), if possible. For example, the originator may have disabled one or more bid item selections that need to be included in the bid request for approval purposes, or left blank one or more buyer-required data fields. If approval of the bid request is not required (step 2040), the bid request is transmitted to the qualified vendors for the bid request (step 2060).

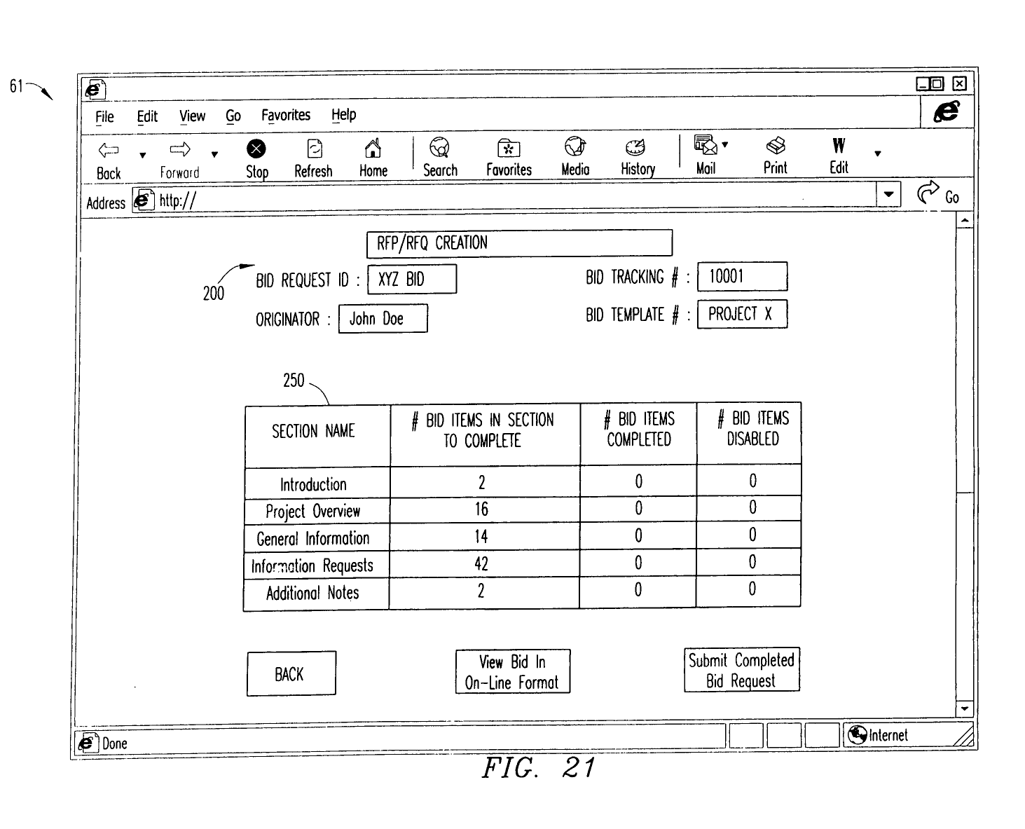

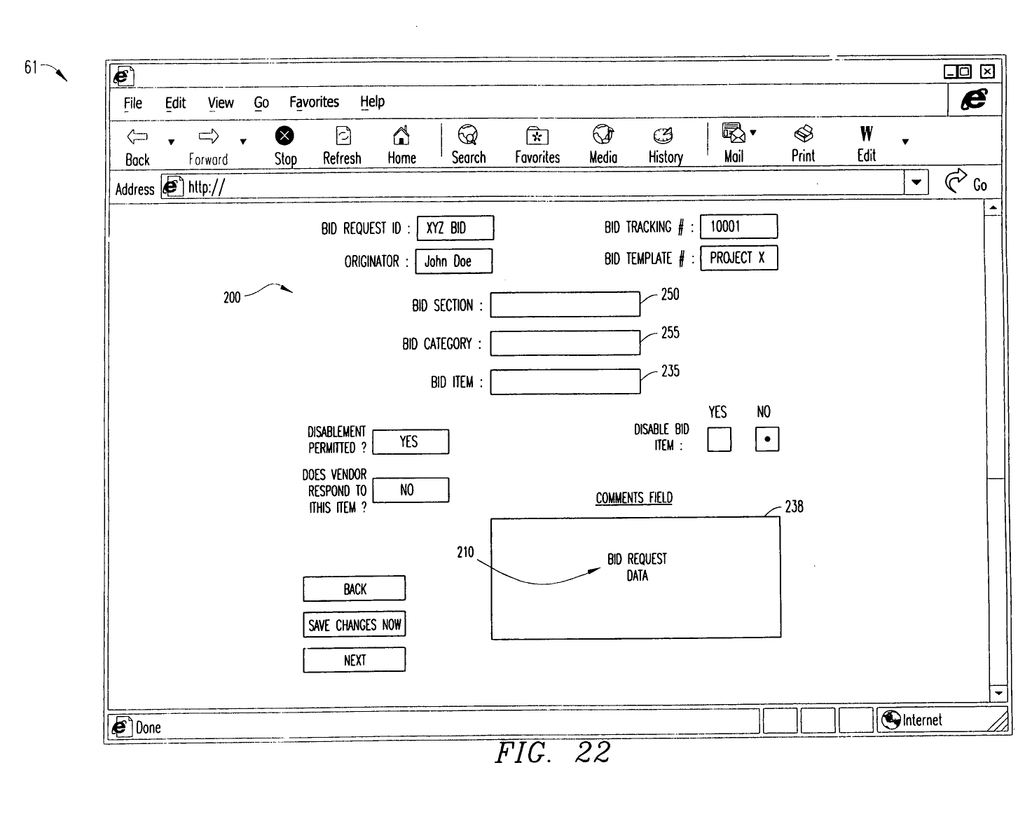

FIGS. 21 and 22 are screen shots of exemplary web pages that can be provided to the buyer user for bid request creation. Using one or more web pages, the buyer user can enter the bid request name 200, select a bid section 250 and select a bid category 255 to display specific bid item selections 230 within the bid category 255 that may be included in the bid request 200. FIG. 21 shows an overview of the status of the bid request 200 listing the number of bid item selections 235 in each section 250 and the number of bid item selections 235 in each section 250 that are completed or disabled. To complete or disable a bid item selection 235, the buyer user can click on the bid section 250 to display the bid categories 255 and bid item selections 235 within each of the bid categories 255. Once all of the bid item selections 235 have been completed or disabled, the buyer user can click on a submit completed bid request button for approval and/or transmission to qualified vendors.

As shown in FIG. 22, each bid item selection 235 in each bid category 255 within each bid section 250 can be reviewed to determine whether or not the bid item selection 235 should be disabled. Some of the bid item selections 235 in one or more of the categories 255 may also require bid request data 210 from the buyer user. For each bid item selection 235 within a bid category 255, the buyer user can either enable or disable that bid item selection 235. However, if a particular bid item selection 235 cannot be disabled, the disable button is ghosted to prevent the buyer user from disabling the bid item selection 235. In addition, if the option is available, the buyer user may also be allowed to disable all bid item selections 235 within a particular bid section 250 or bid category 255. If a bid item selection 235 is enabled and has a field 238 for entering bid request data 210, the buyer user can enter bid request data 210 into the associated data field 238. In addition, if the bid template contains default bid request data 210 for a particular bid item selection 235, the default data 210 can be displayed in the data field 238 and may or may not be allowed to be changed, depending on the template settings.

FIG. 23 illustrates exemplary steps for reviewing and transmitting bid requests to qualified vendors, as shown in FIG. 15. The originator of the bid request can select appropriate qualified vendors from the vendor list based on bid template type and entered bid request data or the bid request can be submitted to a project administrator to choose the qualified vendors, depending on buyer constraints. If the latter, the new bid requests can be displayed to an administrative user (step 2300) to select the desired bid request for review and transmission (step 2305). During the review process, the administrative user may be allowed to edit the bid request for quality control purposes or may request the originator of the bid request to edit the bid request, if significant changes are necessary (step 2310).

Once the bid request is in a completed form, the administrative user accesses the vendor list (step 2315) to determine qualified vendors for the bid request based on the bid template type and entered bid request data (step 2320) (e.g., based on the project family in conjunction with the anticipated geographic work location). If the list of qualified vendors is insufficient (step 2325), the administrative user may also query the top-level database (as shown in FIG. 6) for additional matching vendors to add to the qualified vendor list (step 2330). In addition to or instead of supplementing the qualified vendor list with matching vendors from the top-level database, the administrative user may also be provided the option to include vendors that do not completely match all of the bid request data (steps 2335 and 2340).

A screen shot of an exemplary web page displaying all of the potential vendors to be selected from to include on the qualified vendor list is shown in FIG. 24. The administrative user can select from buyer-contracted vendors that match the bid request data, buyer-contracted vendors that do not completely match the bid request data and non-contracted vendors that match the bid request data provided by the top-level database. The administrative user can select vendors for inclusion in the vendor qualification list based on any number of factors, including previous contract experience with the vendor, vendor reputation and vendor availability.

Turning back to FIG. 23, once the list of qualified vendors is finalized (step 2345), the administrative user transmits the bid request to the qualified vendors (step 2350) and notifies the originator of the bid request of the bid request status (step 2355). For example, the originator can be notified of the particular vendors that received the bid request and any modifications made to the bid request prior to transmission.

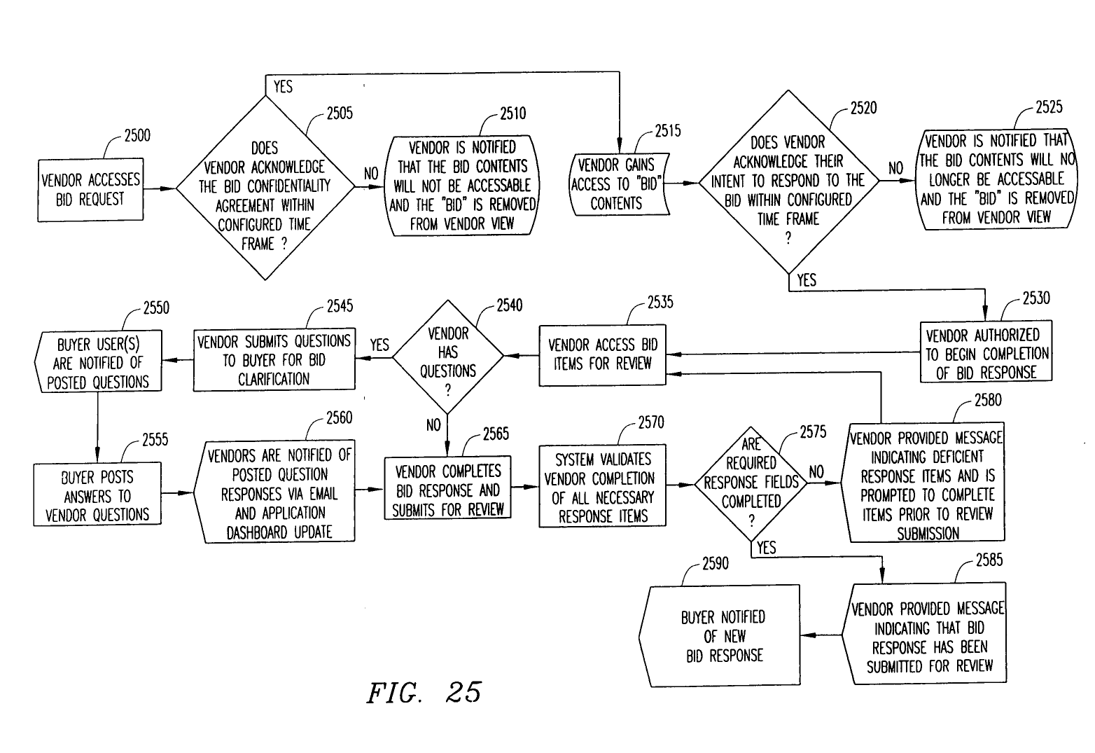

Exemplary steps for generation and transmission of a vendor bid response, as shown generally in FIGS. 1 and 15 at 220, to a received bid request are shown in FIG. 25. In exemplary embodiments, bid requests are transmitted to vendors and routed to the appropriate vendor users, based on vendor user role configurations, as discussed above in connection with FIGS. 9-14. Upon receipt of a bid request, an appropriate vendor user can access the bid request via a menu or dashboard control notification (step 2500). In further exemplary embodiments, the bid request is submitted with a bid confidentiality agreement binding the vendor user to maintain the contents of the bid request in confidence prior to displaying the bid request contents to the vendor user. If the vendor user acknowledges the confidentiality agreement (e.g., by clicking on an accept button) (step 2505), the vendor user can gain access to the contents of the bid request (step 2515). Otherwise, the vendor user is notified that the bid contents will not be accessible and the bid request is removed from the vendor user's view (step 2510).

To limit the amount of time that vendors have to submit vendor bid responses, the bid request may also include a time frame that the vendor must agree to respond within. If the vendor user cannot agree to respond within the time frame (e.g., by clicking on an accept button) (step 2520), the vendor user is notified that the contents of the bid request will no longer be available to the vendor user and the bid request is removed from the vendor user's view (step 2525). The buyer or project administrator is also notified of the vendors that do not acknowledge the confidentiality agreement or time frame constraints, and based on the number of non-acknowledged vendors, the buyer or project administrator can add vendors to the qualified vendor list and transmit the bid request to the additional vendors to ensure that a sufficient number of vendor bid responses are received.

If the vendor user does agree to respond within the time frame (step 2520), the vendor is authorized to begin completion of the vendor bid response (step 2530). To respond to the bid request, the vendor user accesses the bid item selections by bid section and bid category that require vendor response data for review (step 2535). If the vendor user has any questions regarding the bid request (e.g., the type or amount of vendor response data that is required) (step 2540), the vendor user can submit questions to the buyer for bid clarification within a buyer-configured time frame (step 2545). An appropriate buyer user (e.g., the bid request originator or project administrator) is notified of each question submitted by a vendor via e-mail and/or dashboard update (step 2550) and that buyer user is responsible for providing an answer to the submitted questions within applicable time constraints (step 2555). The vendors are notified of the buyer answers via e-mail and/or dashboard update (step 2560).

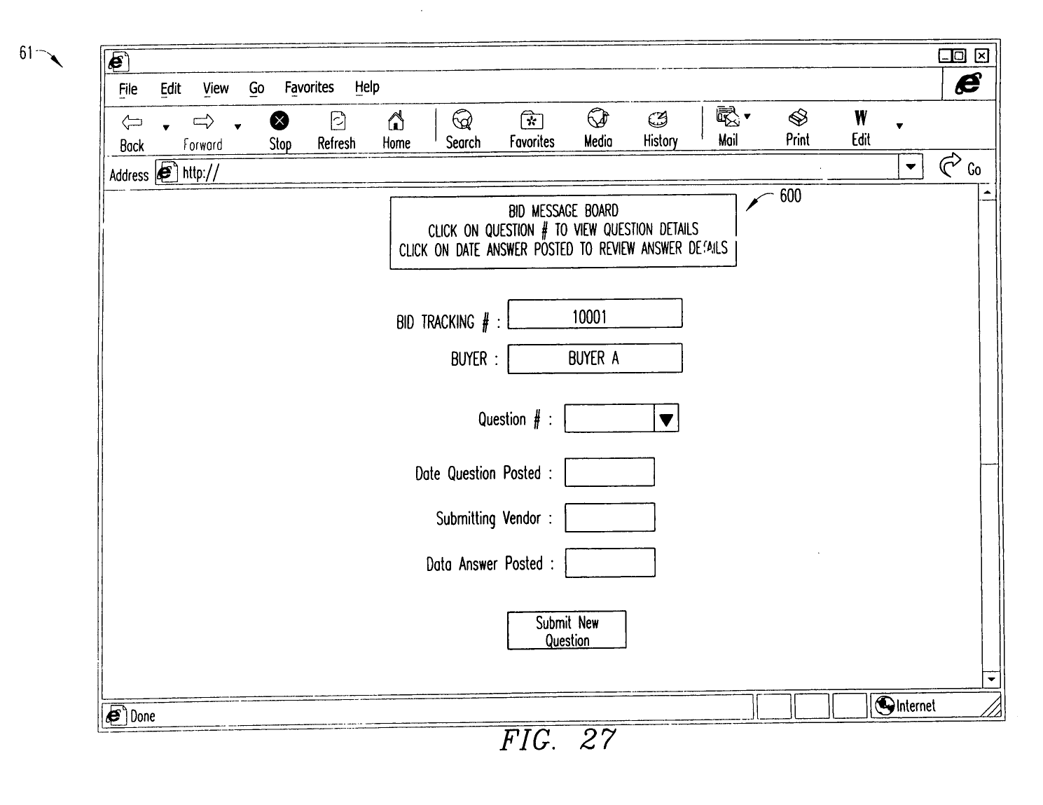

For example, a bid message board can be provided by the system that both the vendors and the buyer can access for a particular bid request. A screen shot of an exemplary bid message board 600 is shown in FIG. 27. Only the buyer and the vendors responding to a particular bid request can access the bid message board 600. All of the vendors may be provided access to all of the submitted questions and buyer answers, or only the vendor that submitted the question may be allowed to view the buyer answer, depending on the buyer settings. In addition, the vendor questions may be anonymous to the vendors and the buyer or only to the vendors, depending on the vendor and/or buyer preferences.

Turning back to FIG. 25, if the vendor user does not have any questions (step 2540) or all of the vendor questions have been answered (step 2560), the vendor user enters the requisite vendor response data into appropriate fields for the required bid item selections in the bid (step 2565). The vendor response data can include costing information including costing elements (e.g., resource requirements, expense types, etc.) and associated pricing information (e.g., resource rates, expense amounts, etc.) and deliverables information including deliverables types (e.g., number of units to be completed, phasing information, etc.) and completion information (e.g., project end date, phase end dates, etc.). Each of the costing elements and deliverables types is associated with a different bid item selection to enable effective comparison and grading of vendor bid responses.

The bid item fields can be of various data types, such as text/currency/numeric-entry fields and/or selectable options fields. In addition, the fields can have multiple levels of detail associated with a singular bid response item for different aspects of the project. For example, if a project has several phases, as determined by the buyer and/or vendor, the vendor response fields can include a separate section for each phase of the project. Upon attempted submission of the vendor bid response, the system validates vendor completion of all necessary data fields for bid item selections in the vendor bid response (step 2570). If all required data fields are not completed (step 2575), the vendor user is provided a system message indicating the deficient vendor response bid item selections, and is prompted to complete the required bid item selections prior to submitting the vendor bid response (step 2580). Once all required data fields for bid item selections are completed in a bid response (step 2575), the vendor (upon submission) is provided a message indicating that the vendor bid response has been submitted to the buyer or project administrator for review (step 2585) and the appropriate buyer user is notified of a new vendor bid response via e-mail and/or dashboard update (step 2590).

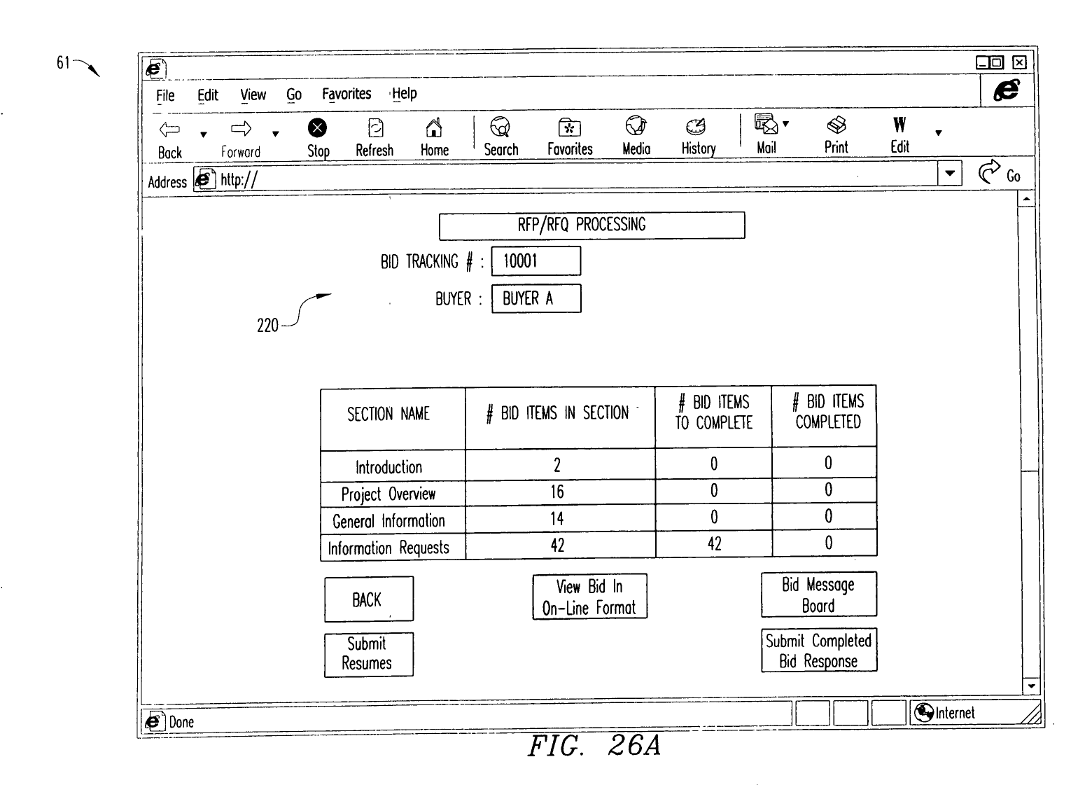

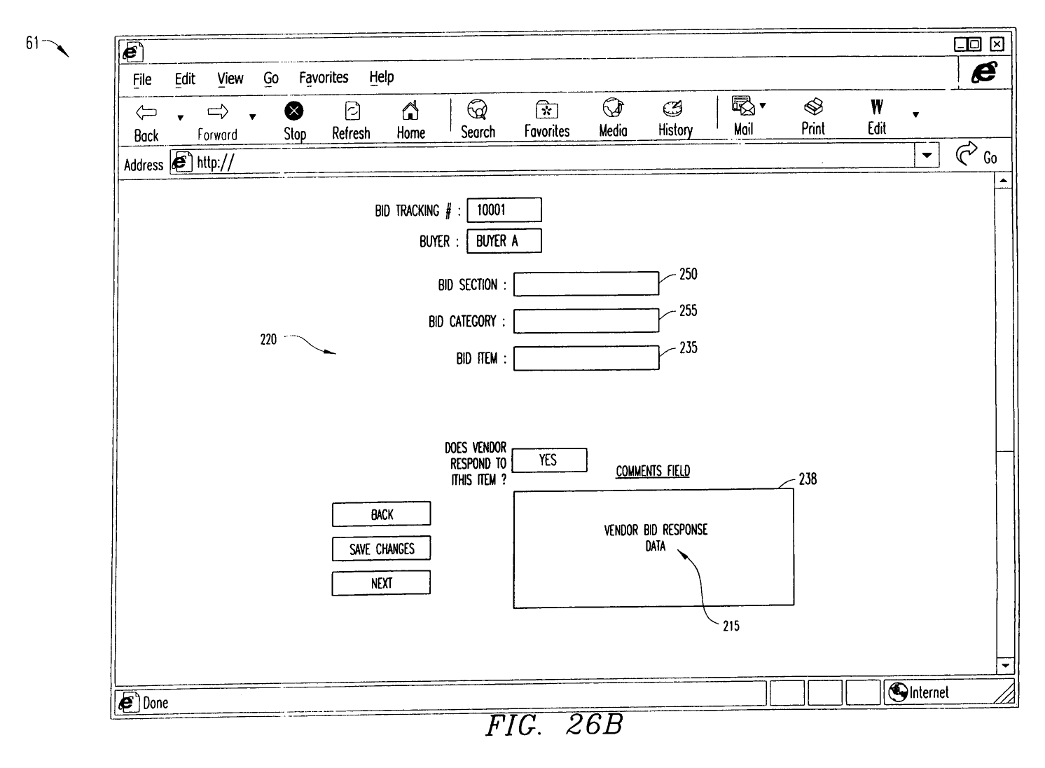

FIGS. 26A and 26B are screen shots of exemplary web pages that can be provided to the vendor user for bid response generation. The vendor user is provided with web pages displaying the bid item selections within the bid request that require vendor response data. For example, as shown in FIG. 26A, the status of the vendor bid response can be displayed to the vendor user listing the number of bid item selections 235 in each section 250, the number of bid item selections 235 in each section that the vendor user must complete and the number of bid item selections 235 in each section 250 that have been completed. In addition, the vendor user can access the bid message board to post vendor questions, view the bid response in an on-line format that is easily readable or submit resumes of potential contractors to be included in the vendor bid response. Furthermore, once the vendor responses to all of the bid item selections 235 have been completed, the vendor user can click on the submit completed bid response button for approval and/or transmission to the buyer or project administrator.

To complete a vendor response to a bid item selection 235, as shown in FIG. 26B, the vendor user can click on the bid section 250 to display the bid categories 255 and bid item selections 235 within each of the bid categories 255. If a vendor response to a particular bid item selection is required, the vendor user can enter the vendor response data 215 into a data field 238 for the bid item selection 235. As discussed above, the data field 238 can be a direct text-entry field or include links to other web pages for selection of the appropriate vendor response data 215 from pre-established vendor responses. In addition, the data field 238 can have multiple levels, with links to web pages for each level. Furthermore, the data field 238 may be able to be directly populated from the vendor database with default vendor response data 215, such as vendor name and vendor address. For example, upon receipt of a bid request, the vendor module can search for particular bid item selections 235 and populate the data fields 238 for those bid item selections 235 with the appropriate vendor response data 215.

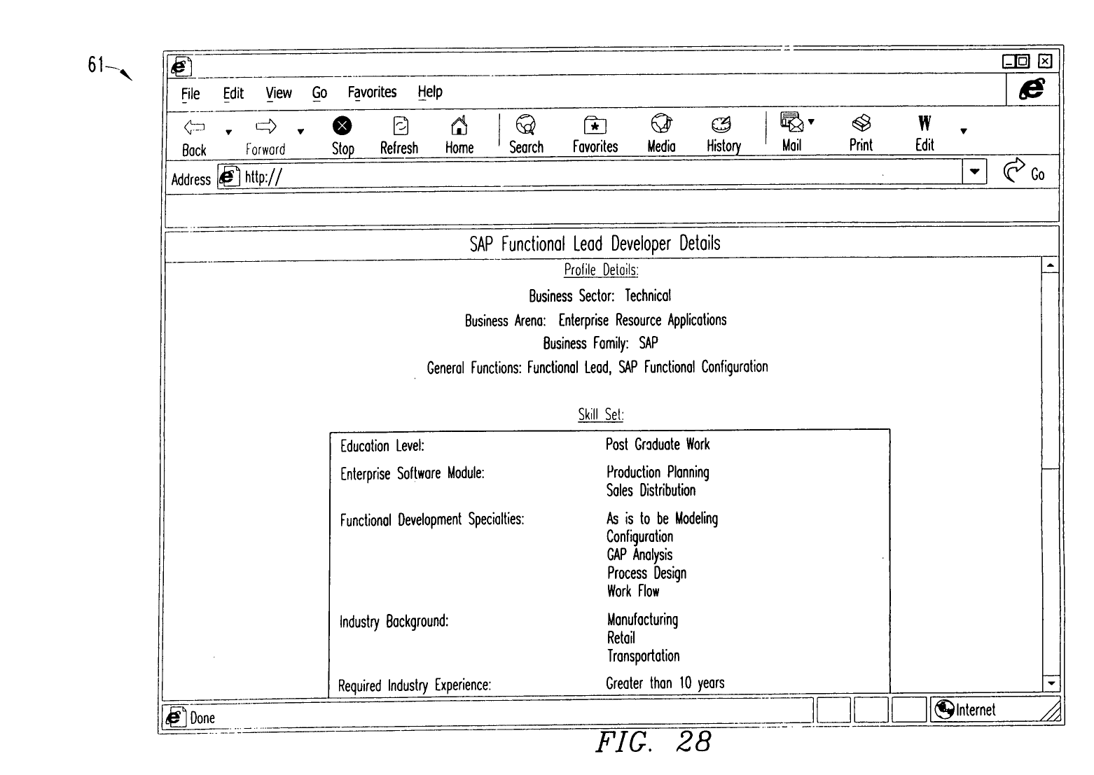

An example of vendor response data selected from pre-established vendor responses is shown in FIG. 28. If the bid request includes a bid item selection requiring the vendor to provide resource requirement information for the project, along with, for example, the resource rates associated with the resource requirement information, the data field 238 can provide links to other web pages for selection of pre-established resource profile parameters. For example, each resource profile can indicate a particular resource type and associated skills needed for the resource profile. To facilitate effective comparison of resource profiles and rates by the buyer, the vendor can select from a number pre-established resource types and associated skills. To implement the resource type and skills selections, a configurable and scalable database structure can be provided that enables the vendor's specific resource requirements to be classified in non-prose fashion.

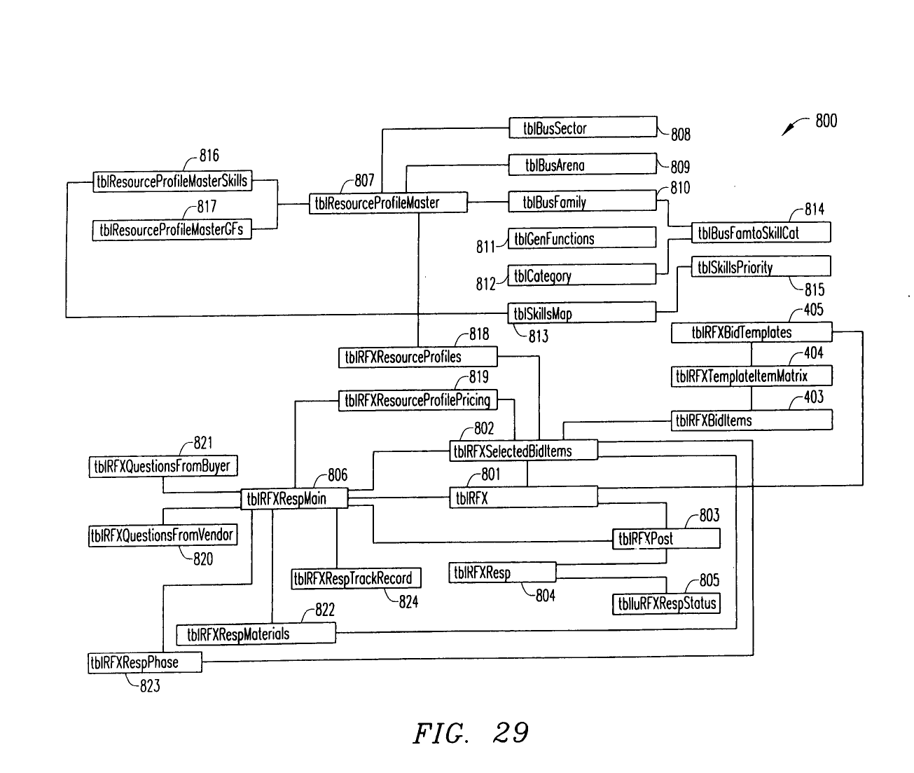

Examples of data structures used for selecting the resource type and associated skills are shown in Tables 30-37 hereinbelow. The data structures are illustrated for simplicity as being organized in a table format, with each table including all of the fields necessary for displaying the resource types and associated skills to the vendor user to select from and storing the selected resource profile within the data field of the associated bid item selection. The tables are related in a hierarchical and relational manner, such that the tables are accessed in a particular order for displaying the resource types and associated skills to the vendor user, as will be described hereinbelow in connection with FIG. 29, which illustrates a database table structure 800 representing an exemplary data scheme associated with a complete vendor bid response the interrelation between the vendor bid response and the buyer bid request.

Table 30 below illustrates sample business sector categories, such as light industrial, management/professional, office and technical. Within each of the business sector categories are one or more business arenas, as shown in Table 31, and within each of the business arenas are one or more business families, as shown in Table 32. Therefore, to select a particular business family associated with the resource type for the bid response, the vendor user can select a business sector category and business arena to display a list of business families to select from. Once the business family is selected, the various skills (general functions and business skills) associated with the resource type can be selected and mapped to the particular resource type, as shown in Tables 33-37. For example, the general functions can identify the level of skill associated with the resource type, the skills category can identify the types of skills, training and experience that the resource type possesses and one or more skills sets associated with each skills category can identify the specific experience associated with the resource type. In addition, certain skills sets can be emphasized over other skills sets by establishing a priority level for each of the skills sets of the resource type. It should be understood that other resource type and skill selections can be provided, and the system is not limited to the particular configuration and information shown in Tables 30-37. For a more complete discussion of resource profiling, reference is made to co-pending and commonly assigned U.S. patent application Ser. No. 10/128,751, which is hereby incorporate by reference in its entirety herein.

TABLE 30
Exemplary Business Sectors Table (tblBusSector)

| Bus_Sector_Name | Bus_Section_ID | ASP_Display_Order |
|---|---|---|
| Light Industrial | 1 | 4 |
| Mgmt/Professional | 2 | 2 |
| Office | 3 | 3 |
| Technical | 4 | 1 |

TABLE 31
Exemplary Business Arenas Table (tblBusArena)

| Bus_Arena_ID | Bus_Arena_Name | Bus_Sector_ID | ASP_Display_Order |
|---|---|---|---|
| 1 | Administrative Support | 3 | 5 |
| 2 | Business Support | 4 | 5 |
| 3 | Communications Software | 4 | 10 |
| 4 | Controller | 2 | 10 |
| 5 | Enterprise Resource Applications | 4 | 15 |
| 6 | Finance | 2 | 15 |
| 7 | General Business Support | 3 | 10 |
| 8 | General Clerical | 3 | 15 |
| 9 | General Support | 1 | 5 |
| 10 | Human Resources | 2 | 20 |
| 11 | Legal | 2 | 25 |
| 12 | Logistics Support | 1 | 10 |
| 13 | Management Information Systems | 4 | 20 |
| 14 | Manufacturing | 2 | 30 |
| 15 | Materials Management | 2 | 35 |
| 16 | Network Engineering | 4 | 25 |
| 17 | Product Development | 4 | 30 |
| 18 | Production | 1 | 15 |
| 21 | Sales | 2 | 40 |
| 22 | Call Center | 2 | 5 |

TABLE 32
Exemplary Business Families Table (tblBusFamily)

| Bus_Family_ID | Bus_Family_Name | Bus_Arena_ID | ASP_Page_Display |
|---|---|---|---|
| 23 | Maintenance | 9 | 5 |
| 24 | Driver/Courier | 9 | 10 |
| 26 | Shipping/Receiving | 12 | 5 |
| 27 | Distribution | 12 | 10 |
| 28 | Inventory Control | 12 | 15 |
| 29 | Light Assembly | 18 | 5 |
| 30 | Electronic Assembly | 18 | 10 |
| 31 | Quality Assurance/Control | 18 | 15 |
| 32 | Assets Management | 4 | 5 |
| 33 | Audit | 4 | 10 |
| 34 | Budgeting | 4 | 15 |
| 35 | Cost Center Accounting | 4 | 20 |
| 36 | Overheads | 4 | 25 |
| 37 | Product Costing | 4 | 30 |
| 38 | Profit Center Accounting | 4 | 35 |
| 39 | Profitability | 4 | 40 |
| 40 | Project Accounting | 4 | 45 |
| 41 | Taxaction | 4 | 50 |
| 42 | TreasuryCash Management | 4 | 55 |
| 43 | Accounts Payable | 6 | 5 |
| 44 | Accounts Receivable | 6 | 10 |
| 45 | Capital Investment | 6 | 15 |
| 46 | Consolidation | 6 | 20 |
| 47 | Credit/Collections | 6 | 25 |
| 48 | General Ledger | 6 | 30 |
| 49 | Other Ledgers | 6 | 35 |
| 50 | Benefits | 10 | 5 |
| 51 | Payroll | 10 | 10 |
| 52 | Personnel | 10 | 15 |
| 53 | Services | 10 | 20 |
| 54 | Antitrust Law | 11 | 5 |
| 55 | Contract Law | 11 | 10 |
| 56 | Corporate Law | 11 | 15 |
| 57 | Environmental Law | 11 | 20 |
| 58 | International Law | 11 | 25 |
| 59 | Labor Law | 11 | 30 |
| 60 | Real Estate Law | 11 | 35 |
| 61 | Taxation Law | 11 | 40 |
| 62 | Maintenance in Manufacturing | 14 | 5 |
| 63 | Manufacturing Process | 14 | 10 |
| 64 | Manufacturing Production | 14 | 15 |
| 65 | Manufacturing Quality Control | 14 | 20 |
| 66 | Distribution/Transportation/Warehousing | 15 | 25 |
| 67 | Materials Management | 15 | 30 |
| 68 | Purchasing | 15 | 35 |
| 69 | Sales Management | 21 | 5 |
| 70 | Sales Operations | 21 | 10 |
| 71 | Customer Service | 22 | 5 |
| 72 | Operations | 22 | 10 |
| 73 | Sales/Marketing | 22 | 15 |
| 74 | Bookkeeping | 7 | 5 |
| 75 | Database Support | 7 | 10 |
| 76 | Desk Top Publishing | 7 | 15 |
| 77 | Spreadsheet Support | 7 | 20 |
| 20 | General Clerical Support | 8 | 5 |
| 21 | Administrative Support | 1 | 5 |
| 18 | Business Analysis | 2 | 5 |
| 19 | Business Support | 2 | 10 |
| 1 | Network Design/Planning/Consulting | 16 | 5 |
| 2 | Network Infrastructure | 16 | 10 |
| 3 | Network Operations/Administration | 16 | 15 |
| 4 | OS Programming | 3 | 15 |
| 5 | Application Development | 3 | 5 |
| 6 | Database Development | 3 | 10 |
| 8 | Product Management | 17 | 10 |
| 9 | Product Design/Development | 17 | 5 |
| 10 | OS Programming | 13 | 9 |
| 11 | Network Infrastructure Support | 13 | 15 |
| 12 | Application Development | 13 | 5 |
| 13 | Network Management/Administration | 13 | 20 |
| 14 | SAP | 5 | 20 |
| 15 | PeopleSoft | 5 | 15 |
| 16 | Oracle | 5 | 10 |
| 17 | Baan | 5 | 5 |
| 78 | Database Development | 13 | 10 |

TABLE 33
Exemplary Business General Functions

| | | | Resource Profile |
|---|---|---|---|
| Column Name | Data Type | Length | Info |
| Business_Family_ID | Int | 4 | 78 |
| General_Function_ID | Int | 4 | 3 |
| General_Function_Name | Nvarchar | 100 | Database Admin. |

TABLE 34
Skill Categories Table (tblCategory)

| Column Name | Data Type | Length |
|---|---|---|
| Skills_Category_ID | Int | 4 |
| Skills_Category | Nvarchar | 255 |

TABLE 35
Skills By Category Table (tblSkillsMap)

| Column Name | Data Type | Length |
|---|---|---|
| Skill_ID | int | 4 |
| Skill_Name | nvarchar | 255 |
| Skills_Category | nvarchar | 255 |
| Skills_Category_ID | int | 4 |

TABLE 36
Business Family to Skill Category Map (tblBusFamtoSkillCat)

| Column Name | Data Type | Length |
|---|---|---|
| BusinessFamilyID | int | 4 |
| Skills_Category_ID | int | 4 |
| Skills_Category | nvarchar | 255 |
| Required | char | 1 |
| Record_ID | int | 4 |

TABLE 37
Exemplary Business Skills Priority

| | | | Resource Profile |
|---|---|---|---|
| Column Name | Data Type | Length | Info |
| Skill_Priority_ID | int | 4 | 2 |
| Skill_Priority_Name | varchar | 50 | Critical |

Upon submission of the vendor bid response, all of the bid item selection fields are populated with bid data (either bid request data or vendor response data), which is stored in system (buyer database and vendor database) as a bid in a hierarchical and relational manner, as shown in the database table structure 800 of FIG. 29. Exemplary data structures for storing the bid data are shown hereinbelow in Tables 38-55, which will be discussed in connection with FIG. 29.

Tables 38 and 39 below illustrate sample bid request data associated with a particular bid request that can be stored in the database in tables tblRFX 801 and tblRFXSelectedBidItems 802, as shown in FIG. 29. For example, in table tblRFX 801, general information concerning the bid request can be stored, such as the bid tracking number assigned to the bid request by the system, the bid request name assigned by the originator, the identity of the bid request originator, the bid template type, the project type, project work location, budgeted expenditure amount for the project, the status of the bid request (e.g., new, submitted, evaluated, awarded, etc.), whether or not top-level database vendors received the bid request and whether any approval was required. However, it should be understood that other bid information can also be included, and the system is not limited to the specific information shown in Tables 38 and 39.

The specific bid items selections included within the bid request and the bid request data (buyer comments) entered by the originator for each of the bid item selections can be stored in the table tblRFXSelectedBidItems 802. Each bid item selection can be stored as a separate record in tblRFXSelectedBidItems 802, with each record containing all of the fields shown in Table 39 below. Table tblRFXSelectedBidItems 802 is tied to the general bid request information table tblRFX 801. As discussed above in connection with FIG. 10, the bid item selections contained within table tblRFXSelectedBidItems 802 are selected from the table tblRFXBidItems 403 and associated with a particular bid template type stored within table tblRFXBidTemplates 405 through table tblRFXTemplateItemMatrix 404.

TABLE 38
Master Bid Table (tblRFX - db structure view)

| Column Name | Data Type | Length |
|---|---|---|
| RFX_Tracking_ID | int | 4 |
| Originator_User_ID | int | 4 |
| RFX_Template_ID | int | 4 |
| Project_Sector_ID | int | 4 |
| Project_Family_ID | int | 4 |
| Project_Type_ID | int | 4 |
| RFX_Status_ID | int | 4 |
| Buyer_Bid_ID | varchar | 100 |
| RFP_Title | varchar | 100 |
| RFX_Administration_Location_ID | numeric | 9 |
| Primary_Work_Location_ID | numeric | 9 |
| External_Work_Location | varchar | 500 |
| Solicit_TLD_Vendors | char | 1 |
| Currency_ID | int | 4 |
| Budgeted_Expenditure | money | 8 |
| Assigned_to_ID | int | 4 |
| RFQ_Team_Member | int | 4 |
| Financial_Approval_Required | char | 1 |
| Non_Financial_Approval_Required | char | 1 |

TABLE 39
RFX Bid Items Table (tblRFXSelectedBidItems)

| Column Name | Data Type | Length |
|---|---|---|
| RFX_Tracking_ID | int | 4 |
| RFX_Item_ID | int | 4 |
| RFX_Item | varchar | 255 |
| Disablement_Allowed | char | 1 |
| HM_Disabled | char | 1 |
| Buyer_Comments | varchar | 8000 |
| Vendor_Bid_Display | char | 1 |
| Vendor_Response_Item | char | 1 |
| Vendor_Response_Required | char | 1 |
| Item_Complete | char | 1 |
| Identity_Key | int | 4 |

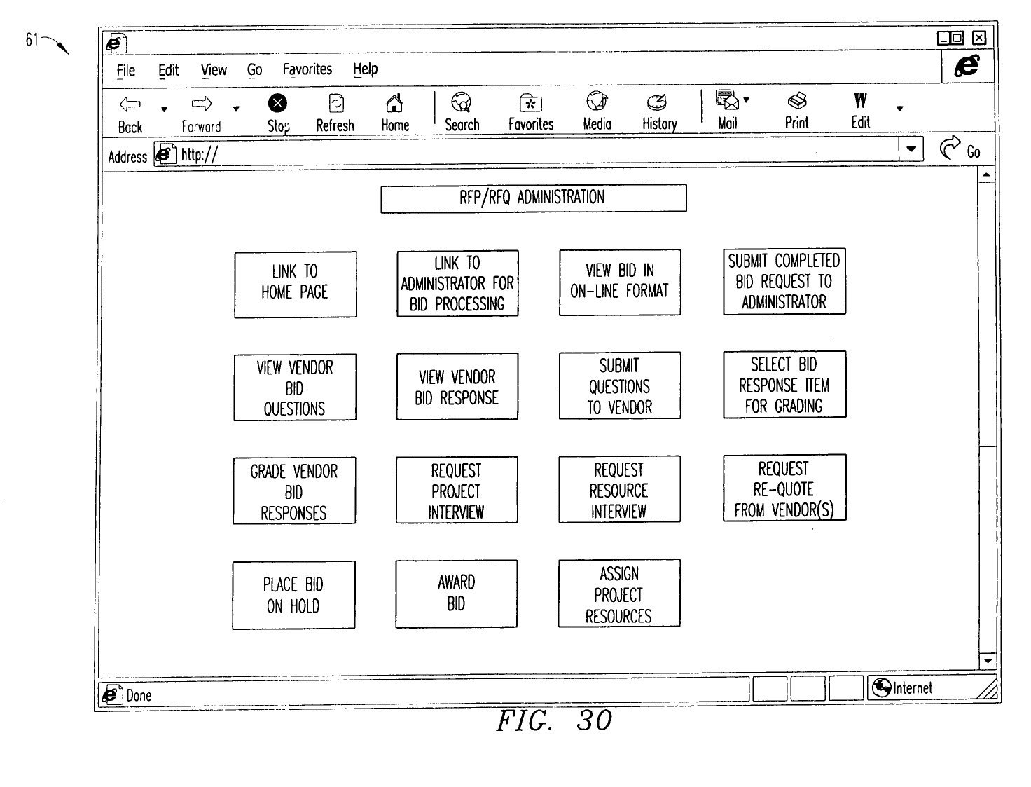

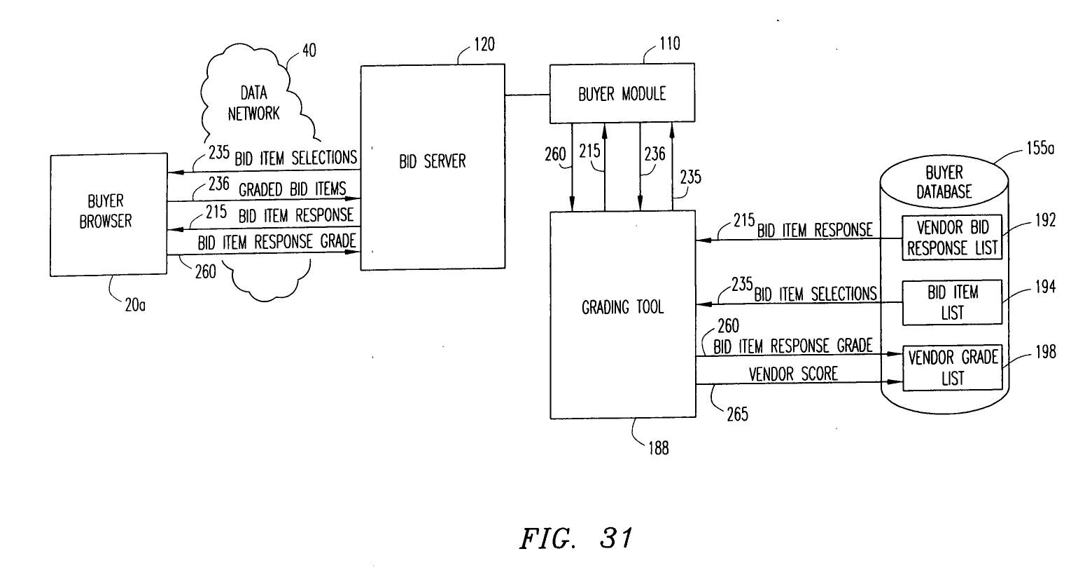

Sample information pertaining to the posting (transmitting) of the bid request to qualified vendors is shown hereinbelow in Table 40, which can be stored in the database in table tblRFXPost 803, as shown in FIG. 29. In exemplary embodiments, posting information is related to each particular vendor that received the bid request, and can include, for example, the date and time the bid request was submitted (posted) to the qualified vendor, the identity of the administrative user that posted the bid request, the identity of the qualified vendor that received the bid request, the vendor bid response identifier and the score assigned to the vendor, as described below in connection with FIGS. 31-35. However, it should be understood that other information can be included, and the system is not limited to the specific information shown in Table 40. A separate record for each vendor that received the bid request can be stored in table tblRFXPost 803, with each record including all of the fields shown hereinbelow.

TABLE 40
tblRFXPost

| Column Name | Data Type | Length |
|---|---|---|
| Bid_Tracking_ID | int | 4 |
| Vendor_ID | int | 4 |
| Posting_Record | int | 4 |
| Post_Time | datetime | 8 |
| Admin_Poster_ID | int | 4 |
| Response_ID | int | 4 |
| Score | int | 4 |

Sample information pertaining to the receipt of the bid request by the vendor and the submission of the vendor bid response is shown hereinbelow in Table 41, which can be stored in the database in table tblRFXResp 804, as shown in FIG. 29. For example, such response submission information can include the vendor bid response identifier, the status of the vendor bid response, the identity of the vendor, the vendor bid response submission date and the dates the vendor acknowledged the confidentiality and intend to respond agreements. Examples of the types of status information that can be included in the table tblRFXResp 804 are shown hereinbelow in Table 42, which can be stored in the database in table tblRFXRespStatus 805, as shown in FIG. 29. Tables tblRFXResp 804 and tblRFXRespStatus 805 are tied to table tblRFXPost 803, which in turn, is tied to tblRFX 801 to associate the vendor response submission information to the bid posting information for the bid request. However, it should be understood that other information can be included, and the system is not limited to the specific information shown in Tables 41 and 42. A separate record for each vendor bid response can be stored in tblRFXResp 804, with each record containing the fields shown in Table 41 below.

TABLE 41
tblRFXResp

| Column Name | Data Type | Length |
|---|---|---|
| Response_ID | int | 4 |
| RFX_Resp_Status_ID | int | 4 |
| Vendor_ID | int | 4 |
| Confidentiality_Acceptance_Date | datetime | 8 |
| Intend_to_Respond_Date | datetime | 8 |
| RFX_Resp_Submit_Date | datetime | 8 |
| Last_Edit_Date | datetime | 8 |

TABLE 42
Exemplary Data from tblRFXRespStatus

```
  1 New
  2 Confidentiality_Terms_Accepted
  3 Confidentiality_Terms_Not_Accepted
  4 Response_Intended
  5 Response_Declined
  6 Temporarily_Saved
  7 Response_Submitted
  8 Bid_Not_Accepted
  9 Awaiting_Re-Bid
10 Re-Bid_Declined
11 Bid_Accepted
12 Bid_On_Hold
13 Waiting_Bid_Description
```

Table 43 below illustrates sample vendor bid response data submitted in a vendor bid response from a vendor to a buyer, which can be stored in the database in table tblRFXRespMain 806, as shown in FIG. 29. For example, such vendor bid response data can include the bid tracking number, the vendor response identifier, the identity of the vendor, the particular bid item selection the vendor has responded to, the vendor response to that particular bid item selection, any bid request data (buyer comments) associated with that particular bid item selection, the record identifier for the vendor response to the particular bid item selection and any grade given to the vendor response by the buyer, as will be described in more detail hereinbelow in connection with FIGS. 31-35. However, it should be understood that other information can be included, and the system is not limited to the specific information shown in Table 43. A separate record for each bid item selection responded to by the vendor is stored in tblRFXRespMain 806, with each record containing the fields shown in Table 43 below. Table tblRFxRespMain 806 is tied to tblRFX 801 and tblRFXPost 803 to associate the vendor bid response with the bid request.

TABLE 43
tblRFXRespMain

| Column Name | Data Type | Length |
|---|---|---|
| Bid_Tracking_ID | int | 4 |
| Response_ID | int | 4 |
| Vendor_ID | int | 4 |
| Identity_Key | int | 4 |
| RFX_Item_ID | int | 4 |
| RFX_Item | varchar | 50 |
| Vendor_Response | varchar | 7000 |
| Required_Item | char | 1 |
| Buyer_Comments | varchar | 7000 |
| Resp_Record_ID | int | 4 |
| Record_Create_Date | datetime | 8 |
| Last_Save_Date | datetime | 8 |
| Item_Grade | char | 1 |

Associated with one or more of the vendor responses to bid item selections may be one or more resource profiles of the particular resources (contractors) that the vendor identified as necessary to complete the project. The resource profiles can be created in advance or as part of the vendor bid response. The resource profiles are generated using the business sector, business arena, business family, general functions and skills discussed above in connection with FIG. 28 and shown in Tables 30-37 above.

Examples of resource profile information (resource type and skills) for resource profiles are shown hereinbelow in Tables 44-46, which can be stored in the database in tables tblResourceProfileMaster 807, tblResourceProfile MasterSkills 816 and tblResourceProfileMasterGF's 817, as shown in FIG. 29. The table tblResourceProfileMaster 807 stores the resource type of the resource profile (e.g., business sector, arena and family), while table tblResourceProfileMasterSkills 816 stores the business skills (skills sets and skill sets priorities) associated with the resource type and table tblResourceProfileMasterGF's 817 stores the general functions of the resource type. However, it should be understood that other information can be included, and the system is not limited to the specific information shown in Tables 44-46. A separate record for each resource profile is included in tables tblResourceProfileMaster 807, tblResourceProfileMasterSkills 816 and tblResourceProfileMasterGF's 817, with each of the records containing all of the fields shown below in Tables 45-46. The table tblResourceProfileMaster 807 is tied to tables tblResourceProfileMasterSkills 816 and tblResourceProfileMasterGF's 817 to associate the general functions and skills sets with the resource type of each resource profile.

TABLE 44
tblResourceProfileMaster (db structure view)

| Column Name | Data Type | Length |
|---|---|---|
| Resource_Profile_ID | int | 4 |
| Resource_Profile_Name | varchar | 255 |
| User_ID | int | 4 |
| Vendor_ID | int | 4 |
| Bus_Sector_ID | int | 4 |
| Bus_Arena_ID | int | 4 |
| Bus_Family_ID | int | 4 |
| User_Notes | varchar | 1000 |
| Record_Date | datetime | 8 |
| Profile_Status | char | 4 |

TABLE 45
tblResourceProfileMasterGFs (db structure view)

| Column Name | Data Type | Length |
|---|---|---|
| Resource_Profile_ID | Int | 4 |
| General_Function_ID | Int | 4 |
| Record_ID | Int | 4 |

TABLE 46
tblResourceProfileMasterSkills (db structure view)

| Column Name | Data Type | Length |
|---|---|---|
| Resource_Profile_ID | int | 4 |
| Skill_ID | int | 4 |
| Record_ID | int | 4 |
| Skill_Priority | int | 4 |

Sample information relating to the particular selected resource profiles submitted with the vendor bid response is shown in Table 47 below, which can be stored in table tblRFXResourcePfoiles 818 in FIG. 29. For example, such selected resource profile information can include the identity of the resource profile and the anticipated quantity of that particular selected resource profile that are needed to complete the project. However, it should be understood that other information can be included, and the system is not limited to the specific information shown in Table 47. A separate record for each selected resource profile for the project is stored in tblRFXResourceProfiles 818, with each record containing all of the fields shown in Table 47 below. Table tblRFXResourceProfiles 818 is tied to table tblRFXResourceProfileMaster 807 to associate the particular resource type, skills and general functions with the selected resource profile. Table tblRFXResourceProfiles 818 is further tied to table tblRFXSelectedBidItems 802 to associate the selected resource profiles with the particular bid item selections requesting the resource profiles.

TABLE 47
tblRFXResouceProfile (db structure view)

| Column Name | Data Type | Length |
|---|---|---|
| Resource_Profile_ID | int | 4 |
| Anticipated_Quantity | int | 4 |
| User_ID | int | 4 |
| Record_Date | datetime | 8 |
| Identity_Key | int | 4 |
| Record_ID | int | 4 |

Depending on the bid request, as part of the vendor bid response to one or more bid item selections, the vendor may also provide pricing information associated with the particular selected resource profiles for the project. Sample resource pricing information is shown in Table 48 below, which can be stored in the database in table tblRFXResourcesProfilePricing 819, as shown in FIG. 29. For example, such resource pricing information can include the resource profile identifier, the identity of the vendor bid response record for the bid item selection requesting the resource profile and pricing information, the anticipated number of hours the resource associated with the resource profile will work, the billing rate associated with the resource profile and the anticipated billing amount of the resource associated with the resource profile. However, it should be understood that other information can be included, and the system is not limited to the specific information shown in Table 48. A separate record for each resource associated with one of the selected resource profiles is stored in table tblRFXResourcesProfilePricing 819, with each record containing the fields shown in Table 48 below. Table tblRFXResourcesProfilePricing 819 is tied to table tblRFXResourceProfiles 818 to associate the resource pricing information for a particular resource to a particular selected resource profile. In addition, table tblRFXResourcesProfilePricing 819 is tied to table tblRFXRespMain 806 and table tblRFXSelectedBidItems to associate the resource pricing information and selected resource profile with the vendor bid response to a particular bid item selection.

TABLE 48
tblRFXResourceProfilesPricing (db structure view)

| Column Name | Data Type | Length |
|---|---|---|
| Resource_Profile_ID | int | 4 |
| Resp_Record_ID | int | 4 |
| Vendor_ID | int | 4 |
| Anticipated_Hours | int | 4 |
| Bill_Rate | money | 8 |
| Anticipated_Billing | money | 8 |
| Record_Date | datetime | 8 |
| Record_ID | int | 4 |
| Identity_Key | int | 4 |

In addition to the particular resource profiles and pricing, the vendor bid response may also include information related to the types of materials needed for the project. Sample material information is shown below in Table 49, which can be stored in the database in table tblRFXRespMaterials 822, as shown in FIG. 29. For example, such material information can include the identity of the vendor bid response record for the bid item selection requesting the material information, the type of material and the cost of the material. However, it should be understood that other information can be included, and the system is not limited to the specific information shown in Table 49. A separate record for each type of material is stored in table tblRFXRespMaterials 822, with each record containing the fields shown in Table 49 below. Table tblRFXRespMaterials 822 is tied to table tblRFxRespMain 806 and table tblRFXSelectedBidItems to associate the material information with the vendor bid response to a particular bid item selection.

TABLE 49
tblRFXRespMaterials (db structure view)

| Column Name | Data Type | Length |
|---|---|---|
| Resp_Record_ID | int | 4 |
| Material_Name | varchar | 100 |
| Material_Description | varchar | 500 |
| Material_Manufacturer | varchar | 100 |
| Unit_Cost | money | 8 |
| Unit_Count | numeric | 9 |
| Line_Item_Cost | money | 8 |
| Record_Date | datetime | 8 |
| Record_ID | int | 4 |
| Identity_Key | int | 4 |

The vendor bid response may also include information related to the phasing of the project. Sample phasing information is shown below in Table 50, which can be stored in the database in table tblRFXRespPhase 823, as shown in FIG. 29. For example, for each phase of the project, the phasing information can include the identity of the vendor bid response record for the bid item selection requesting the phasing information, the number of the particular phase, a description of the phase, the anticipated duration of the phase and the project deliverables at the end of the phase (e.g., number of units to be completed or other project milestones). However, it should be understood that other information can be included, and the system is not limited to the specific information shown in Table 50. A separate record for each phase is stored in table tblRFXRespPhase 823, with each record containing the fields shown in Table 50 below. Table tblRFXRespPhase 823 is tied to table tblRFxRespMain 806 and table tblRFXSelectedBidItems to associate the phasing information with the vendor bid response to a particular bid item selection.

TABLE 50
tblRFXRespPhase (db structure view)

| Column Name | Data Type | Length |
|---|---|---|
| Resp_Record_ID | int | 4 |
| User_ID | int | 4 |
| Project_Phase_# | numeric | 9 |
| Project_Phase_Description | varchar | 7000 |
| Project_Phase_Duration_Anticipated | varchar | 1000 |
| Project_Phase_Deliverables | varchar | 7000 |
| Record_Date | datetime | 8 |
| Record_ID | int | 4 |
| Identity_Key | int | 4 |

All of the questions and answers posted by the vendor and buyer on the bid message board and any questions submitted to the vendor from the buyer regarding the vendor bid response can also be stored in the system and associated with the particular vendor bid response. Sample question information is shown in Tables 51 and 52 below, which can be stored in the database in tables tblRFXQuestionsFromVendor 820 and tblRFXQuestionsFromBuyer 821, as shown in FIG. 29. A separate record for each vendor question/buyer response and buyer question/vendor response is stored in tables tblRFXQuestionsFromVendor 820 and tblRFXQuestionsFromBuyer 821, with each record containing the fields shown in Tables 51 and 52 below. In addition tables tblRFXQuestionsFromVendor 820 and tblRFXQuestionsFromBuyer 821 are tied to table tblRFXRespMain 806 to associate the questions with the particular vendor bid response.

TABLE 51
tblRFXQuestionsfromVendor (db structure view)

| Column Name | Data Type | Length |
|---|---|---|
| Vendor_ID | int | 4 |
| [Vendor_Question/Comment] | varchar | 8000 |
| Question_Post_Date | datetime | 8 |
| Buyer_Response | varchar | 8000 |
| Buyer_Answer_Post_Date | datetime | 8 |
| Record_ID | int | 4 |
| Resp_Record_ID | int | 4 |

TABLE 52
tblRFXQuestionsfromBuyer (db structure view)

| Column Name | Data Type | Length |
|---|---|---|
| Vendor_ID | Int | 4 |
| Identity_Key | int | 4 |
| [Buyer_Question/Comment] | varchar | 8000 |
| Buyer_Post_Date | datetime | 8 |
| Vendor_Response | varchar | 8000 |
| Vendor_Response_Date | datetime | 8 |
| Record_ID | int | 4 |
| Resp_Record_ID | int | 4 |

The vendor bid response can also be associated with details about previous project work that has been performed by the vendor to aid in bid response process. Sample previous project work details are shown in Table 53 below, which can be stored in the database in table tblRFXRespTrackRecord 824, as shown in FIG. 29. For example, such previous project work details can include the vendor bid response identifier, the project name, the name of the buyer, the value of the project, a description of the project, a discussion of deployed resources (contractors) for the project, a discussion of the performance of the vendor, the project start date and the project end date. It should be understood that additional previous project work details can be stored, and the system is not limited to the specific previous project work details shown in Table 53.

TABLE 53
tblRFXRespTrackRecord (db structure view)

| Column Name | Data Type | Length |
|---|---|---|
| Response_ID | Int | 4 |
| Project_Name | Varchar | 255 |
| Buyer_Name | Varchar | 255 |
| Project_Value | money | 8 |
| Project_Description | varchar | 7000 |
| Deployed_Resources | varchar | 7000 |
| Company_Performance | varchar | 7000 |
| Project_Start_Date | datetime | 8 |
| Project_End_Date | datetime | 8 |
| Record_ID | int | 4 |
| Record_Date | datetime | 8 |

Referring now to FIG. 30, a screen shot of a sample web page displaying options to the buyer for administration of the bid request and vendor bid responses is illustrated. From the bid request administration web page, the buyer user can submit a completed bid request to an administrator (or to qualified vendors), view vendor bid responses to a bid request, grade vendor bid responses, submit questions to the vendor about the vendor bid response, request a re-quote from a vendor, request project interviews with vendors or resource interviews with potential resources (contractors) for a project, award the bid (project) to a particular vendor, assign resources for a project or place a bid request on hold.

Once the buyer has received one or more vendor bid responses to a particular bid request, the buyer can grade or otherwise compare the vendor bid responses in order to determine which vendor will get awarded the project. With the use of pre-established bid items in the (bid request and bid responses, all vendor bid responses have the same format, enabling efficient and effective grading and comparison of vendor bid responses. Therefore, prior to begin grading of the vendor bid responses, the buyer can select one or more bid items for grading purposes.

Exemplary functionality for selecting graded bid items and grading vendor responses to the selected graded bid items is shown in FIG. 31. A grading tool 188 is illustrated in FIG. 31 for the selection of graded bid items and grading of vendor bid responses, in accordance with embodiments of the present invention. The grading tool 188 can include any hardware, software and/or firmware required to perform the functions of the tools and can be implemented within the web server 120 or an additional server (not shown).

At any time after the creation of the bid request, a grader (e.g. buyer user or project administrator user) responsible for grading vendor bid responses can access the grading tool 188 to select one or more bid item selections 235 from the bid request for grading purposes. The grading tool accesses the bid item list 194 stored in the database 155, retrieves the bid item selections 235 from the bid item list 194 that are included within the particular bid request identified by the grader and displays the bid item selections 235 to the grader via the buyer module 110, web server 120, data network 40 and buyer browser 20a to choose from. From the bid item selections 235, the grader can select one or more graded bid items 236 and provide a list of the graded bid items 236 to the grading tool 188.

Upon receipt of one or more vendor bid responses, the grading tool 188 can access a vendor bid response list 192 to retrieve the vendor response data 215 associated with one of the graded bid items 236 for one of the vendor bid responses in the list 192. The bid item response data 215 is displayed to the grader for grading purposes. Based on various factors (objective and subjective) regarding the quality and information included within the displayed bid item response data 215, the grader can assign a grade for that bid item response 215 and transmit a bid item response grade 260 to the grading tool 188.

The grading tool 188 further interfaces with the database 155 to store the bid item response grade 260 for the vendor in a vendor grades list 198 that contains the bid item response grades 260 for all graded bid items 236 for each of the vendor bid responses in the vendor bid response list 192. In addition, based on all of the bid item response grades 260 received by the grading tool 188 for all of the graded bid items 236 for a particular vendor bid response, the grading tool 188 can calculate an overall vendor score 265 for the particular vendor bid response and store the vendor score 265 in the vendor grades list 198.

Exemplary steps for selecting graded bid items and grading vendor bid responses using the graded bid items are shown in FIGS. 32 and 33. The main processing steps performed for bid response grading are shown in FIG. 32. Upon receipt of vendor bid responses (step 3200), the bid item selections to be used for grading purposes are identified (step 3210). The bid item selections are associated with the bid request soliciting the vendor bid responses, and vendor bid response data is included within the bid item selections chosen for grading purposes. Using the vendor bid response data within the graded bid items, the vendor bid responses are graded (step 3220).

A more detailed grading process is shown in FIG. 33. After a bid request is created, a buyer user is provided a list of bid item selections associated with the bid request (step 3330). From the list of bid item selections, one or more graded bid items are chosen (step 3305), and each graded bid item may be assigned a weighting factor (e.g., a weighting percentage) (step 3310) to weigh certain responses more heavily than other responses in the final score. It should be noted that in some embodiments, the weighting factors can be equal, thereby eliminating the requirement that the buyer user enter a specific weighting factor. The weighting factors for all the graded bid items must be complete before the vendor bid responses can be graded (step 3315).

Once all of the graded bid items have been chosen and assigned a weighting factor, the grader is provided a list of vendor bid responses (step 3320) and selects one of the vendor bid responses for grading purposes (step 3325). Thereafter, the grader selects one of the graded bid items (step 3330) to grade the vendor bid response data included within the graded bid item (step 3335). The grader can grade the vendor bid response data using any mechanism available to the grader. In one embodiment, the grader can pre-establish grading criteria for a particular graded bid item to enable the system to automatically grade the vendor response data. For example, to grade pricing information, the grader can pre-assign grades to specific pricing ranges, and the system can automatically provide a grade for a pricing graded bid item based on the price submitted in the vendor bid response. In other embodiments, the grader can compare all of the vendor bid response data for a particular graded bid item initially before assigning grades based on the relative differences between the vendor bid response data. In still further embodiments, the grader can pre-establish a checklist or thresholds for each grade to be assigned to a particular graded bid item.

The grade assigned to the vendor response data for the graded bid item is stored in the database (step 3340), and the process is repeated for each graded bid item until the vendor response data included within each graded bid item for a particular vendor bid response is graded (step 3345). Once all of the grades have been completed, the system calculates the vendor's total score based on the individual grades assigned to each graded bid item (step 3350). For example, if the possible grades are A, B, C and D, the vendor score can be calculated by assigning four points for an A, three points for a B, two points for a C and one point for a D.

Each vendor bid response is graded in the same manner (step 3355) to enable the vendor scores to be sorted into descending order (step 3360) for display to the buyer user (step 3365). In addition to the total score, the grader can also be provided with the individual grades for the graded bid items to determine if any re-quotes are necessary. By providing the grader with the total scores and individual grades, the grader can visually determine which vendor had the highest overall score and which vendors had the highest grades for particular graded bid items in order to make a decision as to which vendor to award the project. However, it should be understood that other bid response comparison techniques can be used with the system of the present invention, instead of the specific grading and scoring described herein.

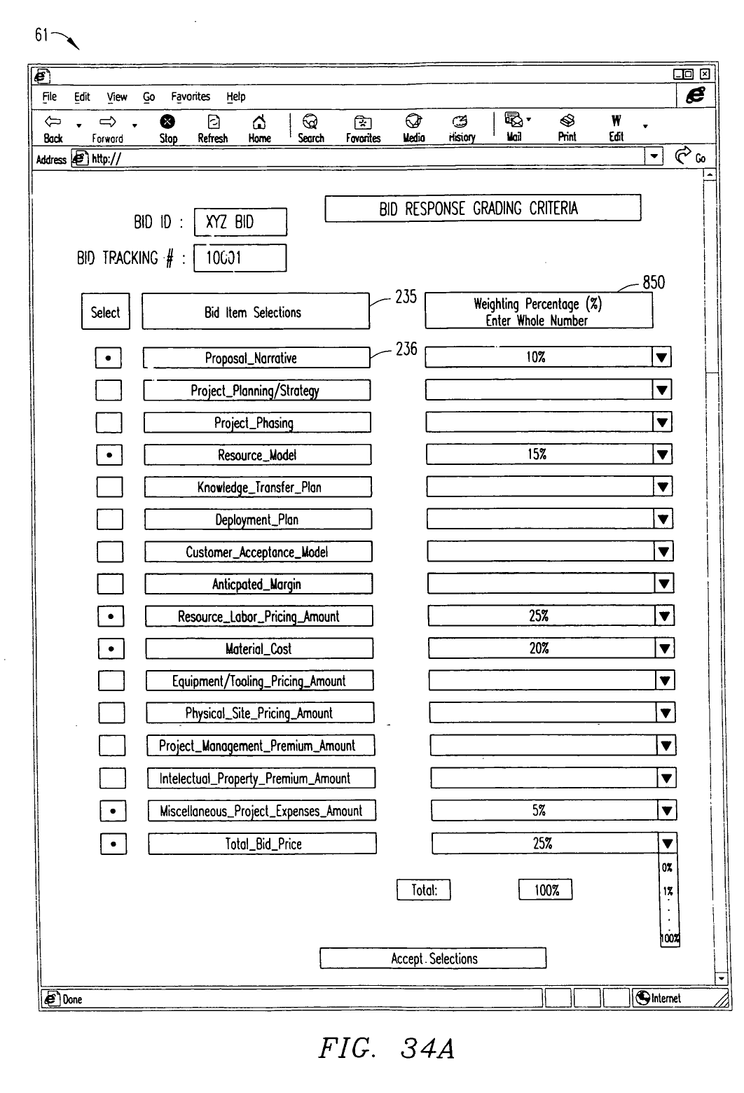

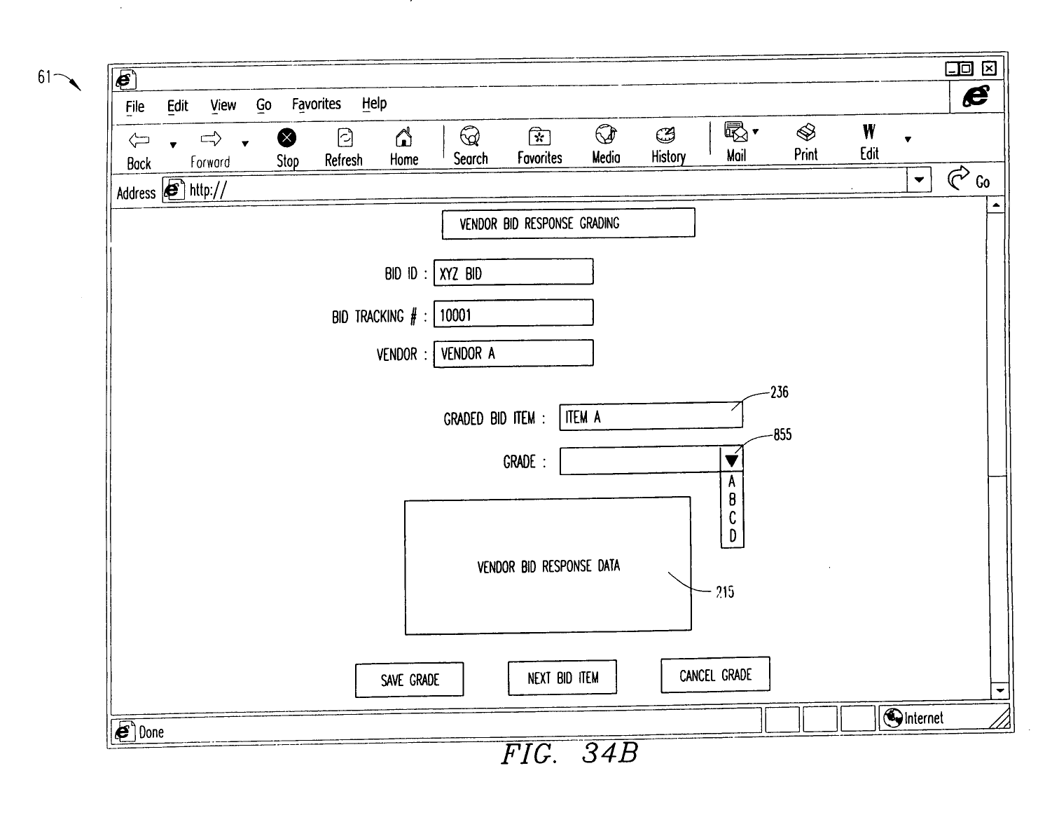

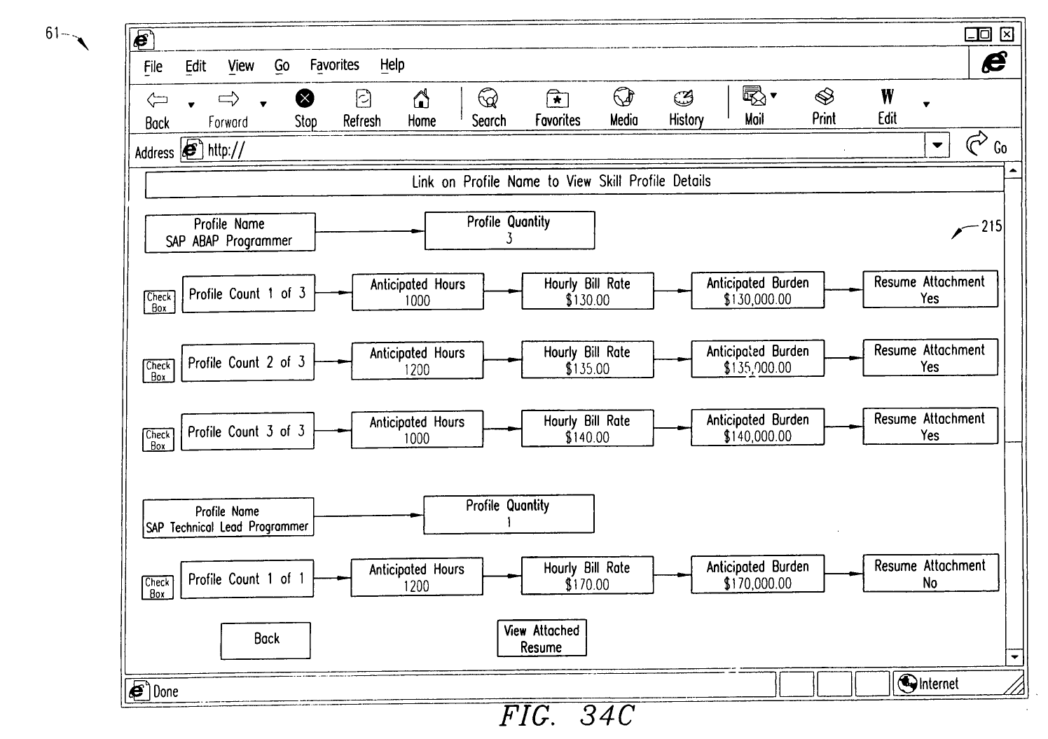

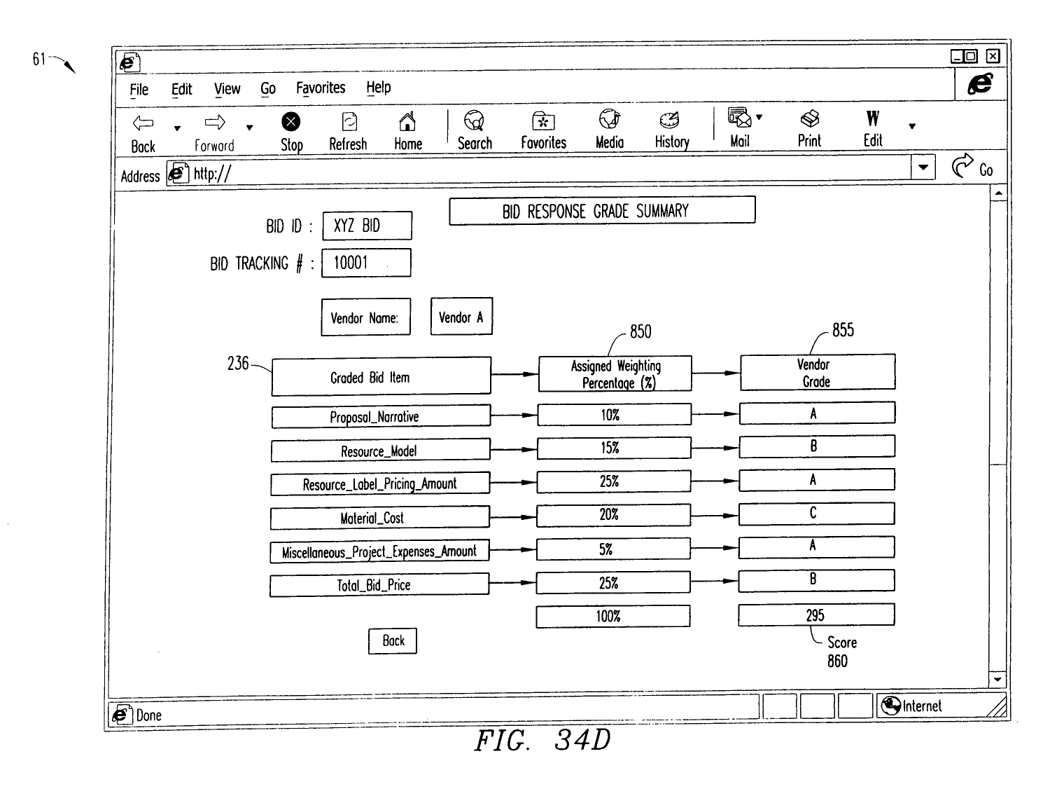

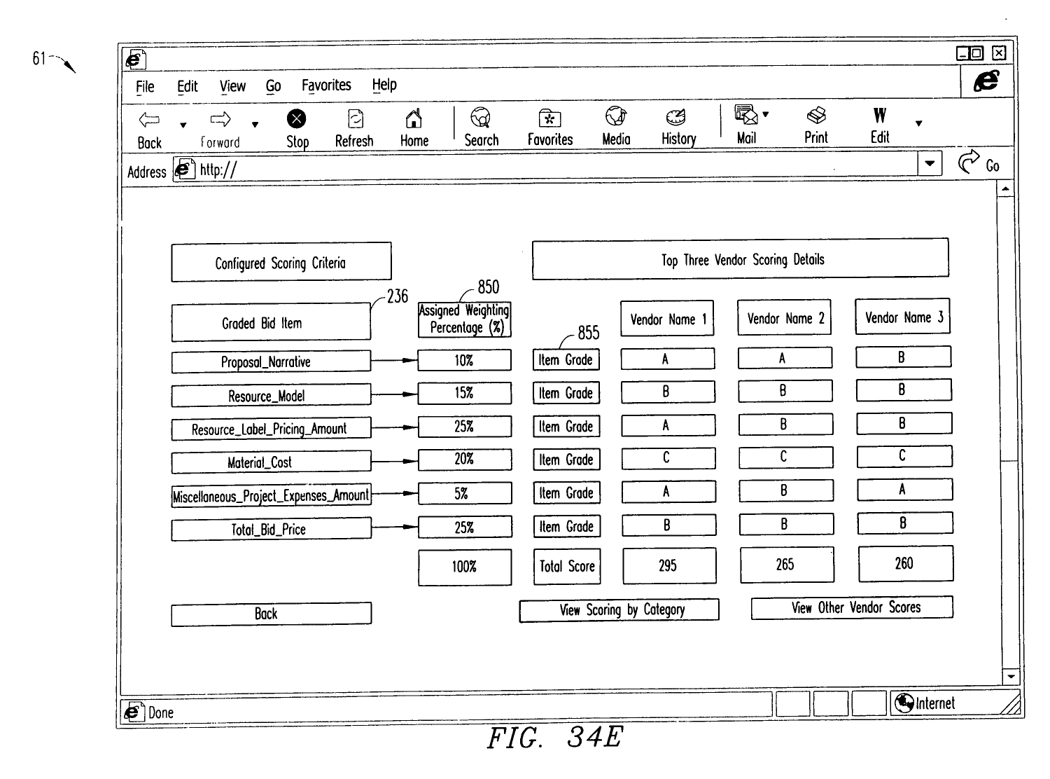

Screen shots of exemplary web pages 61 that can be displayed to the grader for selection of graded bid items and grading of vendor bid responses are shown in FIGS. 34A-34E. In FIG. 34A, the web page contains a list of bid item selections 235 for the grader to select from. For each of the selected graded bid items 236, the grader can also enter a weighting percentage 850 for that graded bid item 236. The grader can adjust the weighting percentages 850 based on pre-established criteria or personal preferences until the weighted percentage 850 total equals one-hundred percent. As discussed above, in other embodiments, all graded bid items 236 can be assigned equal weights, so that the weighting percentages 850 would not need to be displayed to or selected by the grader.

In order to grade vendor bid responses, as shown in FIG. 34B, the grader can be provided a web page listing the particular graded bid item 236 and either displaying the vendor bid response data 215 or providing a link to the vendor bid response data 215. For example, as shown in FIG. 34C, a link to the resource profile and associated resource pricing information can be provided into order to grade a particular graded bid item. Referring again to FIG. 34B, the grader can further be provided a prompt to enter the grade 855 for the vendor bid response data 215 associated with the graded bid item 236. In other embodiments, the grades 855 may be automatically assigned by the system, based on pre-established grading criteria.

Once a vendor bid response has been graded, as shown in FIG. 34D, the grader can be provided a web page displaying all of the graded bid items 236, the weighting percentages 850 assigned to the graded bid items 236 and the vendor grade 855 assigned to each of the graded bid items 236 by the grader. In addition, the total vendor score 860 can also be displayed to enable the grader to determine the total quality of the vendor bid response. Referring now to FIG. 34E, vendor bid responses can be compared side-by-side based on the total vendor score 860 and individual grades 855 assigned to each of the graded bid items 236.

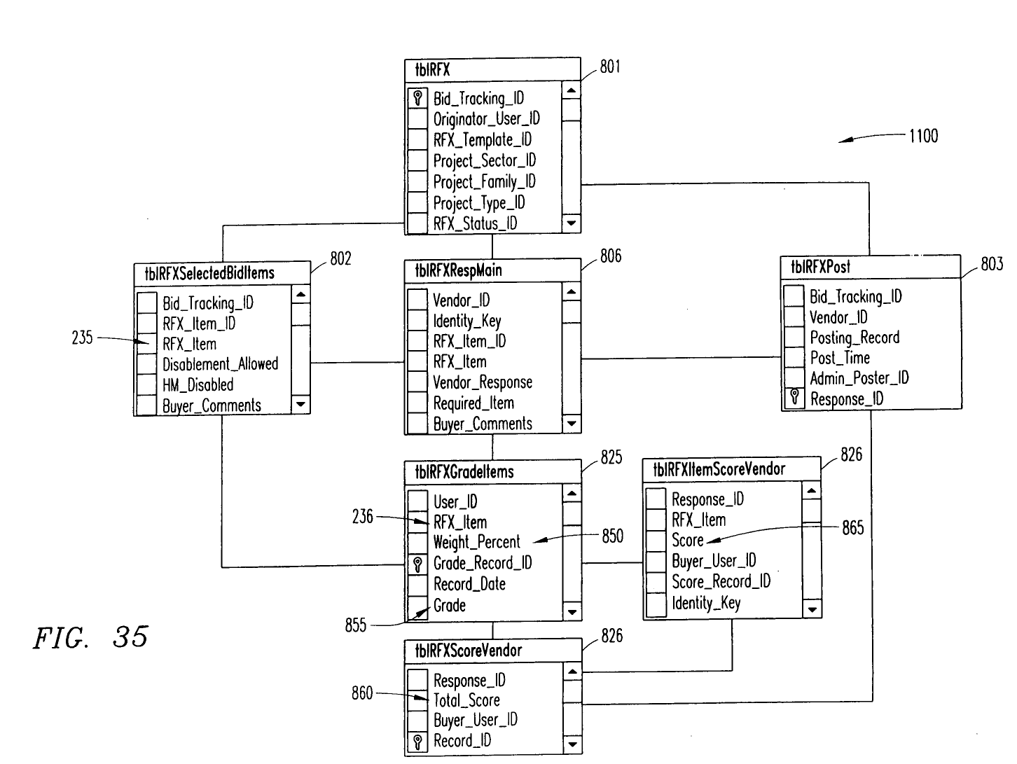

Examples of the data structures used for selecting the graded bid items and storing the vendor grades are shown in Tables 54-56 hereinbelow. The data structures are illustrated for simplicity as being organized in a table format, with each table including all of the fields necessary for displaying bid item selections to the buyer user to select from and storing grades and scores for vendor bid responses. The tables are related in a hierarchical and relational manner, as will be discussed in connection with FIG. 35.

Sample bid item selections that could be included in a bid request and associated vendor bid response are shown in Table 54 below. However, it should be understood that other information can be included, and the system is not limited to the specific information shown in Table 54. For each bid item selection, there is an indication of whether or not that bid item selection is gradable. For example, not all of the bid item selections may include vendor response data to grade. Therefore, only the gradable bid item selections are displayed to the buyer user to select from.

TABLE 54
Exemplary Vendor Listing of Potential Graded Bid Items (By Category)

| | | Default_{—} | |
|---|---|---|---|
| RFX_Category | RFX_Item | Gradable_Item | AV_Response_Data_Type |
| Supplier_General_Information | Agree_To_Confidentiality_Terms | | Char |
| Supplier_General_Information | Intent_To_Respond | | Char |
| Supplier_General_Information | Company_History | | LongText |
| Supplier_General_Information | Competitive_Analysis | | LongText |
| Supplier_General_Information | Product/Services_Heritage_Review | | LongText |
| Supplier_General_Information | Product/Services_Strategy | | LongText |
| Supplier_General_Information | Technology_Vision | | LongText |
| Supplier_General_Information | Strategic_Technology_Partners | | AV Hyperlink |
| | | | to Sub-Table |
| | | | ASP |
| Supplier_General_Information | Track_Record | | AV Hyperlink |
| | | | to Sub-Table |
| | | | ASP |
| Supplier_General_Information | Project_Management_Philosophy | | LongText |
| Supplier_General_Information | PMI_Certified_FTEs | | LongText |
| Supplier_General_Information | Customer_References | | AV Hyperlink |
| | | | to Sub-Table |
| | | | ASP |
| Supplier_Project_Information | Proposal_Narrative | Y | LongText |
| Supplier_Project_Information | Project_Planning/Strategy | Y | LongText |
| Supplier_Project_Information | Statement_Of_Work_Acceptance | | Char |
| Supplier_Project_Information | Statement_Of_Work_Proposed_Changes | | LongText |
| Supplier_Project_Information | Project_Phasing | Y | AV Hyperlink |
| | | | to Sub-Table |
| | | | ASP |
| Supplier_Project_Information | Project_Phasing_Acceptance | | Char |
| Supplier_Project_Information | Resource_Model | Y | AV Hyperlink |
| | | | to Sub-Table |
| | | | ASP |
| Supplier_Project_Information | Knowledge_Transfer_Plan | Y | LongText |
| Supplier_Project_Information | Deployment_Plan | Y | LongText |
| Supplier_Project_Information | Customer_Acceptance_Model | Y | LongText |
| Supplier_Project_Information | Customer_Acceptance_Model_Agreement | | Char |
| Supplier_Project_Information | Customer_Acceptance_Model_Proposed_Changes | | LongText |
| Supplier_Project_Information | Non-Deliverable_Penalties_Acceptance | | Char |
| Supplier_Project_Information | Non- | | LongText |
| | Deliverable_Penalties_Proposed_Changes | | |
| Supplier_Project_Pricing | Resource_Labor_Pricing | | AV Hyperlink |
| | | | to Sub-Table |
| | | | ASP |
| Supplier_Project_Pricing | Resource_Labor_Pricing_Amount | Y | Currency |
| Supplier_Project_Pricing | Equipment/Tooling_Pricing_Comments | | LongText |
| Supplier_Project_Pricing | Materials_List | | AV Hyperlink |
| | | | to Sub-Table |
| | | | ASP |
| Supplier_Project_Pricing | Materials_Cost | Y | Currency |
| Supplier_Project_Pricing | Equipment/Tooling_Pricing_Comments | | Currency |
| Supplier_Project_Pricing | Physical_Site_Pricing_Comments | | LongText |
| Supplier_Project_Pricing | Physical_Site_Pricing_Amount | Y | Currency |
| Supplier_Project_Pricing | Project_Management_Premium_Comments | | LongText |
| Supplier_Project_Pricing | Project_Management_Premium_Amount | Y | Currency |
| Supplier_Project_Pricing | Intellectual_Property_Premium_Comments | | LongText |
| Supplier_Project_Pricing | Intellectual_Property Premium_Amount | Y | Currency |
| Supplier_Project_Pricing | Miscellaneous_Project_Expenses_Comments | | LongText |
| Supplier_Project_Pricing | Miscellaneous_Project_Expenses_Amount | Y | Currency |
| Supplier_Project_Pricing | Anticipated_Margin | Y | Currency |
| Supplier_Project_Pricing | Total_Bid_Price | Y | Currency |
| Supplier_Resource_Expenses_Handling | Resource_Travel_Expense_Comments | | LongText |
| Supplier_Resource_Expenses_Handling | Resource_Living_Expense_Comments | | LongText |
| Supplier_Resource_Expenses_Handling | Resource_Per_Diem_Comments | | LongText |
| Supplier_Resource_Expenses_Handling | Resource_Mileage_Expense_Comments | | LongText |
| Supplier_Resouce_Expenses_Handling | Reimbersable_Miscellaneous_Expense_Comments | | LongText |
| Capital_Risk_Model | Capital_Risk_Model_Comments | | LongText |
| Capital_Risk_Model | Capital_Risk_Model_Amount | Y | Currency |
| Supplier_Rebate_Model_for_Non- | Rebate_Model_for_non- | Y | LongText |
| deployed_Investment | deployed_investment | | |
| Supplier_Payment_Release_Schedule | Supplier_Payment_Release_Schedule | | LongText |

A separate grade is stored for each of the graded bid items, as shown in Table 55 below, which can be stored in the database table structure 1100 in table tblRFXGradeItems 825, as shown in FIG. 35. Along with the assigned grade 855 for a particular graded bid item 236, table tblRFXGradeItems 825 may also include the identity of the buyer user grader, the weighting percentage 850 assigned to the graded bid item 236 and the vendor bid response identifier associated with the grade 855. However, it should be understood that other information can be included, and the system is not limited to the specific information shown in Table 55. Each vendor grade 855 for each vendor is stored in a separate record in the table tblRFXGradeItems 825, with each record containing the fields shown below in Table 55. In addition, table tblRFXGradeItems 825 is tied to the table tblRFXRespMain 806, which is tied to table tblRFX 801, both of which are described above in connection with FIG. 29, in order to associate the vendor grade 855 to the vendor bid response and bid request. In addition, the table tblRFXGradeItems 825 is tied to the table tblRFXSelectedBidItems 802 to associate the vendor grade 855 to the particular bid item selection 235.

TABLE 55
Graded Bid Items Table (tblRFXGradeItems)

| Column Name | Data Type | Length |
|---|---|---|
| User_ID | Int | 4 |
| RFX_Item | Varchar | 50 |
| Weight_Percent | percent | 4 |
| Grade_Record_ID | int | 4 |
| Record_Date | datetime | 8 |
| Grade | char | 1 |
| Response_ID | int | 4 |

The calculated scores 865 for each of the vendor grades 855 for each bid item 235 can be stored as shown below in Table 56, which can be stored in the database in table RFXItemScoreVendor 826, as shown in FIG. 35. A separate record for each graded bid item for each vendor bid response is stored in table tblRFXItemScoreVendor 826, with each record containing the fields shown in Table 56. In addition, the total score 860 based on all of the vendor scores 865 stored in the table tblRFXItemScoreVendor 826 can also be stored as shown in Table 57 below, which can be stored in the database in table tblRFXScoreVendor 827, as shown in FIG. 35. A separate record for each vendor bid response is stored in table tblRFXScoreVendor 827, with each record containing the fields shown in Table 57.

The table tblRFXItemScoreVendor 826 is tied to the table tblRFXGradeItems 825 to associate each score 865 with the pertinent grade 855 for all of the graded bid items 236 for a particular vendor bid response. In addition, the table tblRFXScoreVendor 827 is tied to the table tblRFXItemScoreVendor 826 to associate all of the scores 865 for all of the graded bid items 236 for a particular vendor bid response with the total score 860 for that particular vendor bid response. Furthermore, table tblRFXScoreVendor 827 is tied to table tblRFXPost 803, which is described above in connection with FIG. 29, to update the table tblRFXPost with the vendor score 860.

TABLE 56
Vendor Item Scoring Table (tblRFXItemScoreVendor)

| Column Name | Data Type | Length |
|---|---|---|
| Response_ID | Int | 4 |
| RFX_Item | Int | 4 |
| Score | Numeric | 4 |
| Buyer_User_ID | Int | 4 |
| Score_Record_ID | Int | 4 |
| Identity_Key | Int | 4 |

TABLE 57
Vendor Scoring Table (tblRFXScoreVendor)

| Column Name | Data Type | Length |
|---|---|---|
| Response_ID | int | 4 |
| Total_Score | numeric | 9 |
| Buyer_User_ID | int | 4 |
| Score_Record_ID | int | 4 |
| Identity_Key | int | 4 |

After a vendor bid response is received and graded, the buyer user may provide the opportunity for a vendor to submit a re-quote on one or more graded bid items to improve the vendor's score. For example, a vendor that the buyer user typically chooses or that has high grades on other graded bid items may have a lower score than another vendor, and the buyer user may want to provide the vendor the opportunity to revise the vendor bid response data for the one or more graded bid items that have low grades.

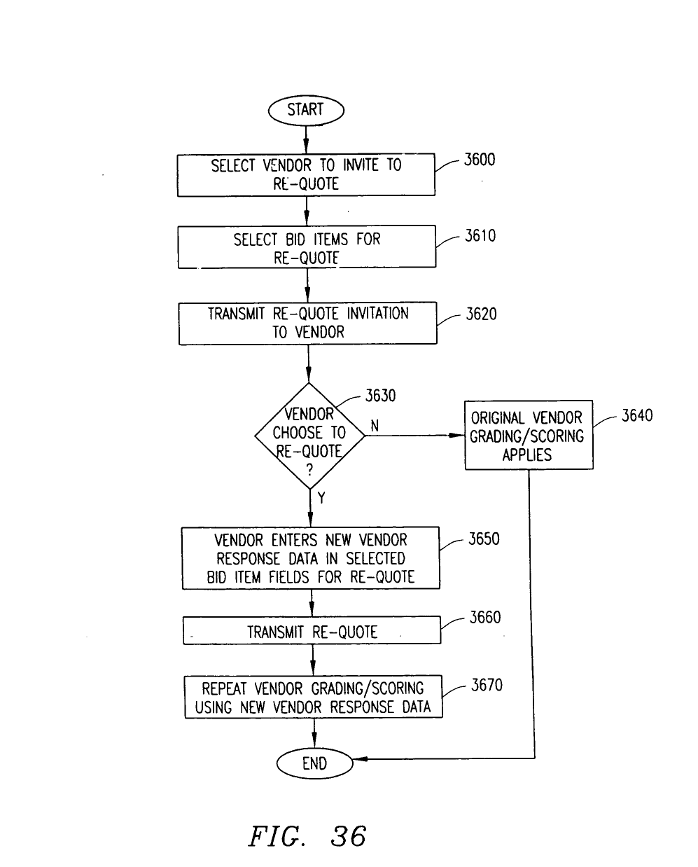

Exemplary steps for facilitating the re-quote process are shown in FIG. 36. When the grader becomes aware of one or more low grades for a particular vendor on one or more graded bid items, the grader can invite the vendor to re-quote on one or more selected graded bid items (steps 3600 and 3610). The invitation to re-quote (step 3620) may identify only the particular graded bid items that the vendor is allowed to re-quote on to prevent the vendor from re-quoting on any other graded bid items that the grader does not want to re-grade. For example, the re-quote can include a copy of the original vendor bid response and enable only those re-quoted bid items to be selected by the vendor user to input new vendor response data. The old vendor response data can be deleted or stored along with the new response data in the database for reference purposes. In addition, the re-quote invitation can indicate the vendor grade for each re-quoted bid item, along with the vendor ranking for each re-quoted bid item, and other similar information, such as the high and low vendor grades for the re-quoted bid item.

If the vendor chooses to not re-quote within a buyer-constrained time frame (step 3630), the original vendor grading and scoring applies to the vendor bid response (step 3640). However, if the vendor does re-quote on one or more of the re-quoted bid items (step 3630), the vendor user can enter new vendor response data into bid item fields for the selected re-quoted bid items (step 3650). Upon receipt of the re-quote (step 3660), the grader grades the re-quoted bid items using the new vendor response data and modifies the vendor score accordingly (step 3670).

Exemplary steps for awarding the bid and entering project tracking parameters are shown in FIG. 37. Once all of the vendor bid response grading and scoring is completed (step 3700), the bid can be awarded to one of the vendors. If the buyer user has the authority to select the vendor based on vendor score and other factors (e.g., personal preferences, knowledge of vendor reputation, knowledge of vendor availability, etc.) (step 3705), the buyer user can select the vendor for the project (step 3710). Otherwise, the vendor with the highest score is awarded the bid (step 3715).

Once the vendor for the project has been selected, the system notifies both the project administrator (step 3720) and the awarded vendor of the bid award (step 3725). Thereafter, the awarded vendor and buyer enter into negotiations to finalize the terms and conditions of the project, as conventionally done (step 3730). If the awarded vendor and buyer cannot agree on the terms and conditions of the project (step 3735), the buyer can re-open the bid process to select a new vendor based on existing vendor scores, based on new vendor bid responses or both (step 3740). However, if the terms and conditions are agreed to (step 3735), the buyer and awarded vendor can load various project tracking parameters into the system (step 3745), such as the project start date, project end date, anticipated project expenditure (requisition amount), assigned resources, project phasing schedule, project payment release schedule, project deliverables, project materials and project expenses to create a purchase requisition for the project. It should be understood that additional project tracking parameters can be loaded into the system to track the performance of the project, and the system is not limited to the project tracking parameters described herein. Once the purchase requisition for the project is approved by the appropriate approval users for the project administrator and the vendor (step 3750), the project can begin.

Screen shots of exemplary web pages 61 for the project administrator and vendor to load project tracking parameters 870 into the system are shown in FIGS. 39A and 39B. For the project administrator, as shown in FIG. 39A, various requisition information can be entered into the system, such as the purchase requisition create date, purchase requisition status (which can be updated automatically by the system), the purchase requisition amount, purchase requisition currency (e.g., U.S. dollars), project start date and project end date. In addition, the project administrator can also enter into the system various project terms and conditions, such as the statement of work, project goods and services deliverables, project contract, project materials, assigned project resources and billable rates, project expenses, project phasing schedule and project payment release schedule. Furthermore, the project administrator can assign administrative users to various administrative user roles that have not already been assigned for the project. Moreover, other financial project tracking parameters applicable to the project can also be entered into the system, such as account assignments, ledger codes, cost center codes, project codes, tax codes and accounting plants.

As shown in FIG. 39B, the vendor can access the buyer-entered data to modify previously entered project tracking parameters 870 in the system and/or enter new project tracking parameters 870 into the system as the project administrator. For example, the vendor can enter one or more of the project terms and conditions discussed above. The parties can agree on who is going to enter the project tracking parameters 870, or both parties can enter and/or modify the project tracking parameters 870, and the system can provide notification to both parties if any changes are made. It should be understood that other project tracking parameters can be inserted into the system, and the system is not limited to those project tacking parameters shown in FIGS. 39A and 39B.

For example, as shown in FIGS. 40A and 40B, taxation information 875 can also be entered into the system as part of the project tracking parameters 870. The taxation information 875 can be used by the buyer and vendor to ensure that all taxation authorities and applicable taxation amounts are accounted for in the project for financial administration and tax liability purposes. As shown in FIGS. 40A and 40B, when a requisition item line number is created for an activity, e.g., a material used by the vendor during the course of the project, the buyer and vendor can designate within the system all pertinent transactional information that would be necessary to properly assess taxation.

For example, as shown in FIG. 40A, as part of the material requisition entry, the buyer and vendor can originate or update the taxation information 875 by entering location information related to the buyer location, origination location, shipping address, physical delivery address, vendor location, etc., all of which may indicate an applicable taxation authority. In addition, if the buyer is tax exempt, the buyer can designate a tax exempt reason. Both the buyer and the vendor can further originate or update the taxation information 875 by entering the applicable taxation authorities and the taxation percentage rates. As shown in FIG. 40B, when a purchase order for a particular activity is submitted for payment, the system can access the taxation percentage rates previously entered by the buyer and vendor for the particular activity and calculate the taxation amount for the purchase order. The taxation information 875, including the taxation authorities, percentage rates, amounts, and other taxation-related transactional information, are stored in the database and made available to authorized users.

An exemplary process for entering and processing taxation information is shown in FIG. 40C. When a purchase requisition is created by the buyer/administrator that specifies all elements of an activity of the project (project tracking parameters), including human labor, expenses, materials, deliverables, unit work and other miscellaneous expenses, the location of where the goods/services will be delivered or performed (step 4000) and taxation information, the system can make the purchase requisition, including the taxation information, available to the applicable vendor to review (step 4005). At that time, the vendor can also enter any pertinent taxation information into the system and approve the purchase requisition (steps 4010 and 4015). The complete purchase requisition, including both vendor-approved buyer taxation information and vendor taxation information is provided to the buyer for final approval (steps 4020 and 4025).

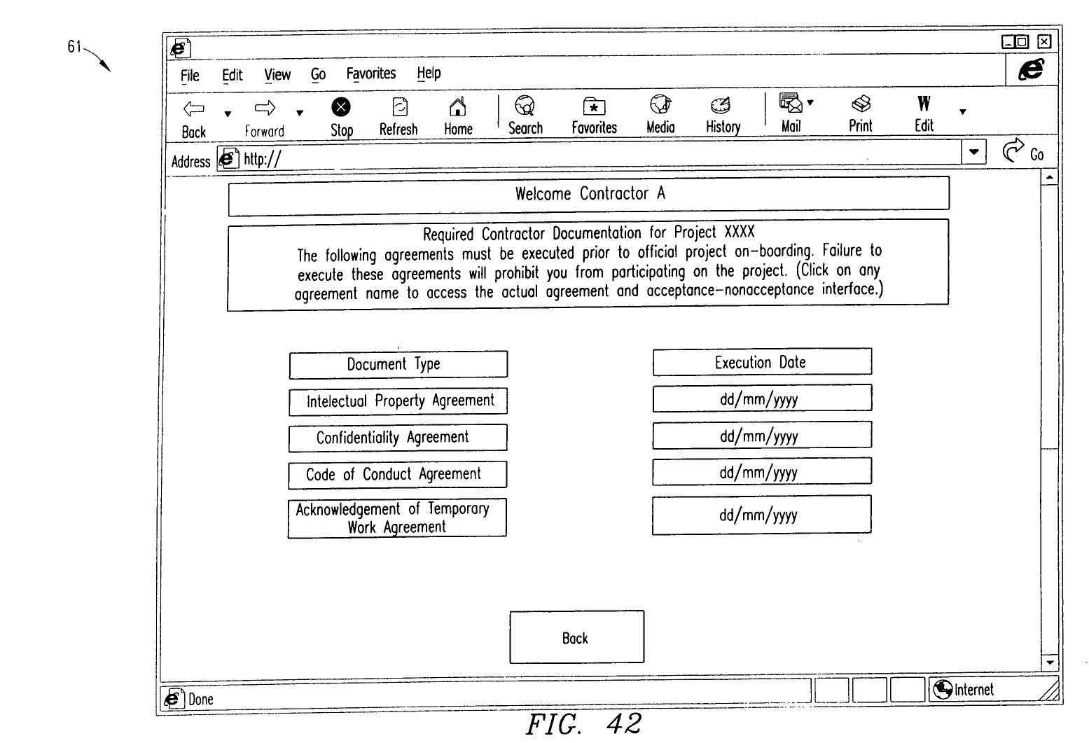

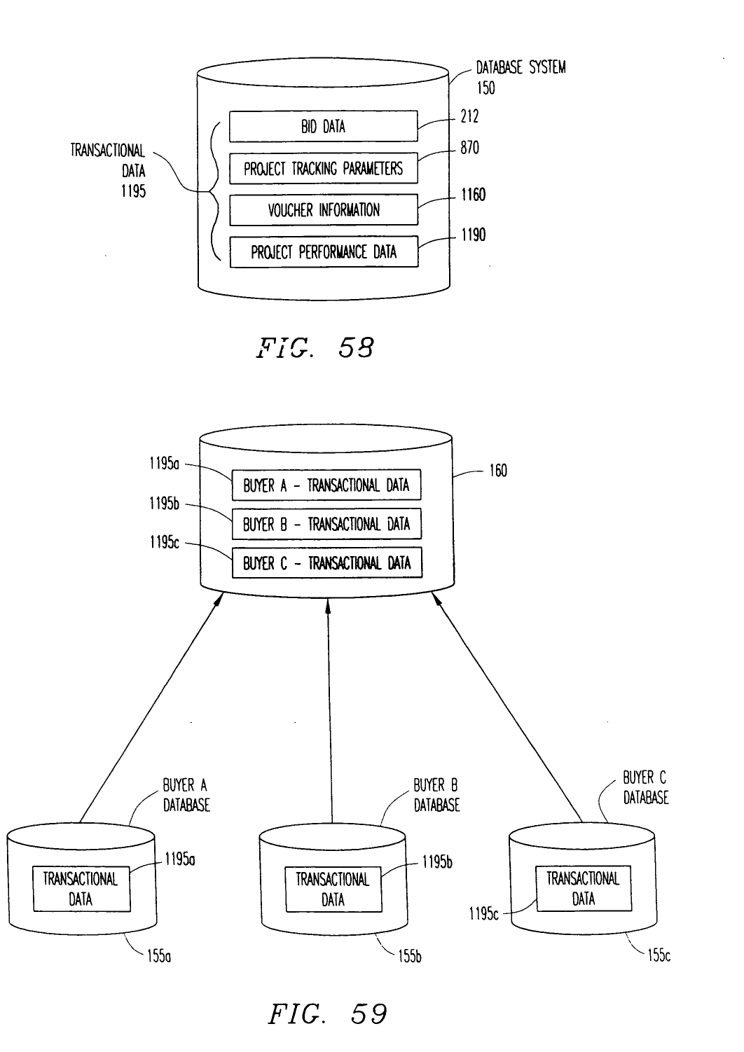

Upon approval by the buyer, the vendor purchase order is created and issued to the vendor (step 4030) to begin working on the project (step 4035). During the commencement of the project, one or more purchase order designated goods or services are performed by the vendor (step 4040). If the good/service is related to billable time expenses of a contractor, the contractor completes his or her time card (step 4045), as will be described in more detail hereinbelow in connection with FIGS. 42-47. For all other goods/services, the vendor enters other voucher information (step 4050), as will be described in more detail hereinbelow in connection with FIGS. 48-50. Thereafter, the voucher is routed to the designated buyer user for review (step 4055). Upon approval of the voucher by the buyer, the system administrator can create a billing file that imports any applicable taxation amount calculated using the previously entered taxation percentage rates, where applicable, and submits an invoice to buyer for payment thereof (step 4060). Thereafter, the buyer pays the administrator (step 4065) and the administrator pays the vendor (step 4070). The administrator maintains financial transactional data in the billing file related to the payment of the voucher and grants access to the financial transaction data to authorizes buyer or vendor personnel (step 4075), and can optionally upload the financial transaction data to the top-level database for subsequent processing (step 4080), as will be described in more detail hereinbelow in connection with FIG. 59.

As another example of project tracking parameters that can be entered into the system, during the final negotiation, the buyer may request the vendor to submit resumes of resource candidates (actual contractors) for the buyer to approve to ensure that the resource profile positions included in the vendor bid response are filled by actual candidates having the resource profiles. Exemplary data structures for the submission of resource candidates and the review of resource candidates are shown in Tables 58 and 59 below.

Table 58 below illustrates sample resource candidate information that can be submitted for each resource candidate selected by the vendor for a resource profile position in the project. For example, the resource candidate information can include the bid tracking number of the particular bid (bid request and bid response) associated with the resource candidate, the identity of the resource profile for the resource candidate, personal resource candidate information, vendor information, the resume of the resource candidate and the status of the resource candidate submittal. Table 59 illustrates various resource submittal status information that can be included in Table 58. However, it should be understood that other information can be included, and the system is not limited to the specific information shown in Table 58.

TABLE 58
Exemplary Resource Submittal Table (db structure view)

| Column Name | Data Type | Length |
|---|---|---|
| Submittal_ID | int | 4 |
| Bid_Tracking_ID | int | 4 |
| RFX_Resource_Profile_ID | int | 4 |
| Profile_ID | int | 4 |
| Candidate_ID | int | 4 |
| First_Name | varchar | 50 |
| Last_Name | varchar | 50 |
| Middle_Name | varchar | 50 |
| Name_Suffix | varchar | 10 |
| Citizenship_Country1 | int | 4 |
| Citizenship_Country2 | int | 4 |
| Authorized_in_Work_Country | char | 1 |
| Authorization_Description | varchar | 500 |
| Resume_Attachment | char | 1 |
| Vendor_ID | int | 4 |
| Vendor_Contact_Name | varchar | 100 |
| Vendor_Contact_Phone | varchar | 50 |
| Vendor_Contact_Email | varchar | 100 |
| Record_Date | datetime | 8 |
| Submittal_Status_ID | int | 4 |

TABLE 59
Exemplary Resource Submittal Status Table (data view)

| Submittal_Status_ID | Submittal_Status | Display_Value |
|---|---|---|
| 1 | New | Being_Reviewed_by_Admin |
| 2 | On_Hold_by_Admin | Admin_Temporary_Hold |
| 3 | Declined_by_Admin | Candidate_Declined_by_Admin |
| 4 | Submitted_to_Buyer | Forwarded_for_Buyer_Review |
| 5 | Declined_by_Buyer | Candidate_Declined_by_Buyer |
| 6 | Interview_Requested | Interview_Requested |
| 7 | Interview_Scheduled | Interview_Scheduled |
| 8 | Interview_Conducted | Interview_Conducted |
| 9 | Offer_Tendered | Buyer_Offer_Tendered |
| 10 | Offer_Accepted | Vendor_Offer_Accepted |
| 11 | Candidate_Engaged | Candidate_Assigned_To_Order |
| 12 | On_Hold_by_Buyer | Buyer_Temporary_Hold |
| 13 | Withdrawn | No_Longer_Available |

Exemplary steps for approving resource candidates are shown in FIG. 38. For each resource profile included in the vendor bid response, the vendor submits a resume of a potential resource candidate for the resource profile position (step 3800). The buyer reviews all of the resumes and assigns qualified resource candidates to the resource profile positions (step 3810).

If one or more of the resource candidates is not acceptable (e.g., the resume does not indicate that the resource candidate has the requisite skills for the resource profile) (step 3820), and there are no other acceptable candidates for the resource profile position (step 3830), the buyer can re-open the bid process to secure another vendor for the project that can provide the necessary resources (step 3840). However, if all resource profile positions can be filled by qualified resource candidates, the buyer and/or vendor enters resource information associated with each of the assigned resource candidates (contractors) into the contractor database (step 3850). For example, personal information concerning the contractor, such as the contractor name, address, telephone numbers and employee number, can be entered into the contractor database. In addition, specific project-related contractor information, such as the total number of authorized billable hours, billable rate, the total amount and type of expenses authorized and any agreements or documents that the contractor needs to execute or provide prior to beginning work, can be entered into the contractor database.

Once the contractor information is entered, the system can authenticate the contractor for time keeping and system access purposes (step 3860). For example, the system can provide a user name and password to the contractor for system log-in and authentication purposes. In addition, the system can require the contractor to execute one or more agreements (e.g., by acknowledging the terms of the agreements on-line) and/or provide one or more documents before being allowed access to the time keeping system.

A screen shot of an exemplary web page 61 displayed to a contractor upon initial log-in and authentication is shown in FIG. 42. The web page lists several documents that must be executed before the contractor can begin working on the project. For example, the contractor may need to sign an Intellectual Property agreement, a Confidentiality agreement, a Code-of-Conduct agreement and an Acknowledgement of Temporary Work agreement. By clicking on each of the listed documents, a web page showing the agreement can be displayed to the contractor and the contractor can click on an acceptance button to execute the agreement.

Exemplary database structures for storing contractor information and ensuring that relevant documents are obtained from the contractor or agreed to by the contractor are shown in Tables 60-63 below. Table 60 lists various sample documents that either need to be obtained from the contractor or that the contractor needs to execute at some point during the project. Table 60 also lists the time constraints for obtaining or executing such documents. Table 61 lists the contractor information, such as the identity of the contractor, the number of billable hours authorized, the amount of expenses authorized, the execution date of various documents and the contractor type. Table 62 lists the particular document and identifies whether the contractor has executed or provided that document and the date of such execution or provision. It should be understood that a separate record for each document is stored having the format of Table 62. Table 63 illustrates various exemplary information identifying the type of contractors, such as the number of days the contractor has and has not worked for the buyer. However, it should be understood that other information can be included, and the system is not limited to the specific information shown in Tables 60-63.

TABLE 60
Exemplary Contractor Documents Table

| Non-Employee_Document_ID | Document_Description | Due_Diligence_Method | Time_Constraint |
|---|---|---|---|
| 1 | Confidentiality | Electronic | Project_Duration |
| | Agreement | Challenge/Acknowledgment | |
| 2 | Intellectual Property | Electronic | Project_Duration |
| | Rights Agreement | Challenge/Acknowledgment | |
| 3 | Code of Conduct | Electronic | Project_Duration |
| | Agreement | Challenge/Acknowledgment | |
| 4 | Temporary Work | Electronic | Project_Duration |
| | Assignment Agreement | Challenge/Acknowledgment | |
| 5 | Commercial Drivers | Physical | License_Defined |
| | License (CDL) | Copy/Purchasing | |
| | | Database Approval | |
| 6 | Drug Test | Physical | 6 months |
| | Documentation | Copy/Purchasing | |
| | | Database Approval | |
| 7 | USA Military Clearance | Physical | Clearance |
| | | Copy/Purchasing | Defined |
| | | Database Approval | |
| 8 | Bonded | Physical | Notary Defined |
| | | Copy/Purchasing | |
| | | Database Approval | |
| 9 | USA Technology Export | Physical | Project_Duration |
| | Compliant Citizen | Copy/Purchasing | |
| | | Database Approval | |
| 10 | Independent Contractor | Physical | Project_Duration |
| | Qualified | Copy/Purchasing | |
| | | Database Approval | |
| 11 | W-2 Verification | Physical | 6 months |
| | | Copy/Purchasing | |
| | | Database Approval | |
| 12 | Certified Union Member | Physical | Certification |
| | | Copy/Purchasing | Defined |
| | | Database Approval | |
| 13 | Right to Work Country | Physical | Project_Duration |
| | | Copy/Purchasing | |
| | | Database Approval | |

TABLE 61
Exemplary Contractor Table

| Column Name | Data Type | Length |
|---|---|---|
| Requistion_ID | int | 4 |
| Buyer_PO_# | varchar | 20 |
| Current_Status_ID | int | 4 |
| Contractor_ID | int | 4 |
| Time_Keeping_Only | char | 1 |
| Billable_Hours_Authorized | int | 4 |
| Expenses_Authorized | money | 8 |
| Vendor_ID | int | 4 |
| User_ID | int | 4 |
| Record_ID | int | 4 |
| IP_Agreement_Date | datetime | 8 |
| ATW_Agreement | datetime | 8 |
| Confidentiality_Agreement | datetime | 8 |
| Drug_Screen | datetime | 8 |
| Code_Of_Conduct | datetime | 8 |
| Contractor_Type | int | 4 |
| Profile_ID | int | 4 |

TABLE 62
Exemplary Contractor Execution Dates Table

| Column Name | Data Type | Length |
|---|---|---|
| Contractor_ID | int | 4 |
| Non-Employee_Liability_Issue_ID | int | 4 |
| Agreement_Executed | char | 1 |
| Agreement_Execution_Date | datetime | |
| Assessment_Complete_Date | datetime | 1 |
| Assessment_Disposition | char | 1 |
| Assessment_User_ID | int | 4 |
| Tickler_Date | datetime | |

TABLE 63
Exemplary ContractorTypes Table (db structure view)

| Column Name | Data Type | Length |
|---|---|---|
| Contractor_Type_ID | Int | 4 |
| Contractor_Type | Varchar | 50 |
| Notes | Varchar | 500 |
| Tenure_Days | Numeric | 9 |
| Separation_Days | Numeric | 9 |

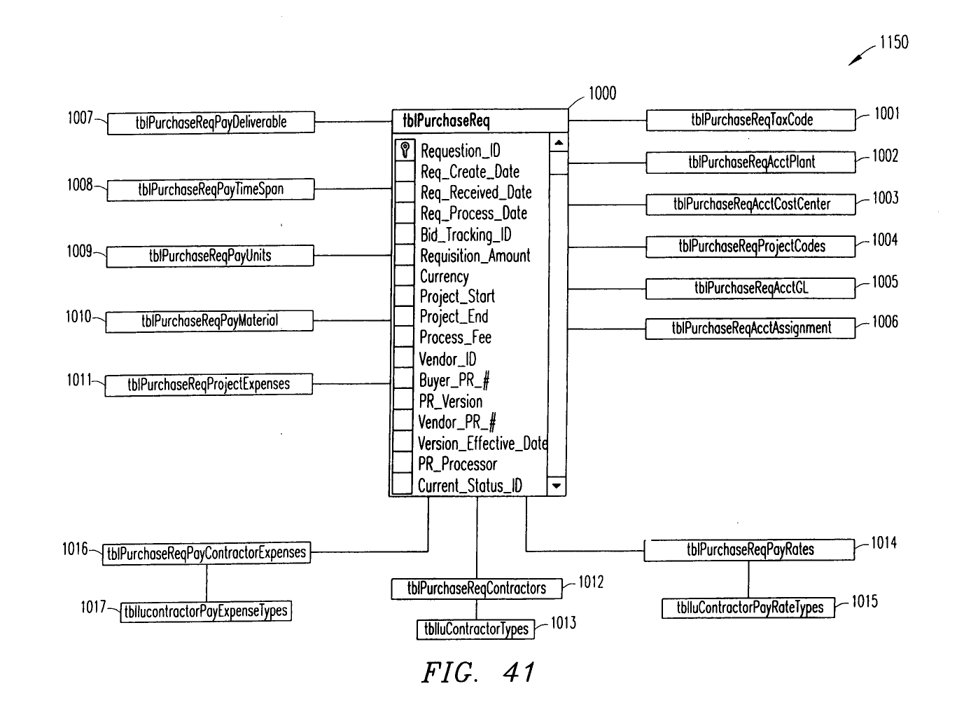

Examples of the data structures used for storing the project tracking parameters are shown in Tables 64-79 hereinbelow. The data structures are illustrated for simplicity as being organized in a table format, with each table including all of the fields necessary for tracking the performance of the project. The tables are related in a hierarchical and relational manner, as will be discussed in connection with FIG. 41.

Table 64 below illustrates sample general purchase requisition information, which can be stored in the database in table tblPurchaseReq 1000, as shown in FIG. 41. For example, such general purchase information can include the identity assigned to the purchase requisition by the system, the buyer and the vendor, the requisition create date, the requisition amount, the bid tracking number for the bid (bid request and bid response) associated with the purchase requisition, the project start and end dates, along with any other pertinent purchase requisition information. However, it should be understood that other information can be included, and the system is not limited to the specific information shown in Table 64. Referring now to the database table structure 1150 in FIG. 41, table tblPurchaseReq 1000 is shown tied to table tblPurchaseReqContractors 1012 and table tblluContractorTypes 1013, which include information in the data structure format corresponding to Tables 61 and 63 above, respectively, to associate the assigned contractors to the purchase requisition.

TABLE 64
tblPurchaseReq

| Column Name | Data Type | Length |
|---|---|---|
| Requisition_ID | int | 4 |
| Req_Created_Date | datetime | 8 |
| Req_Received_Date | datetime | 8 |
| Req_Process_Date | datetime | 8 |
| Bid_Tracking_ID | int | 4 |
| Requistion_Amount | money | 8 |
| Currency | int | 4 |
| Project_Start | datetime | 8 |
| Project_End | datetime | 8 |
| Process_Fee | numeric | 9 |
| Vendor_ID | int | 4 |
| Buyer_PR_# | varchar | 20 |
| PR_Version | numeric | 9 |
| Vendor_PR_# | varchar | 20 |
| Version_Effective_Date | datetime | 8 |
| Req_Processor | int | 4 |
| Current_Status_ID | int | 4 |

Tables 65-70 below illustrate sample specific purchase requisition information associated with tax codes, account plants, cost centers, project codes, account assignment and other similar buyer specific purchase requisition information, all of which can be stored in the database in respective tables tblPurchaseReqTaxCode 1001, tblPurchaseReqAcctPlant 1002, tblPuchaseReqAcctCostCenter 1003, tblPurchaseReqProjectCodes 1004, tblPurchaseReqAcctGL 1005 and tblPurchaseReqAcctAssignment 1006, as shown in FIG. 41. However, it should be understood that additional tables and information related to the purchase requisition can be included, depending on the purchase requisition requirements. Tables tblPurchaseReqTaxCode 1001, tblPurchaseReqAcctPlant 1002, tblPuchaseReqAcctCostCenter 1003, tblPurchaseReqProjectCodes 1004, tblPurchaseReqAcctGL 1005 and tblPurchaseReqAcctAssignrment 1006 are tied to the table tblPurchaseReq 1000 to associate the specific purchase requisition information with the general purchase requisition information.

TABLE 65
tblPurchaseReqTaxCodes

| Column Name | Data Type | Length |
|---|---|---|
| Requistion_ID | int | 4 |
| Buyer_PR_# | varchar | 20 |
| Tax_Code | varchar | 10 |
| Current_Status_ID | int | 4 |
| Record_ID | int | 4 |

TABLE 66
tblPurchaseReqAcctPlant

| Column Name | Data Type | Length |
|---|---|---|
| Requisition_ID | int | 4 |
| Buyer_PR_# | varchar | 20 |
| Accounting_Plant | varchar | 10 |
| Record_ID | int | 4 |
| Current_Status_ID | int | 4 |

TABLE 67
tblPurchaseReqAcctCostCenter

| Column Name | Data Type | Length |
|---|---|---|
| Requistion_ID | int | 4 |
| [Billable_Dept/Cost_Center] | nvarchar | 10 |
| Buyer_PR_# | varchar | 20 |
| Record_ID | int | 4 |
| Current_Status_ID | int | 4 |

TABLE 68
tblPurchaseReqProjectCodes

| Column Name | Data Type | Length |
|---|---|---|
| Purchase_Req_ID | int | 4 |
| Buyer_PR_# | varchar | 20 |
| Project_Code | varchar | 20 |
| [Billable_Dept/Cost_Center] | nvarchar | 20 |
| Record_ID | int | 4 |
| Current_Status_ID | int | 4 |

TABLE 69
tblPurchaseReqAcctGL

| Column Name | Data Type | Length |
|---|---|---|
| Requisition_ID | int | 4 |
| Buyer_PR_# | varchar | 20 |
| G_L_Account | varchar | 20 |
| Record_ID | int | 4 |
| Current_Status_ID | int | 4 |

TABLE 70
tblPurchaseReqAcctAssignment

| Column Name | Data Type | Length |
|---|---|---|
| Requistion_ID | int | 4 |
| Buyer_PR_# | varchar | 20 |
| Account_Assignment | varchar | 10 |
| Current_Status_ID | int | 4 |
| Record_ID | int | 4 |

Tables 71-75 below illustrate sample requisition payment information related to the purchase requisition. For example, such requisition payment information can include payment amounts based on project deliverables (e.g., goods and services delivered at the end of the project or during phases of the project), payment amounts based on time frames, payment amounts based on the number of units completed, payment amounts based on project materials and payment amounts based on project expenses. In FIG. 41, the requisition payment information is shown as stored in the database in tables tblPurchaseReqPayDeliverable 1007, tblPurchaseReqPayTimeSpan 1008, tblPurchaseReqPayUnits 1009, tblPurchaseReqPayMaterials 1010 and tblPurchaseReqPayProjectExpenses 1011. Each of the tables tblPurchaseReqPayDeliverable 1007, tblPurchaseReqPayTimeSpan 1008, tblPurchaseReqPayUnits 1009, tblPurchaseReqPayMaterials 1010 and tblPurchaseReqPayProjectExpenses 1011 are shown tied to table tblPurchaseReq to associate the payment information with the general purchase requisition information.

It should be understood that additional tables or information may be included, depending on the purchase requisition requirements. In addition, it should be understood that one or more of the payment tables can be included, depending on the project. Furthermore, it should be understood that a separate record for each payment amount is included having the format of one of Tables 71-75 below.

TABLE 71
Exemplary tblPurchaseReqPayDeliverable (db structure view)

| Column Name | Data Type | Length |
|---|---|---|
| Requisition_ID | int | 4 |
| Buyer_PR_# | varchar | 20 |
| Deliverable_Description | varchar | 1000 |
| Anticipated_Completion_Date | datetime | 8 |
| Payment_Amount | money | 8 |
| Partial_Payment_Authorized | char | 1 |
| Current_Status_ID | int | 4 |
| Vendor_ID | int | 4 |
| User_ID | int | 4 |
| Record_ID | int | 4 |
| Record_Date | datetime | 8 |

TABLE 72
Exemplary tblPurchaseReqPayTimeSpan (db structure view)

| Column Name | Data Type | Length |
|---|---|---|
| Requisition_ID | int | 4 |
| Buyer_PR_# | varchar | 20 |
| Current_Status_ID | int | 4 |
| Work_Start_Date | datetime | 8 |
| Payment_Release_Date | Datetime | 8 |
| Payment_Amount | Money | 8 |
| Vendor_ID | Int | 4 |
| User_ID | Int | 4 |
| Record_ID | Int | 4 |

TABLE 73
Exemplary tblPurchaseReqPayUnits (db structure view)

| Column Name | Data Type | Length |
|---|---|---|
| Requisition_ID | int | 4 |
| Buyer_PR_# | varchar | 20 |
| Current_Status_ID | int | 4 |
| Unit_Completion_Description | varchar | 1000 |
| Unit_Count | numeric | 9 |
| Unit_Cost | money | 8 |
| Partial_Payment_Authorized | char | 1 |
| Vendor_ID | int | 4 |
| User_ID | int | 4 |
| Record_ID | int | 4 |

TABLE 74
Exemplary tblPurchaseReqPayMaterials (db structure view)

| Column Name | Data Type | Length |
|---|---|---|
| Requisition_ID | Int | 4 |
| Buyer_PR_# | Varchar | 20 |
| Vendor_ID | int | 4 |
| Material_Name | varchar | 100 |
| Material_Description | varchar | 500 |
| Material_Manufacturer | varchar | 100 |
| Unit_Cost | money | 8 |
| Unit_Count | numeric | 9 |
| Line_Item_Cost | money | 8 |
| Currency_ID | int | 4 |
| Current_Status_ID | int | 4 |
| User_ID | int | 4 |
| Record_ID | int | 4 |
| Record_Date | datetime | 8 |

TABLE 75
Exemplary tblPurchaseReqPayProjectExpenses (db structure view

| Column Name | Data Type | Length |
|---|---|---|
| Requisition_ID | int | 4 |
| Buyer_PR_# | varchar | 20 |
| Project_Expense_Description | varchar | 500 |
| Maximum_Threshold | money | 8 |
| Currency_ID | int | 4 |
| User_ID | int | 4 |
| Vendor_ID | int | 4 |
| Current_Status_ID | int | 4 |
| Record_ID | int | 4 |
| Record_Date | datetime | 8 |

Tables 77 and 77 below illustrate sample information associated with the pay rates for contractors assigned to the purchase requisition. For example, the contractor pay rate information can indicate the type of pay (e.g., hourly, fixed, overtime, etc.) and the pay rate amount (e.g., billable rate per hour, billable rate per overtime hour, billable amount). The pay rate information can be stored in the database in tables tblPurchaseReqPayRates 1014 and tblluContractorPayRateTypes 1015, which are shown in FIG. 41 tied to table tblPurchaseReq 1000 to associate the pay rate information with the purchase requisition. It should be understood that a separate pay rate record for each pay rate type of each contractor can be stored in table tblPurchaseReqPayRates 1014. It should further be understood that additional tables or information can be included, depending on the purchase requisition requirements.

TABLE 76
tblPurchaseReqPayRates (db structure view)

| Column Name | Data Type | Length |
|---|---|---|
| Requisition_ID | int | 4 |
| Buyer_PR_# | varchar | 20 |
| Current_Status_ID | int | 4 |
| Contractor_ID | int | 4 |
| Pay_Rate_Type | int | 4 |
| Pay_Rate | money | 8 |
| Currency_ID | int | 4 |
| User_ID | int | 4 |
| Vendor_ID | int | 4 |
| Record_ID | int | 4 |

TABLE 77
tblluContractorPayRateTypes (db structure view)

| Column Name | Data Type | Length |
|---|---|---|
| Hour_Type_ID | int | 4 |
| Hour_Type_Description | varchar | 50 |

Tables 78 and 79 below illustrate sample payment information associated with the contractor expenses for contractors assigned to the purchase requisition. For example, the contractor expense information can indicate the type of expense and the maximum amount allocated for the expense. The contractor expense information can be stored in the database in tables tblPurchaseReqPayContractorExpenses 1016 and tblluContractorPayExpenseTypes 1017, which are shown in FIG. 41 tied to table tblPurchaseReq 1000 to associate the contractor expense information with the purchase requisition. It should be understood that a separate contractor expense record for each contractor expense type of each contractor can be stored in table tblPurchaseReqPayContractorExpenses 1016. It should further be understood that additional tables or information can be included, depending on the purchase requisition requirements.

TABLE 78
tblPurchaseReqPayContractorExpenses (db structure view)

| Column Name | Data Type | Length |
|---|---|---|
| Requisition_ID | int | 4 |
| Buyer_PR_# | varchar | 20 |
| Current_Status_ID | int | 4 |
| Contractor_ID | int | 4 |
| Expense_Type_ID | int | 4 |
| Maximum_Threshold | money | 8 |
| Currency_ID | int | 4 |
| User_ID | int | 4 |
| Vendor_ID | int | 4 |
| Record_ID | int | 4 |

TABLE 79
tblluContractorPayExpenseTypes (db structure view)

| Column Name | Data Type | Length |
|---|---|---|
| Contractor_Expense_Type_ID | Int | 4 |
| Contractor_Expense_Type | varchar | 50 |

Post-Bid Activity

Once the project has begun, the project administrator (or buyer) can monitor the progress of the project using a time keeping system, in which contractors enter time into time cards for project work performed. The time cards can be stored to assess project performance for requisition payment information and/or to generate payment vouchers based on time worked, depending on the requisition payment information. For example, if the requisition payment amount was based, at least in part, on an anticipated number of billable hours of a particular contractor at a particular pay rate, and the contractor completed the project under the anticipated number of billable hours, the project administrator and vendor may be able to re-negotiate the requisition payment amount that was initially set for payment based on deliverables, time frames or units.

Referring now to FIG. 43, there are illustrated exemplary steps for implementing a time keeping system within the system of the present invention. After the contractor has completed all necessary documentation and is authorized to enter the time keeping system, the contractor can enter the time keeping system (step 4300) to input time keeping information (step 4310) associated with the number of hours worked by the contractor into a time card (e.g., a time keeping record for the contractor). The time keeping information can be entered at any time the time keeping system is accessible. For example, the time keeping system can be accessible only at specific times (e.g., the end of the week, the beginning of week, etc.) as determined by the project administrator or during times that the time keeping system is not off-line.

Once the contractor has entered the time keeping information into the time card, the time card is provided to the project administrator (step 4325) for review and approval (step 4330). If the time card is not approved (step 4340), the contractor and vendor are notified of the time card rejection (step 4350) and the contractor is instructed to access the time keeping system to modify the time card (step 4300). For example, if the contractor has not completely filled out the time card, the time keeping information (e.g., number of hours) entered into the time card is out of the normal or unreasonable or the project administrator has knowledge that the time keeping information is incorrect, the time card may be rejected. If the time card is approved (step 4340), all applicable records within the system are updated with the time keeping information (step 4360) and any payable vouchers associated with the time keeping information are extracted for invoice processing (step 4370). For example, if requisition payment is based on the number of hours worked within a particular time frame, a payable voucher may need to be generated based on the time keeping information entered by the contractor.

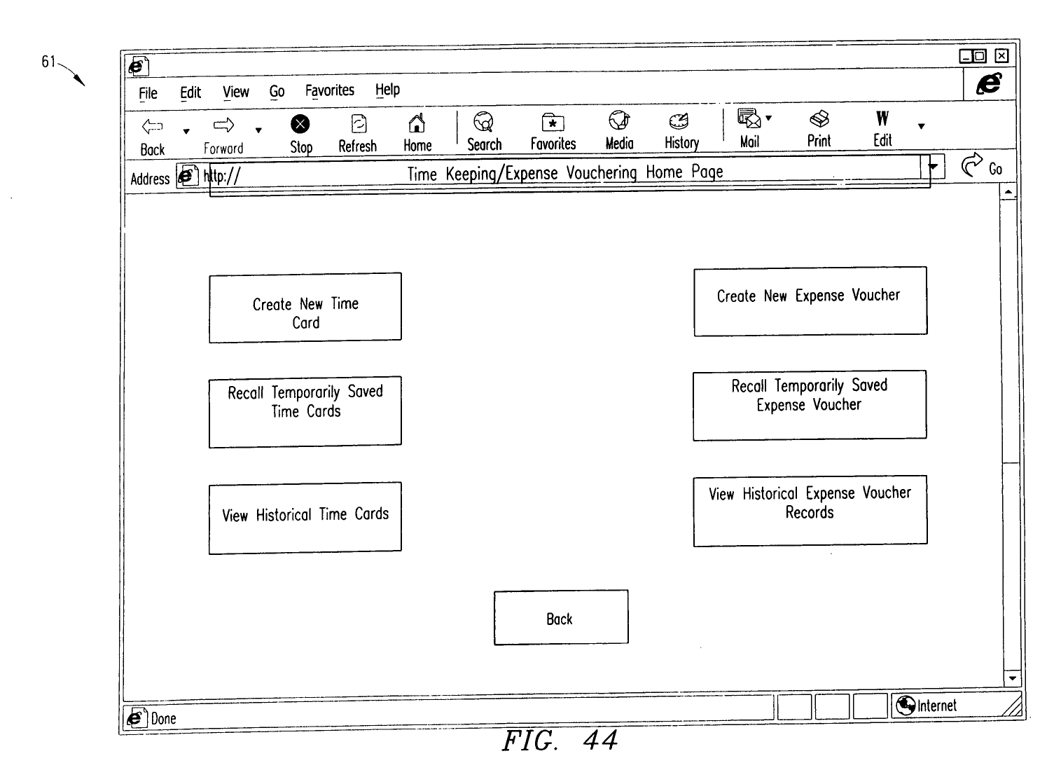

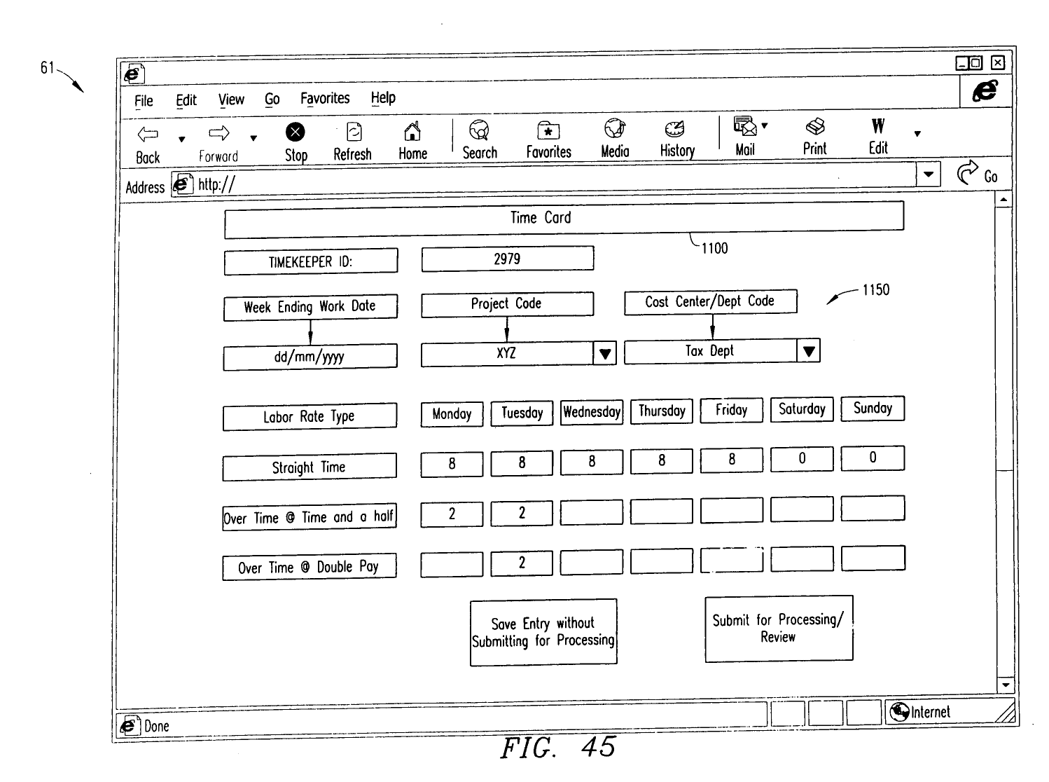

Screen shots of exemplary web pages 61 provided to the contractor through the time keeping system are shown in FIGS. 44 and 45. A sample time keeping system home page is illustrated in FIG. 44. From the home web page, the contractor can create a new time card, recall temporarily saved time cards for completion purposes or view previously submitted time cards. In addition, if the contractor is allowed to enter contractor expenses (depending on the purchase requisition), the contractor can create a new expense voucher, recall a temporarily saved expense voucher for completion or view previously submitted expense vouchers.

To create a new time card (or complete a temporarily saved time card), as shown in FIG. 45, the contractor can enter various time keeping information 1150 into the time card 1100. For example, the contractor can enter the week ending work date, project code for the project and cost center responsible for payment. In addition, the contractor can enter the number of regular hours worked each day and the number of overtime hours worked each day (at each overtime pay rate). It should be understood that other time keeping information can also be entered by the contractor, and the system is not limited to the particular time keeping information shown in FIG. 45.

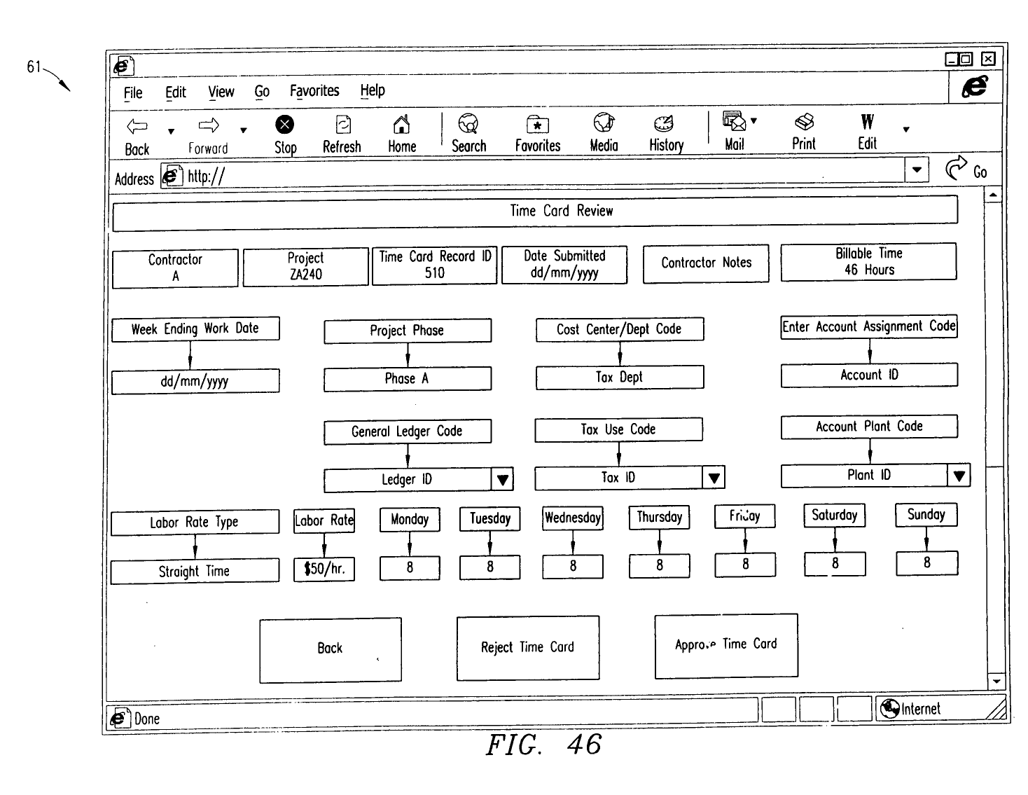

A screen shot of a sample web page 61 displayed to the project administrator for review of the submitted time card is shown in FIG. 46. In addition to the entered time keeping information, the project administrator may also be provided with other pertinent purchase requisition information associated with the time card, such as the current project phase, general ledger code, tax use code, account assignment code and account plant code. Based on the displayed time keeping information, the project administrator can either reject the time card or approve the time card. If the project administrator rejects the time card, a pop-up window can be displayed for the project administrator to provide a reason for time card rejection. It should be understood that other information can be displayed to the project administrator for time card approval purposes, and the system is not limited to the specific information shown in FIG. 46.

Exemplary database structures for storing the time cards and contractor expense vouchers are shown in Tables 80-83 below. The data structures are illustrated for simplicity as being organized in a table format, with each table including all of the fields necessary for storing time cards and contractor expense vouchers. The tables are related in a hierarchical and relational manner with other tables stored in the database, as will be discussed in connection with FIG. 47.

Table 80 below illustrates sample general time keeping information, which can be stored in the database table structure 1160 in table tblTimeCard 1050, as shown in FIG. 47. For example, the time keeping information can include the time card identifier, the associated purchase requisition identifier, the contractor identifier, the vendor identifier, an indication of whether or not the time entered is billable time for generation of a billing record, the week ending date associated with the time card, the creation date, the review date and an indication of whether or not the time card has been approved. However, it should be understood that other information can be included, and the system is not limited to the specific information shown in Table 80. Table tblTimeCard 1050 is shown in FIG. 47 tied to table tblPurchaseReqContractors 1012, which is tied to table tblPurchaseReq 1000, both of which are discussed above in connection with FIG. 41, to associate the time card with the contractor and the purchase requisition. In addition, various other tables shown in FIG. 41 are illustrated in FIG. 47 to show the interrelation between the various purchase requisition tables and the time card and contractor expense voucher tables.

TABLE 80
Exemplary tblTimeCard (db structure view)

| Column Name | Data Type | Length |
|---|---|---|
| Time_Card_ID | int | 4 |
| tcStatus_ID | int | 4 |
| Requisition_ID | int | 4 |
| Contractor_ID | int | 4 |
| Vendor_ID | int | 4 |
| Billable_Time | char | 1 |
| HM_Submitter_ID | int | 4 |
| Vendor_Submitter_ID | int | 4 |
| Reviewer_ID | int | 4 |
| Week_Ending_Date | datetime | 8 |
| Record_Create_Date | datetime | 8 |
| Last_Edit_Date | datetime | 8 |
| Submit_Date | datetime | 8 |
| Review_Date | datetime | 8 |
| Approval_Date | datetime | 8 |
| Date_Rejected | datetime | 8 |
| Contractor_Notes | varchar | 1000 |
| Client_Notes | varchar | 1000 |

The time card status identifier stored in the table tblTimeCard 1050 can be selected from a table tblluTimeCardStatus 1051, which stores time card status types (e.g., temporarily saved, submitted, approved, rejected, etc.) and their associated time card status identifiers.

Table 81 illustrates sample detailed time keeping information, which can be stored in the database in table tblTimeCardDetails 1052, as shown in FIG. 47. For example, such detailed time keeping information can include the number of hours entered as worked on a particular day for a particular pay rate type, the pay rate associated with the pay rate type and other detailed time keeping information. Table tblTimeCardDetails 1052 is shown tied to table tblTimeCard 1050 to associate the detailed time keeping information with the general time keeping information. In addition, table tblTimeCardDetails 1052 is tied to table tblluDayCode 1053 to associate the day code stored in table tblTimeCardDetails 1052 with the particular day. It should be understood that a separate record in the format of Table 81 is stored in table tblTimeCardDetails 1052 for each pay rate type on each day for which the contractor enters time. It should further be understood that other tables and time keeping information can be included, and the system is not limited to the specific tables and time keeping information shown in FIG. 47.

TABLE 81
Exemplary tblTimeCardDetails (db structure view)

| Column Name | Data Type | Length |
|---|---|---|
| Time_Card_ID | int | 4 |
| Record_ID | int | 4 |
| Pay_Rate_Type_ID | int | 4 |
| Day_Code | int | 4 |
| Quantity | float | 8 |
| Account_Assignment | varchar | 10 |
| [Billable_Dept/Cost_Center] | nvarchar | 10 |
| Accounting_Plant | varchar | 10 |
| Project_Code | varchar | 20 |
| Tax_Code | varchar | 10 |
| G_L_Account | varchar | 20 |
| Pay_Rate | money | 8 |

Table 82 below illustrates sample general contractor expense voucher information, which can be stored in the database in table tblContractorExpenseVoucher 1054, as shown in FIG. 47. For example, such general contractor expense voucher information can include the expense voucher identifier, the associated purchase requisition identifier, the contractor identifier, the vendor identifier, the week ending date associated with the expense voucher, the creation date, the review date and an indication of whether or not the expense voucher has been approved. However, it should be understood that other information can be included, and the system is not limited to the specific information shown in Table 82. Table tblContractorExpenseVoucher 1054 is shown tied to table tblPurchaseReqContractors 1012, which is tied to table tblPurchaseReq 1000, both of which are discussed above in connection with FIG. 41, to associate the contractor expense voucher with the particular contractor and the purchase requisition.

TABLE 82
Standard tblContractorExpenseVoucher (db structure view)

| Column Name | Data Type | Length |
|---|---|---|
| Requisition_ID | int | 4 |
| Expense_Voucher_ID | int | 4 |
| tcStatus_ID | int | 4 |
| Contractor_ID | int | 4 |
| Vendor_ID | int | 4 |
| HM_Submitter_ID | int | 4 |
| Vendor_Submitter_ID | int | 4 |
| Approver_ID | int | 4 |
| Week_Ending_Date | datetime | 8 |
| Record_Create_Date | datetime | 8 |
| Last_Edit_Date | datetime | 8 |
| Submit_Date | datetime | 8 |
| Approval_Date | datetime | 8 |
| Date_Rejected | datetime | 8 |
| Contractor_Notes | varchar | 1000 |
| Client_Notes | varchar | 1000 |

Table 83 below illustrates sample detailed contractor expense voucher information, which can be stored in the database in table tblContractorExpenseVoucherDetails 1055, as shown in FIG. 47. For example, such detailed expense voucher information can include the expense amount of a particular expense type on a particular day and other detailed expense voucher information. Table tblContractorExpenseVoucherDetails 1055 is shown tied to table tblContractorExpenseVoucher 1054 to associate the detailed expense voucher information with the general expense voucher information. In addition, table tblContractorExpenseVoucherDetails 1055 is tied to table tblluDayCode 1053 to associated the day code stored in table tblContractorExpenseVoucherDetails 1055 with the particular day. It should be understood that a separate record in the format of Table 83 is stored in table tblContractorExpenseVoucherDetails 1055 for each type of expense on each day for which the contractor enters an amount. It should further be understood that other tables and contractor expense voucher information can be included, and the system is not limited to the specific tables and contractor expense voucher information shown in FIG. 47.

TABLE 83
Standard tblContractorExpenseVoucherDetails (db structure view)

| Column Name | Data Type | Length |
|---|---|---|
| Expense_Voucher_ID | int | 4 |
| Record_ID | int | 4 |
| Expense_Type_ID | int | 4 |
| Day_Code | int | 4 |
| Expense_Amount | money | 8 |
| Account_Assignment | varchar | 10 |
| [Billable_Dept/Cost_Center] | varchar | 10 |
| Accounting_Plant | varchar | 10 |
| Project_Code | varchar | 20 |
| Tax_Code | varchar | 10 |
| G_L_Account | varchar | 20 |

Referring now to FIG. 48, there are a number of different types of voucher information 1160 that can be entered into the system and stored in the database 155 for generation of a payable voucher 1180 to be paid by the buyer or project administrator to the awarded vendor. For example, the voucher information 1160 can include time keeping voucher information 1160a, which includes the time keeping information 1150 (shown in FIG. 45 above) entered by the contractor and requisition payment information as determined by the entered project work tracking parameters 870 (shown in FIGS. 39 and 40 above) pertaining to the time keeping information. The voucher information can also include project expenses voucher information 1160b, project deliverables voucher information 1160c, project materials voucher information 1160d, contractor expensing voucher information 1160e, project unit completion voucher information 1160f and project timed payment release voucher information 1160g. The system can automatically generate payable vouchers 1180 based on voucher information 1160 previously entered in other contexts (e.g., project tracking parameters entry, time keeping entry, contractor expense entry and/or project expense entry), or the vendor or buyer/project administrator can generate payable vouchers 1180 and enter various applicable portions of the voucher information 1160 (e.g., unit completion entry or deliverable completion entry) into the payable vouchers 1180.

Referring now to FIG. 49, exemplary steps involved in a voucher processing and payment system are illustrated. Initially, various project tracking parameters (e.g., purchase requisition information) are entered into the system (step 4400) and all vendor responsibilities for goods and services, both billable and non-billable are stored in the database (step 4410). When the vendor provides an authorized good or service (as determined by the entered vendor responsibilities) (step 4420), the vendor accesses the system to record the good or service performed and request payment for the good or service (step 4430). In other embodiments, payment may be automatically requested by the system at certain time intervals. The system generates a voucher based on the project tracking parameters and other voucher information (e.g., timekeeping information, expenses, materials, etc.) (step 4440) and routes the voucher to the appropriate buyer user or administrator user for approval of the voucher (step 4450).

If the voucher is not approved (step 4460), the vendor is notified and provided the option of re-submitting the voucher (step 4470). If the voucher is approved (step 4460), the vendor is notified of the approval of the voucher (step 4480). If the voucher is a billable voucher (step 4490), the voucher is processed for electronic invoicing based on prescribed scheduling (using system or buyer constraints) (step 4495). For example, the system can employ a batch process to collect all payment vouchers for the buyer (for one or more projects) approved during a pre-designated time period. All invoices can be generated in a format based on buyer specifications or in a system-defined format. The buyer receives the invoice(s) (step 4498) and releases payment of the invoice(s) to the vendor(s) via a pre-configured method (e.g., EFI, check, etc.) (step 4499).

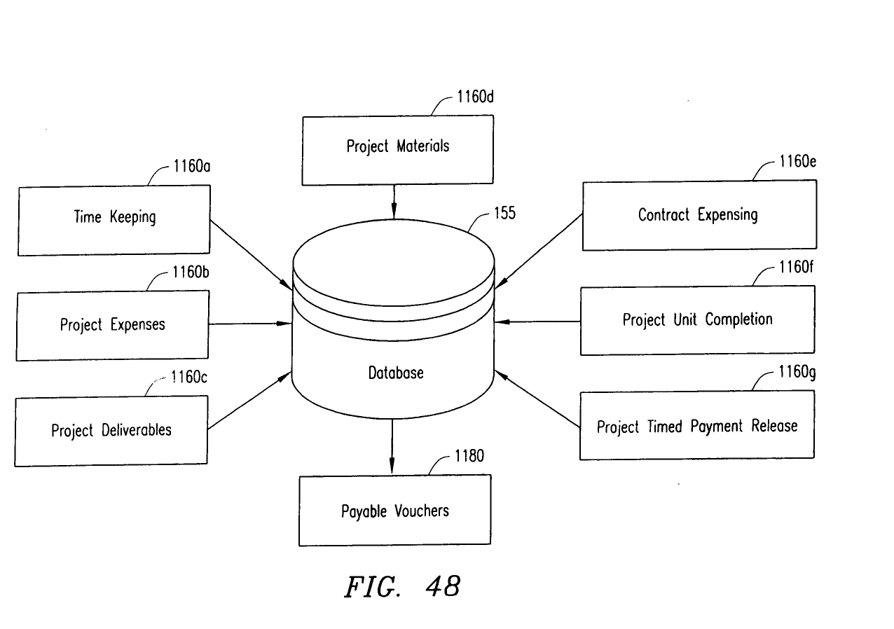

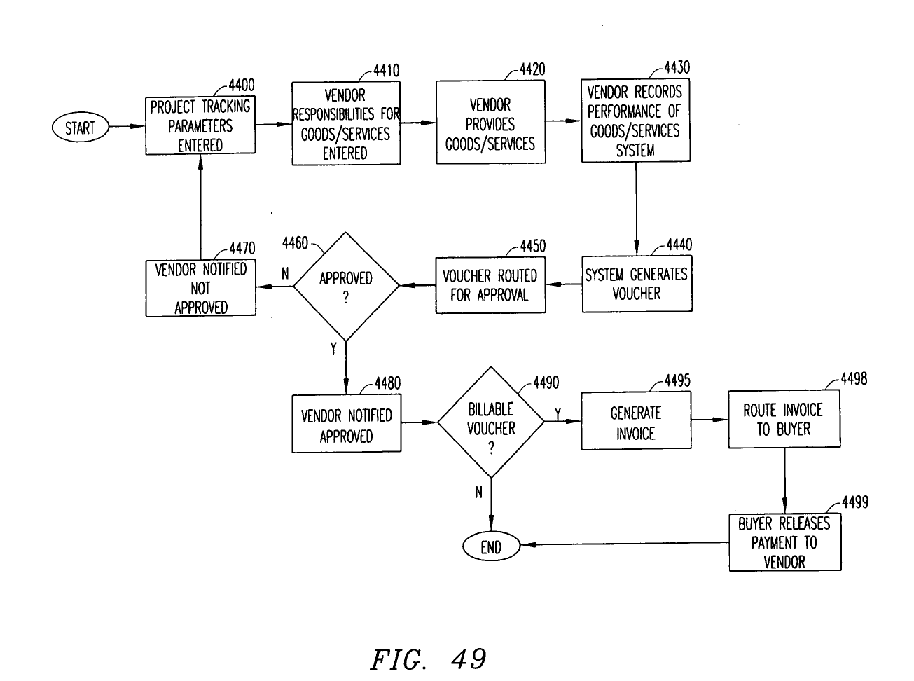

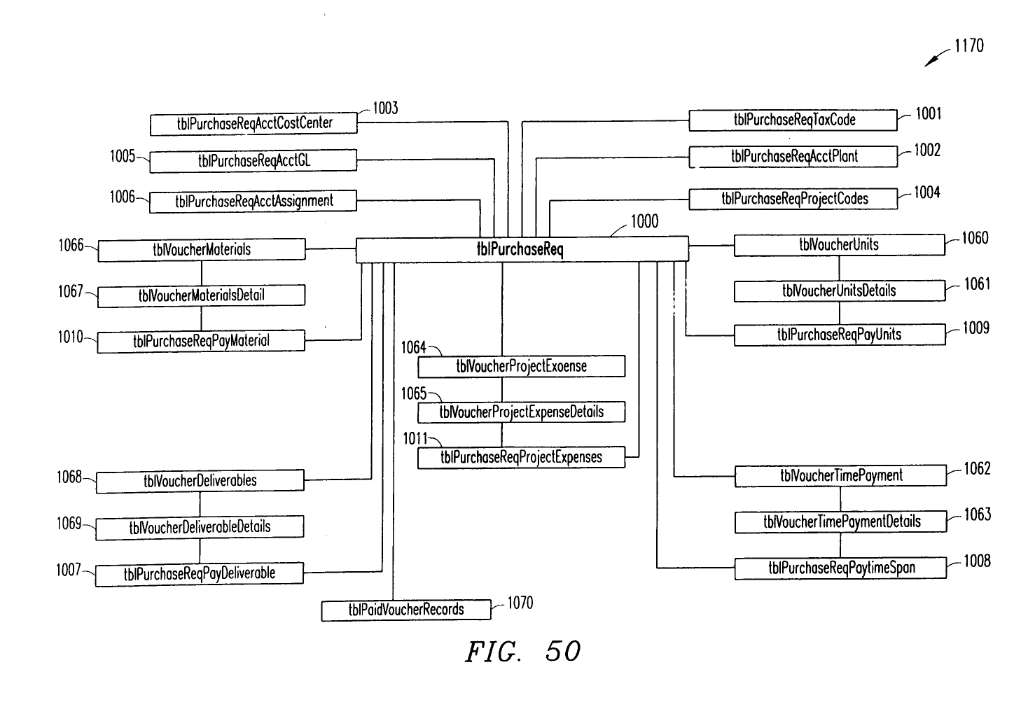

Exemplary database structures for storing the voucher information in payable vouchers and generating a paid voucher record are shown in Tables 84-92 below. The data structures are illustrated for simplicity as being organized in a table format, with each table including all of the fields necessary for storing voucher information. The tables are related in a hierarchical and relational manner with other tables stored in the database, as will be discussed in connection with FIG. 50.

Table 84 below illustrates sample general project unit completion voucher information, which can be stored in the database table structure 1170 in table tblVoucherUnits 1060, as shown in FIG. 50. For example, the general project unit completion voucher information can include the unit voucher identifier, the associated purchase requisition identifier, an indication of whether all time cards associated with the unit completion have been approved, the vendor identifier, the week ending date associated with the voucher information, the creation date, the review date and an indication of whether or not the voucher information has been approved. Table tblVoucherUnits 1060 is shown tied to table tblPurchaseReq 1000, which is discussed above in connection with FIG. 41, to associate the voucher information with the purchase requisition. In addition, various other tables shown in FIG. 41 are illustrated here in FIG. 50 to show the interrelation between the various purchase requisition tables and the voucher tables. It should be understood that a separate record in the format of Table 84 is stored in table tblVoucherUnits 1060 for each payable unit voucher.

Furthermore, although not shown, the table tblContractorExpenseVoucher 1054, shown in FIG. 47, is also considered a voucher table for generation of a payable voucher. It should be understood that other tables and voucher information can be included, and the system is not limited to the specific tables and voucher information shown in FIG. 50.

TABLE 84
tblVoucherUnits (db structure view)

| Column Name | Data Type | Length |
|---|---|---|
| Requisition_ID | int | 4 |
| Unit_Voucher_ID | int | 4 |
| tcStatus_ID | int | 4 |
| Vendor_ID | int | 4 |
| Week_Ending_Date | datetime | 8 |
| Record_Create_Date | datetime | 8 |
| Last_Edit_Date | datetime | 8 |
| Submit_Date | datetime | 8 |
| Approval_Date | datetime | 8 |
| Review_Date | datetime | 8 |
| Date_Rejected | datetime | 8 |
| Reviewer_ID | int | 4 |
| Vendor_Notes | varchar | 1000 |
| Buyer_Notes | varchar | 1000 |

Table 85 below illustrates sample detailed project unit completion voucher information, which can be stored in the database in table tblVoucherUnitsDetails 1061, as shown in FIG. 50. For example, such detailed project unit completion voucher information can include a description of the unit completion, the number of units authorized, the cost per unit, the number of units completed and other detailed project unit completion voucher information. Table tblVoucherUnitsDetails 1061 is shown tied to table tblVoucherUnits 1060 to associate the detailed project unit completion voucher information with the general project unit completion voucher information. In addition, table tblVoucherUnitsDetails 1061 is tied to table tblPurchaseReqPayUnits 1009 to associated the requisition unit payment information with the project unit completion voucher information.

It should be understood that a separate record in the format of Table 85 is stored in table tblVoucherUnitsDetails 1061 for each payable unit voucher. It should further be understood that other tables and project unit completion voucher information can be included, and the system is not limited to the specific tables and project unit completion voucher information shown in FIG. 50.

TABLE 85
tblVoucherUnitsDetails (db structure view)

| Column Name | Data Type | Length |
|---|---|---|
| Unit_Voucher_ID | int | 4 |
| puRecord_ID | int | 4 |
| Unit_Completion_Description | varchar | 1000 |
| Units_Authorized | numeric | 9 |
| Unit_Cost | money | 8 |
| Units_Completed | numeric | 9 |
| Line_Item_Cost | money | 8 |
| Account_Assignment | varchar | 10 |
| [Billable_Dept/Cost_Center] | nvarchar | 10 |
| Accounting_Plant | varchar | 10 |
| Project_Code | varchar | 20 |
| Tax_Code | varchar | 10 |
| G_L_Account | varchar | 20 |
| Record_ID | int | 4 |

Table 86 below illustrates sample general time completion voucher information, which can be stored in the database in table tblVoucherTimePayment 1062, as shown in FIG. 50. For example, the general time completion voucher information can include the time voucher identifier, the associated purchase requisition identifier, an indication of whether all time cards associated with the time completion have been approved, the vendor identifier, the week ending date associated with the voucher information, the creation date, the review date and an indication of whether or not the voucher information has been approved. Table tblVoucherTimePayment 1062 is shown tied to table tblPurchaseReq 1000, which is discussed above in connection with FIG. 41, to associate the voucher information with the purchase requisition. It should be understood that a separate record in the format of Table 86 is stored in table tblVoucherTimePayment 1062 for each payable time voucher.

TABLE 86
tblVoucherTimePayment (db structure view)

| Column Name | Data Type | Length |
|---|---|---|
| Requistion_ID | int | 4 |
| Time_Pay_Voucher_ID | int | 4 |
| tcStatus_ID | int | 4 |
| Vendor_ID | int | 4 |
| Week_Ending_Date | datetime | 8 |
| Record_Create_Date | datetime | 8 |
| Last_Edit_Date | datetime | 8 |
| Approval_Date | datetime | 8 |
| Date_Rejected | datetime | 8 |
| Review_ID | int | 4 |
| Vendor_Notes | varchar | 1000 |
| Buyer_Notes | varchar | 1000 |

Table 87 below illustrates sample detailed time completion voucher information, which can be stored in the database in table tblVoucherTimePaymentDetails 1063, as shown in FIG. 50. For example, such detailed time completion voucher information can include the work start date, payment release date, payment amount and other detailed time completion voucher information. Table tblVoucherTimeCompletionDetails 1063 is shown tied to table tblVoucherTimePayment 1062 to associate the detailed time completion voucher information with the general time completion voucher information. In addition, table tblVoucherTimePaymentDetails 1063 is tied to table tblPurchaseReqPayTimeSpan 1008 to associated the requisition time payment information with the time completion voucher information.

It should be understood that a separate record in the format of Table 87 is stored in table tblVoucherTimePaymentDetails 1063 for each payable unit voucher. It should further be understood that other tables and time completion voucher information can be included, and the system is not limited to the specific tables and time completion voucher information shown in FIG. 50.

TABLE 87
tblVoucherTimePaymentDetails (db structure view)

| Column Name | Data Type | Length |
|---|---|---|
| Time_Pay_Voucher_ID | int | 4 |
| pptRecord_ID | int | 4 |
| Work_Start_Date | datetime | 8 |
| Payment_Release_Date | datetime | 8 |
| Payment_Amount | money | 8 |
| Account_Assignment | varchar | 10 |
| [Billable_Dept/Cost_Center] | nvarchar | 10 |
| Accounting_Plant | varchar | 10 |
| Project_Code | varchar | 20 |
| Tax_Code | varchar | 10 |
| G_L_Account | varchar | 20 |
| Record_ID | int | 4 |

Table 88 below illustrates sample general project expense voucher information, which can be stored in the database in table tblVoucherProjectExpense 1064, as shown in FIG. 50. For example, the general project expense voucher information can include the project expense voucher identifier, the associated purchase requisition identifier, an indication of whether all time cards associated with the project expense (if any) have been approved, the vendor identifier, the week ending date associated with the voucher information, the creation date, the review date and an indication of whether or not the voucher information has been approved. Table tblVoucherProjectExpense 1064 is shown tied to table tblPurchaseReq 1000, which is discussed above in connection with FIG. 41, to associate the voucher information with the purchase requisition. It should be understood that a separate record in the format of Table 88 is stored in table tblVoucherProjectExpense 1064 for each payable project expense voucher.

TABLE 88
tblVoucherProjectExpense (db structure view)

| Column Name | Data Type | Length |
|---|---|---|
| Requisition_ID | int | 4 |
| Project_Expense_Voucher_ID | int | 4 |
| tcStatus_ID | int | 4 |
| Vendor_ID | int | 4 |
| Week_Ending_Date | datetime | 8 |
| Record_Create_Date | datetime | 8 |
| Last_Edit_Date | datetime | 8 |
| Submit_Date | datetime | 8 |
| Approval_Date | datetime | 8 |
| Date_Rejected | datetime | 8 |
| Reviewer_ID | int | 4 |
| Vendor_Notes | varchar | 1000 |
| Buyer_Notes | varchar | 1000 |

Table 89 below illustrates sample detailed project expense voucher information, which can be stored in the database in table tblVoucherProjectExpenseDetails 1065, as shown in FIG. 50. For example, such detailed project expense voucher information can include the date the expense was incurred, a description of the project expense, the amount of the project expense and other detailed project expense voucher information. Table tblVoucherProjectExpenseDetails 1065 is shown tied to table tblVoucherProjectExpense 1064 to associate the detailed project expense voucher information with the general project expense voucher information. In addition, table tblVoucherProjectExpenseDetails 1065 is tied to table tblPurchaseReqPayProjectExpense 1011 to associated the requisition project expense payment information with the project expense voucher information.

It should be understood that a separate record in the format of Table 89 is stored in table tblVoucherProjectExpenseDetails 1065 for each payable project expense voucher. It should further be understood that other tables and project expense voucher information can be included, and the system is not limited to the specific tables and project expense voucher information shown in FIG. 50.

TABLE 89
tblVoucherProjectExpenseDetails (db structure view)

| Column Name | Data Type | Length |
|---|---|---|
| Project_Expense_Voucher_ID | int | 4 |
| Expense_Incurred_Date | datetime | 8 |
| ppeRecord_ID | int | 4 |
| Project_Expense_Description | varchar | 500 |
| Project_Expense_Amount | money | 8 |
| Account_Assignment | varchar | 10 |
| [Billable_Dept/Cost_Center] | nvarchar | 10 |
| Accounting_Plant | varchar | 10 |
| Project_Code | varchar | 20 |
| Tax_Code | varchar | 10 |
| G_L_Account | varchar | 20 |
| Record_ID | int | 4 |

Table 90 below illustrates sample general material voucher information, which can be stored in the database in table tblVoucherMaterials 1066, as shown in FIG. 50. For example, the general material voucher information can include the material voucher identifier, the associated purchase requisition identifier, an indication of whether all time cards associated with the material (if any) have been approved, the vendor identifier, the week ending date associated with the voucher information, the creation date, the review date and an indication of whether or not the voucher information has been approved. Table tblVoucherMaterials 1066 is shown tied to table tblPurchaseReq 1000, which is discussed above in connection with FIG. 41, to associate the voucher information with the purchase requisition. It should be understood that a separate record in the format of Table 90 is stored in table tblVoucherMaterial 1066 for each payable material voucher.

TABLE 90
tblVoucherMaterials (db structure view)

| Column Name | Data Type | Length |
|---|---|---|
| Reqisition_ID | int | 4 |
| Material_Voucher_ID | int | 4 |
| tcStatus_ID | int | 4 |
| Vendor_ID | int | 4 |
| Week_Ending_Date | datetime | 8 |
| Record_Create_Date | datetime | 8 |
| Last_Edit_Date | datetime | 8 |
| Submit_Date | datetime | 8 |
| Approved_Date | datetime | 8 |
| Reviewed_Date | datetime | 8 |
| Date_Rejected | datetime | 8 |
| Reviewer_ID | int | 4 |
| Vendor_Notes | varchar | 1000 |
| Buyer_Notes | varchar | 1000 |

Table 91 below illustrates sample detailed material voucher information, which can be stored in the database in table tblVoucherMaterialsDetails 1067, as shown in FIG. 50. For example, such detailed material voucher information can include the date the material expense was incurred, the name of the material, a description of the material, the number of units of material purchased, the cost per unit of material and other detailed project expense voucher information. Table tblVoucherMaterialsDetails 1067 is shown tied to table tblVoucherMaterials 1066 to associate the detailed material voucher information with the general material voucher information. In addition, table tblVoucherMaterialsDetails 1067 is tied to table tblPurchaseReqPayMaterials 1010 to associated the requisition material payment information with the material voucher information.

It should be understood that a separate record in the format of Table 91 is stored in table tblVoucherMaterialsDetails 1067 for each payable material voucher. It should further be understood that other tables and material voucher information can be included, and the system is not limited to the specific tables and material voucher information shown in FIG. 50.

TABLE 91
tblVoucherMaterialsDetails (db structure view)

| Column Name | Data Type | Length |
|---|---|---|
| Material_Voucher_ID | int | 4 |
| Expense_Incurred_Date | datetime | 8 |
| ppmRecord_ID | int | 4 |
| Material_Name | varchar | 100 |
| Material_Description | varchar | 500 |
| Unit_Count | numeric | 9 |
| Unit_Cost | money | 8 |
| Line_Item_Cost | money | 8 |
| [Billable_Dept/Cost_Center] | nvarchar | 10 |
| Accounting_Plant | varchar | 10 |
| Project_Code | varchar | 20 |
| Tax_Code | varchar | 1- |
| G_L_Account | varchar | 20 |
| Record_ID | int | 4 |

Table 92 below illustrates sample general deliverables voucher information, which can be stored in the database in table tblVoucherDeliverables 1068, as shown in FIG. 50. For example, the general deliverables voucher information can include the deliverables voucher identifier, the associated purchase requisition identifier, an indication of whether all time cards associated with the deliverable (if any) have been approved, the vendor identifier, the week ending date associated with the voucher information, the creation date, the review date and an indication of whether or not the voucher information has been approved. Table tblVoucherDeliverables 1068 is shown tied to table tblPurchaseReq 1000, which is discussed above in connection with FIG. 41, to associate the voucher information with the purchase requisition. It should be understood that a separate record in the format of Table 92 is stored in table tblVoucherDeliverables 1068 for each payable deliverables voucher. However, it should be understood that other information can be included, and the system is not limited to the specific information shown in Table 92.

TABLE 92
tblVoucherDeliverables (db structure view)

| Column Name | Data Type | Length |
|---|---|---|
| Requisition_ID | int | 4 |
| Deliverable_Voucher_ID | int | 4 |
| tcStatus_ID | int | 4 |
| Vendor_ID | int | 4 |
| Week_Ending_ID | datetime | 8 |
| Record_Create_Date | datetime | 8 |
| Last_Edit_Date | datetime | 8 |
| Submit_Date | datetime | 8 |
| Approval_Date | datetime | 8 |
| Review_Date | datetime | 8 |
| Date_Rejected | datetime | 8 |
| Reviewer_ID | int | 4 |
| Vendor_Notes | varchar | 1000 |
| Buyer_Notes | varchar | 1000 |

Table 93 below illustrates sample detailed deliverables voucher information, which can be stored in the database in table tblVoucherDeliverablesDetails 1069, as shown in FIG. 50. For example, such detailed deliverables voucher information can include a description of the deliverable, the anticipated completion date of the deliverable, the actual completion date of the deliverable, the payment amount requested and other detailed deliverables voucher information. Table tblVoucherDeliverablesDetails 1069 is shown tied to table tblVoucherDeliverables 1068 to associate the detailed deliverables voucher information with the general deliverables voucher information. In addition, table tblVoucherDeliverablesDetails 1069 is tied to table tblPurchaseReqPayDeliverables 1007 to associated the requisition deliverables payment information with the deliverables voucher information.

It should be understood that a separate record in the format of Table 93 is stored in table tblVoucherDeliverablesDetails 1069 for each payable deliverables voucher. It should further be understood that other tables and deliverables voucher information can be included, and the system is not limited to the specific tables and deliverables voucher information shown in FIG. 50.

TABLE 93
tblVoucherDeliverableExpenseDetails (db structure view)

| Column Name | Data Type | Length |
|---|---|---|
| Deliverable_Vendor_ID | int | 4 |
| ppdRecord_ID | int | 4 |
| Deliverable_Description | varchar | 1000 |
| Anticipated_Completion_Date | datetime | 8 |
| Actual_Completion_Date | datetime | 8 |
| Payment_Amount_Requested | money | 8 |
| Account_Assignment | varchar | 10 |
| [Billable_Dept/Cost_Center] | nvarchar | 10 |
| Accounting_Plant | varchar | 10 |
| Project_Code | varchar | 20 |
| Tax_Code | varchar | 10 |
| G_L_Account | varchar | 20 |
| Record_ID | int | 4 |

Table 94 below illustrates sample paid voucher information, which can be stored in the database as table tblPaidVoucherRecords 1070, as shown in FIG. 50. For example, such paid voucher information can include the invoice number, purchase requisition identities assigned by the buyer and vendor, the voucher approval date, the name of the approver, the type of voucher (e.g., time card, contractor expense, project expense, deliverable, time completion or unit completion) and associated voucher identifier, the invoice amount, the payment date and other paid voucher information.

Table tblPaidVoucherRecords 1070 is shown tied to table tblPurchaseReq 1000, which is discussed above in connection with FIG. 41, to associate the paid voucher information with the purchase requisition. It should be understood that a separate record in the format of Table 94 is stored in table tblPaidVoucherRecords 1070 for each paid voucher. However, it should be understood that other information can be included, and the system is not limited to the specific information shown in Table 94.

TABLE 94
Exemplary tblPaidVoucherRecords (db structure view)

| Column Name | Data Type | Length |
|---|---|---|
| Invoice_ID | int | 4 |
| Buyer_PR_# | varchar | 20 |
| PR_Version | numeric | 9 |
| Vendor_PR_# | varchar | 20 |
| Approval_Date | datetime | 8 |
| Approver_Name | varchar | 100 |
| Approver_Employee_ID | nvarchar | 10 |
| Time_Card_ID | int | 4 |
| Expense_Voucher_ID | int | 4 |
| Material_Voucher_ID | int | 4 |
| Project_Expense_Voucher_ID | int | 4 |
| Deliverable_Voucher_ID | int | 4 |
| Time_Pay_Voucher_ID | int | 4 |
| Unit_Voucher_ID | int | 4 |
| Invoice_Amount | money | 8 |
| Account_Assignment | varchar | 10 |
| [Billable_Dept/Cost_Center] | varchar | 10 |
| Accounting_Plant | varchar | 10 |
| Project_Code | varchar | 20 |
| Tax_Code | varchar | 10 |
| G_L_Account | varchar | 20 |
| Currency_ID | int | 4 |
| File_Extract_Date | datetime | 8 |
| EDI_File_Transmission_Date | datetime | 8 |
| Buyer_Check_Register_Date | datetime | 8 |
| Vendor_Payment_Date | datetime | 8 |
| Vendor_AP_Register_# | varchar | 20 |
| Vendor_Check_# | varchar | 25 |
| Vendor_Check_Issuance_Date | datetime | 8 |
| Record_ID | int | 4 |

Referring now to FIG. 51, there is illustrated a screen shot of an exemplary web page 61 showing the financial status of the project. This web page may be accessible in one or more formats to the buyer, vendor and/or administrator, depending upon system constraints. As can be seen in FIG. 51, the different types of payment vouchers, and the estimated amount for each of the payment vouchers can be displayed. In addition, the actual amount expended for each of the payment voucher types and the estimated additional funds to be expended for each of the payment voucher types can also be tracked. In this way, the buyer, vendor and/or administrator can maintain a working knowledge of the project performance from a financial perspective. However, it should be understood that other financial information can be displayed instead of or in addition to the specific financial information shown in FIG. 51. Furthermore, it should be understood that other project related information (in lieu of or in addition to financial information) can be displayed depending on the buyer, vendor, administrator and/or system configuration, as discussed in more detail hereinbelow.

Analysis and Reporting of Transactional Data

During the pre-bid, bid and post-bid activities described above, various transactional data related to the bid/project process are obtained from the buyer, vendor and other parties (e.g., administrator) involved in the process. As shown in FIG. 58, the transactional data 1195 may include one or more components: bid data 212, project tracking parameters 870, voucher information 1160 and project performance data 1190. Each of the components of the transactional data 1195 is obtained during separate stages of the bid/project process. Other components can also be included in the transactional data 1195, such as vendor qualification information, buyer-defined vendor criteria information, commodity information and other pre-bid and project-related data. In sum, the transactional data 1195 can include any data stored within the database system 150.

For example, referring now to FIG. 52, there is illustrated a signaling diagram showing the information exchange between the buyer 50, the vendor 10 and the PBMS (hereinafter the system) 30. As discussed above, initially, a buyer 50 transmits a bid request via the system 30 to the vendor 10 (step 4500). The bid request contains data fields having bid request data entered therein by the buyer 50 and data fields for the vendor 10 to enter bid response data. When the vendor 10 has entered the bid response data into the appropriate data fields, a bid response including the bid response data is transmitted back to the buyer 50 via the system 30 (step 4510). Together, the bid request data and bid response data form the bid data 212 of the completed bid. The bid data 212 is stored in the system database in records associated with the bid, as described above.

Once the buyer 50 has awarded the bid to a particular vendor 10, both the buyer 50 and vendor 10 can enter project tracking parameters 870 (e.g., purchase requisition information, taxation information, etc.) into the system 30 (step 4520) for storage in the database, along with the bid data 212. The project tracking parameters 870 can include some or all of the contract terms and conditions, including vendor responsibilities for goods and services, both billable and non-billable. When the vendor 10 provides an authorized good or service (as determined by the entered project tracking parameters 870), the vendor 10 can access the system to submit a voucher to request payment, or buyer acknowledgment of completion in the event that the activity is non-billable, for the good provided or service performed (step 4530). Upon approval of the voucher and subsequent invoicing for the same, the buyer releases payment to the vendor via a pre-configured method (step 4540). The information entered by the buyer 50 and vendor 10 during the voucher submittal and payment process is stored as voucher information 1160 in the database.

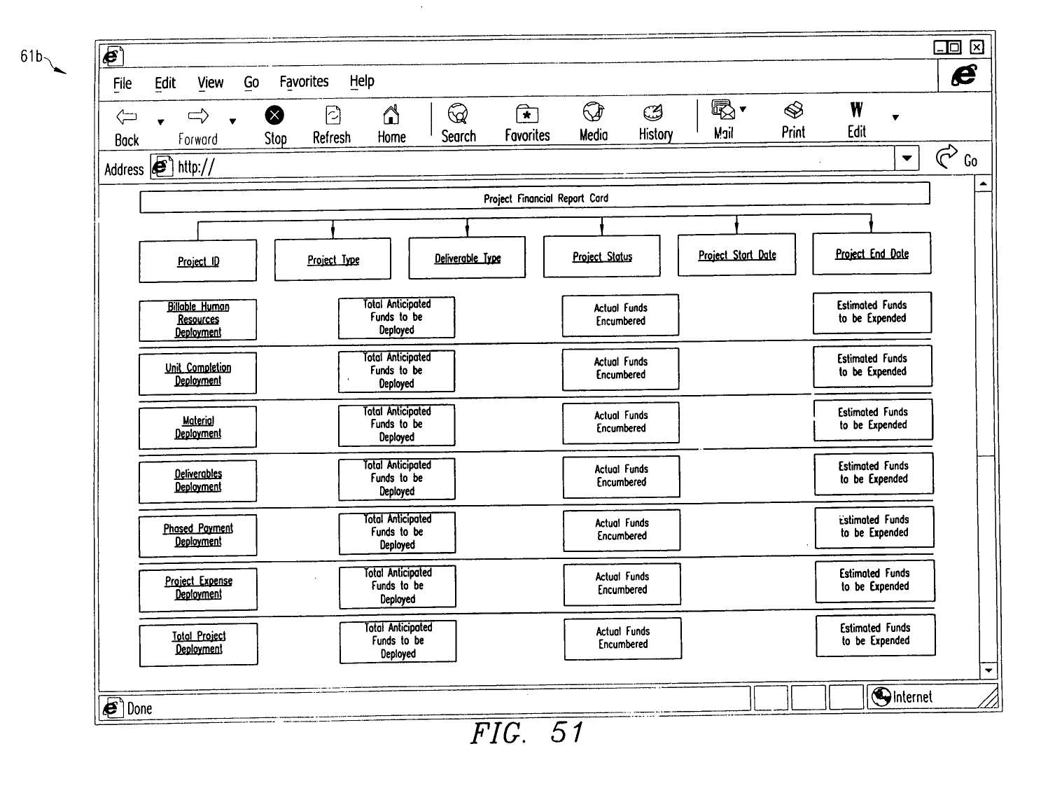

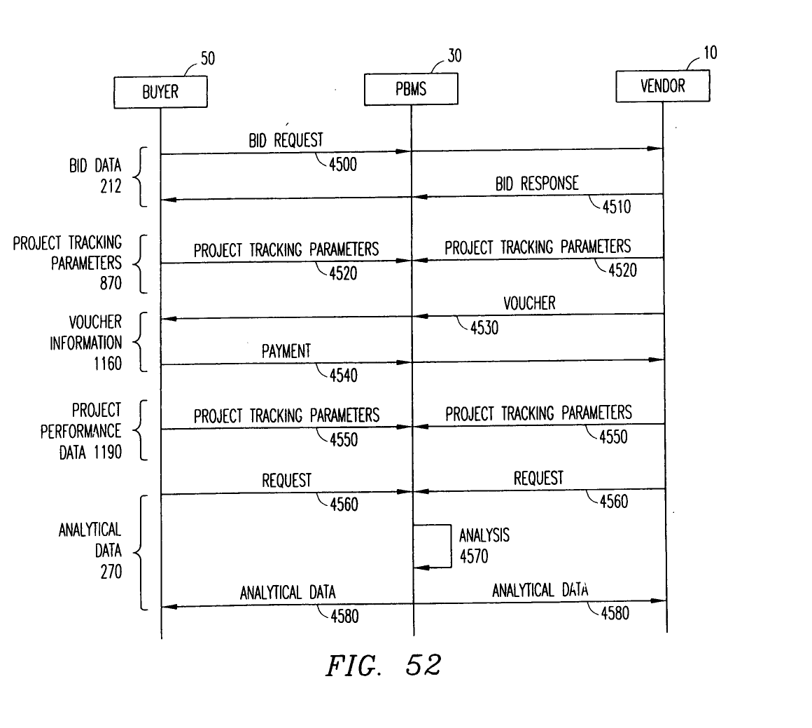

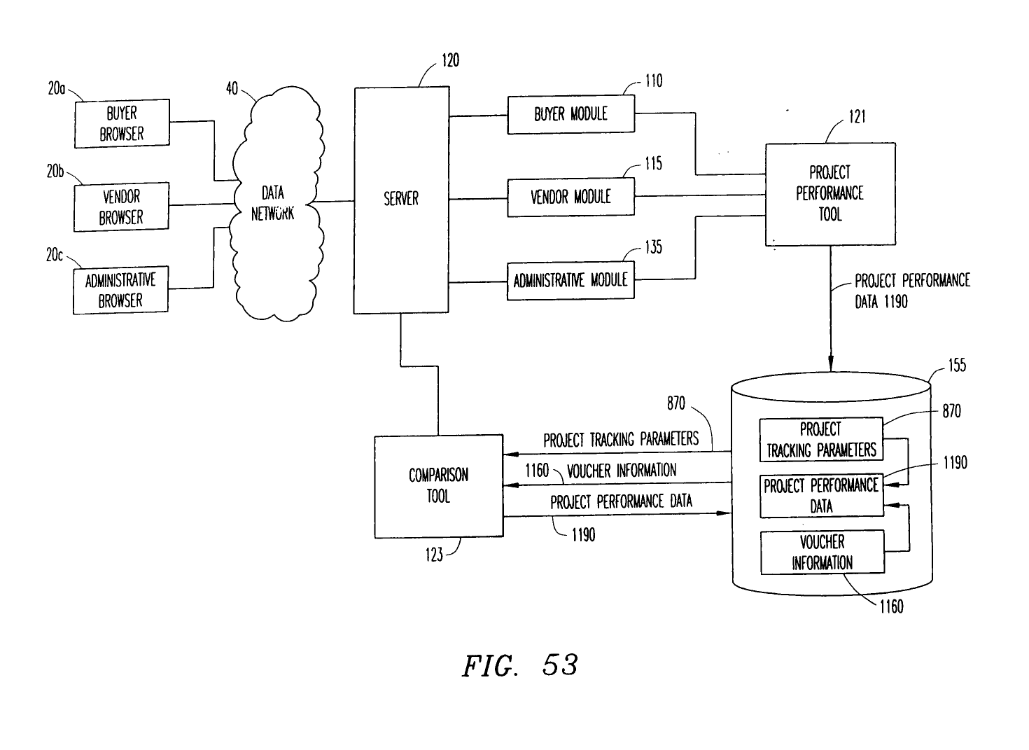

During the performance of the project, various project performance data 1190 can be entered into the system 30, or generated automatically by both the vendor 10 and the buyer 50 (step 4550), as will be described in more detail hereinbelow with respect to FIGS. 53-57. For example, the project performance data 1190 can include various status information, such as timing information (e.g., an indication of the timeliness of the vendor on completion of one or more phases or components of the project), or cost information (e.g., the actual cost of one or more components of the project as compared with the respective projected (requisition) costs). The project performance data 1190 can also include project-specific information, such as the importance of the project or the impact of the project on other aspects of the company, or other customer-specific information.

The bid data 212, project tracking parameters 870, voucher information 1160 and project performance data 1190 are all stored in the system database as transactional data related to the bid and project. With access to all of this transactional data, the system 30 can perform virtually any type of analysis desired and generate reports based on the analysis. Thus, the system 30 is operable to receive requests for certain types of analytical data from the buyer, vendor or another user with access to the analytical data (step 4560). In accordance with the request, the system 30 performs an analysis of the transactional data to generate the analytical data (step 4570) and provides the analytical data to the requestor (e.g., buyer 50, vendor 10 or other user) (step 4580) in a reporting view.

For example, a buyer 50 can request reports containing analytical data related to a specific project, multiple projects or multiple vendors 10. The analytical data can be directed to financial information (e.g., invoice details, spending (past, present and future) and other types of financial analysis), project information (e.g., project performance, future project activity and project planning), vendor information (e.g., vendor financial information, vendor operational information and supply chain information) and any other type of information desired. In addition, a buyer 50 can request reports containing industry analytical data related to multiple projects commissioned by multiple buyers 50. The industry analytical data can be directed to financial information (e.g., the percentage of total cost spent on various aspects of a project type or the percentage amount spent industry-wide on various types of projects), vendor information (e.g., the on-time percentage of the vendor in the industry or the cost percentage over/under budget of the vendor in the industry), and any other type of industry information as desired. Similar analytical data can be provided to a vendor 10 or other authorized user. For example, a vendor 10 or administrator can request reports containing analytical data related to a specific project or multiple projects that the vendor 10 is involved in conducting.

Turning now to FIG. 53, there is illustrated exemplary functionality for entering project performance data 1190. A project performance tool 121 and comparison tool 123 are illustrated in FIG. 53 for the entering of the project performance data, in accordance with embodiments of the present invention. The project performance tool 121 and comparison tool 123 can include any hardware, software and/or firmware required to perform the functions of the tools, and can be implemented within the server 120 or an additional server (not shown). For example, the project performance tool 121 and comparison tool 123 can be resident in software modules 128 within the server 120, as shown in FIG. 3B.

In one embodiment, the project performance data 1190 can be entered directly into the database 155 by a buyer, vendor or administrator through the project performance tool 180. The buyer, vendor or administrator can access the server 120 of the computer system 100 via the buyer browser 20a, vendor browser 20b or administrative browser 20c, respectively, and the data network 40. The buyer module 110, vendor module 115 or administrative module 135 interfaces with the project performance tool 121 to push web pages to the buyer browser 20a, vendor browser 20b or administrative browser 20c, respectively, soliciting the project performance data. The project performance tool 121 accesses the database 155 to populate project performance data fields associated with a particular project with the project performance data entered by the buyer, vendor and/or administrator. For example, the project performance data can include comments by the buyer, vendor and/or administrator on the status or personal project satisfaction thus far.

Upon receiving project performance data 1190 from either the buyer, vendor or administrator, the project performance tool 121 can further be configured to automatically generate a message (e.g., e-mail message) to the other parties informing them of the new project performance data 1190, thereby enabling the other parties to enter additional project performance data 1190 clarifying, responding or providing data unrelated to the previously entered project performance data 1190.

In other embodiments, the comparison tool 123 can automatically enter the project performance data 1190 into the database 155 based on a comparison of project tracking parameters 870 and voucher information 1160 associated with a particular project. The comparison tool retrieves requisite project tracking parameters 870 and voucher information 1160 from the database 155, performs a comparison or analysis of the retrieved project tracking parameters 870 and voucher information 1160, and based on the results of the comparison or analysis, enters any necessary project performance data 1190 into data fields associated with the project within the database 155.

As an example, the comparison tool 123 can be configured to monitor the database 155 for new voucher information 1160 entries or otherwise be triggered upon the entry of new voucher information 1160 to compare the entered voucher information 1160 with the previously stored project tracking parameters 870 for the project. The voucher information 1160 can contain cost, timing or other information with which to compare to the project tracking parameters 870. The results of the comparison can be stored as project performance data 1190 in the database 155. For example, the voucher information 1160 could indicate an invoice amount paid by the buyer 50 on a project, and the comparison tool 123 can compare the invoice amount with the requisition amount to determine if a discrepancy exists. In this case, the project performance data 1190 could include an indication of the cost status, such as under-budget, over-budget or in-budget, and the amount over or under budget, if any.

As another example, the comparison tool 123 can be configured to search the database 155 for particular project tracking parameters 870, and enter the status of the project tracking parameters 870 as project performance data 1190. For example, the comparison tool 123 can search the database 155 for expired target completion dates on projects, and enter the number of days each of the projects are past due as project performance data 1190 related to those projects. The comparison tool 123 can further search for voucher information 1160 related to those past due projects and enter the status of the projects based on the voucher information 1160. For example, if the vendor has submitted a voucher for payment, but the buyer has not yet made the payment, the status could indicate voucher submitted, awaiting payment.

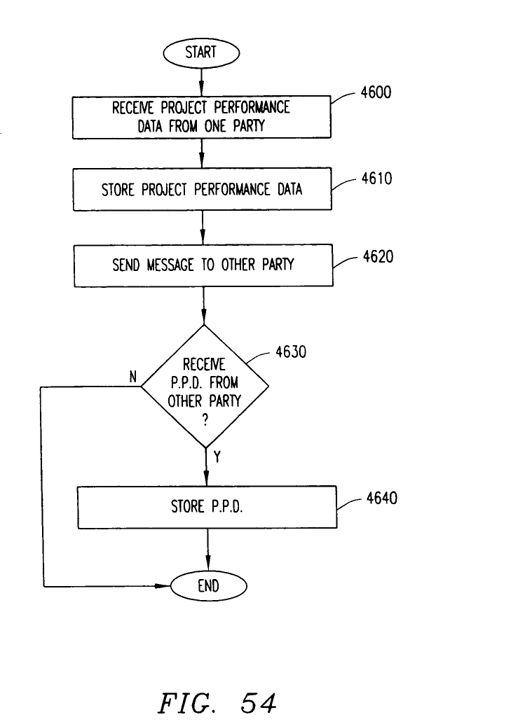

Exemplary processes for entering project performance data 1190 from various system perspectives are shown in FIGS. 54-56. FIG. 54 illustrates exemplary steps for a user, such as a buyer, vendor or administrator, to enter project performance data into the system. Upon receiving the project performance data from a user associated with a project (step 4600), the system stores the project performance data in data fields associated with the project for later use and retrieval (step 4610). If the parties (buyer, vendor and administrator) involved in the project have established conditions for allowing disclosure of some or all project performance data between the parties, the system generates a message to the other parties informing them of the received project performance data in accordance with the conditions set by the parties (step 4620). In response to the message, the other parties may choose to enter additional project performance data clarifying, responding or providing data unrelated to the previously entered project performance data. If additional project performance data is received (step 4630), the system stores the additional project performance data in data fields associated with the project, along with the previously entered project performance data, within the database (step 4640).

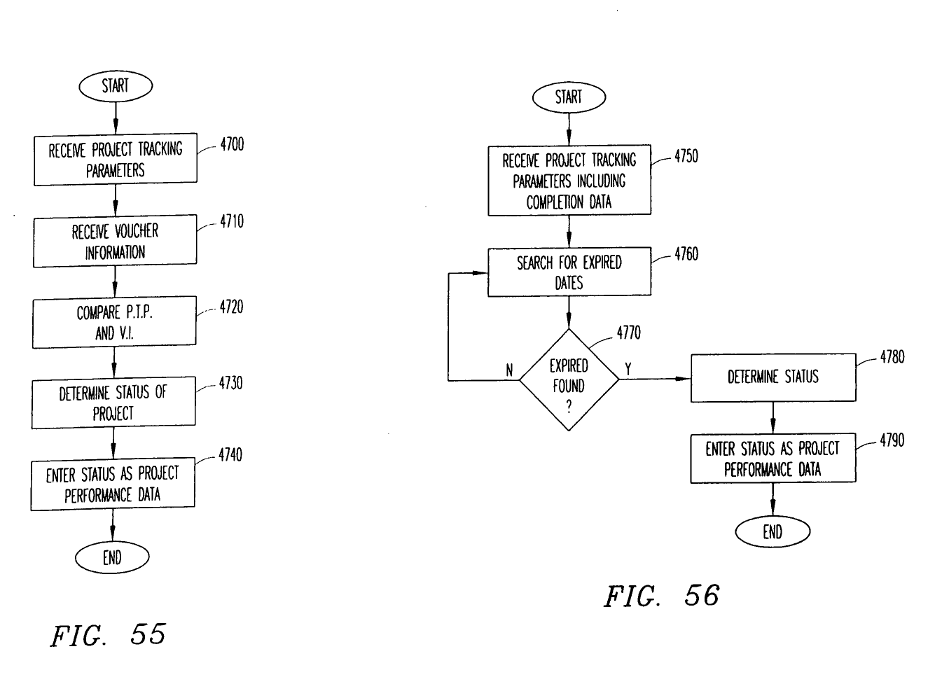

FIG. 55 illustrates exemplary steps for automatically entering project performance data into the system based on the previously stored project tracking parameters and the voucher information. After the system receives both project tracking parameters (step 4700) and voucher information (step 4710) for a particular project, the system can compare the project tracking parameters with the voucher information (step 4720) to determine the status of the project (step 4730). The project status can be entered into the system and stored as project performance data related to the project (step 4740). For example, the voucher information can indicate the actual project completion date on a project, and the system can compare the actual project completion date with the target project completion date to determine if a discrepancy exists. In this case, the project performance data could include an indication of the status, such as complete on-time, complete past-due or complete early, along with the number of days past-due or early.

FIG. 56 illustrates exemplary steps for automatically entering project performance data into the system based on the status of previously stored project tracking parameters. After the system receives project tracking parameters for a particular project (step 4750), such as a target completion date, the system can search the database for expired target completion dates on projects (step 4760). If expired completion dates are found (step 4770), the system can determine the status of the project (step 4780), based on any voucher information that has been received, and enter the status of the project into the system as project performance data (step 4790).

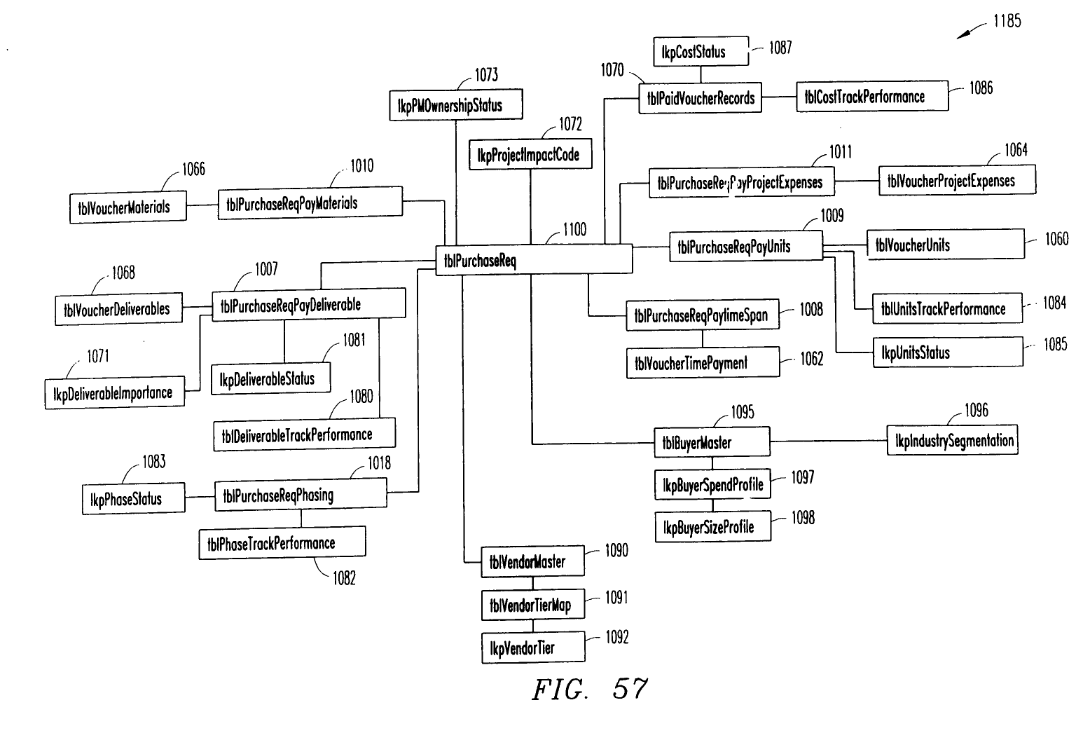

Exemplary database structures for storing the project performance data 1190 are shown in Tables 95-112 below. The data structures are illustrated for simplicity as being organized in a table format, with each table including all of the fields necessary for storing project performance data 1190. The tables are related in a hierarchical and relational manner with other tables stored in the database, as will be discussed in connection with FIG. 57.

Tables 95 and 96 below illustrate sample deliverable project performance data, which can be stored in the database table structure 1185 in table tblDeliverableTrackPerformance 1080 and table lkpDeliverableStatus 1081, as shown in FIG. 57. The deliverable project performance data can include the deliverable status as determined from the table lkpDeliverableStatus 1081. For example, the deliverable status can be incomplete—current, incomplete—past due, partial complete—current, partial complete—past due, complete—on-time, complete—past due or complete—early. The identifier associated with the status can be stored in the table tblDeliverableTrackPerformance, along with the identifier associated with the deliverable project tracking parameters stored in the table tblPurchaseReqPayDeliverables 1007, the current status (e.g., the number of days late or early), and any user notes.

For example, if the buyer, vendor or other user has entered any comments related to the status of the deliverables, these comments can be stored in table tblDeliverableTrackPerformance 1080. The identity of the user that entered the comments, along with the date the comments were entered can also be stored in addition to the comments. If the system is configured to inform the vendor when the buyer enters comments, the status of the vendor response (e.g., not yet responded, no response, response) can also be stored.

Tables tblDeliverableTrackPerformance 1080 and lkpDeliverableStatus 1081 are shown tied to table tblPurchaseReqPayDeliverable 1007, which in turn is tied to table tblPurchaseReq 1000, which are discussed above in connection with FIG. 41, to associate the project performance data with the voucher information and the project tracking parameters (e.g., purchase requisition). In addition, various other tables shown in FIG. 41 are illustrated here in FIG. 57 to show the interrelation between the various project performance tables, voucher tables and purchase requisition tables. It should be understood that a separate record in the format of Table 95 is stored in table tblDeliverableTrackPerformance 1080 for each deliverable. It should be understood that other tables and project performance data can be included, and the system is not limited to the specific tables and project performance data shown in FIG. 57.

TABLE 95
Exemplary tblDeliverableTrackPerformance

| Column | Data Type | Length |
|---|---|---|
| DeliverableID | int | 4 |
| DeliverableStatusID | int | 4 |
| CurrentStatus | varchar | 1000 |
| BuyerUserID | int | 4 |
| BuyerUserNotes | varchar | 1000 |
| BuyerRecordDate | datetime | 8 |
| VendorUserID | int | 4 |
| VendorUserNotes | varchar | 1000 |
| VendorRecordDate | datetime | 8 |

TABLE 96
Exemplary lkpDeliverableStatus

| DeliverableStatusID | DeliverableStatusDesc |
|---|---|
| 1 | Incomplete-Current |
| 2 | Incomplete-PastDue |
| 3 | PartialComplete-Current |
| 4 | PartialComplete-PastDue |
| 5 | Complete-OnTime |
| 6 | Complete-PastDue |
| 7 | Complete-Early |

Tables 97 and 98 below illustrates sample phase project performance data, which can be red in the database table structure 1185 in table tblPhaseTrackPerformance 1082 and table PhaseStatus 1083, as shown in FIG. 57. The phase project performance data can include the se status as determined from the table lkpPhaseStatus 1082. For example, the phase status be open—current, open—out of date, open—future date, closed—on-time, closed—out of date, or closed—early. The identifier associated with the status can be stored in the table tblPhaseTrackPerformance, along with the identifier associated with the phase project tracking parameters stored in the table tblPurchaseReqPhasing 1018, which can be a table similar to the tables shown in FIG. 41, the current status (e.g., the number of days late or early), and any user notes.

For example, if the buyer, vendor or other user has entered any comments related to the status of the phasing, these comments can be stored in table tblPhaseTrackPerformance 1083. The identity of the user that entered the comments, along with the date the comments were entered can also be stored in addition to the comments. If the system is configured to inform the vendor when the buyer enters comments, the status of the vendor response (e.g., not yet responded, no response, response) can also be stored.

TABLE 97
Exemplary tblPhaseTrackPerformance

| Column | Data Type | Length |
|---|---|---|
| PhaseID | int | 4 |
| PhaseStatusID | int | 4 |
| CurrentStatus | varchar | 1000 |
| BuyerUserID | int | 4 |
| BuyerUserNotes | varchar | 1000 |
| BuyerRecordDate | datetime | 8 |
| VendorUserID | int | 4 |
| VendoruserNotes | varchar | 1000 |
| VendorRecordDate | datetime | 8 |

TABLE 98
Exemplary lkpPhaseStatus

| PhaseStatusID | PhaseStatusDesc |
|---|---|
| 1 | Open-Current |
| 2 | Open-Out Of Date |
| 3 | Open - Future Date |
| 4 | Closed - On-Time |
| 5 | Closed - Out Of Date |
| 6 | Closed - Early |

Tables 99 and 100 below illustrates sample units project performance data, which can be stored in the database table structure 1185 in table tblUnitsTrackPerformance 1084 and table lkpUnitStatus 1085, as shown in FIG. 57. The units project performance data can include the units status as determined from the table lkpUnitsStatus 1085. For example, the units status can be Incomplete-Current, Incomplete-PastDue, Complete-On-Time, Complete-PastDue or Complete-Early. The identifier associated with the status can be stored in the table tblUnitTrackPerformance, along with the identifier associated with the unit project tracking parameters stored in the table tblPurchaseReqPayUnits 1009, the current status (e.g., the number of days late or early), and any user notes.

For example, if the buyer, vendor or other user has entered any comments related to the status of the units, these comments can be stored in table tblUnitsTrackPerformance 1084. The identity of the user that entered the comments, along with the date the comments were entered can also be stored in addition to the comments. If the system is configured to inform the vendor when the buyer enters comments, the status of the vendor response (e.g., not yet responded, no response, response) can also be stored.

TABLE 99
Exemplary tblUnitsTrackPerformance

| Column | Data Type | Length |
|---|---|---|
| UnitsID | int | 4 |
| UnitsStatusID | int | 4 |
| CurrentStatus | varchar | 1000 |
| BuyerUserID | int | 4 |
| BuyerUserNotes | varchar | 1000 |
| BuyerRecordDate | datetime | 8 |
| VendorUserID | int | 4 |
| VendoruserNotes | varchar | 1000 |
| VendorRecordDate | datetime | 8 |

TABLE 100
Exemplary lkpUnitsStatus

| UnitsStatusID | UnitsStatusDesc |
|---|---|
| 1 | Incomplete-Current |
| 2 | Incomplete-PastDue |
| 3 | Complete-Current |
| 4 | Complete-PastDue |
| 5 | Complete-Early |

Tables 101 and 102 below illustrates sample cost project performance data, which can be stored in the database table structure 1185 in table tblCostTrackPerformance 1086 and table lkpCostStatus 1087, as shown in FIG. 57. The cost project performance data can be related to any paid voucher for any type of voucher, including materials vouchers, expenses vouchers, deliverables vouchers, phasing vouchers, units vouchers and time payment vouchers. The cost project performance data is represented by the cost status as determined from the table lkpCostStatus 1087. For example, the cost status can be over-budget, under-budget or in-budget. The identifier associated with the status can be stored in the table tblCostTrackPerformance, along with the identifier associated with the voucher information stored in the table tblPaidVoucherRecords 1070, the current status (e.g., the amount over or under budget), and any user notes.

For example, if the buyer, vendor or other user has entered any comments related to the status of the cost, these comments can be stored in table tblCostTrackPerformance 1086. The identity of the user that entered the comments, along with the date the comments were entered can also be stored in addition to the comments. If the system is configured to inform the vendor when the buyer enters comments, the status of the vendor response (e.g., not yet responded, no response, response) can also be stored.

TABLE 101
Exemplary tblCostTrackPerformance

| Column | Data Type | Length |
|---|---|---|
| PaidVoucherRecordID | int | 4 |
| CostStatusID | int | 4 |
| CurrentStatus | varchar | 1000 |
| BuyerUserID | int | 4 |
| BuyerUserNotes | varchar | 1000 |
| BuyerRecordDate | datetime | 8 |
| VendorUserID | int | 4 |
| VendoruserNotes | varchar | 1000 |
| VendorRecordDate | datetime | 8 |

TABLE 102
Exemplary lkpCostStatus

| CostStatusID | CostStatusDesc |
|---|---|
| 1 | Over-Budget |
| 2 | Under-Budget |
| 3 | In-Budget |

Other tables are shown in FIG. 57 that contain additional data related to the project and/or vendor or buyer that can serve to further identify the type of project and other project variables that have not been explicitly discussed previously. The additional data can also be included in the transactional data utilized for analysis and reporting purposes. For example, Table 103 below illustrates the impact of the project on other aspects of the buyer, which can be stored in the database table structure 1185 in table lkpProjectImpactCode 1072, Table 104 below illustrates the deliverable importance, which can be stored in the database table structure 1185 in table lkpDeliverableImportance, and Table 105 below illustrates the ownership status of the project, which can be stored in the database table structure 1185 in table lkpPMOwndershipStatus 1073, as shown in FIG. 57.

Other information related to the vendor and the buyer can be stored in additional tables. For example, Table 106 below illustrates master vendor data, which can be stored in the database table structure 1185 in table lkpVendorMaster 1090, and Table 107 below illustrates master buyer data, which can be stored in the database table structure 1185 in table lkpBuyerMaster 1095, as shown in FIG. 57. In addition, Tables 108 and 109 below illustrate vendor tier information indicating the tier group that the buyer has assigned to the vendor (e.g., Tier 1 vendors are the vendors that are typically used first or most often), which can be stored in the database table structure 1185 in tables lkpVendorTier 1091 and tblVendorTierMap 1092, as shown in FIG. 57. Furthermore, Tables 110-112 below illustrate buyer industry segmentation, spend and size information, which can be stored in the database table structure 1185 in tables lkpIndustrySegmentation 1096 lkpBuyerSpendProfile 1097 and lkpBuyerSizeProfile 1098, as shown in FIG. 57. The industry segmentation can be project-specific or applicable to the buyer as a whole.

TABLE 103
Exemplary lkpProjectImpactCode

| ProjectImpactCodeID | ProjectImpactCode |
|---|---|
| 1 | EmployeeHealty&Safety |
| 2 | EmployeeTraining |
| 3 | FacilitiesImprovement |
| 4 | InternalProcessImprovement |
| 5 | LiabilityReduction |
| 6 | MarketShareIncrease |
| 7 | MarketShareRetention |
| 8 | ProductDevelopment-Core |
| 9 | ProjectDevelopmentNon-Core |
| 10 | ProfitabilityGains |
| 11 | ProvisionClientServices |
| 12 | PublicReputationEnhancement |

TABLE 104
Exemplary lkpDeliverableImportance

| DeliverableImportanceID | DeliverableImportanceDesc |
|---|---|
| 1 | Critical |
| 2 | HighPriority |
| 3 | MediumPriority |
| 4 | LowPriority |

TABLE 105
Exemplary lkpPMOwnershipStatus

| PMOwnershipID | PMOwnershipDesc |
|---|---|
| 1 | ClientOwned |
| 2 | SupplierOwned |
| 3 | JointOwnership-ClientPM |
| 4 | JointOwnership-SupplierPM |
| 5 | 3rdPartyConsultantPM |

TABLE 106
Exemplary lkpVendorMaster

| Column | Data Type | Length |
|---|---|---|
| VendorID | int | 4 |
| vCompanyName | varchar | 100 |
| vParentCompanyName | varchar | 100 |
| vBusinessEntityTypeID | int | 4 |
| vFedIdentity | varchar | 50 |
| vYearCorp | varchar | 50 |
| vFTEmployees | int | 4 |
| vURL | varchar | 100 |
| vPhone | varchar | 50 |
| vFax | varchar | 50 |
| vEmail | varchar | 50 |
| vCountryID | int | 4 |

TABLE 107
Exemplary lkpBuyerMaster

| Column | Data Type | Length |
|---|---|---|
| BuyerID | int | 4 |
| bCompanyName | varchar | 100 |
| bParentCompanyName | varchar | 100 |
| bBusinessEntityTypeID | int | 4 |
| bFedIdentity | varchar | 50 |
| bYearCorp | varchar | 50 |
| bFTEmployees | int | 4 |
| bURL | varchar | 100 |
| bPhone | varchar | 50 |
| bFax | varchar | 50 |
| bEmail | varchar | 50 |
| bCountryID | int | 4 |

TABLE 108
Exemplary lkpVendorTier

| Column | Data Type | Length |
|---|---|---|
| TierCode | int | 4 |
| TierCodeDesc | varchar | 50 |
| CurrentStatusID | int | 4 |
| UserTypeID | int | 4 |
| UserID | int | 4 |
| RecordDate | datetime | 8 |

TABLE 109
Exemplary tblVendorTierMap

| Column | Data Type | Length |
|---|---|---|
| VendorID | int | 4 |
| TierID | int | 4 |
| CurrentStatusID | int | 4 |
| UserTypeID | int | 4 |
| UserID | int | 4 |
| RecordDate | datetime | 8 |
| RowID | int | 4 |

TABLE 110
lkpIndustrySegmentation

| IndustrySegmentID | IndustrySegmentDesc |
|---|---|
| 1 | Aerospace |
| 2 | Automotive |
| 3 | Banking |
| 4 | Engineering |
| 5 | Finance |
| 6 | Government |
| 7 | Insurance |
| 8 | Manufacturing |
| 9 | Medical/BioResearch |
| 10 | Pharmaceutical |
| 11 | Retail |
| 12 | Telecommunications |
| 13 | Transportation |

TABLE 111
lkpBuyerSpendProfile

| BuyerSpendProfileDesc | SpendThresholdLow |
|---|---|
| ExtraLargeCommoditySpender | $250,000,000 |
| LargeCommoditySpender | $100,000,000 |
| MidSizeCommoditySpender | $40,000,000 |
| SmallCommoditySpender | $5,000,000 |

TABLE 112
lkpBuyerSizeProfile

| BuyerSizeProfileDesc | CapLowThreshold |
|---|---|
| XLCap | $10,000,000,000 |
| LCap | $5,000,000,000 |
| MCap | $1,000,000,000 |
| SCap | $100,000,000 |

As described above in connection with FIG. 52, the project performance data forms a part of the transactional data that is stored in the database. Referring again to FIG. 58, the transactional data 1195 may include not only the bid data 212, but also the project tracking parameters 870, voucher information 1160 and project performance data 1190. All of the transactional data 1195 is stored in the lower-level database system 150 that contains databases (155, not shown) for buyers, vendors and administrators. In some embodiments, the transactional data 1195 is maintained only at the lower-level database 150, and therefore, the analytical data is restricted to only the transactional data 1195 within that lower-level database. For example, a buyer/administrator or vendor may not permit their transactional data to be accessed by any outside (third-party) sources. In this situation, to generate analytical data including the buyer/administrator or vendor transactional data, the buyer/administrator or vendor is limited to just their transactional data.

In other embodiments, as shown in FIG. 59, all or a portion of the transactional data 1195 can be transferred up to the top-level database 160 (hereinafter the central database 160) for later use or retrieval for analytical purposes. The transactional data can be transferred from the lower-level database 155 to the central database 160 at any time or for any reason. As an example, the transactional data 1195a, 1195b and 1195c (collectively, 1195) stored in multiple buyer databases 155a, 155b and 115c, respectively, can be transferred up to the central database 160 for storage therein. The transfer can take place in a batch mode process, in which the transactional data 1195 having record creation dates within a specific time period are transferred in a batch up to the central database 160. For example, each week, all of the transactional data 1195 having record creation dates for that week can be transferred in a batch up to the central database 160.

The transferred transactional data 1195 can include all of the transactional data 1195 in the lower-level database 160 or only a portion as designated by the system or the buyer/administrator and/or vendor. For example, various portions of the transactional data 1195 may not be necessary for industry-wide analytical purposes, and therefore, the transactional data 1195 transferred to the central database 160 may exclude those portions that are unnecessary. As another example, the buyer/administrator and/or vendor may desire to limit the type of transactional data 1195 that is made available to the central database 160 for privacy or other reasons.

Referring now to FIG. 60, there is illustrated exemplary functionality for generating the analytical data 270. A reporting module 126 or 127 is shown in FIG. 60 for the generation of the analytical data 270, in accordance with embodiments of the present invention. The reporting module 126 or 127 can include any hardware, software and/or firmware required to perform the functions of the module, and can be implemented within the server 120 or 125, respectively, or an additional server (not shown). For example, the reporting module 126 can be resident in software modules 128 within the server 120, as shown in FIG. 3B.

The analytical data 270 can be generated using transactional data 1195 from a lower-level database (not specifically shown) within the lower-level database system 150 or from the central database 160, depending on the type of analytical data 270 desired. For example, if a buyer user requires analytical data related to only those projects associated with the buyer, the buyer user would access the transactional data 1195 within the lower-level database of the buyer within the lower-level database system 150. However, if the buyer user requires industry analytical data related to projects associated with multiple buyers, the buyer user would access the transactional data 1195 within the central database 160.

To receive analytical data 270 using transactional data 1195 from either the lower-level database system 150 or the central database 160, a buyer user, vendor user or administrative user accesses the respective server 120 or 125 associated with the database 150 or 160 via the buyer browser 20a, vendor browser 20b or administrative browser 20c, respectively and the data network 40. The buyer module 110 or 140, vendor module 115 or 145 or administrative module 135 or 149 interfaces with the reporting module 126 or 127 to push web pages to the buyer browser 20a, vendor browser 20b or administrative browser 20c, respectively, to assist the buyer user, vendor user or administrative user in generating a request 285 for a specific type of analytical data 270. For example, the analytical data 270 requested can be related to various price and performance factors as a function of the transactional data 1195. The analytical data 270 can be related to a single project, multiple projects, multiple vendors or multiple buyers, the latter being possible with only the central database transactional data 1195. The different permutations and possibilities for the different types of analytical data 270 that can be generated are limited only by the type and amount of transactional data 1195 that is stored. In addition, it should be understood that, although not shown, in other embodiments, a contractor user may be allowed to access various analytical data 270 that the contractor is authorized to view, such as the number of hours worked by the contractor on a project to date, the number of hours worked on all projects within a certain time period, the pay rate for different projects, the average pay rate, etc.

In some embodiments, the request 285 submitted by the user may contain one or more filters 280 to focus the analytical data 270 on specific transactional data 1195. For example, the user may want to receive analytical data 270 related to only those projects completed in a specific geographical area or associated with a specific project type or industry segmentation. The reporting module 126 or 127 uses the filters 280 to access the database 150 or 160 to retrieve filtered transactional data 1198 that contains only that transactional data that meets the requirements of the filters 280. From the filtered transactional data 1198, the reporting module 126 or 127 generates the analytical data 270.

Using the transactional data 1195 or filtered transactional data 1198, the reporting module 126 or 127 generates the analytical data 270 based on the request 285. For example, if the request 285 is for a financial report indicating the projected spending in future months on current projects, the reporting module 126 or 127 can access the transactional data 1195 to retrieve various project tracking parameters related to future requisition amounts of current projects, and aggregate the requisition amounts by month to generate the analytical data 270. As another example, if the request 285 is for a statistical report on the percentage of expenditures on various components of projects (e.g., materials, expenses, deliverables, labor, etc.) with tier 1 vendors, the reporting module 126 or 127 can access the transactional data 1195 to retrieve various bid data (to determine the projects tied to tier 1 vendors), project tracking parameters, voucher information and project performance data and utilize various mathematical and statistical functions to produce the analytical data 270. The reporting module 126 or 127 pushes web pages including reporting views containing the analytical data to the buyer browser 20a, vendor browser 20b or administrative browser 20c.

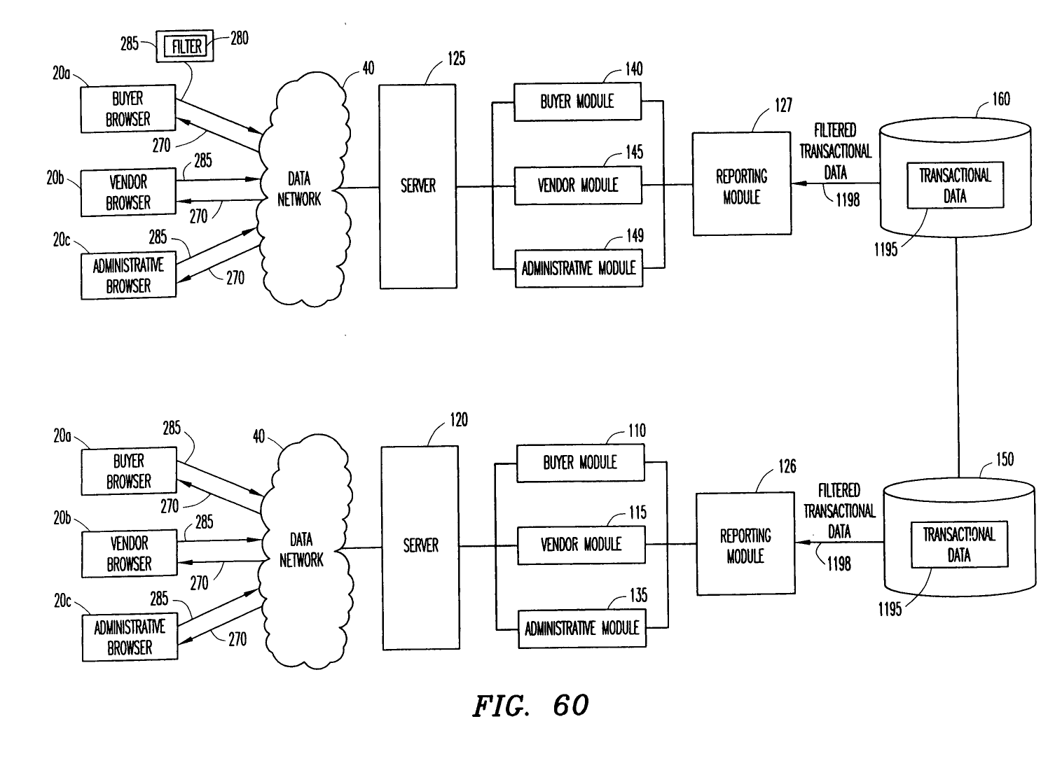

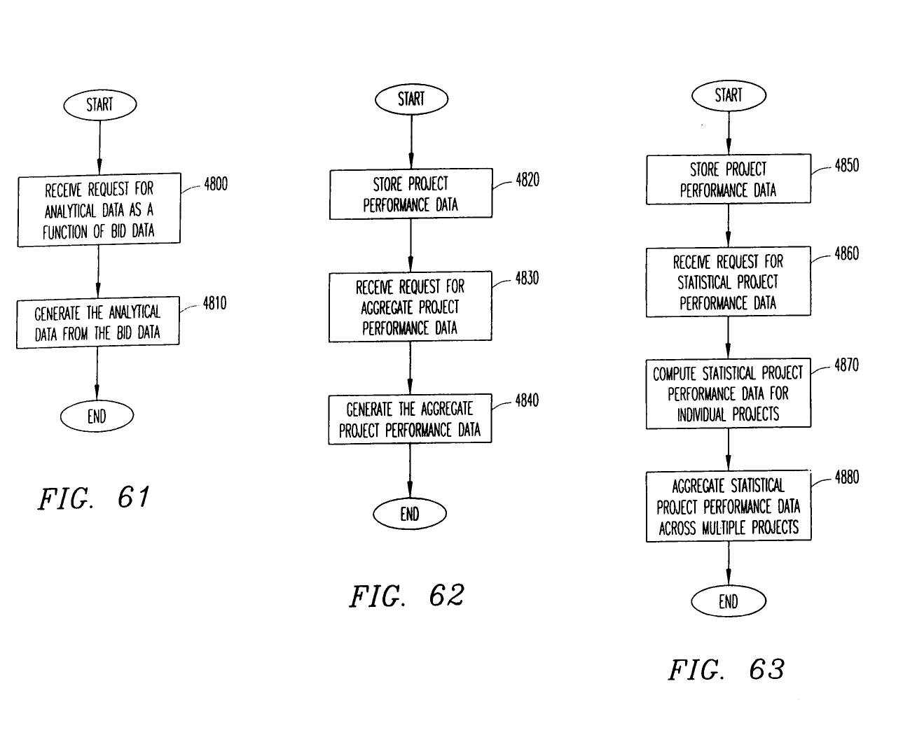

Exemplary processes for generating various types of analytical data 270 using various types of transactional data are shown in FIGS. 61-67. However, it should be understood that the processes shown are merely examples of the numerous processes capable of being performed using the system of the present invention. FIG. 61 is an exemplary flow chart describing a process for generating analytical data as requested by a user of the system. In this process, a request for the analytical data as a function of transactional data including at least the bid data that was collected during the on-line bid process is received (step 4800). The request may be submitted as a search and/or sort request to select particular or general types of bid data as submitted in the bids. In addition, the request may include one or more filters to narrow the amount of bid data within the selected types of bid data that is used in the generation of the analytical data.

Once the requisite transactional data is identified and retrieved, the analytical data is generated from the transactional data (step 4810). In generating the analytical data, various mathematical and statistical functions may be utilized to produce a wide variety of information requested by the user. The analytical data can be generated from bid data related to a single project, multiple projects, multiple vendors or multiple buyers, and it can be presented to the user in a variety of reporting views. For example, exemplary reporting views include summary views, aggregate views, estimation views, statistical views, project performance views or any combination of thereof. The analytical data may be utilized by the user for a variety of purposes, including assessing individual bids, assessing vendor performance, assessing spending or income, assessing inflation within an industry, producing industry trend information, etc.

FIG. 62 is an exemplary flow chart describing a process for generating analytical data including aggregate project performance data across current, past and/or future projects within the system. The project performance data is stored by the system (step 4820), as described above in connection with FIGS. 53-56. In this process, a request for aggregate project performance data is received from an authorized user of the system (step 4830). The request may be submitted as a search and/or sort request to select particular or general types of project performance data as collected by the system. In addition, the request may include one or more filters to narrow the amount of project performance data within the selected types of project performance data that is used in the generation of the analytical data. It should be understood that the request is to collect project performance data from across multiple projects being performed by one or more vendors for one or more buyers so as to aggregate the project performance data.

Once the requisite project performance data is identified and retrieved, the aggregate project performance data is generated (step 4840). In generating the aggregate project performance data, various arithmetic and/or statistical analysis operations may be utilized. For example, the system can compute a variety of information related to projects, such as the percentage of projects that are on-time or under-budget, etc. The aggregate project performance data can be presented to the user in a variety of reporting views. For example, exemplary reporting views include summary views, estimation views or statistical views. The aggregate project performance data may be utilized by the user for a variety of purposes, including assessing the individual performance of a vendor relative to other vendors, assessing past, present or future spending or income, assessing inflation within an industry, producing industry trend information, etc.

FIG. 63 is an exemplary flow chart describing a process for generating analytical data including aggregate statistical project performance data related to individual projects. The project performance data is stored by the system (step 4850), as described above in connection with FIGS. 53-56. In this process, a request for aggregate statistical project performance data is received from an authorized user of the system (step 4860). The request may be submitted as a search and/or sort request to select particular or general types of project performance data as collected by the system. In addition, the request may include one or more filters to narrow the amount of project performance data within the selected types of project performance data that is used in the generation of the analytical data. It should be understood that the request is to collect project performance data from across multiple projects being performed by one or more vendors for one or more buyers so as to calculate statistical data related to the individual projects and aggregate the statistical data.

Once the requisite project performance data is identified and retrieved, statistical project performance data is calculated for individual projects (step 4870) using various arithmetic and/or statistical analysis operations. The statistical analysis can compute a variety of information about a project, such as average monthly cost, average expenditure, percentage of total cost for various components or aspects of the project, etc. Thereafter, the individual statistical data is aggregated to generate aggregate statistical project performance data (step 4880). The aggregate statistical project performance data can be presented to the user in a variety of reporting views. For example, exemplary reporting views include summary views, estimation views, etc. By aggregating the statistical data across multiple projects being performed by vendors, the buyer may get an overall view of the projects being performed to assist in assessing the projects as a whole.

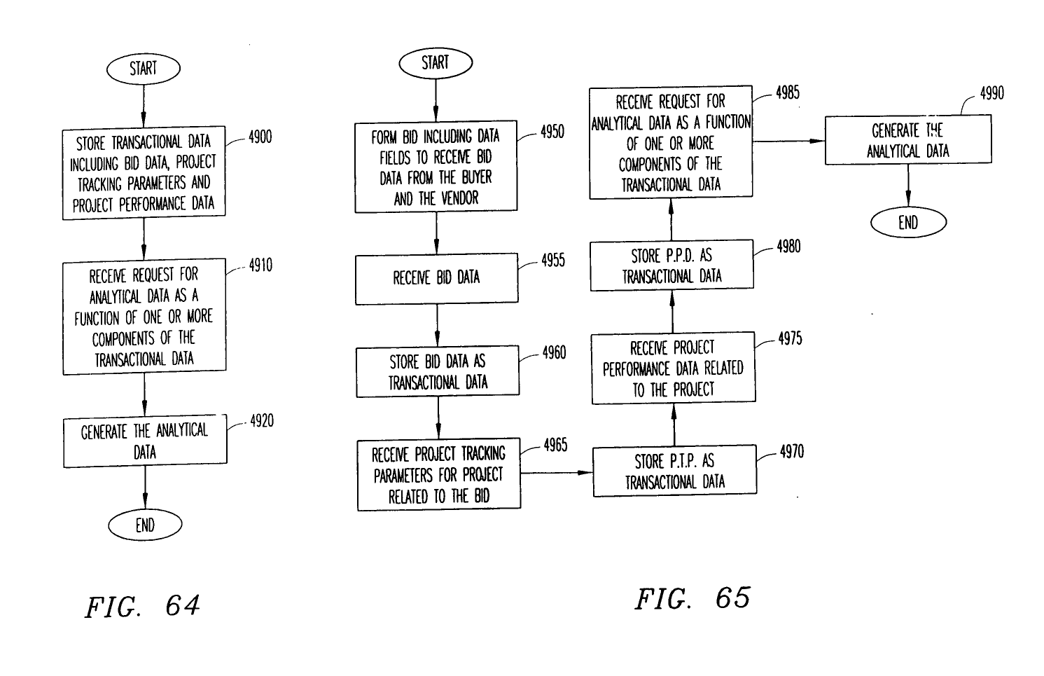

FIG. 64 is an exemplary flow chart describing the generation of analytical data based on transactional data, where the transactional data includes at least bid data, project tracking parameters and project performance data. The transactional data is stored by the system (step 4900), as described above in connection with FIG. 52. In this process, a request for the analytical data is received from an authorized user of the system (step 4910). The request may be submitted as a search and/or sort request to select particular or general types of transactional data as collected by the system. In addition, the request may include one or more filters to narrow the amount of transactional data within the selected types of transactional data that is used in the generation of the analytical data.

Once the requisite transactional data is identified and retrieved, the analytical data is generated from one or more components of the transactional data (e.g., bid data, project tracking parameters and/or project performance data) (step 4920). In generating the analytical data, various mathematical and statistical functions may be utilized to produce a wide variety of information requested by the user. The analytical data can be generated from transactional data related to a single project, multiple projects, multiple vendors or multiple buyers, and it can be presented to the user in a variety of reporting views. For example, exemplary reporting views include summary views, aggregate views, estimation views, statistical views, project performance views or any combination of thereof. The analytical data may be graphically displayed to assist the user in analyzing projects or industry trends.

FIG. 65 is an exemplary flow chart describing a more detailed process of collecting the transactional data and generating analytical data from the transactional data. Initially, a bid is formed by the buyer, where the bid includes data fields to receive bid data from the buyer and vendor (step 4950). For example, the data fields can enable the buyer and vendor to enter bid data related to the price, quantity, and procurement time terms. It should be understood that the data fields included in the bid are associated with the selected bid items, as described above in the Bid Activity section. When the bid data is received by the system from the buyer and vendor (step 4955), the bid data is stored in the system as transactional data (step 4960).

Upon award of the project, the project tracking parameters for the project related to the bid are received (step 4965) and stored as further transactional data (step 4970). During the performance of the project, various project performance data related to the project are received (step 4975) and stored as further transactional data (step 4980). Once the transactional data has been received and stored, a subsequent request for analytical data as a function of the transactional data is received (step 4985). The request may be submitted as a search and/or sort request by the user to select particular or general types of transactional data as collected by the system. In addition, the request may include one or more filters to narrow the amount of transactional data within the selected types of transactional data that is used in the generation of the analytical data.

Once the requisite transactional data is identified and retrieved, the analytical data is generated from one or more components of the transactional data (e.g., bid data, project tracking parameters and/or project performance data) (step 4990). In generating the analytical data, various mathematical and statistical functions may be utilized to produce a wide variety of information requested by the user. The analytical data can be generated from transactional data related to a single project, multiple projects, multiple vendors or multiple buyers, and it can be presented to the user in a variety of reporting views. For example, exemplary reporting views include summary views, aggregate views, estimation views, statistical views, project performance views or any combination of thereof. The analytical data may be graphically displayed to assist the user in analyzing projects or industry trends.

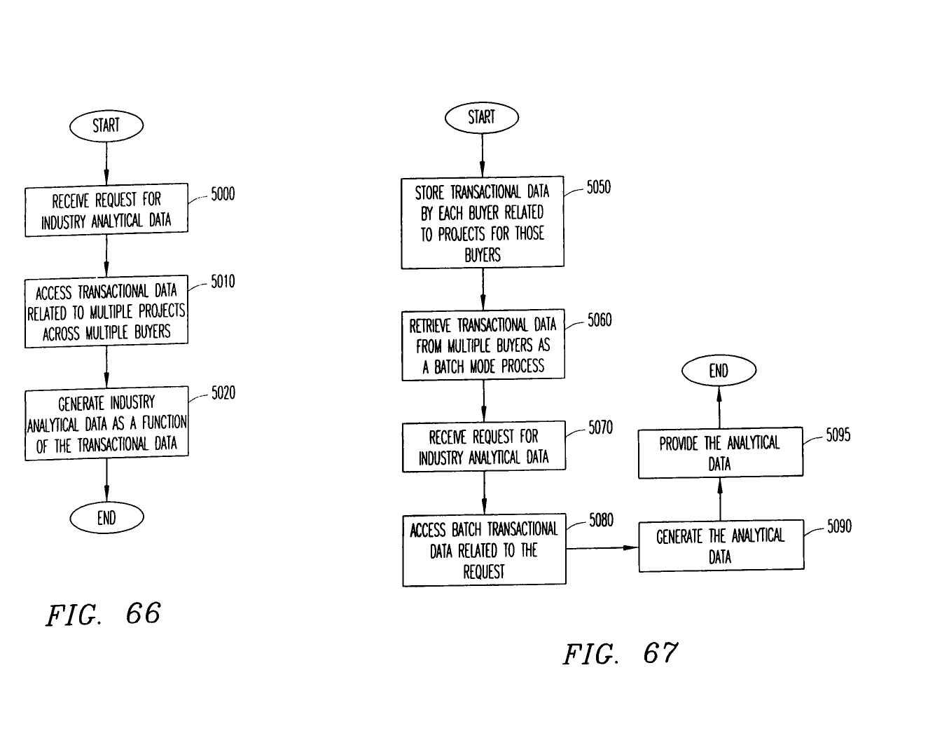

FIG. 66 is an exemplary flow chart describing a process for generating industry analytical data as a function of transactional data produced by projects of one or more buyers. Because the system is capable of managing projects for multiple buyers, industry analytical data may be assessed from the projects being performed across an entire industry. As a matter of course in using the system, the various projects of the buyers who utilize the system can be tracked via the transactional information. By analyzing the transactional data across multiple buyers, industry trends may be developed. For example, in the telecommunications industry, where there may be multiple projects related to the installation of central switches, the average cost, development time, installation time, and failure rates of central switches may be generated utilizing the principles of the present invention.

Initially, the industry analysis process begins when a request for industry analytical data is received by the system (e.g., the administrative server 125 in FIG. 2A) (step 5000). The request may be from the vendors, buyers, or administrator of the system. Based on the request, the transactional data related to multiple projects across multiple buyers is accessed in the central database (step 5010). The request may be submitted as a search and/or sort request by the user to select particular or general types of transactional data as collected by the system. In addition, the request may include one or more filters to narrow the amount of transactional data within the selected types of transactional data that is used in the generation of the analytical data.

Once the requisite transactional data is identified and retrieved, industry analytical data can be generated as a function of the transactional data (step 5020). In generating the industry analytical data, mathematical and/or statistical functions may be utilized to produce a variety of industry analytical data that the user is interested in viewing. The industry analytical data can be presented to the user in a variety of reporting views. For example, exemplary reporting views include summary views, aggregate views, estimation views, statistical views, project performance views or any combination of thereof. The analytical data may be graphically displayed to assist the user in analyzing projects or industry trends.

FIG. 67 is an exemplary flow chart describing a more detailed process for collecting the transactional data via a batch mode process from multiple buyers and generating industry analytical data from the transactional data. Transactional data for individual projects is stored in the lower-level databases associated with the buyers, vendors and administrators related to projects (step 5050). To process requests for industry analytical data, the necessary and authorized transactional data from each of the lower-level databases is retrieved up into the central database as a batch mode process, as described above and as is understood in the art (step 5060). Once the batch transactional data has been received and stored, a subsequent request for industry analytical data as a function of the batch transactional data is received (step 5070). The request may be submitted as a search and/or sort request by the user to select particular or general types of transactional data as collected by the system. In addition, the request may include one or more filters to narrow the amount of transactional data within the selected types of transactional data that is used in the generation of the analytical data.

Based on the request and any filters, the system accesses the batch transactional data to identify and retrieve the particular batch transactional data needed to perform the requested industry analysis (step 5080). Thereafter, the industry analytical data is generated from the identified batch transactional data (step 5090). In generating the industry analytical data, various mathematical and statistical functions may be utilized to produce a wide variety of information requested by the user. The industry analytical data can be presented to the user in a variety of reporting views (step 5095). For example, exemplary reporting views include summary views, aggregate views, estimation views, statistical views, project performance views or any combination of thereof. The industry analytical data may be graphically displayed to assist the user in analyzing projects or industry trends.

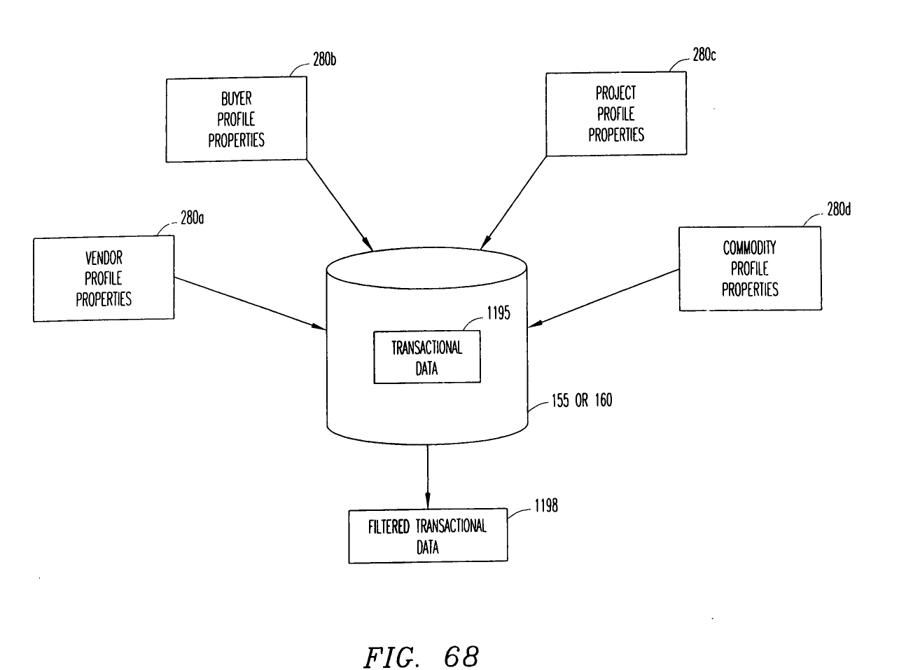

As discussed above, the analytical data request submitted by the user can include one or more filters to tailor the types of transactional data utilized in the analytical process. Referring now to FIG. 68, there is illustrated exemplary types of filters 280 than can be used to access the database 155 or 160 to retrieve filtered transactional data 1198 for analysis and reporting purposes. For example, the filters 280 can include vendor profile properties 280a, buyer profile properties 280b, project profile properties 280c and commodity profile properties 280d. The vendor profile properties 280a include any type of data related to the vendor, such as the vendor tier group, vendor business entity type, vendor qualification data, vendor geographical location, etc. Likewise, the buyer profile properties 280b similarly include any type of data related to the buyer, such as the buyer industry segmentation, buyer size or spend capacity, buyer geographical location, etc. The project profile properties 280c include any type of data related to a project, such as the project type, project management ownership type, business impact type, project geographical location, project sector/family, other project tracking parameters, etc. The commodity profile properties 280d include any type of data related to a commodity (e.g., human resource or materials resource), such as the project sector/family associated with the commodity, resource profiling, activity types, geographical location, etc.

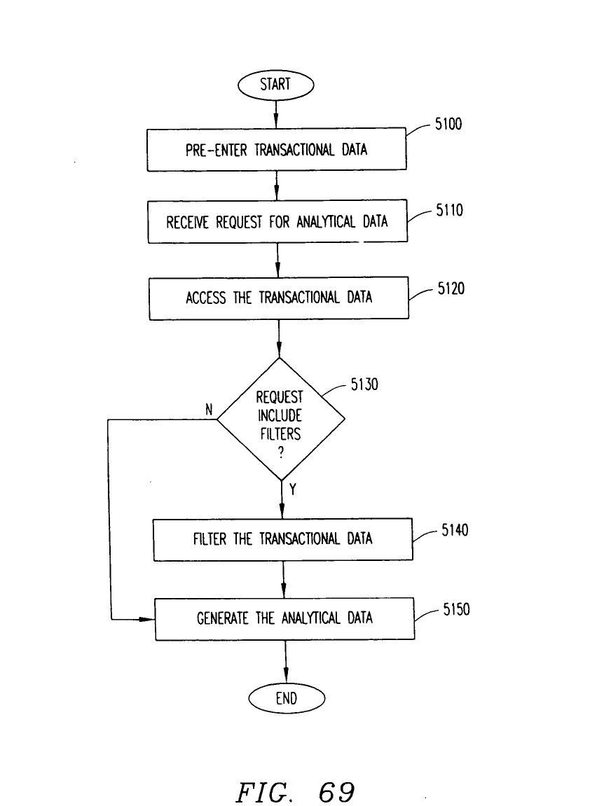

Exemplary steps for retrieving filtered transactional data from the database are shown in FIG. 69. After the transactional data is stored in the database (step 5100), a subsequent request for analytical data as a function of the transactional data can be received (step 5110). Based upon the type of request (e.g., the type of analytical data requested), the system accesses the database to retrieve the types of transactional data necessary for responding to the request (step 5120). If the request included one or more filters (step 5130), the system filters the retrieved transactional data (step 5140) before generating the requested analytical data (5150). The filters serve the function of narrowing the amount of transactional data that is used in the analytical process. For example, if the request is for a financial report summarizing the monthly expenditures on projects for the buyer, the buyer can filter the report to include only the monthly expenditures on projects for a particular vendor or projects of a particular project type.

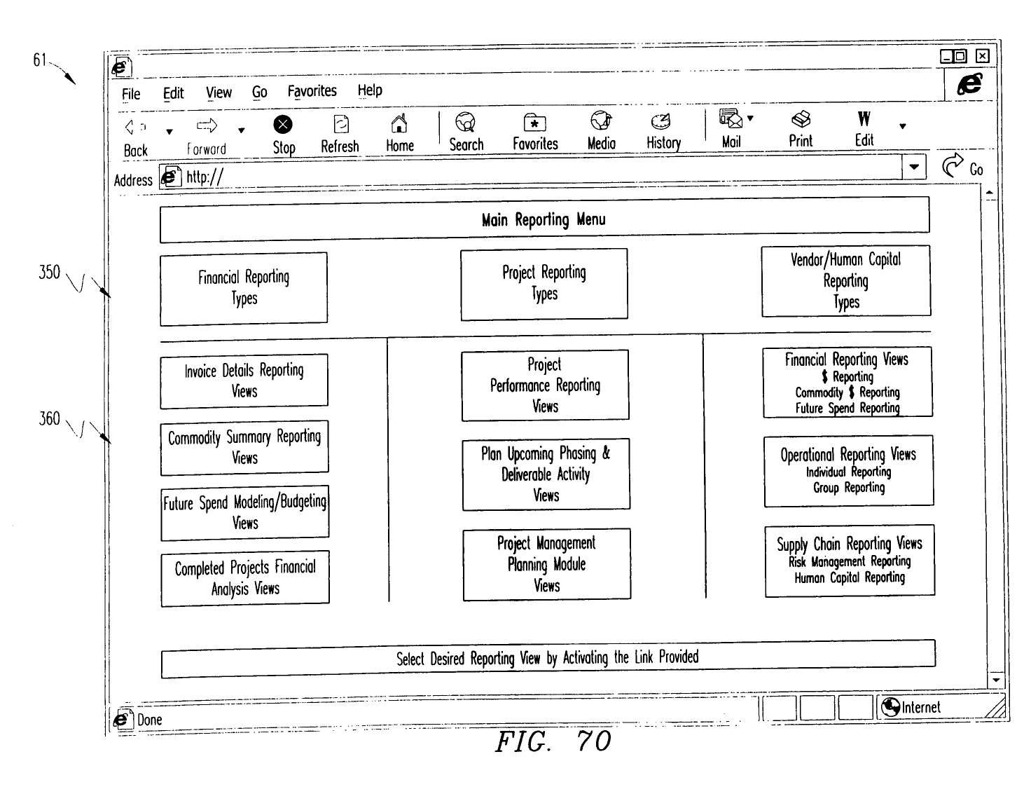

Screen shots of exemplary web pages presenting reporting views containing analytical data are shown in FIGS. 70-88. FIG. 70 is an exemplary depiction of a buyer user Main Reporting Menu web page 61. It should be understood that similar Main Reporting Menus can be provided to vendor users, administrative users and contractor users. The Main Reporting Menu is designed to enable users to manage projects from a variety of perspectives. Therefore, from the Main Reporting Menu, a user can select a reporting type 350, from which a user can select a particular reporting view 360. For example, FIG. 70 illustrates three reporting types 350: financial, project and vendor/human capital. Within each of these reporting types are numerous reporting views 360.

Examples of reporting views 360 within the financial reporting type 350 are invoice details reporting views, commodity summary reporting views, future spend modeling/budgeting reporting views and completed projects financial analysis reporting views. Examples of reporting views 360 within the project reporting type 350 are project performance reporting views, plan upcoming phasing and deliverable activity reporting views and project management planning module reporting views. Examples of reporting views 360 within the vendor/human capital reporting type 350 are financial reporting views, operational reporting views and supply chain reporting views. However, it should be understood that the present invention is not limited to the specific reporting types 350 and reporting views 360 shown in FIG. 70, and the reporting types 350 and reporting views 360 are included in FIG. 70 merely for simplicity and exemplary purposes. The number of different reporting types 350 and reporting views 360 is limited only by the type and amount of transactional data maintained by the system and the requirements of the user.

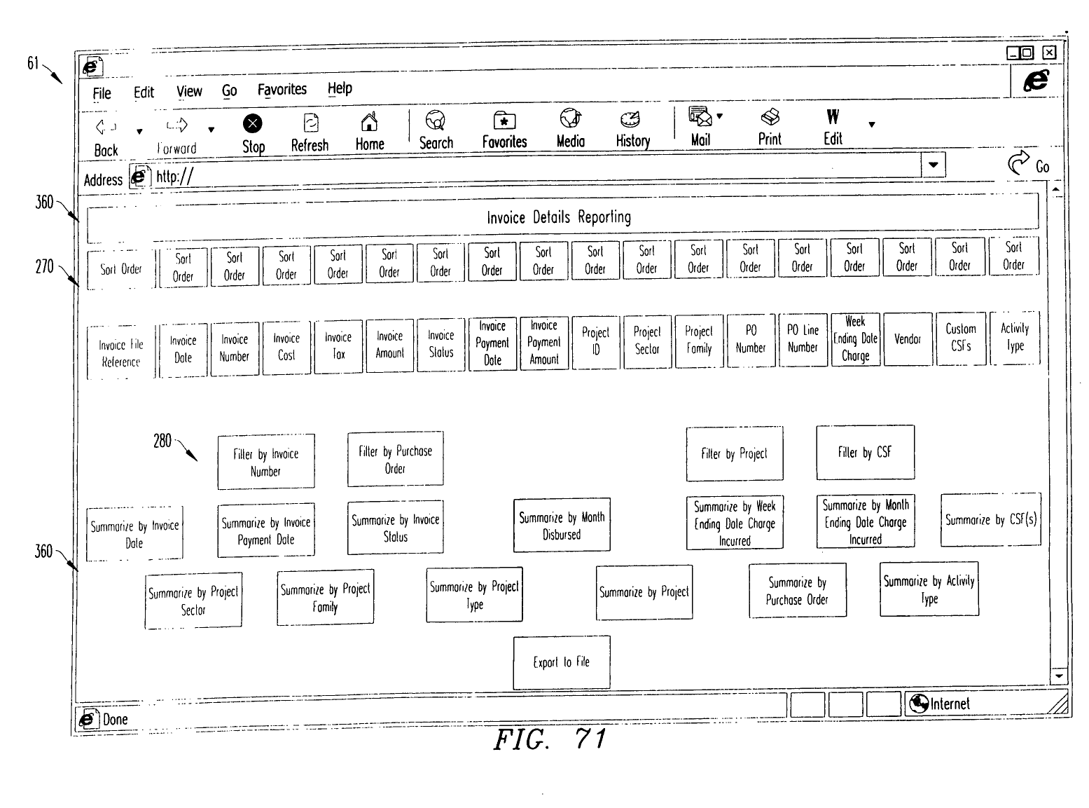

Examples of specific types of reporting views 360 are shown in FIGS. 71-88. For example, FIG. 71 is an exemplary screen shot of a web page 61 presenting an invoice details reporting view 360. Included within the reporting view 360 is analytical data 270 related to particular invoices (or vouchers). The invoice analytical data 270 can be sorted by a number of variables, filtered using a number of different filters 280 and summarized in a number of different reporting views 360. For example, from the invoice details reporting view, the transactional data used to generate the analytical data in the invoice details reporting view can be summarized by project type and displayed on a project type invoice summary reporting view as project type invoice analytical data. The filters 280 and additional reporting views 360 possible for the invoice details reporting view 360 are not limited to those illustrated in FIG. 71, and can be extended to include any customer-specific field (CSF).

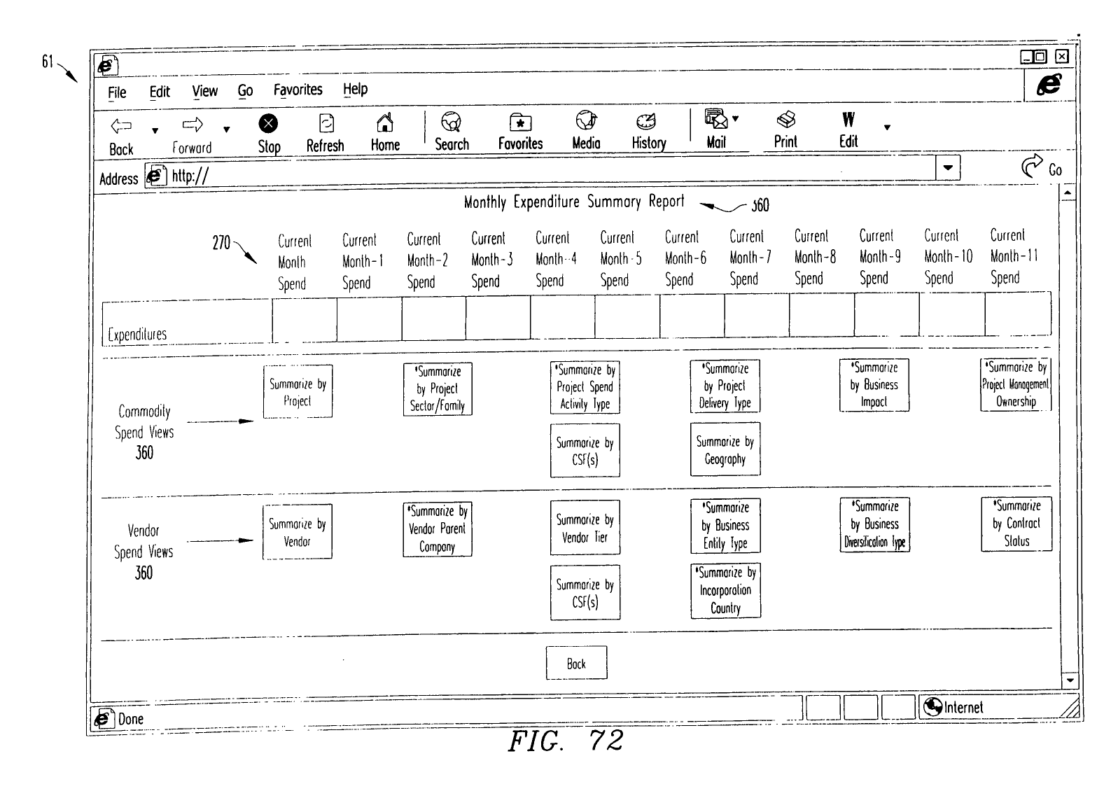

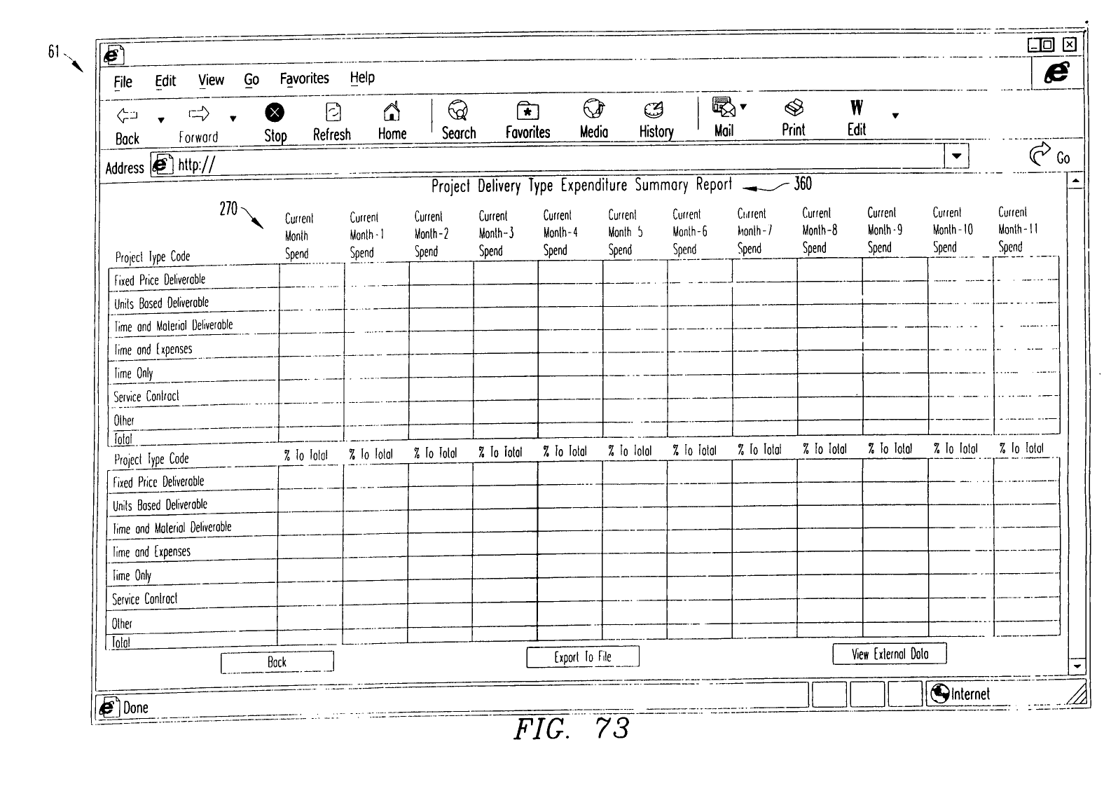

FIG. 72 is an exemplary screen shot of a web page 61 presenting a general monthly expenditure summary reporting view 360 containing analytical data 270 listing the total project expenditures for the current month and preceding months. Numerous additional summary reporting views 360 can be linked to from the general monthly summary reporting view 360. For example, the transactional data forming the analytical data 270 can be summarized by geography, and displayed as a geography expenditure summary reporting view to assist the user in determining the amount of expenditures on projects in different geographical areas. As another example, as shown in FIG. 73 the transactional data forming the analytical data 270 can be summarized by project type and displayed on a web page 61 as a project delivery type expenditure summary reporting view 360 containing analytical data 270 listing the monthly expenditures on different project delivery types. For example, the expenditures can be summarized by fixed price deliverables, unit based deliverables, time and material deliverables, time and expenses, time only, service contract or other project delivery types. In addition, statistical analytical data 270 related to the expenditure transactional data in each project delivery type can be generated to assist the user in identifying the percentage of total expenditures made on each project delivery type for each month. However, it should be understood that numerous other analytical/statistical data can be generated and displayed in numerous other reporting views using the same expenditure transactional data.

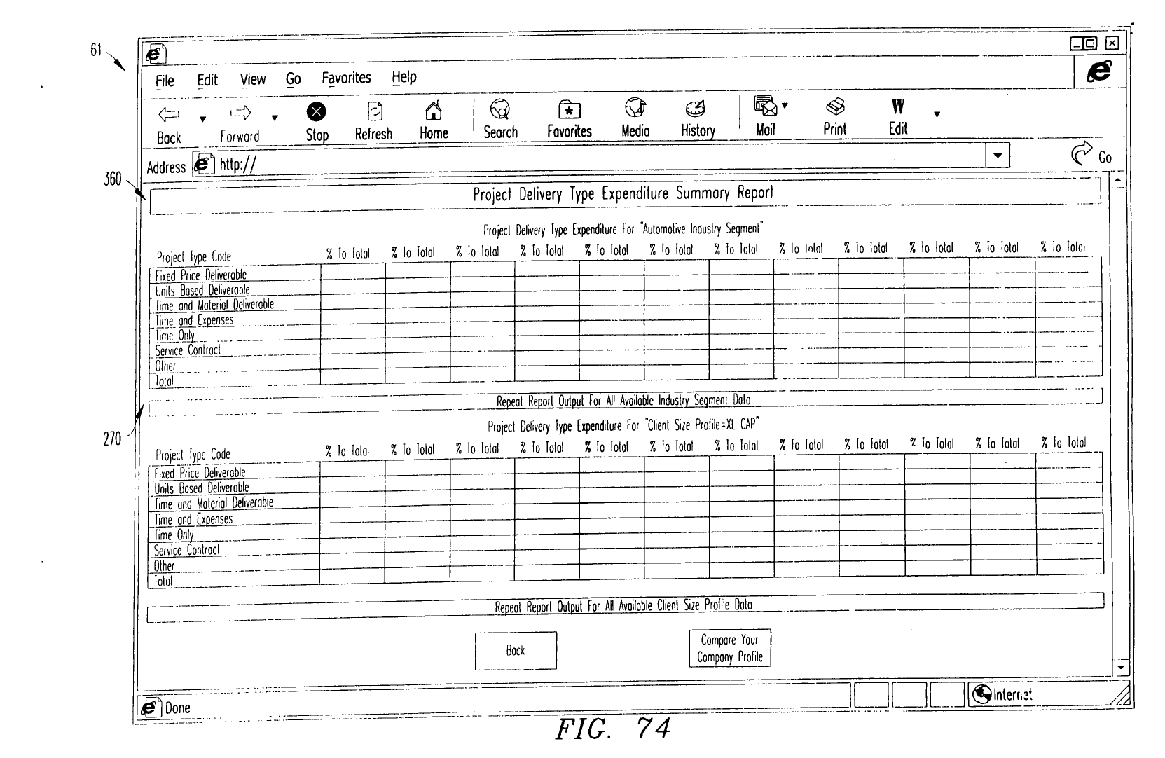

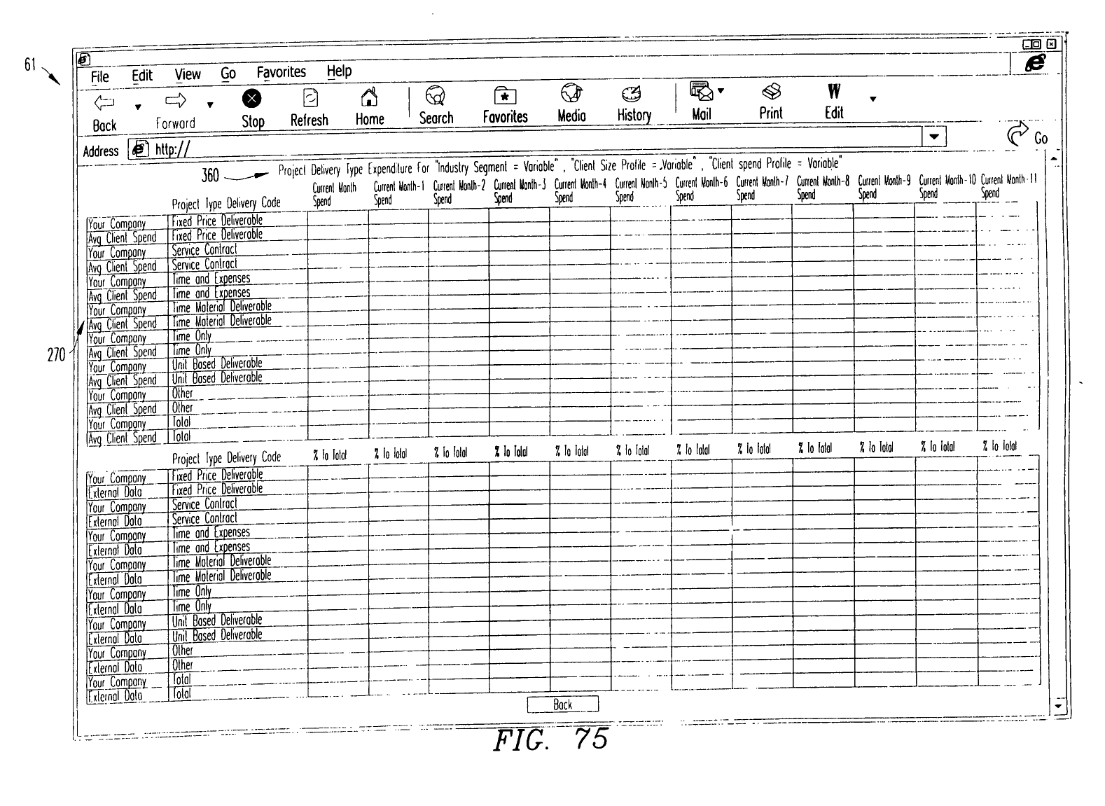

As can be seen on the bottom of the web page shown in FIG. 73, a link can be provided to view external (e.g., top-level database) data related to expenditure transactional data. Therefore, the user is not required to log-on to a different server to access the top-level transactional data. Although, it should be understood that in other embodiments, a separate log-on procedure may be required. If the user clicks on the link to the external data, a summary reporting view 360 of the type shown in FIG. 74 may be presented to the user.

FIG. 74 is a screen shot of an exemplary web page 61 containing industry analytical data 270 presented in an external data project delivery type expenditure summary reporting view 360. Two different examples of industry analytical data 270 are shown in FIG. 74, although only one of which may be displayed at a time, depending on the request and filters entered by the user. At the top of the web page 61, statistical analytical data 270 identifying the percentage of total expenditures made on each project delivery type for each month in the automotive industry segment is shown. In the middle of the web page 61, statistical analytical data 270 identifying the percentage of total expenditures made by extra-large cap buyers on each project delivery type for each month is shown.

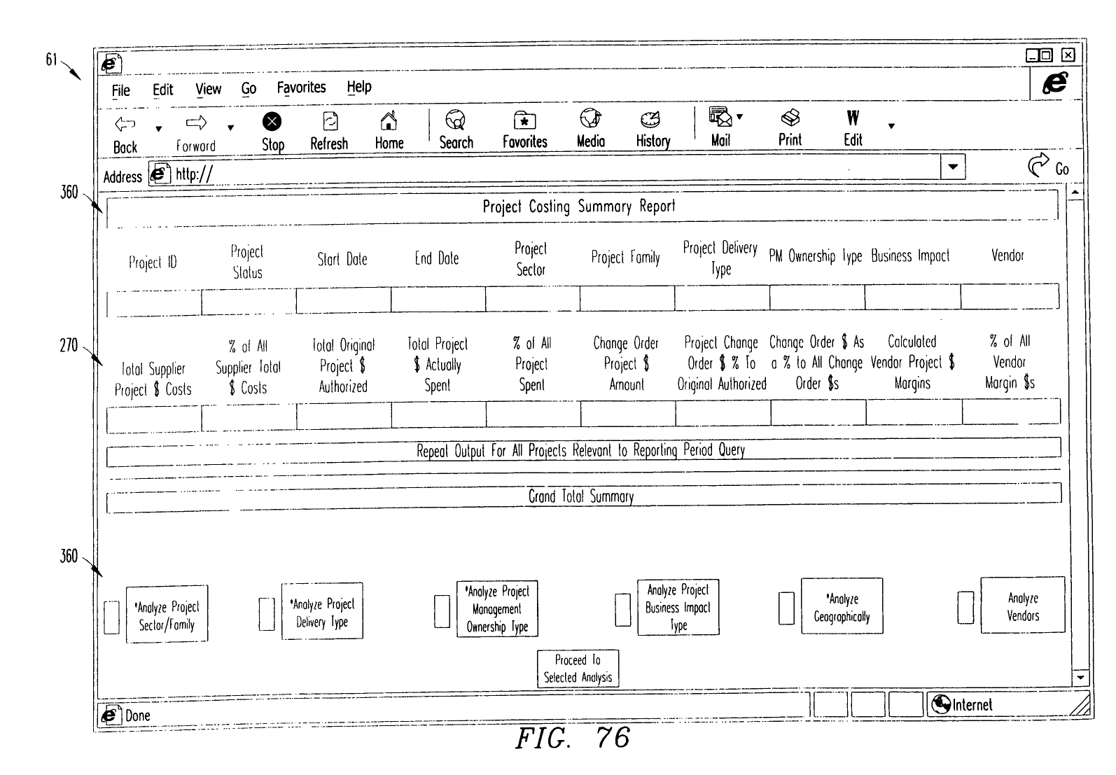

As can be seen in the web page 61 shown in FIG. 74, a link can be provided to a different reporting view that compares the industry analytical data to the user's individual company analytical data. If the user clicks on the link to the external data, a summary reporting view 360 of the type shown in FIG. 75 may be presented to the user. FIG. 75 illustrates a screen shot of an exemplary web page 61 containing a comparison of industry analytical data 270 and individual buyer analytical data 270 presented in a comparison project delivery type expenditure summary report 360. Two different examples of comparison analytical data 270 are shown in FIG. 75, although only one of which may be displayed at a time, depending on the request and filters entered by the user. At the top of the web page 61, analytical data 270 identifying the individual buyer expenditures on each project delivery type on a monthly basis is compared to the average industry expenditure on each project delivery type on a monthly basis. At the bottom of the web page 61, analytical data 270 identifying the percentage of total expenditures made on each project delivery type for each month by the buyer is compared to the percentage of total expenditures made on each project delivery type for each month by the industry.

FIG. 76 is a screen shot of an exemplary web page 61 containing analytical data 270 related to a particular project that is presented in a project costing summary reporting view 360. The analytical data 270 can include the project status, the total project costs to date, the requisition amount (i.e., the amount authorized for the project), the percentage spent on this project in comparison to all projects currently being handled by the buyer, the project margins and other relevant project costing analytical data. At the bottom of the web page 61 are links to different project costing reporting views 360 summarized by different types of transactional data, such as business impact type, geography, vendors, etc.

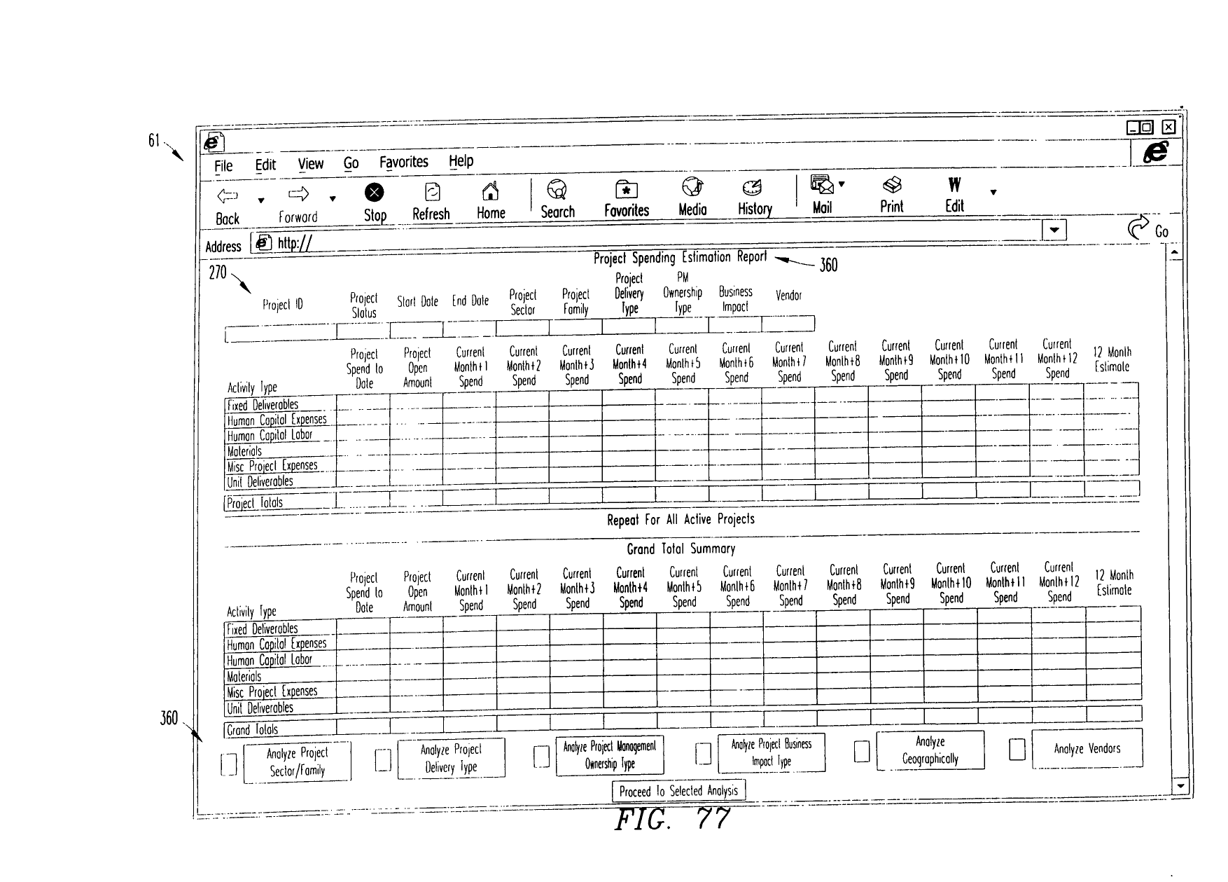

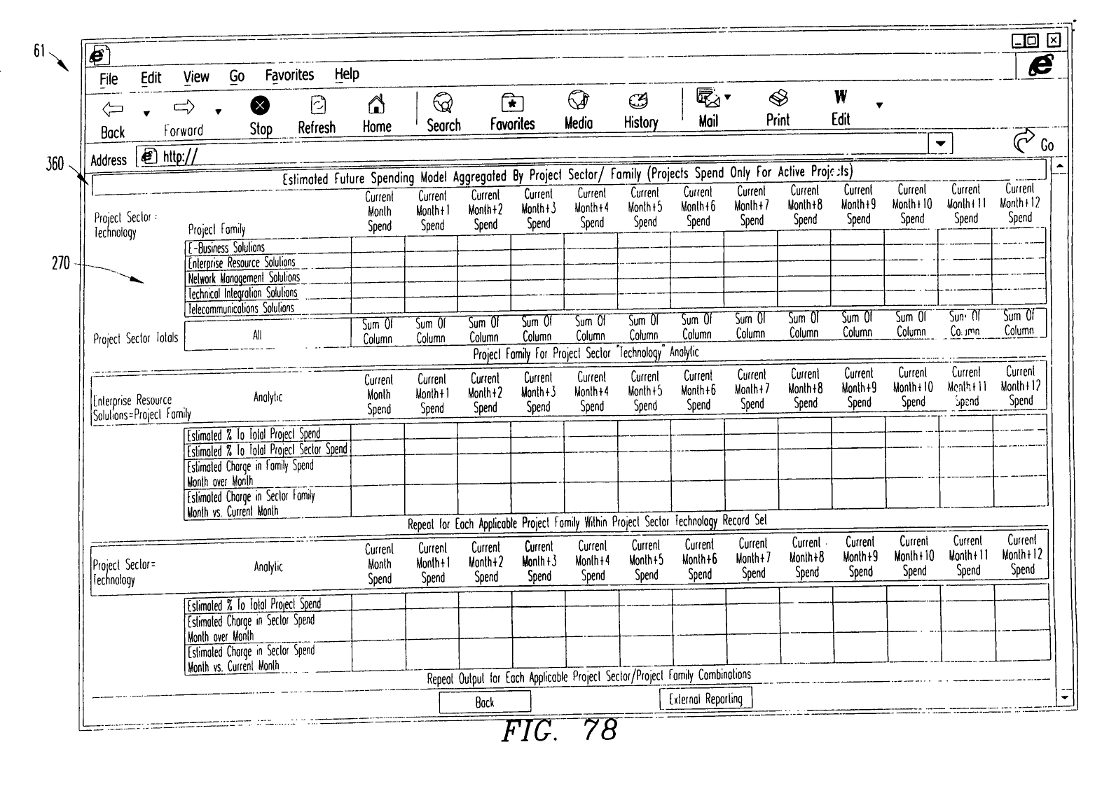

FIG. 77 is a screen shot of an exemplary web page 61 containing analytical data 270 related to estimated future spending for one or more projects that is presented in a project spending estimation reporting view 360. Two different examples of future spending analytical data 270 are shown in FIG. 77, although only one of which may be displayed at a time, depending on the request and filters entered by the user. At the top of the web page 61, analytical data 270 related to estimated future spending on a particular project is shown, while in the middle of the web page, estimate future spending on all projects is shown. At the bottom of the web page 61 are links to different project spending estimation reporting views 360 summarized by different types of transactional data, such as business impact type, geography, vendors, etc.

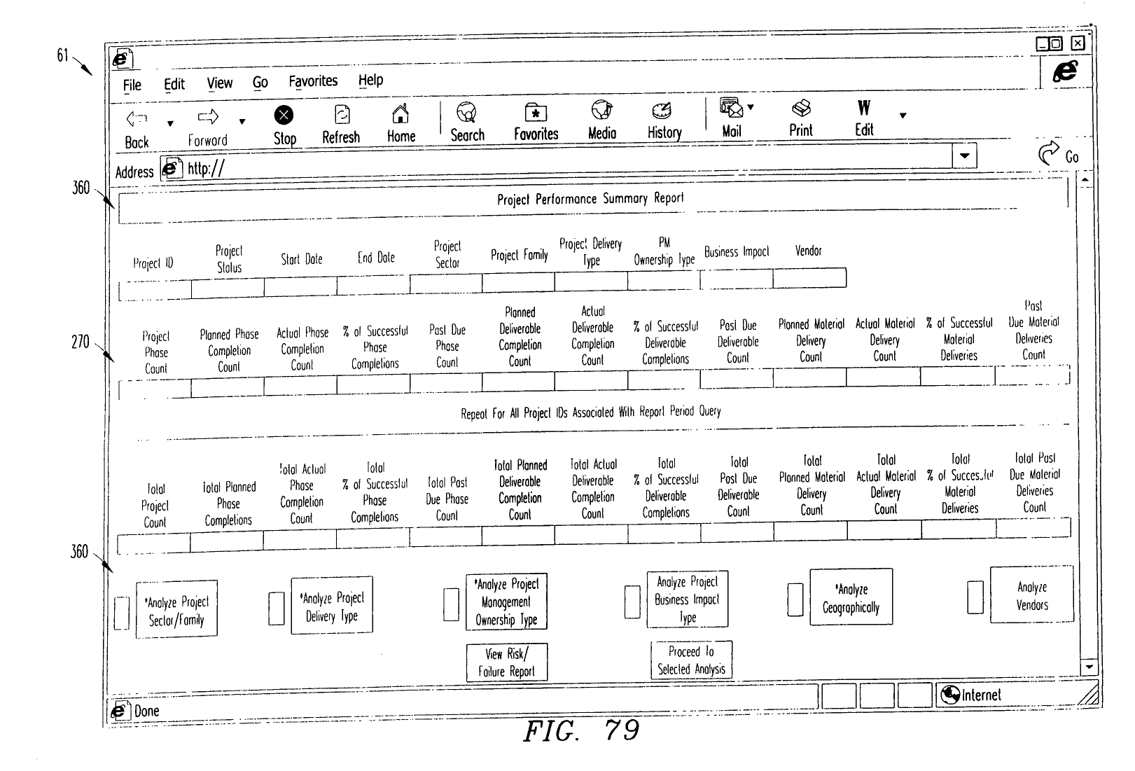

As an example, if a user clicked on the link to summarize the estimated future project spending by project sector and family, a reporting view 360 similar to the one shown in FIG. 78 may be presented on an exemplary web page 61 to the user. The reporting view 360 shown in FIG. 78 is an estimated future spending model aggregated by project sector/family reporting view 360 containing analytical data 270 related to the estimated future spending on projects in different project sector/families. This type of reporting view 360 may be useful to users to ensure that organizational investments are being made in accordance with business plans.

Three different examples of estimated future project sector/family spending are shown in FIG. 78, although only one of which may be displayed at a time, depending on the request and filters entered by the user. At the top of the web page 61, the analytical data 270 contains estimated future spending by month that is aggregated by project sector/family. In the middle of the web page, the analytical data 270 contains statistical data related to the estimated future spending for a particular project family, such as the estimated percentage of the total expenditures that will be made on the particular project family by month. At the bottom of the web page, the analytical data 270 contains statistical data related to the estimated future spending for a particular project sector, such as the estimated percentage of the total expenditures that will be made on the particular project sector by month. As can further be seen at the bottom of the web page 61, a link can be provided to external data to view reports containing external analytical data on projected future spending. Such external data may be useful to provide insight as to how the general market or specific market members are investing or planning to meet their business objectives.

FIG. 79 is a screen shot of an exemplary web page 61 containing analytical data 270 related to project performance data for a particular project that is presented in a project performance summary reporting view 360. The analytical data 270 can include the project status, the project phase completion count, the past due phase count, the deliverable completion count, the past due deliverable completion count, the percentage of on-time deliverable completions, and other project performance analytical data. At the bottom of the web page 61 are links to different project performance reporting views 360 summarized by different types of transactional data, such as business impact type, geography, vendors, etc. Thus, from this web page 61, aggregate and other statistical analytical data summarized by transactional data type can be generated.

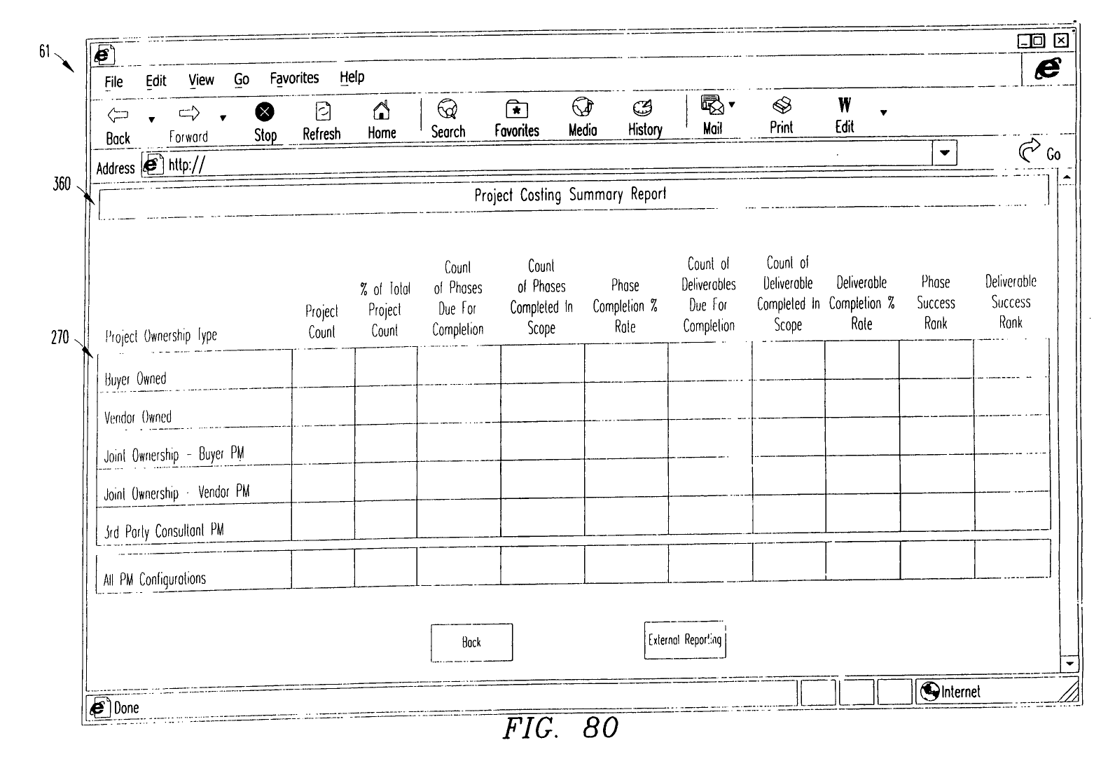

As an example, if a user clicked on the link to summarize the project performance analytical data by project management ownership type, a reporting view 360 similar to the one shown in FIG. 80 may be presented on an exemplary web page 61 to the user. The reporting view 360 shown in FIG. 80 is an operational performance summary for projects managed by different ownership types, such as buyer-owned, vendor-owned, joint ownership, etc., containing analytical data 270 related to the performance of projects having different ownerships. This type of reporting view 360 may be useful to users to understand the relationship between success/failure rates as a function of project management ownership. As can be seen at the bottom of the web page 61, a link can be provided to external data to view reports containing external analytical data on project performance as it relates to project management ownership.

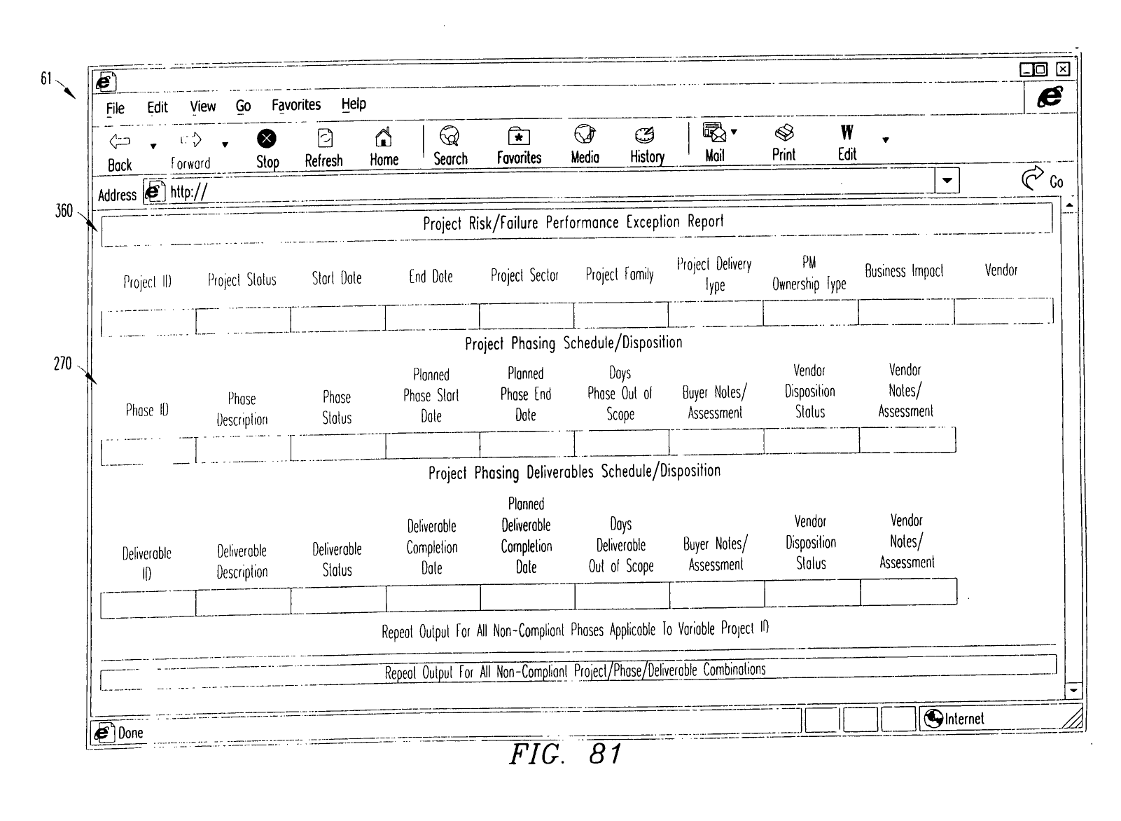

As another example, if a user clicked on the link on the bottom of the web page 61 in FIG. 79 to view a risk/failure report, a reporting view 360 similar to the one shown in FIG. 81 may be presented on an exemplary web page 61 to the user. The reporting view 360 shown in FIG. 81 is a project risk/failure performance exception report containing analytical data 270 related to the performance of at-risk or non-compliant projects having past due dates or other difficulties.

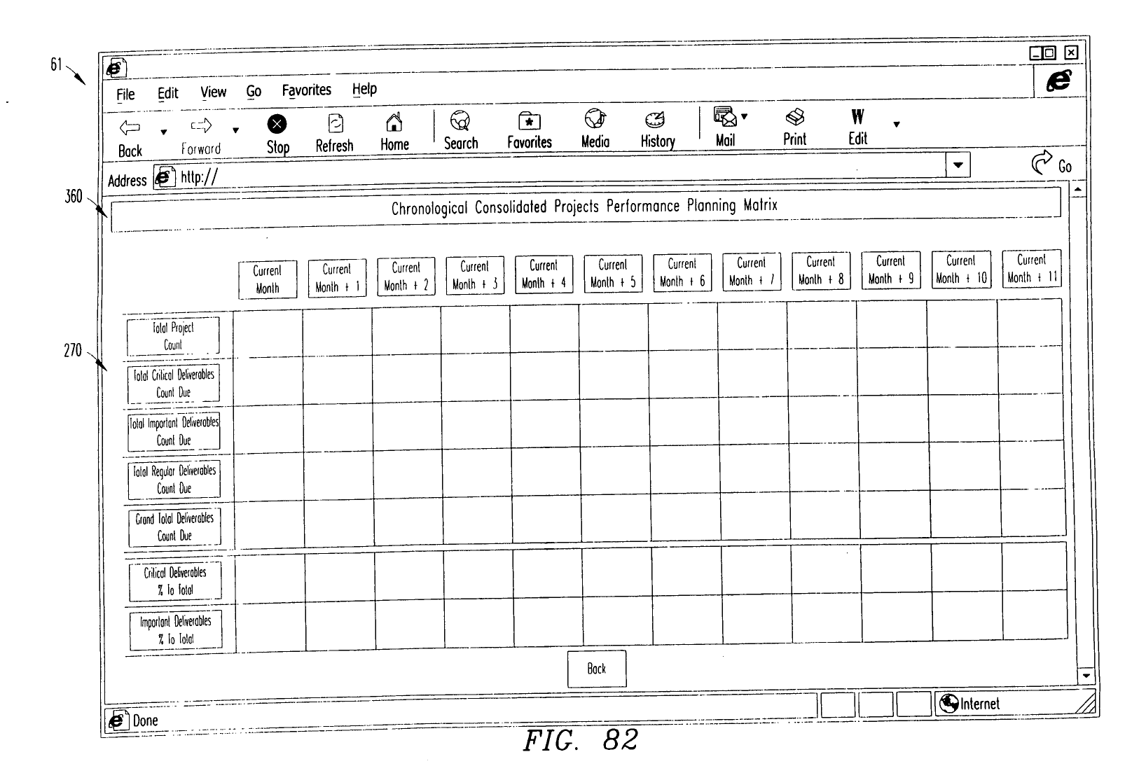

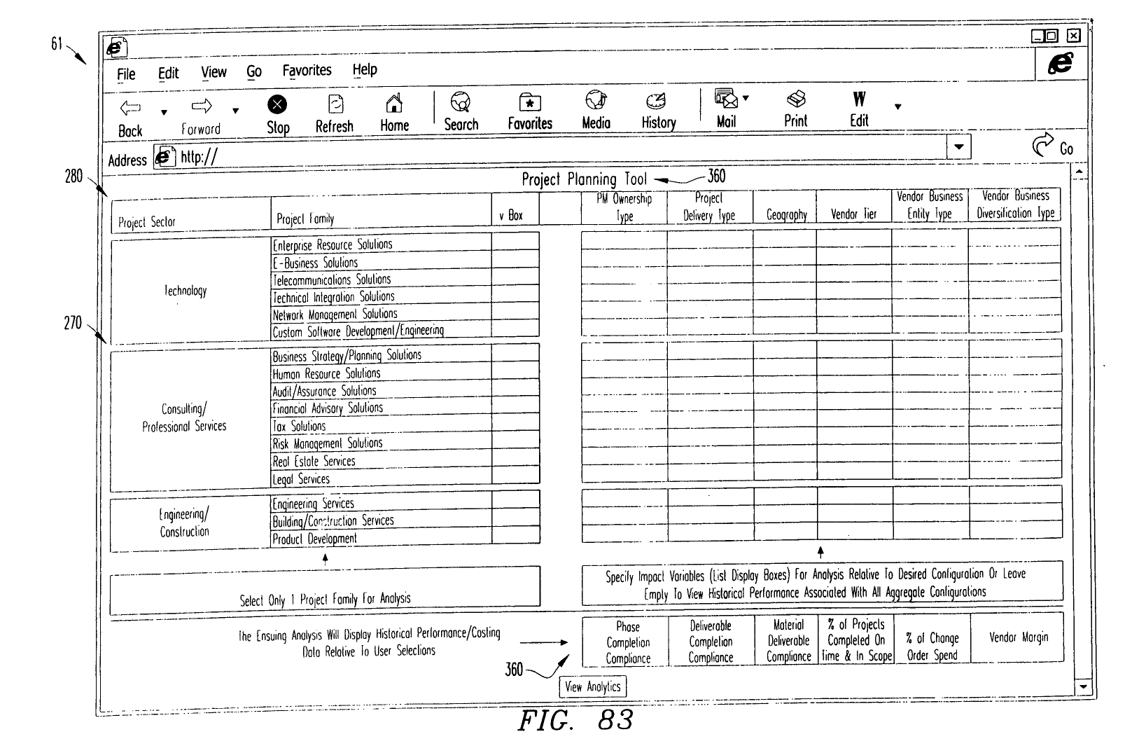

FIG. 82 is a screen shot of an exemplary web page 61 containing analytical data 270 related to project planning that is presented in a planning matrix reporting view 360. The analytical data 270 can include, for example, the total project count for the current month and future months, and other project planning analytical data 270. FIG. 83 is a screen shot of an exemplary web page 61 containing analytical data related to more specific project planning that is presented in a project planning tool reporting view 360. For example, a user can select a particular project sector/family and choose from various impact variables (e.g., filters 280), such as geography, vendor tier, etc., and various project performance reporting views 360 to present a reporting view 360 containing aggregate summary analytical data 270 associated with every combination of the listed impact variables associated with the specific historical project performance data. This type of reporting view 360 may be useful to a user to provide significant insight into which business configurations (variable aggregates) have been successful and which ones have not.

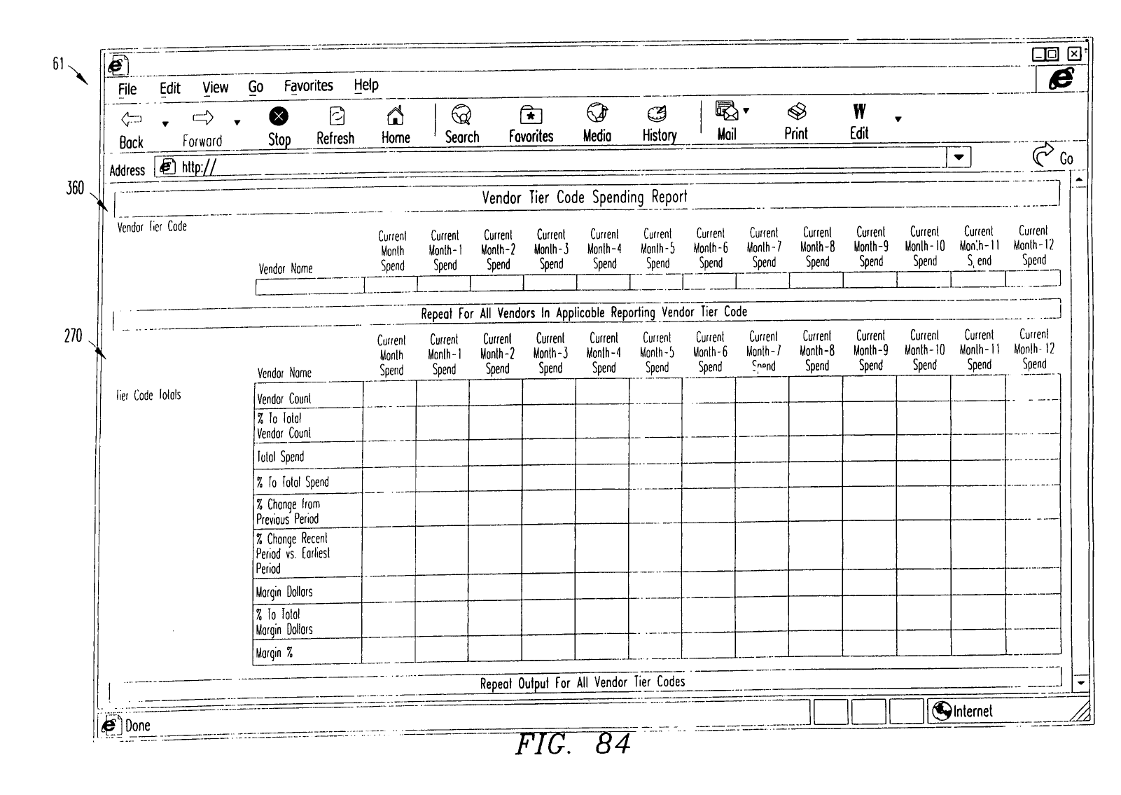

FIG. 84 is a screen shot of an exemplary web page 61 containing analytical data 270 related to spending trends as a function of vendor tiers that is presented in a vendor tier code spending reporting view 360. Two examples of vendor tier spending data are shown in FIG. 84, although only one of which may be displayed at a time, depending on the request and filters entered by the user. At the top of the web page 61, the analytical data 270 includes the amount spent on one or more vendors within a specific vendor tier on a month-by-month basis. At the bottom of the web page 61, the analytical data 270 includes the number of vendors in the vendor tier, the total amount spent with the vendors in the vendor tier on a month-by-month basis and other aggregate or statistical vendor tier spending analytical data 270.

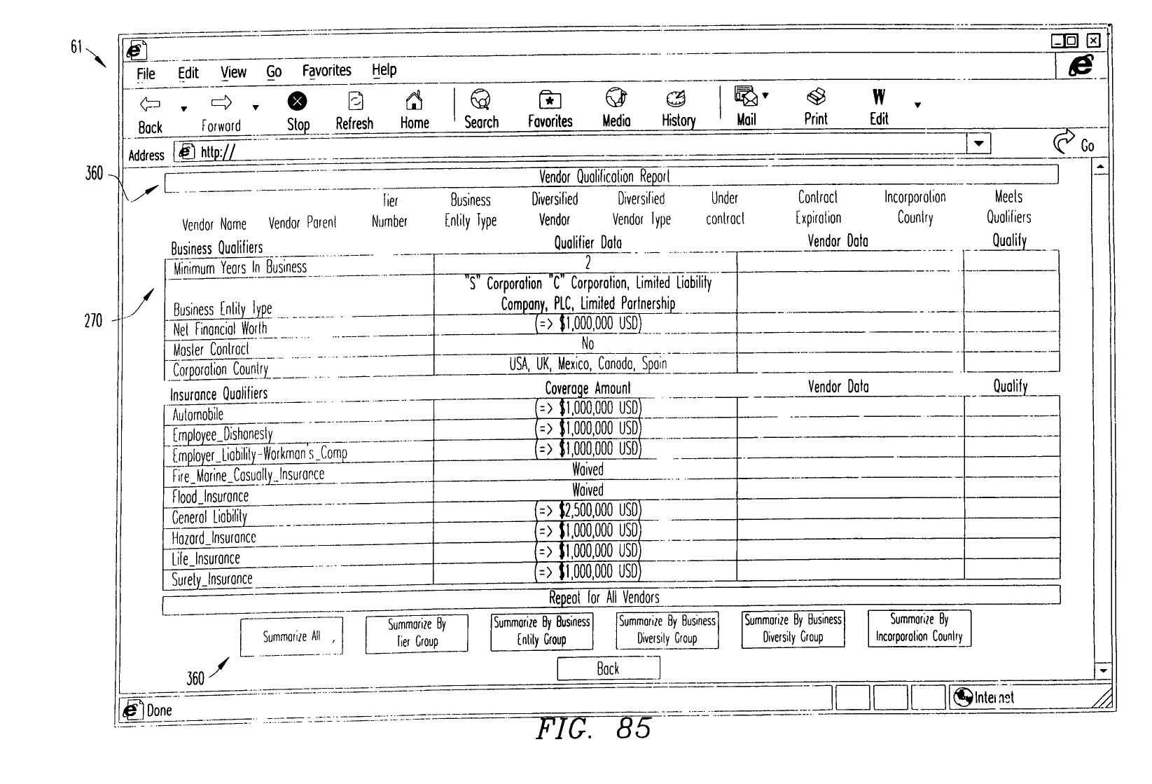

FIG. 85 is a screen shot of an exemplary web page 61 containing analytical data 270 related to vendor qualification information that is presented in a vendor qualification reporting view 360. The analytical data can include, for example, a listing of buyer-defined vendor criteria information, associated vendor qualification information for each vendor and an indication of whether or not the vendor meets each of the buyer-defined vendor qualifiers. At the bottom of the web page 61, there are further links to different summary reporting views 360 to aggregate and/or perform statistical analyses on various vendor qualification data.

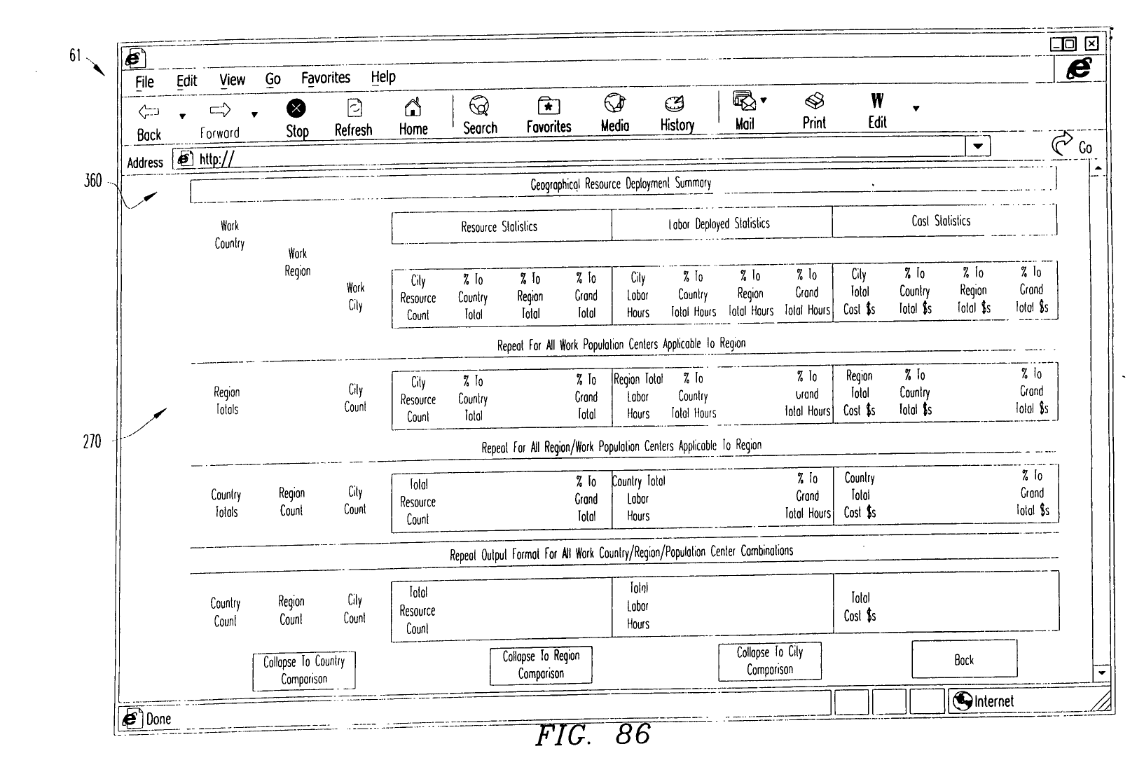

FIG. 86 is a screen shot of an exemplary web page 61 containing analytical data 270 related to deployment of human resources as a function of geography that is presented in a geographical resource deployment reporting view 360. The analytical data 270 can include statistical information, such as the percentage of resources deployed in a specific country, region or city, the percentage of time worked in a specific country, region or city and the percentage of money spent on human resources in a specific country, region or city. The analytical data 270 can further include various aggregate information, such as the total resource count, time and money spent in a specific country, region or city. This type of human resource reporting view 360 may be useful to a user when dealing with issues such as capacity management, pricing, co-employment, re-deployment, etc.

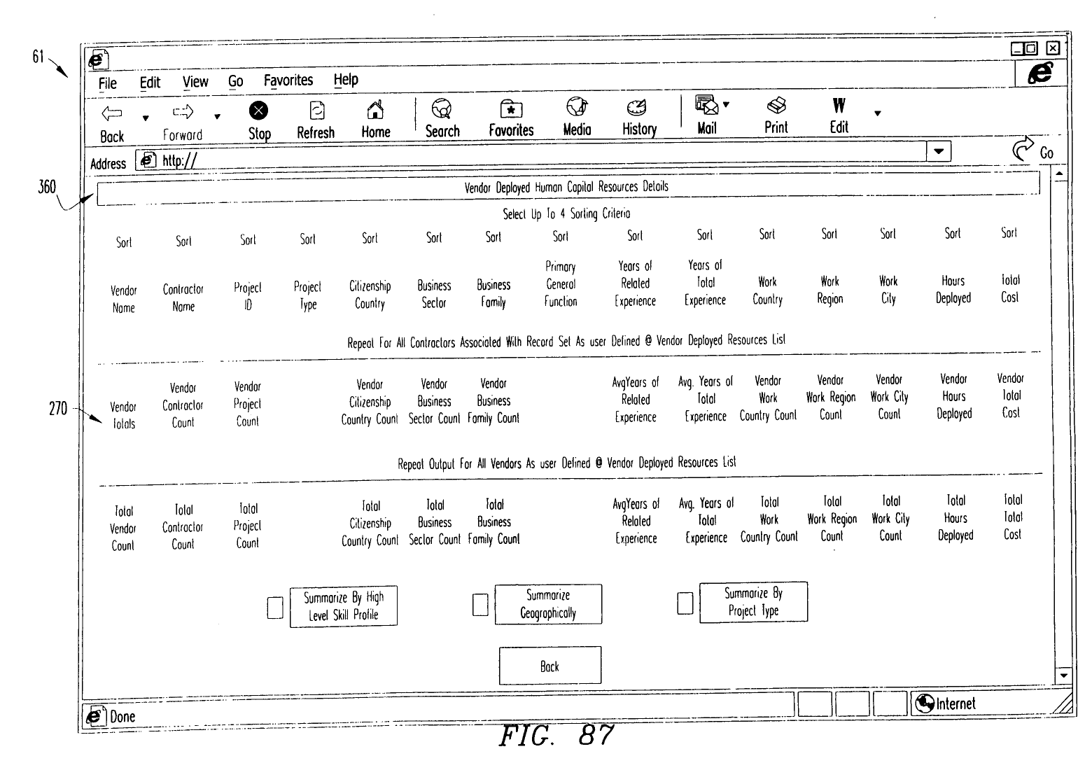

FIG. 87 is a screen shot of an exemplary web page 61 containing analytical data 270 related to human resources that is presented in a vendor deployed human capital resources reporting view 360. Three different examples of human resource data are shown in FIG. 84, although only one of which may be displayed at a time, depending on the request and filters entered by the user. At the top of the web page 61, the analytical data 270 includes individual contractor information as a function of project performance. In the middle of the web page 61, the analytical data 270 includes aggregate and statistical contractor information related to a particular vendor. At the bottom of the web page 61, the analytical data 270 includes aggregate and statistical contractor information related to multiple vendors. At the bottom of the web page 61, there are further links to different summary reporting views 360 to aggregate and/or perform statistical analyses on various contractor data.

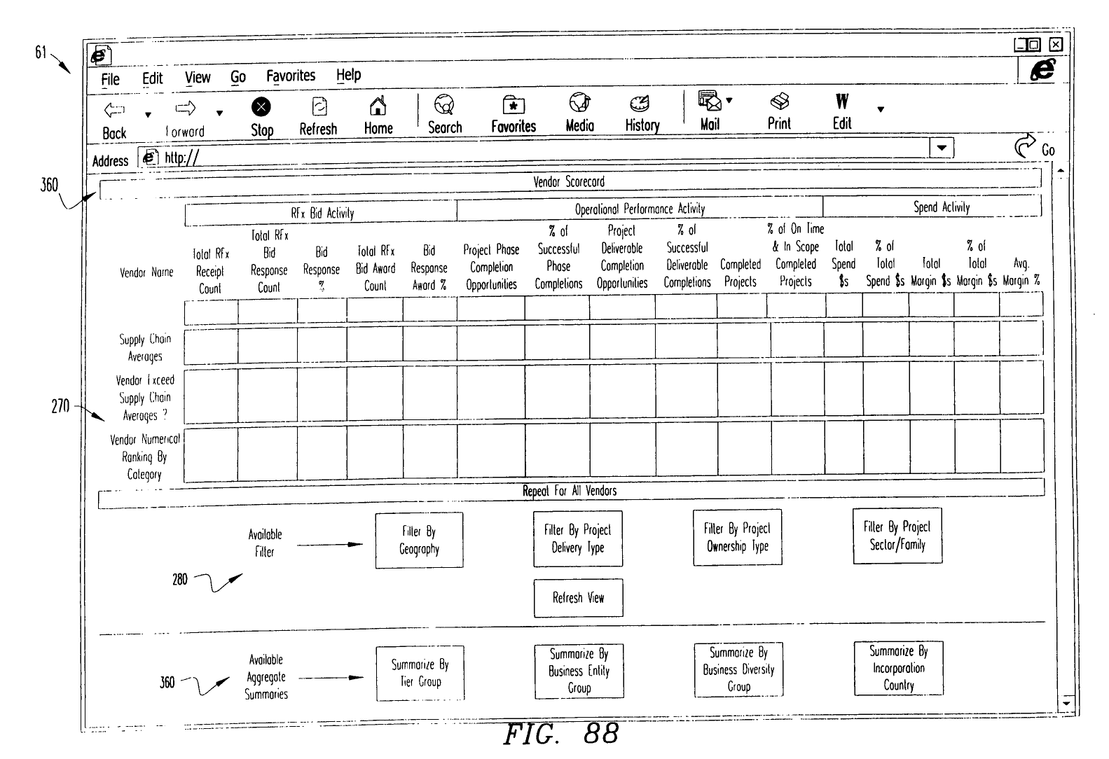

FIG. 88 is a screen shot of an exemplary web page 61 containing analytical data 270 related to vendor performance that is presented in a vendor scorecard reporting view 360. This reporting view 360 includes several filters 280 that can be utilized to focus the view 360 on specific types of transactional data. It should be understood, that although not shown in each reporting view 360 discussed above, various filters would be available to some or all of the reporting views 360. The analytical data 270 can include aggregate and statistical information related to the bid, project performance and spending activity of various vendors. At the bottom of the web page 61, there are further links to different summary reporting views 360 to aggregate and/or perform statistical analyses on various vendor performance data. The above-described reporting views 360 and types of analytical data 270 presented herein are meant to provide only an example of the robustness of the reporting module. It should be readily apparent to one skilled in the art the number and variations of reporting views that are possible with the present invention. In various of the FIGURES below, negative branches extending from process-flow decision blocks have been omitted in order to avoid unnecessary complication of the description of various features and embodiments of the invention. Those having skill in the art will appreciate that the negative branches can be supplied as dictated by design constraints without department from principles of the invention.

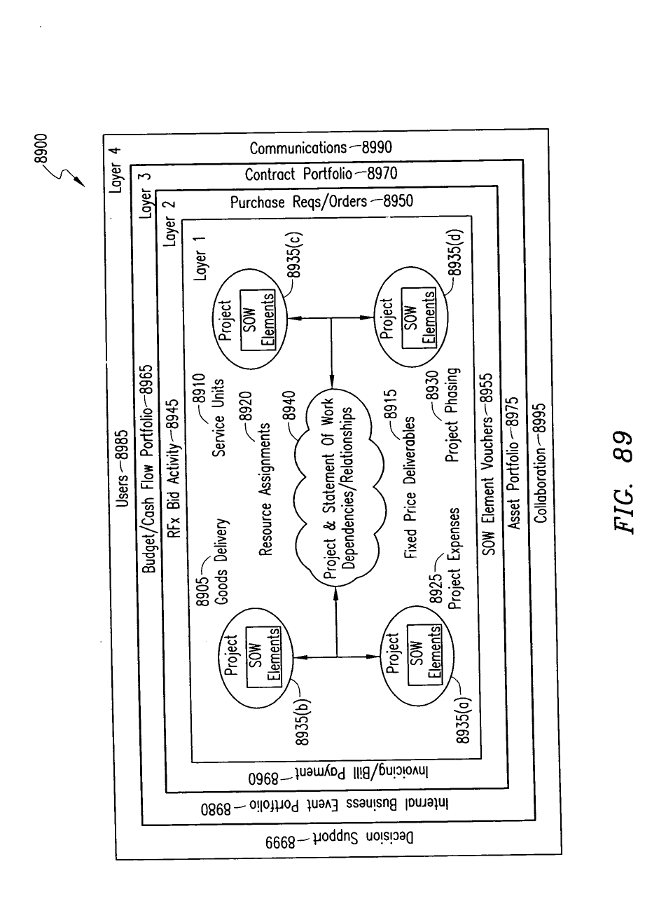

FIG. 89 illustrates an exemplary visual project work environment dynamic 8900 that may be implemented on the system 30. An innermost Layer 1 of the dynamic 8900 shows basic tangible activity elements of project work transactional data associated with a project and represented, for example, by goods delivery, service unit delivery, fixed price deliverables, human resource assignments, (including labor and costs), miscellaneous project expenses, and project phasing. Elements 8905-8930 represent the project work that actually gets done. Activities represented by the elements 8905-8930 do not necessarily represent individual or even aggregate billable activities, but oftentimes do.

The elements 8905-8930 facilitate granular visibility and administrative management of tangible project work activities. The transactional data take the form of special data objects as illustrated in, for example, FIGS. 40A and 41. Special data objects are complex data containers that may house, for example, multiple variable data types, code, database queries, and hierarchical relational data sets. In contrast, simple data objects are, for example, single text field, cost field, or date field objects. These special data objects are used primarily to acquire, store, and process the transactional data.

Also shown within Layer 1 are project statement-of-work (SOW) components represented as elements 8935(a)-(d). In typical embodiments, deliverable and SOW refer to a tangible description of objective project output and are synonymous. However, in some embodiments, this may not be the case, such as, for example, when a sub-contractor does not produce a purchase-order deliverable. Those having skill in the art will appreciate that there need not be exactly four project SOW components, but that the number may be determined by project milestone configuration design constraints. The SOW components 8935(a)-(d) represent a tangible description of objective project output (e.g., a project milestone or SOW/deliverable). Project output may be represented as SOW outputs and does not typically stipulate specifics pertinent to, for example, labor resources or logistics. Thus, one SOW could map to one or more tangible project work elements. Project work activities are typically sub-components of a SOW, where the sub-components could range in number from as few as one or as many as an extremely large number. Component 8940 of the Layer 1 illustrates traditional Project Management (PM) SOW dependencies. SOW outputs are organized in relationships. Sub-components (i.e., the project work activities) are integrated so that a cohesive working environment is established.

Layer 2 illustrates a transactional commerce aspect of the dynamic 8900 represented as components 8945-8960, also referred to as a source-through-pay cycle. An RFx bid template/item system 8945 serves as a support structure for Layer 1. As described above, items go to templates, templates are used to create RFx bids, and RFx bids are broadcasted/posted to suppliers. Suppliers then process the RFx bid responses. Buyers analyze the RFx bid responses and issue awards associated with specific RFx bid response elements. These RFx bid response elements are integrated systematically into a purchase requisition/order environment. As work is completed, these specific purchase order (PO) records are accessed by the supplier to create project activity acknowledgement vouchers, at which time the buyer can review and quality assess the work, ultimately resulting in buyer approval. Finally, approved voucher data can be extracted and used to generate invoicing data that results in payment to the supplier.

Special transactional data objects (e.g., RFx bid data objects as in Table 26) can also be used outside of a bid process. For example, in some instances, a buyer may not have the time or desire to initiate a competitive bidding process. In such cases, the buyer can start, for example, at the purchase requisition leg 560 of the process 500.

Layer 3 illustrates the rest of the dynamic 8900 that is directly impacted by the project work transactional commerce aspect. Although an administrative management portfolio group as illustrated includes budgeting/cash flow 8965, contracts 8970, assets 8975, and internal business events 8980, there could easily be many others, such as, for example, a manufacturing or an internal human resource function element. The portfolios of the Layer 3 could vary greatly depending, for example, upon what industry a business entity exists in or where its business is conducted. For exemplary purposes, those portfolios have been selected that would typically impact any buyer entity conducting project work.

Oftentimes there are many business events that are impacted by a project but do not actually belong within the project scope. For instance, a specific project might entail installation of computer equipment and software at a particular business location. Directly impacted by this activity, though not part of the project work per se, may be a business entity's help desk department. Thus, a distinct business event termed help desk personnel training is a related business event. Layer 3 represents a behind-the-scenes aspect of project work within a business entity.

The next and outermost environment of the visual dynamic is Layer 4, which includes components 8985-8999. Users 8985, communications 8990, collaboration 8995, and decision support 8999 represent the people or soft aspect of the dynamic 8900.

Project work is often a complex endeavor. Project work activities must be integrated with a commerce environment (i.e., source-through-pay data processing system) as illustrated in, for example, FIG. 8, which environment often in turn directly impacts higher-level business administrative endeavors such as, for example, budgeting, cash flow, contract management, asset/capital management, and a host of other related business activities/events. Surrounding all of these variables is the need to connect users and communications together in a secure and managed collaborative environment so that data can be processed in an organized fashion, produce desired outputs, and provide sound decision support to further fuel overall business endeavors. Therefore, the dynamic 8900 can be extremely complex in typical implementations.

FIG. 89 displays the intricate web that exists between the illustrated dynamic elements. For example, if a goods delivery were to fail, a specific SOW may be delayed or cancelled. This failure may result in the need to modify a purchase order, which may change budgets and cash flow positions. There is the possibility that a fixed asset repository will be changed, which will likely impact service and or maintenance contracts, which may result in the need to modify physical plant configurations and ultimately result in the need to revisit a dozen or so other related projects that are impacted.

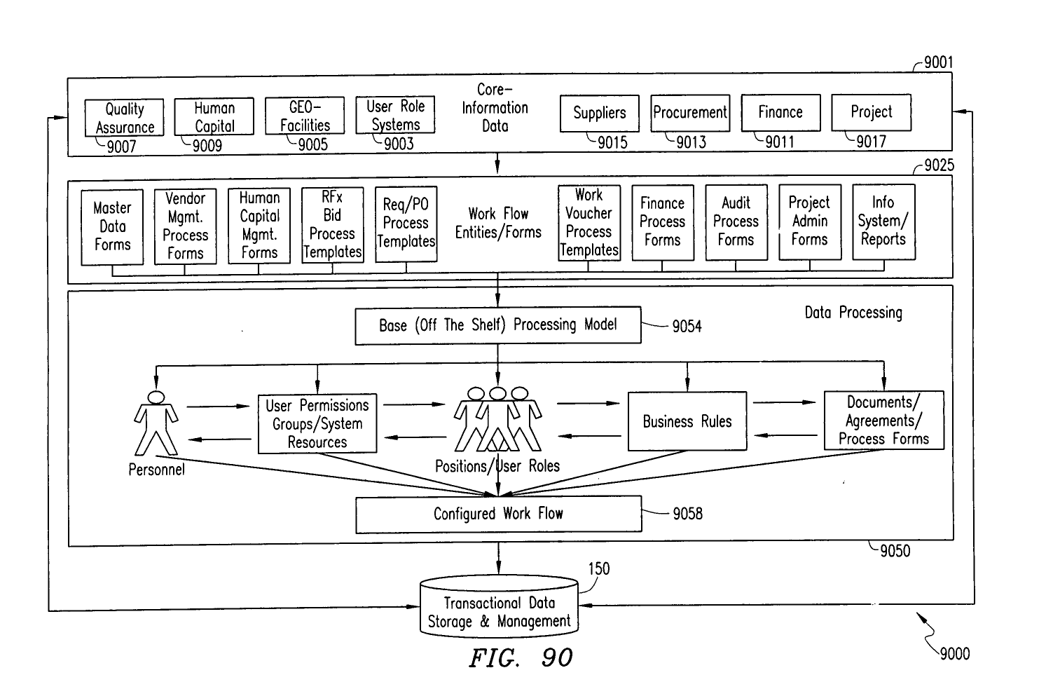

FIG. 90 is a block diagram illustrating a high-level view of a business data processing environment that may be used to implement the dynamic 8900. A data processing environment 9000 includes four high-level components segmented as a core-information data component 9001, a work flow entities component 9025, a data processing component 9050, and a database component 150. The database component 150 is where processed data is stored and retrieved. The core-information data component 9001 has structures and attributes that physically reside in the database component 150; however, they are displayed separately in order to point out the differences between managing data and transactional data.

From a high-level perspective, the business data processing environment 9000 can be explained as including of users, information, processing containers/forms, work flow paths and data storage components. The core-information data component 9001 represents information that not only defines the infrastructure of the enterprise (e.g., industry, products or services offered, etc. . . . ) but also the boundaries of enterprise endeavors within the scope of a commerce management solution (i.e., how the enterprise may interact with the solution in the context of project work) such as, for example, as illustrated in FIG. 5. This information is thus considered managing data (i.e., data that is not limited to a particular project, but is instead descriptive of the enterprise and its processes independently of a particular project) as opposed to transactional data. The core-information data component 9001 also defines the boundaries of the environment 9000.

The core-information data component 9001 includes the following eight exemplary systems:

1) A user role system 9003, which is an application module by which personnel/users identities and attributes are stored and managed. Configuration aspects of this module facilitate user interactivity with the environment 9000 from basic login permission to work flow data-processing actions.

2) A geo-facilities system 9005, which is an application module defining geographic scope and construct of a buyer entity and how physical plant facilities relate to that construct. Configurations define a geographic scope to be either domestic or international, for instance, or whether a buyer entity utilizes a custom regional segmentation schema utilizes mail/zip codes for business processing. In addition to the basic geographic construct, physical plant sites could be integrated into the geo-facilities system 9005, with attributes applicable to the physical plants defined. Attribute information regarding, for example, facility activities, safety regulations, occupation constraints, delivery access, could also be maintained in the geo-facilities system 9005.

3) A quality assurance system 9007, which is an application module by which business process and functions may be defined as critical to the buyer entity. Additionally, corresponding measurement attributes applicable to the business process and functions may be defined.

4) A human capital system 9009, which is an application module defining buyer-entity views and managing data pertinent to non-employee workers. Within this module, a buyer entity may define and configure attributes for one or more of the following: worker types, worker qualifiers, worker agreements, worker tenure, worker on-boarding requirements, worker off-boarding requirements, worker labor types, worker expense types, worker location rules, worker audit rules, and worker waivers.

5) A financial management system 9011, which is a financial application module by which a buyer entity can manage various facets of spend management and financial data processing endeavors. Typical information components may include, but are not necessarily limited to: designation and attribute definition of money spending types, designation and attribute definition of money currency types, designation and attribute definition of payment terms, designation and attribute definition of discount terms, designation and attribute definition of rebate terms, designation and attribute definition of accrual computation, designation and attribute definition of tax classes, designation and attribute definition of taxation exception, and designation and attribute definition of financial transaction approval schema.

6) A procurement management system 9013, which is a procurement application module by which a buyer entity can manage various facets of procurement and commerce transactional data processing endeavors. Within this module reside the information and configurations for one or more of the following: commodity system, RFx bid system, purchase requisition/order system and voucher (i.e., work acknowledgement processing) system as in, for example FIG. 40C.

7) A supplier management system 9015, which is a supplier application module by which a buyer entity can manage various facets of supplier management relative to their commerce environment. Various business aspects of supplier management, from specific liability protection through strategic supplier spend management, can be achieved within configuration elements of the supplier management system 9015 if the necessary business information to do so is available. Typical configuration elements may include, but are not necessarily limited to: designation and attribute definition of supplier types, designation and attribute definition of supplier business qualifiers, designation and attribute definition of supplier insurance qualifiers, designation and attribute definition of supplier tiers, designation and attribute definition of supplier agreements, designation and attribute definition of supplier business audits, designation and attribute definition of supplier business qualification waivers and of course specification of supplier provision capacity in relation to buyer-utilized commodities.

8) A project administration system 9017 is an application module by which a buyer entity can manage the facets of project administration.

The work flow entities component 9025 represents information containers (e.g., forms or web pages) that are utilized to process transactional information within the environment 9000. Work flow entities are essentially an expression of the available data environment (e.g., the core-information data components 9001) that are used to display or acquire information.

The data processing component 9050 represents a primary work flow component of the environment 9000, while the components 9001 and 9025 actually define data and data processing forms used in the business data processing environment 9000. The data process component 9050 is where the data processing forms are configured to move along their respective data-processing paths.

As is the case with the core-information data components 9001 and the work flow entities component 9025, the data processing component 9050 includes a base set of pre-configured work flow paths 9054 used to populate work flow forms that travel along work-flow paths to pre-defined user roles premised, for example, upon specific condition or status codes. Variably-configured work flow processing 9058 represents customized buyer-entity-planned work flow processes. The configured work flow processing 9058 uses, inter alia, the buyer user role positions of the user role system 9003, the buyer work flow entities component 9025, and buyer business rules (e.g., data value and condition attributes) to configure precise work flow data processing to meet business needs.

The database component 150 represents a database storage aspect of the environment 9000 in which transactional data acquired during the operation of the data processing component 9050 is stored and maintained. The database component 150 is shown at the end of the environment 9000 flow so as to emphasize transactional data acquisition and storage. However, the database component 150 is operational at all times throughout all four of the components 9001, 9025, 9050, and 150.

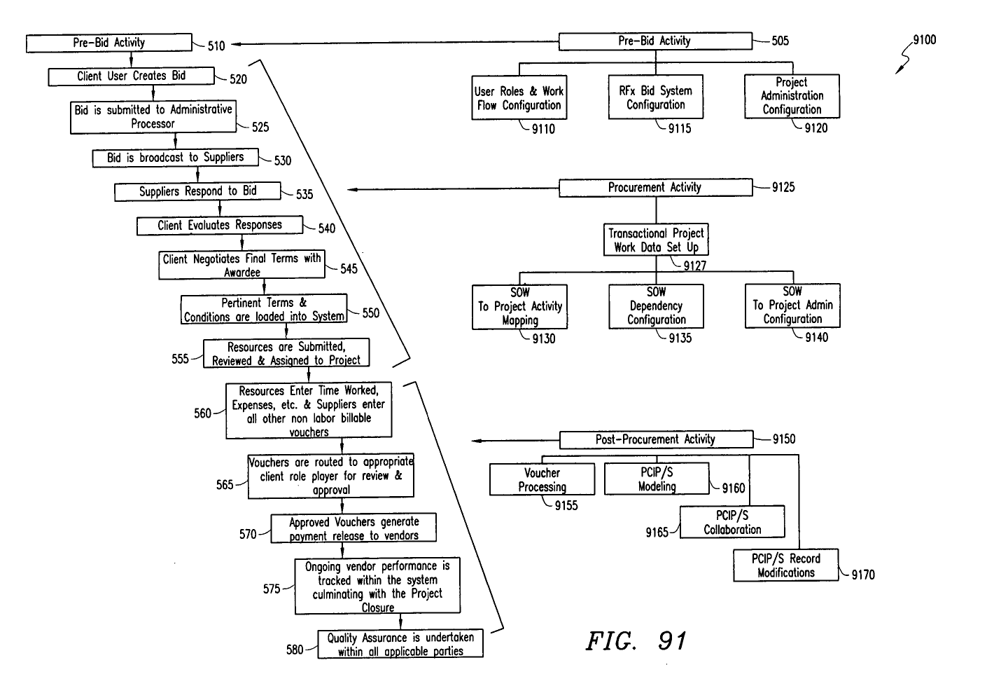

FIG. 91 is a modified version of FIG. 5 above and provides a high-level visual overview of a project change in plan/scope process in accordance with principles of the invention. As indicated in FIG. 5 above, the process 500 may be segmented into pre-bid activity 505, bid activity 515, and post-bid activity 560. In FIG. 5, the pre-bid activity 505 includes step 510, while the bid activity 515 includes steps 520-555, and the post-bid activity 560 includes steps 565-580. In contrast, the process 9100 is segmented into the pre-bid activity 505, procurement activity 9125, and post-procurement activity 9150. In FIG. 91, the pre-bid activity 505 occurs before step 520, the procurement activity 9125 occurs before step 560, and the post-procurement activity 9150 occurs during steps 560-580.

The pre-bid activity 505 includes user roles and work flow configuration 9110, RFx bid system configuration 9115, and project administration configuration 9120. The procurement activity 9125 includes transactional project work data setup 9127, which includes SOW to project activity mapping 9130, SOW dependency configuration 9135, and SOW to project administration configuration 9140. The post-procurement activity 9150 includes voucher processing 9155, PCIP/S modeling 9160, PCIP/S collaboration 9165, and PCIP/S record modifications 9170. The voucher processing 9155 occurs during steps 560-570. The PCIP/S modeling 9160, the PCIP/S collaboration 9165, and the PCIP/S record modifications 9170 occur at or before step 575.

FIG. 92 is a modified version of FIG. 91 in which a competitive bid process is not utilized. Those having skill in the art will appreciate that various embodiments of the invention are not restricted to an environment that includes a competitive bid, as indicated in FIG. 92. FIG. 92 includes modifications to remove procurement/bid activities shown in FIG. 91. In a process 9200 illustrated in FIG. 92, pre-project activity 9210 includes the user roles and work flow configuration 9110 and the project administration configuration 9120. The project setup activity 9215 includes transactional project work data setup 9227. The transactional project work data setup 9227 includes the SOW to project activity mapping 9130, the SOW dependency configuration 9135, and the SOW to project administration configuration 9140. Project tracking activity 9220 includes the voucher processing 9155, the PCIP/S modeling 9160, the PCIP/S collaboration 9165, and the PCIP/S record modifications 9170. In similar fashion to FIGS. 5 and 91, the pre-project activity 9210 occurs at step 9205, while project setup activity 9215 occurs at step 550 and project tracking activity 9220 occurs during steps 560-565.

Utilization of the special data objects as bid items that migrate into purchase requisition/order data and then to transactional voucher data is not constrained to the sequence as described in FIG. 91. There is no technical constraint at all that would prohibit the use of the special data objects in a manner that excluded the purchase order process totally. In such an instance, the same type of records would simply be used for project activity data. Such data could then be used in conjunction with various embodiments of the invention just as if it had been acquired as the result of procurement activity within the system. Moreover, specifying user role positions and assigning personnel to the user role positions as in, for example, FIG. 9, in like manner is in no way constrained to a bidding process and may be instead applied to other work flow processes, such as, for example, qualifying and uploading of potential vendors or acquiring contractor agreement data.

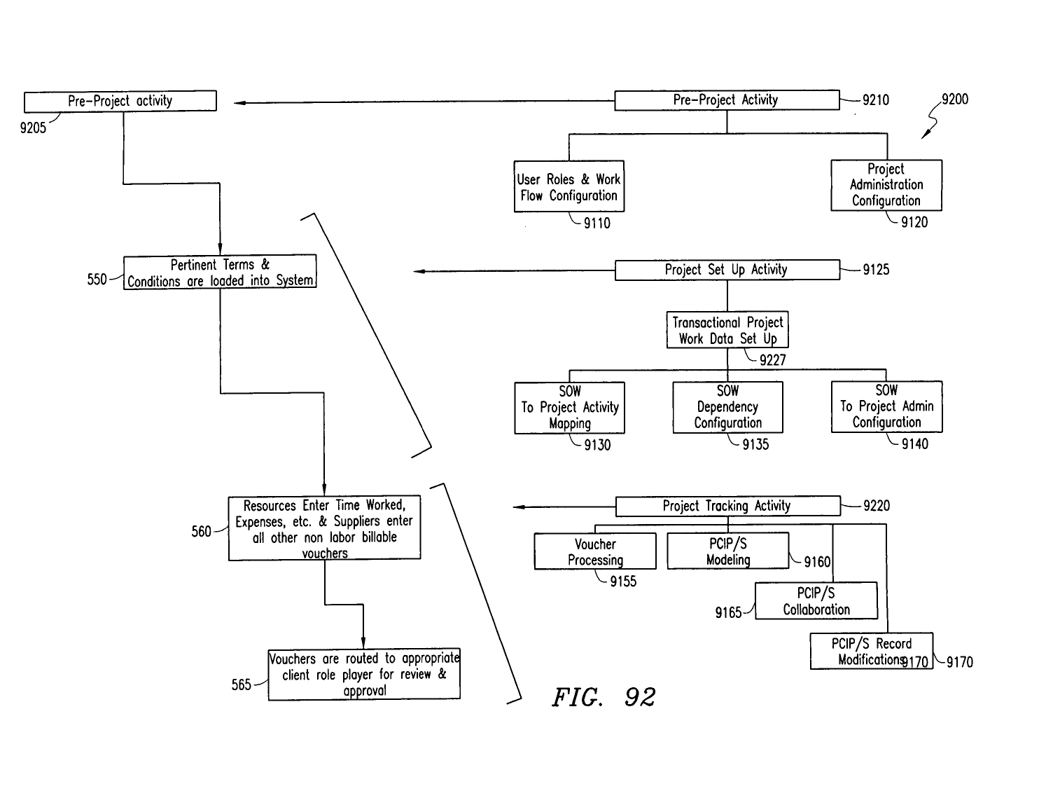

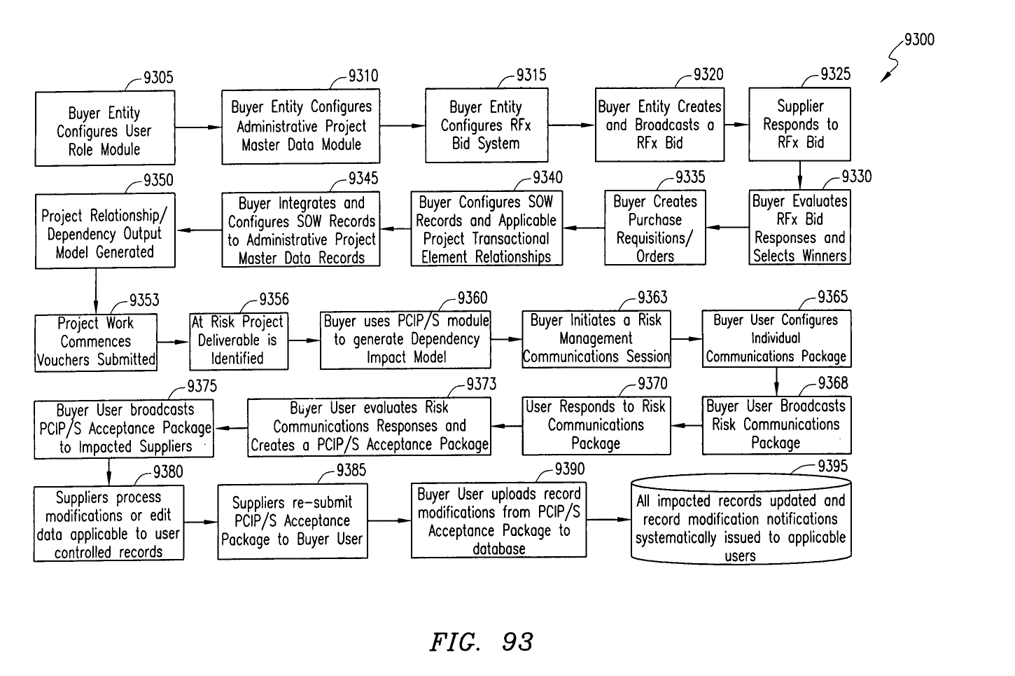

FIG. 93 illustrates a project change in plan/scope (PCIP/S) process flow in accordance with principles of the invention. In FIG. 93, a process flow 9300 begins with a pre-procurement data configuration segment that includes user role configuration 9305, project administrative module configuration 9310, and an RFx bid system configuration 9315. After the pre-procurement data configuration activities 9305-9315, the next major segment of the process 9300 includes acquisition and storage of transactional project work data shown as steps 9320-9335.

At step 9320, the buyer entity creates and broadcasts an RFx bid. At step 9325, a supplier responds to the RFx bid. At step 9330, the buyer evaluates the RFx bid responses and selects winners. At step 9335, the buyer creates purchase requisitions/orders. A third major process segment, SOW record configuration (steps 9340-9250), is a process segment in which traditional project SOW dependency configuration occurs as well as the marriage of the data configurations set up in the project administrative module configuration 9310 and the transactional data setup segment with acquisition and storage of transactional project work data.

A fourth major process segment, referred to as a PCIP/S impact model component, is represented by steps 9353-9360. Steps 9353-9360 take place upon project work commencement 9353 and include submission of work acknowledgement vouchers. Through milestone variable configuration and voucher milestone data management, various embodiments can identify for a buyer entity those specific project work activities or SOW records that are out of milestone compliance and that have therefore become (or may soon become) a risk activity.

At-risk identification 9356 is facilitated by a vouchering aspect of the system. The last activity within this fourth process segment is the PCIP/S dependency impact report 9360, which utilizes previously-configured information to display to a buyer entity a report detailing a related business-record set potentially impacted by the at-risk activity. This view gives a buyer entity information regarding what is at stake based upon one at-risk activity. During step 9360, a controlling buyer entity user can change key milestone variable data values and have the system generate an impact output report based upon the information changes.

A fifth process segment, a risk communications session, is represented by steps 9363-9370. The controlling buyer entity user can determine if the at-risk activity has a broad or significant enough impact to warrant alerting other enterprise users that problems exist that may result in changes to plan or scope of one or multiple projects. For example, the user could initiate a risk management communications session 9363. Once the session 9363 is created, with reference to a specific at-risk project-work element, the controlling buyer entity user is able at step 9365 to select which potentially-affected enterprise users are to be communicated with and configure or manipulate the individual communications packages to the users to suit specific information needs. Once the individual communications packages are configured, the buyer entity user can then at step 9368 broadcast the communication packages to individuals that are controlling owners of related business records.

In similar fashion to a supplier bid response 220, the buyer entity users that receive the at-risk communication packages can, at step 9370, process their responses via a provided user interface. The users may provide feedback regarding the anticipated impacts to their controllable business records/events. Upon completion of all recipients' at-risk communications packages, this process segment ends.

With all of the completed at-risk communications packages in hand, an issuing buyer entity user can now proceed to a sixth major process segment, the PCIP/S acceptance package session, which is represented by steps 9373-9385. Within this process, the controlling buyer entity user aggregates and evaluates the information gathered during the previous communications session (i.e., steps 9363-9370). The controlling user ultimately makes a final disposition regarding the fate of the at-risk project work activity variable(s) and saves the record change(s). Upon these changes, the user can then at step 9373 generate a new dependency impact report premised upon the new variable data, which will provide a complete view of the related business records and variable data change to the records.

After the new impact model is calculated, the buyer entity user can proceed at step 9375 to the broadcasting of the PCIP/S acceptance package to supplier users as desired. The PCIP/S acceptance package session is created with reference to an existing and open risk management communications session (i.e., steps 9363-9370), thereby already determining the broadcast target supplier list referencing impacted system purchase orders. The process of steps 9272-9385 is similar to the previous communications process (i.e., steps 9363-9370), whereby individual configurations and notations can be made pertinent to each individual recipient if so desired. The broadcasting of step 9375 is typically tracked at the database level.

Similar to the session of steps 9363-9370, the individual users receiving the PCIP/S acceptance package can process and return the package to the issuing user at steps 9380 and 9385. Responses are typically constrained to accepting modified variable data or actually defining a variable data element. Information values are acquired and stored that the system needs to reflect in light of the disposition being made pertinent to the source at-risk project-work-activity record. Variable information modifications are made by the controlling interest parties, with the problem source identified and collaboration being undertaken over a single platform (e.g., the system 30), while the activity is tracked in full visibility of the enterprise.

Upon receipt of the completed PCIP/S acceptance packages, a seventh major process segment is the PCIP/S record modification administration segment (i.e., 9390-9395). The controlling user activates a provided control through, for example, user interface and gives the approval for the variable data modifications to be updated. Upon completion of step 9395, the affected buyer entity users are systematically notified indicating that expected modifications have been made within the system.

Pre-Procurement Data Configuration

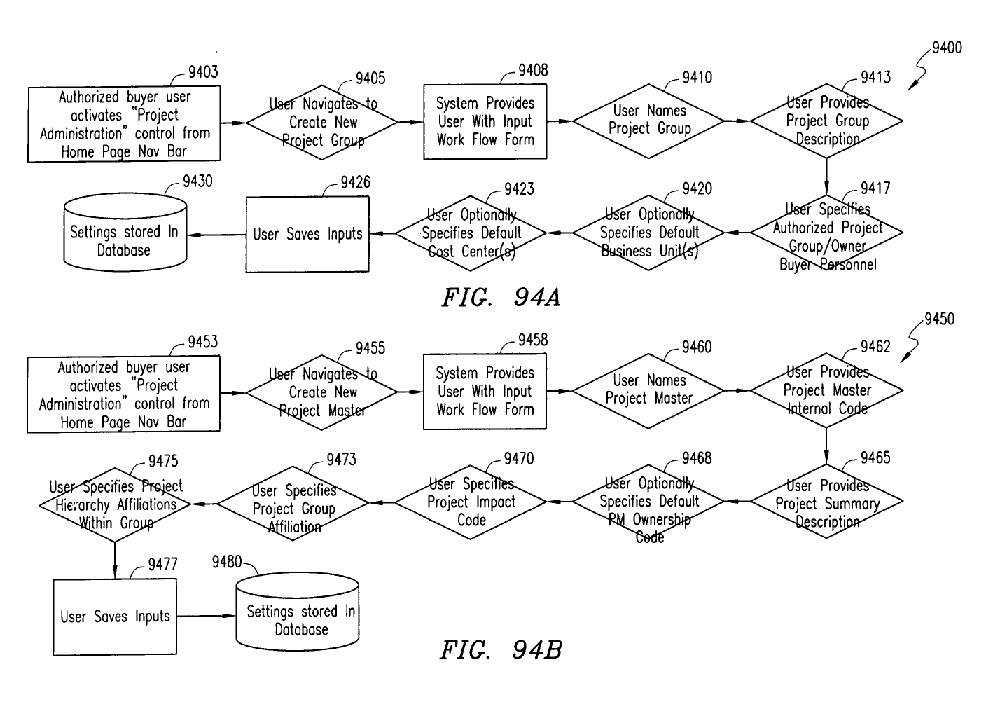

Various high-level configuration and data management activities typically take place before actual project work transactional data is acquired. These pre-procurement configuration and data management activities provide tangible information threads to which future project work transactional data will connect. These information threads typically include project groups/master, budget groups/master, asset groups/master, contract master, and business event/master, although many others are possible. FIGS. 94A-101 illustrate in greater detail step 9310 of FIG. 93, during which step a buyer entity configures the administrative project core-information data components 9001.

FIGS. 94A-B relate primarily to creation and storage process flows for both project group and project master records. Project groups are collections of one or more projects that are grouped together according to some predefined criteria such as, for example, technology area, business unit, or industry. A project master is a record associated with a particular project. The project-master and project-group records are typically found within the project administration system 9017. The process flows result in information acquisition and storage into database tables such as, for example, Tables 113-114A. A project group and project master schema illustrated in FIGS. 94A-B represents a basic support structure for overall information and project portfolio administration. Project portfolio management may be facilitated by specifying default ownership of a project or project group, for example, to any applicable business units, cost centers, or personnel. A project relationship hierarchy may be established between project master records and anticipated project management ownership may be specified. Project impact code may be specified to reflect a relation of the project to identified business endeavors (See, e.g., Table 103). Although a two-tier project structure is depicted in FIGS. 94A-B, a tiered structure of more than two tiers could be created without departing from principles of the invention.

Referring now to FIG. 94A, a project group creation process flow 9400 begins at step 9403. At step 9403, an authorized buyer user activates a project administration control from, for example, a home page navigation bar. At step 9405, the user navigates to create a new project group. At step 9408, the system provides the user with an input work flow form. At step 9410, the user names the project group. At step 9413, the user provides a project group description. At step 9417, the user specifies authorized project group owner/buyer personnel. At step 9420, the user optionally specifies default business unit(s). At step 9423, the user optionally specifies default costs center(s). At step 9426, the user saves the inputs previously made. At step 9430, the user settings are stored in a database.

Referring now to FIG. 94B, a project master creation process flow 9450 begins at step 9453. At step 9453, the authorized buyer user activates a project administration control from, for example, a home page navigation bar. At step 9455, the user navigates to create a new project master. At step 9458, the system provides the user with an input work flow form. At step 9460, the user names the project master. At step 9462, the user provides a project master internal code. At step 9465, the user provides a project summary description. At step 9468, the user optionally specifies a default project master (PM) ownership code defining the responsible project management party for the project as, for example, in Table 103. At step 9470, the user specifies a project impact code (See, e.g., Table 103). At step 9473, the user specifies a project group affiliation (i.e., which project group the project is a member of). At step 9475, the user specifies project hierarchy affiliations within the project group. At step 9477, the user saves the previously-made inputs. At step 9480, the user settings are stored in a database.

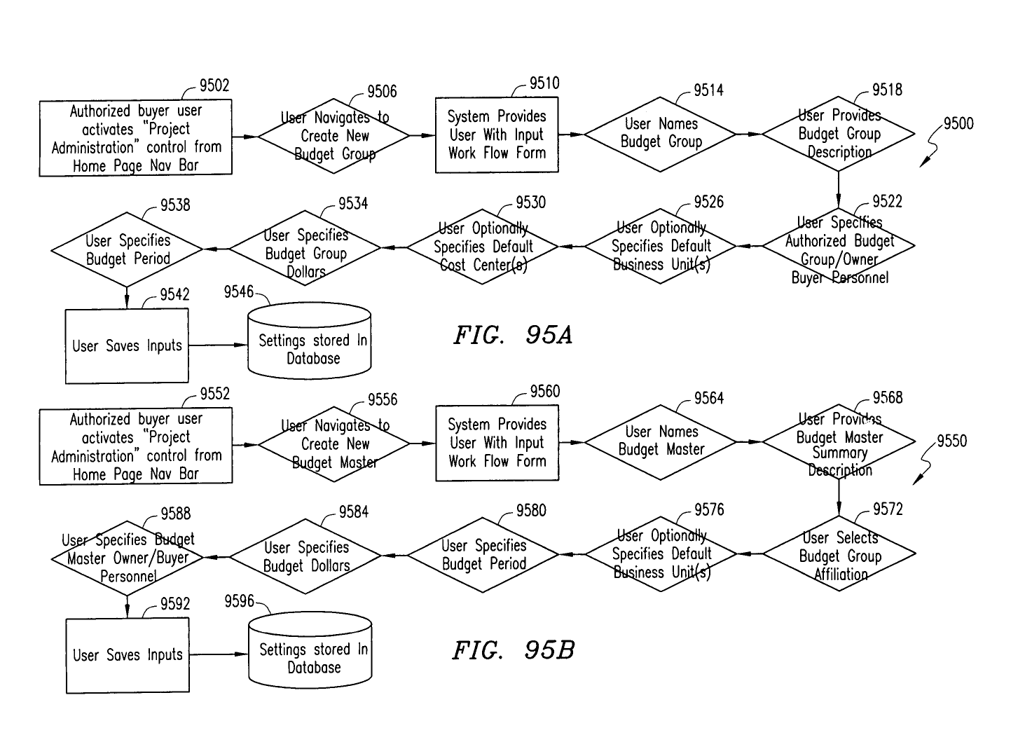

FIGS. 95A-B follow a similar pattern as described above in FIGS. 94A-B for setup of project groups/masters; however, specific process flows shown in FIGS. 95A-B deal with budget groups/master record creation and storage. Data storage described in FIGS. 95A-B occurs in database tables, such as for example, Tables 118 and 119. Budgetary data is managing data within the financial management system 9011 of the core-information data component 9001. Although a two-tier budget structure is depicted in FIGS. 95A-B, a tiered structure of more than two tiers could be created without departing from principles of the invention.

In an analogous fashion to project groups, a budget group is a collection of one or more budgets. As will be appreciated by those having skill in the art, budgets are typically categorized according to business organization, such as, for example, in a hierarchical fashion by division, business unit, and cost center. However, principles of the invention relative to budgeting, including structuring of budget groups and budget masters, may be used to structure budgeting functions of an enterprise in numerous different ways according to the needs of the enterprise. The budget-master and budget-group records are typically found within the financial management system 9011.

Referring now to FIG. 95A, a budget group creation process flow 9500 begins at step 9502. At step 9502, an authorized buyer user activates a project administration control from, for example, a home page navigation bar. At step 9506, the user navigates to create a new budget group. At step 9510, the system provides the user with an input work flow form. At step 9514, the user names the budget group. At step 9518, the user provides a budget group description. At step 9522, the user specifies authorized budget group owner/buyer personnel. At step 9526, the user optionally specifies default business unit(s). At step 9530, the user optionally specifies default cost center(s). At step 9534, the user specifies a budget-group dollar amount. At step 9538, the user specifies a budget. At step 9542, the user saves the previously-made user inputs. At step 9546, the settings are stored in a database.

Referring now to FIG. 95B, a budget master creation process flow 9550 begins at step 9552. At step 9552, an authorized buyer user activates a project administration control from, for example, a home page navigation bar. At step 9556, the user navigates to create a new budget master. At step 9560, the system provides the user with an input work flow form. At step 9564, the user names the budget master. At step 9568, the user provides a budget master summary description. At step 9572, the user selects a budget group affiliation (i.e., which budget group the budget belongs to). At step 9576, the user optionally specifies default business unit(s). At step 9580, the user specifies a budget. At step 9584, the user specifies budget dollar amount. At step 9588, the user specifies budget master owner/buyer personnel. At step 9592, the user saves previously-made inputs. At step 9596, the settings are stored in a database.

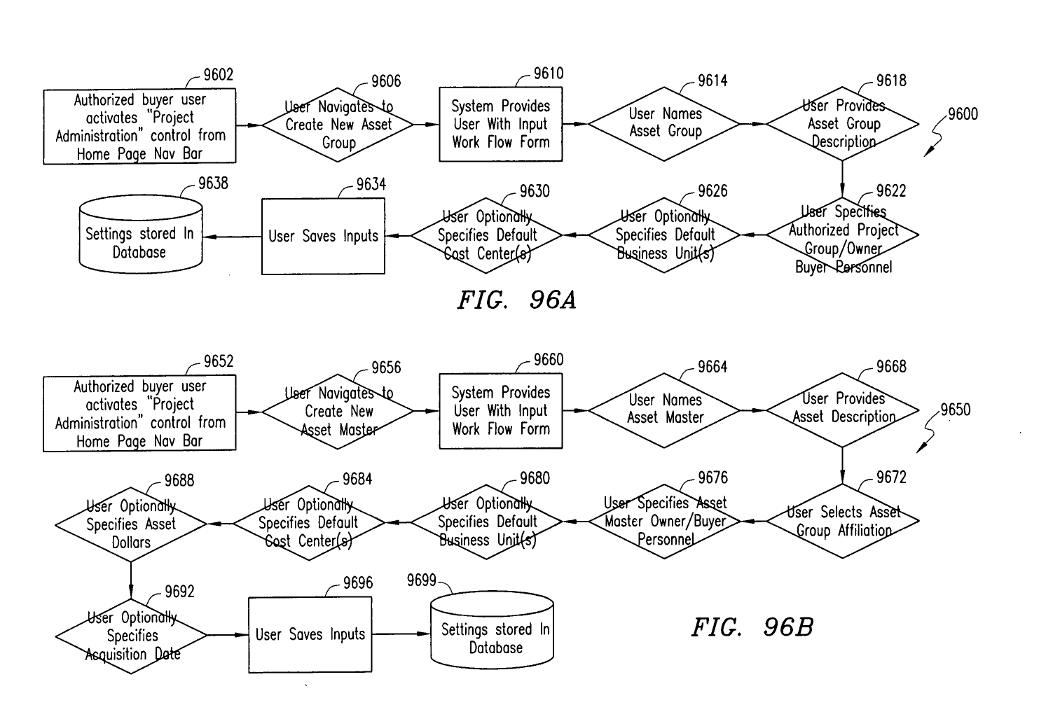

FIGS. 96A-B follow a similar pattern as described above for setup of the project masters/groups and budget masters/groups in FIGS. 94A-B and 95A-B above; however, the process flows of FIGS. 96A-B pertain to asset group/master record creation and storage. FIGS. 96A-B illustrate creation of an asset master/group records as described generally relative to step 9310. Data storage depicted in FIGS. 96A-B occurs in database tables, such as for example, Tables 125-126. Asset data created in the process flows depicted in FIGS. 96A-B is managing data within the financial management system 9011 of the core-information data component 9001. Creation of asset group/master record as depicted in FIGS. 96A-B can serve to facilitate various accounting functions, such as, for example, depreciation of assets by various business organizations within the enterprise. Although a two-tier asset structure is depicted in FIGS. 96A-B, a tiered structure of more than two tiers could be created without departing from principles of the invention.

Referring now to FIG. 96A, an asset group creation process flow 9600 begins at step 9602. At step 9602, an authorized buyer user activates a project administration control from, for example, a home page navigation bar. At step 9606, the user navigates to create a new asset group. At step 9610, the system provides the user with an input work flow form. At step 9614, the user names the asset group. At step 9618, the user provides an asset group description. At step 9622, the user specifies authorized project group owner/buyer personnel. At step 9626, the user optionally specifies default business unit(s). At step 9630, the user optionally specifies default cost center(s). At step 9634, the user saves the previously-made inputs. At step 9638, the settings are stored in a database.

Referring now to FIG. 96B, an asset master creation process flow 9650 begins at step 9652. At step 9652, an authorized buyer user activates a project administration control from, for example, a home page navigation bar. At step 9656, the user navigates to create a new asset master. At step 9660, the system provides the user with an input work flow form. At step 9664, the user names the asset master. At step 9668, the user provides an asset description. At step 9672, the user selects an asset group affiliation. At step 9676, the user specifies asset master owner/buyer personnel. At step 9680, the user optionally specifies default business unit(s). At step 9684, the user optionally specifies default cost center(s). At step 9688, the user optionally specifies asset dollars. At step 9692, the user optionally specifies an asset acquisition date. At step 9696, the user saves the previously-made inputs. At step 9699, the settings are stored in a database.

The exemplary processes discussed relative to FIGS. 94A-96B thus far may imply that these are necessarily consecutive procedures. However, those having skill in the art will recognize that they are in fact independent application processes that need not be performed in the order described.

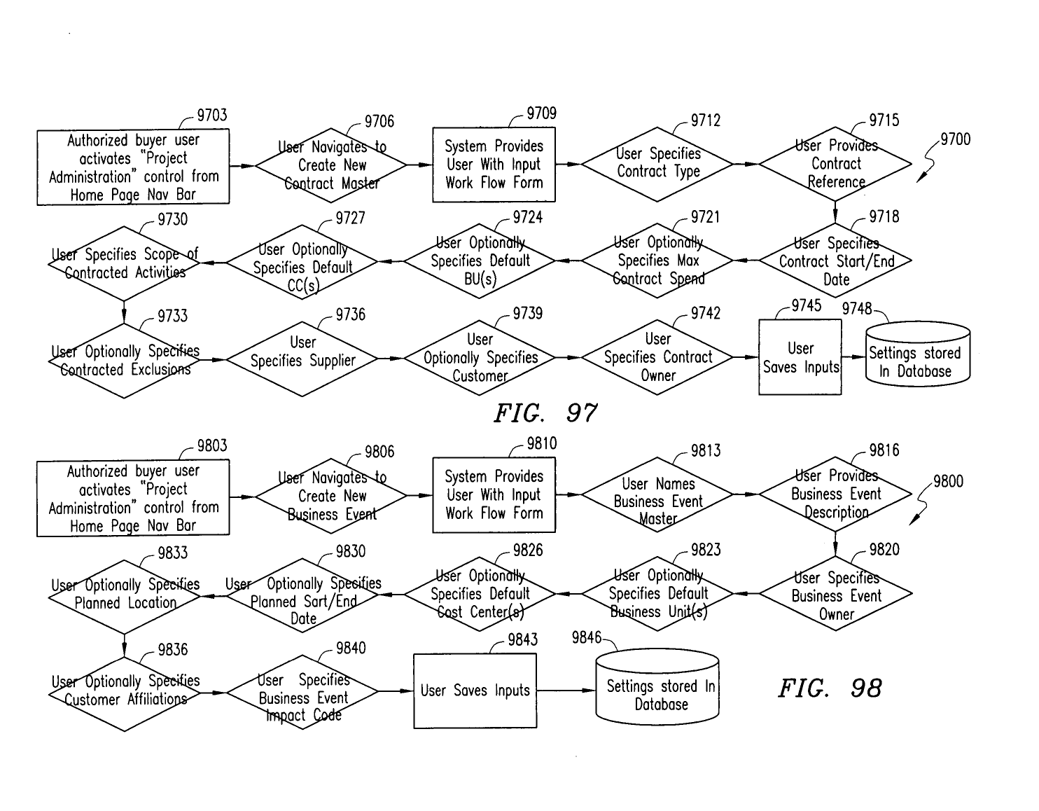

FIG. 97 is process flow for creation and storage of contract master records in order to capture specific contract information elements in order to integrate the contract information to projects and ultimately to project work transactional data. The process flow described in FIG. 97 may be used to specify various attributes of a contract utilized by the enterprise in order to insure that those attributes are met during project work undertaken by or on behalf of the enterprise. A contract master record is stored in a database table, such as, for example, Table 123. Those having skill in the art will understand that contract information is typically contained in a prose format stored in either an electronic text document, on paper, or both. In such cases, there is typically no data processing capacity or interoperability applicable to the contract information, inasmuch as the prose document does not represent a traditional application-processing element. Although not specifically illustrated in FIG. 97, those having skill in the art will appreciate that contract records could be tiered in similar fashion to that described above relative to projects, assets, and budget. Contract records are typically found within the supplier management system 9015.

Referring again to FIG. 97, a contract record creation process flow 9700 begins at step 9703. At step 9703, an authorized buyer user activates a project administration control from, for example, a home page navigation bar. At step 9706, the user navigates to create a new contract master. At step 9709, the system provides the user with an input work flow form. At step 9712, the user specifies a contract type. At step 9715, the user provides a contract reference. At step 9718, the user specifies contract start and end dates. At step 9721, the user optionally specifies a maximal contract spend amount. At step 9724, the user optionally specifies default business unit(s). At step 9727, the user optionally specifies default cost center(s). At step 9730, the user specifies the scope of contracted activities. At step 9733, the user optionally specifies contracted exclusions. At step 9736, the user specifies a supplier. At step 9739, the user optionally specifies a customer. At step 9742, the user specifies a contract owner. At step 9745, the user saves the previously-made inputs. At step 9748, the settings are stored in a database.

FIG. 98 represents a process flow pertinent to creation and storage of business event master records. Business events are buyer activities that, although not directly related to project work, may have either a cause or an effect relationship relative to one or more projects being undertaken by a buyer entity. An example of a business event would be a project that involves creating a new product. An advertising and marketing campaign to launch the product could be considered a business event, since the advertising and marketing campaign arguably has nothing to do with the project creating the product; however, the business event is dependent upon the project of creating the product having been completed. If, for example, the product is determined to never be created due to some failure within the project, it would be unwise to spend money unnecessarily on the dependent business event, namely, the advertising and marketing campaign related thereto. A business event master record is stored in database tables, such as, for example, Table 121. In the event of a less catastrophic failure, the business event could be delayed or undergo a collateral material modification in light of project risk notification. Although not explicitly illustrated as having a tiered structure as in the discussion above of projects, budgets, and assets, those having skill in the art will appreciate that business events could be structured in a tiered fashion without departing from principles of the invention.

Referring again to FIG. 98, a business event record creation process flow 9800 begins at step 9803. At step 9803, an authorized buyer user activates a project administration control from, for example, a home page navigation bar. At step 9806, the user navigates to create a new business event. At step 9810, the system provides the user with an input work flow form. At step 9813, the user names the business event master. At step 9816, the user provides a business event description. At step 9820, the user specifies a business event owner. At step 9823, the user optionally specifies default business unit(s). At step 9826, the user optionally specifies default cost center(s). At step 9830, the user optionally specifies planned start and end dates. At step 9833, the user optionally specifies a planned location. At step 9836, the user optionally specifies customer affiliations of the business event. At step 9840, the user specifies a business event impact code. At step 9843, the user saves the previously-made inputs. At step 9846, the settings are stored in a database.

Once core-information data elements such as budget, asset, contract, and business-event records are affiliated with a project master or project group, they then become what master data. Otherwise, if unused in the context of project work or general procurement transactional data, they simply are unused core-information data. Once affiliations of projects to core data are made, the resultant settings are stored in the project administration system 9017.

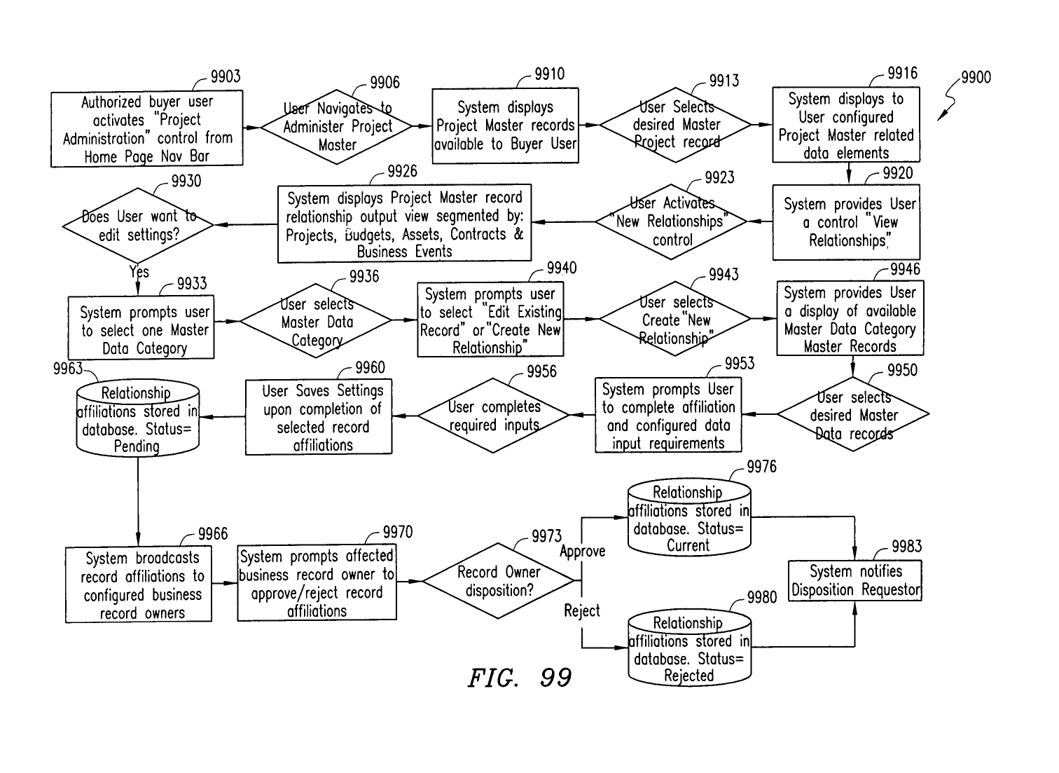

FIG. 99 illustrates a process flow for project-master-to-core-data affiliation. A process flow 9900 depicts mapping of project master records to other master records (e.g., budget, asset, business event, or contract master records). The mappings of the process flow 9900 typically are stored in database tables, such as, for example, Tables 117, 120, 122, 124 and 127. The process flow 9900 emanates from the buyer entity project master record owner; however, those having skill in the art will recognize that this is an exemplary mode. The process flow 9900 could emanate from the other master data information components being affiliated therewith and flow in the opposite direction.

As the process flow 9900 indicates, individual information inputs may vary dependent upon the affiliations being made. These affiliations represent a default initial mapping that may change once the project is bid. The mapping of project master records of the project administration system 9017 to other core-information data records typically becomes more definitive when project-work transactional data is introduced. Though not explicitly shown within the process flow 9900, those having skill in the art will recognize that editing of existing project master record affiliations may be performed after the project record transactional data has been introduced.

Referring again to FIG. 99, the process flow 9900 begins at step 9903. At step 9903, an authorized buyer user activates a project administration control from, for example, a home page navigation bar. At step 9906, the buyer user navigates to administer the project master. At step 9910, the system displays project master records available to the buyer user. At step 9913, the buyer user selects a desired project master record. At step 9916, the system displays to the user configured project-master-related data elements. At step 9920, the system provides the user a control labeled “view relationships” or the like. At step 9923, the user activates the “view relationships” control. At step 9926, the system displays a project-master-record-relationship output view. The project-master-record-relationship output view is typically segmented by projects, budgets, assets, contracts, and business events.

From step 9926, execution proceeds to step 9930. At step 9930, the user is prompted regarding whether the user wants to edit settings. Responsive to a response at step 9930 in the affirmative, execution proceeds to step 9933. At step 9933, the system prompts the user to select a core-information data category. At step 9936, the user selects a core-information data category (e.g., budget, contract, business event, or asset). At step 9940, the system prompts the user to select “edit existing record” or “create new relationship.” At step 9943, if the user selects “create new relationship,” the system provides the user a display of available core-information data category master records at step 9946.

At step 9950, the user may select desired master records. At step 9953, the system prompts the user to complete affiliation and configured data input requirements. At step 9956, the user completes the required inputs. At step 9960, the user saves the settings upon completion of the selected record affiliations. At step 9963, the relationship affiliations are stored in a database and are marked with a status of “pending.”

At step 9966, the system broadcasts the record affiliations to configured business record owners affected by the affiliations. At step 9970, the system prompts the affected business record owners to approve or reject the record affiliations. At step 9973, the affected business record owners are permitted to approve or reject the affiliations. Responsive to approval of the affiliations, execution proceeds to step 9976, at which step the affiliations are stored in a database with a status of “current.” If, however, at step 9973, the disposition of the record affiliations is rejected, execution proceeds to step 9980, at which step the affiliations are stored in a database with a status of “rejected.” From either of step 9976 or step 9980, execution proceeds to step 9983. At step 9983, the system notifies the disposition requester (i.e., the buyer user) of the record owner disposition.

Thus, at the conclusion of the process flow 9900, the project master record is affiliated with other core-information data records, such as, for example, budget master records, asset master records, contract master records, and business-event master records. In various embodiments of the invention, the other record owners to which the buyer user is seeking to affiliate the project master record have authority to approve or reject the affiliation requested by the buyer user of the project master record.

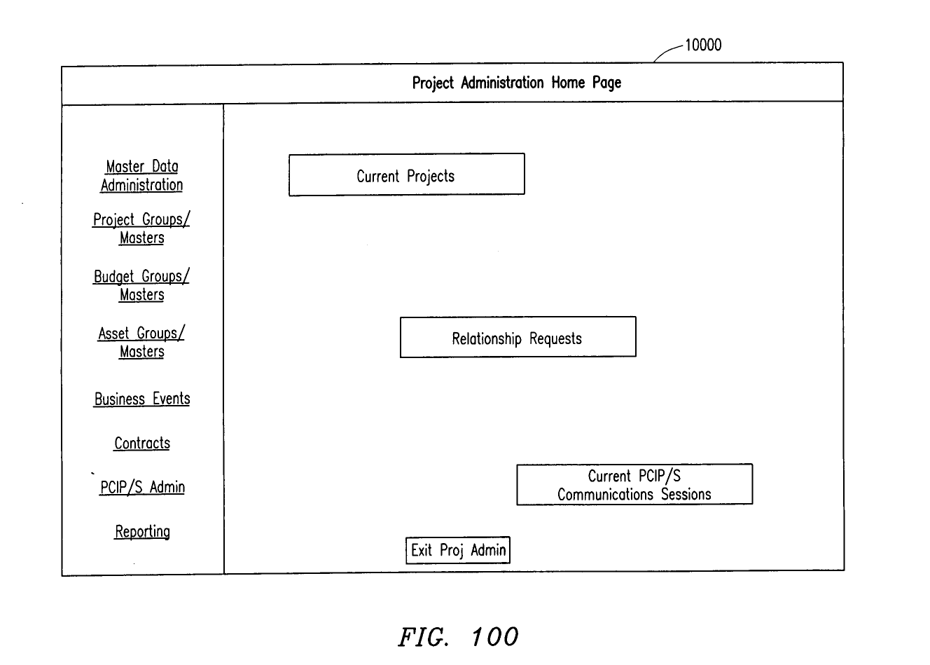

FIG. 100 represents an exemplary Project Administration Home Page User Interface for a Buyer User.

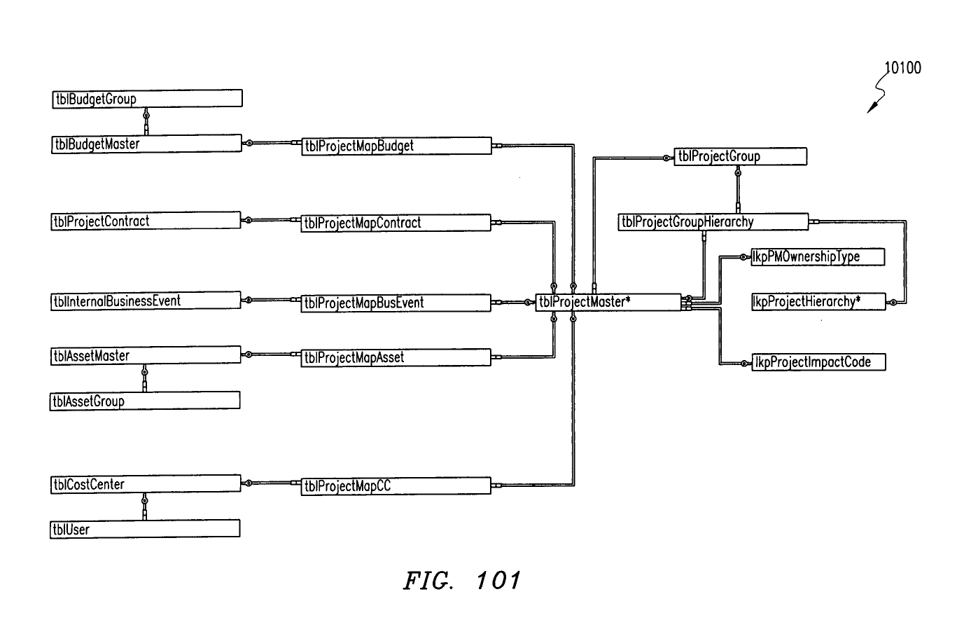

FIG. 101 represents an exemplary enabling database schema that supports the activities discussed herein. Those having skill in the art will recognize that implementation of various embodiments of the invention on a net-work based system (e.g., the internet) will typically utilize either a code and/or database information processing foundation. The database schemas and corresponding database tables included herein serve as an example how such a network-based implementation could be made.

Acquisition and Storage of Transactional Project Work Data

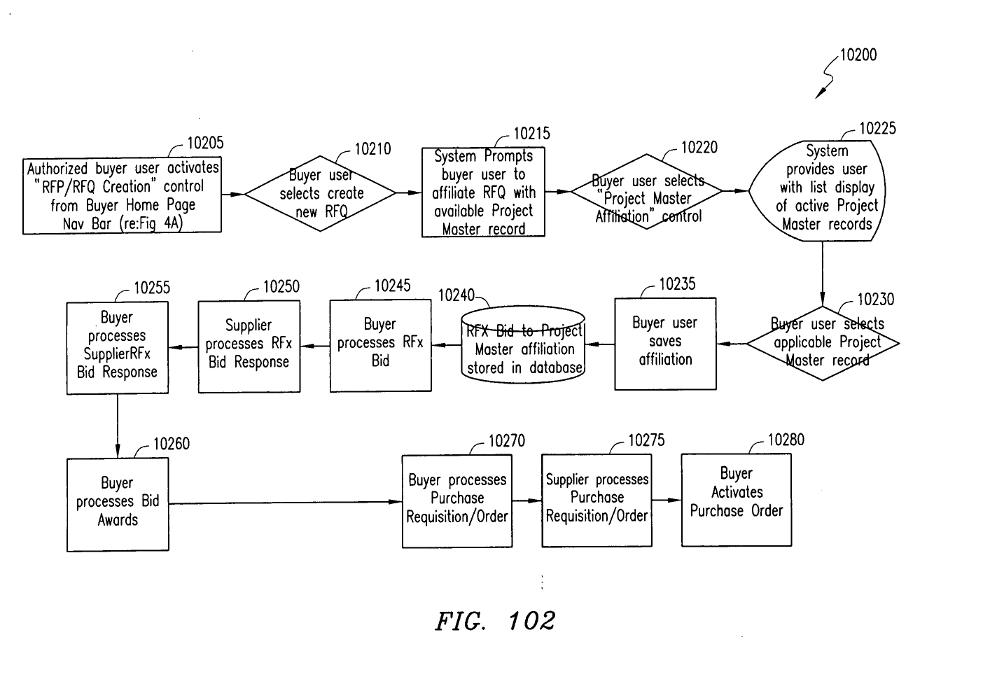

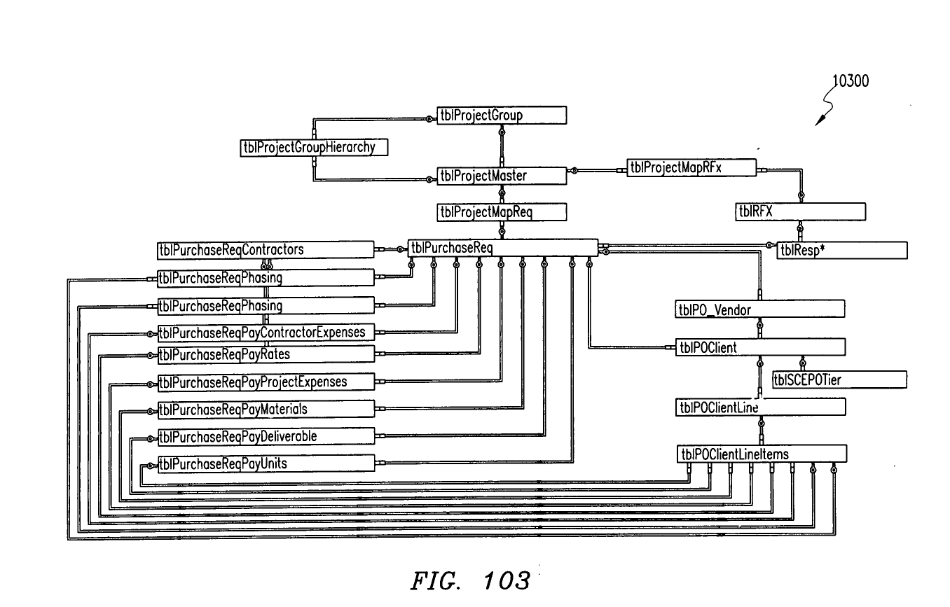

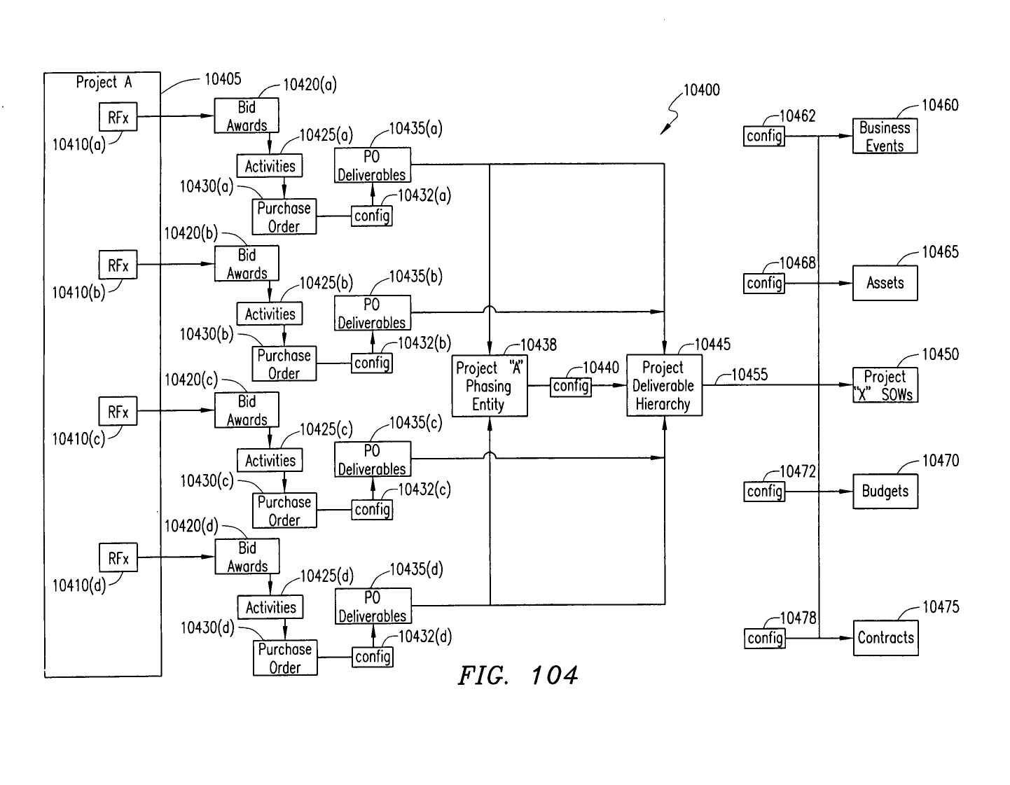

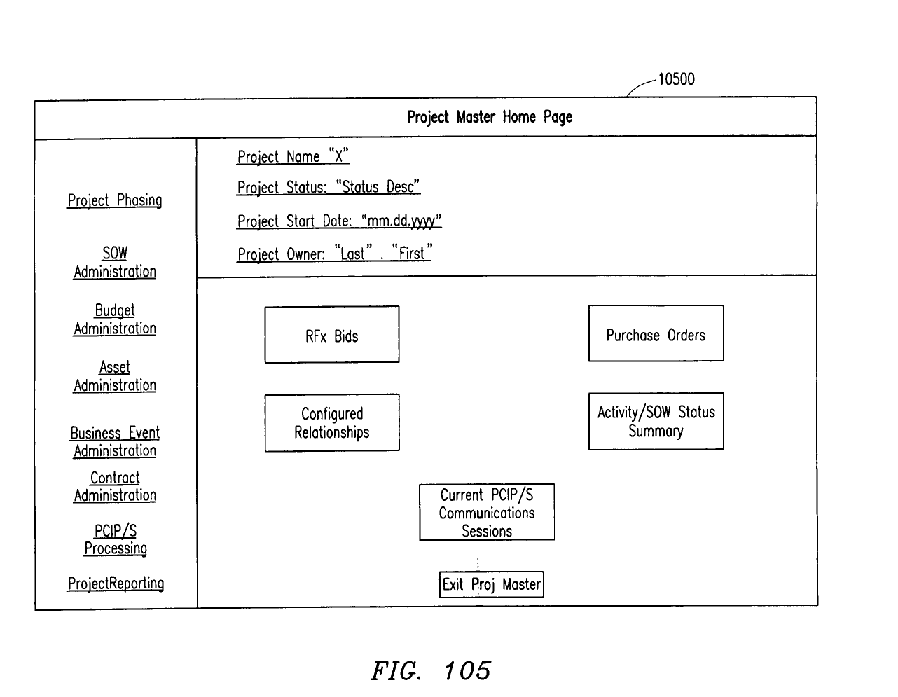

FIGS. 102-103 illustrate in more detail acquisition and storage of transactional project work data illustrated generally at steps 9320-9335 of FIG. 93. A process flow illustrated in FIG. 102 serves to integrate two diverse data sets with one another. In other words, the project master record is affiliated with an RFx bid. Following this affiliation, an RFx bid process analogous to that discussed above prior to FIG. 89 is undertaken.

FIG. 102 illustrates a summary view of an RFx bid through purchase order activation process flow 10200. Steps 10215-10240 of the process flow 10200 depict a sub-process by which a new buyer bid request is mapped to an existing project master record. Resultant relationship settings from steps 10215-10240 are stored in a database table, such as, for example, Table 128, and serve as a mapping to subsequent purchase requisitions as a result of a bid award, in which case the relationship settings are stored in a database table such as, for example, Table 129.

Variant processes are possible, such as but not limited to, when the user has no authority to view project master records, the project master records available are not pertinent to the bid request activities, or the project owner needs notification or approval permissions for project-related bid requests. The project work bid request illustrated in FIG. 102 emanates from a business need or a defined project. The mapping of the bid request to the project master record facilitates later integration between transactional data resulting from a successful bid process with previously-configured master data records.

Referring again to FIG. 102, the process flow 10200 begins at step 10205. At step 10205, an authorized buyer user activates an RFP/RFQ creation control from, for example, a buyer home page navigation bar (See, e.g., FIG. 4A). From step 10205, execution proceeds to step 10210. At step 10210, the buyer user selects “create new RFQ.” At step 10215, the system prompts the buyer user to affiliate the RFQ with an available project master record. At step 10220, the buyer user selects a “project master affiliation” control. At step 10225, the system provides the user with a list display of active project master records. At step 10230, the buyer user selects an applicable project master record. At step 10235, the buyer user saves the affiliation. At step 10240, the RFx-bid-to-project-master affiliation is stored in a database.

At step 10245, the buyer processes the RFx bid as, for example, in FIGS. 16A-D. At step 10250, the supplier processes the RFx bid response, as, for example, in FIG. 25. At step 10255-10260, the buyer processes and awards the supplier RFx bid response as, for example, in FIGS. 31-37. At steps 10270-10275, the buyer and supplier process a purchase requisition/order as, for example, in FIG. 40C. At step 10280, the buyer activates the purchase order as, for example, in FIG. 40C.

FIG. 103 illustrates a modified procurement database schema 10300 that includes connectivity between the master data, bid request, and purchase order data. The schema 10300 permits high-level connectivity of the project administration system 9017 and the procurement management system 9013.

Statement of Work (SOW) Record Configuration

FIGS. 104-115 illustrate Statement Of Work (SOW) record configuration. The SOW record configuration process is described generally at steps 9340-9350 of FIG. 93.

FIG. 104 illustrates a statement of work dynamic 10400 in accordance with principles of the invention. Project A 10405 is broken down into four distinct RFx Bids 10410(a)-(d). The RFx bids 10410(a)-(d) could ultimately result in the issuance of bid awards 10420(a)-(d) upon completion of bidding and bid response review processes. Awarded project work activities 10425(a)-(d) are integrated into purchase requisition/order modules 10430(a)-(d) for data processing by both buyer and supplier entities.

Individual project work activities 10425(a)-(d) defined and stored in the purchase orders can be mapped to specific deliverables contained on the purchase order deliverable modules 10430(a)-(d). In effect, purchase order line activities can be aggregated to reflect to what deliverable record they relate or affiliate. This mapping is represented as elements 10432(a)-(d). Resulting deliverables with affiliated activities are represented as elements 10435(a)-(d).

A project-level concept represents an additional level of relationship building that maps the deliverables/SOWs from the supplier-specific project work component into an overall project deliverables/SOWs framework. It is common to have multiple suppliers working independently or in tandem towards an aggregate output while working on and producing their individual outputs as stipulated in respective bids and purchase orders. An example is when a project is being tactically managed in chunks of progress such as phases. Traditionally, many deliverables from various suppliers, engaged as a result of different RFx bids, would collectively, upon successful completion, result in a deliverable/SOW being achieved. This aggregation of smaller deliverables into larger project level milestones will be recognized by those having skill in the art as being the traditional phased project model.

The mapping/affiliation of various supplier SOWs into a project milestone or phase is represented as element 10438 and results in bundled supplier SOWs integrated into an aggregate project phase. The dynamic 10400 thus far segments the various project deliverables into larger milestone aggregations. At this point, relationships are established between the deliverables and a hierarchy of dependencies (i.e., cause and effect) is configured within the affiliated record set. The configuration, represented by element 10440, results in a completed project work deliverable hierarchy 10445, by which all finite project work outputs are not only tied to project milestone progress, but are also defined in a manner that facilitates cause and effect management. Thus, the deliverables are tied together so as to define dependencies between diverse deliverable/SOW records.

The next aspect of relationship building is the project to project group relationship layer. Within project portfolios there may be many independent activities taking place within multiple projects that have a cause and effect impact. Hence, the need for this connectivity. Familial projects (i.e., projects within a project group) are represented as element 10450, while the mapping of relationships between Project A and Project X is represented as element 10455. When the relationship mapping takes place within the same data processing environment and database structure, the same dependency hierarchy configuration can take place even though the deliverable outputs belong to different projects. This connectivity represents a third layer of project SOW integration, which is multi-project SOW/deliverable integration.

Next described is the integration of SOW/deliverable records outside of the project work environment and into the general business framework of the enterprise. This integration is represented respectively by elements 10462, 10468, 10472 and 10478 and targets the core-information data elements 10460, 10465, 10470 and 10475.

FIG. 105 is an exemplary buyer user project master web page accessible, for example, from a project administration home page via user navigation and record selection. FIG. 105 represents the primary information and processing interface portal relative to a specific Project for authorized users. User access to individual functional controls on the page is governed by user permissions.

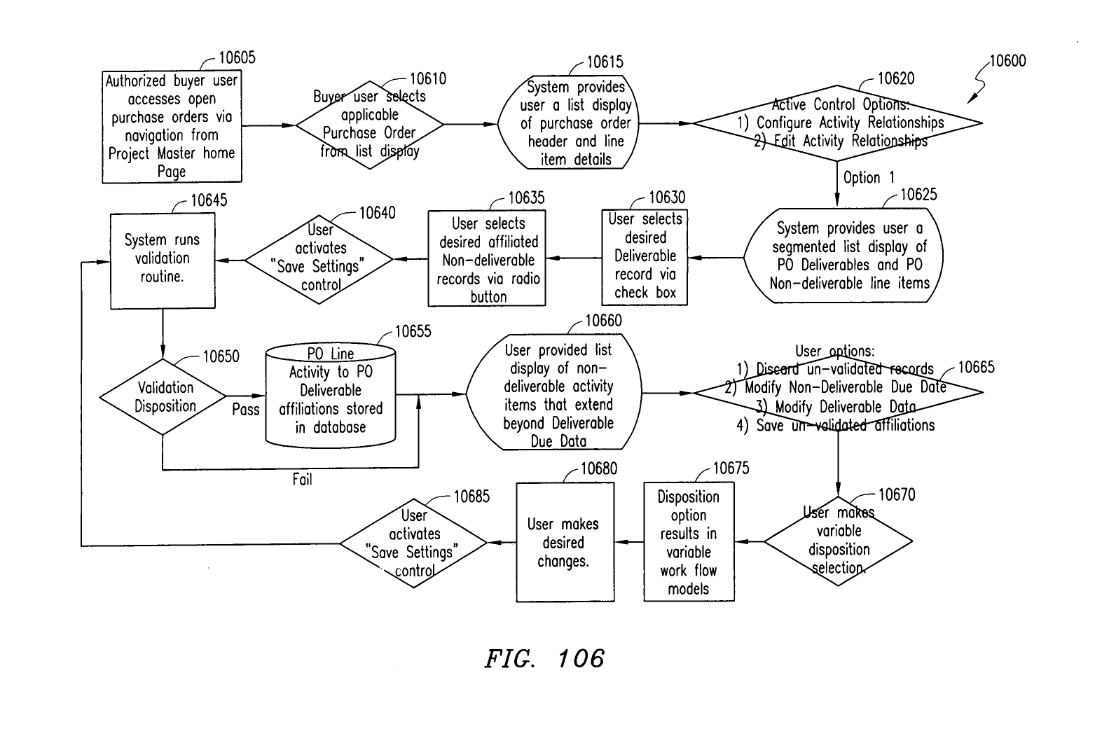

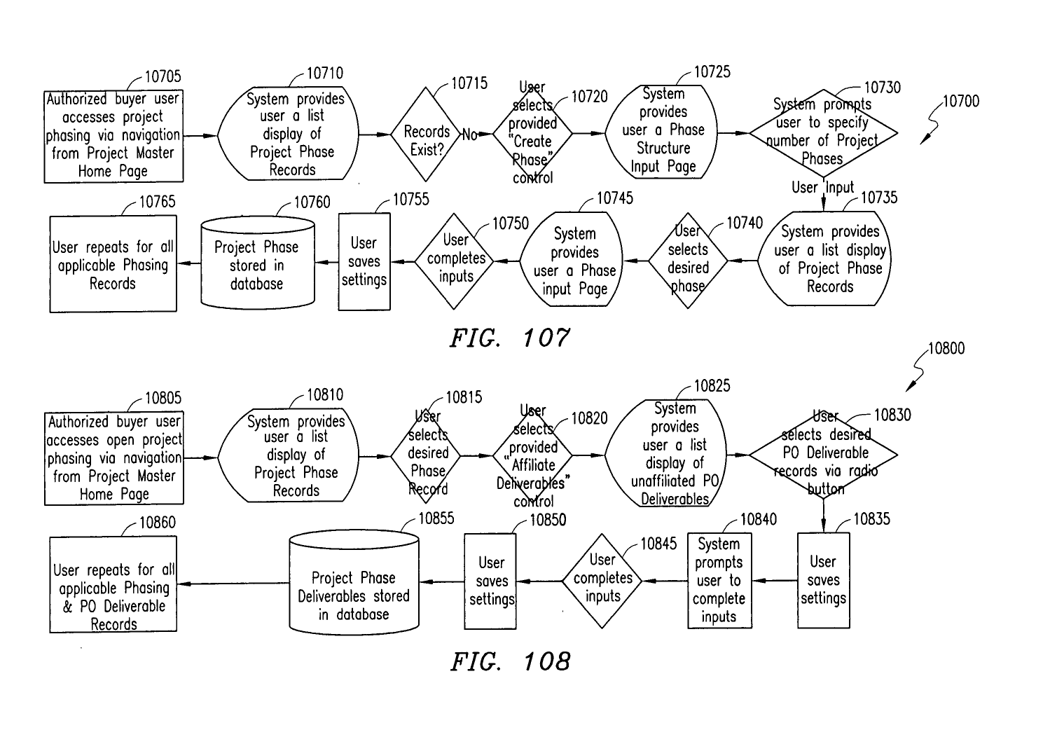

FIG. 106 is an exemplary process flow depicting project work affiliation with deliverable/SOW records. The process flow illustrated in FIG. 106 is described generally at elements 10432 and 10435 of FIG. 104. In FIG. 106, a purchase-order-activity to purchase-order-deliverable-record affiliation process flow 10600 begins at step 10605. At step 10605, an authorized buyer user accesses open purchase orders via navigation, for example, from a project master home page. At step 10610, the buyer user selects an applicable purchase order. At step 10615, the system provides to the user a display of purchase order header and line-item details. At step 10615, purchase orders are governed by status codes. Thus, some purchase orders may be yet to be approved or in a processing state where they are still purchase requisitions. Therefore, step 10615 pertains to display to the user of purchase orders that are completed, approved, and ready for purchase-order non-deliverable-line-item to deliverable/SOW mapping.

At step 10620, active control options are provided to the user to configure activity relationships or edit activity relationships. Step 10620 reflects the practical need to be able to edit line-item-to-deliverable relationships. Responsive to selection of the configure-activity-relationships option at step 10620, at step 10625 the system provides to the user a segmented list display of purchase-order deliverables and purchase-order non-deliverable line items. Step 10625 addresses segmentation of deliverable/SOW records from non-deliverable purchase-order line items. At step 10630, the user selects a desired deliverable record via, for example, a check box. At step 10635, the user selects a desired affiliated non-deliverable line-item record or records via, for example, a radio button. At step 10640, the user activates a “save settings” control. At this point in the process flow 10600, the buyer user has affiliated a purchase order deliverable with one or more purchase order non-deliverable line items.

At step 10645, the system runs a validation routine. The validation routine of step 10645 typically entails a date comparison operation. For example, since the purchase order non-deliverable line items contain information about specific activities, a simple date comparison can be performed to insure that the activities associated with the purchase order non-deliverable line items do not logically extend, for example, beyond a due date for the affiliated purchase order deliverable. For example, if a purchase order deliverable is due by Oct. 15, 2006 and the buyer user has affiliated four purchase order non-deliverable line items with associated activities that are active and extend until January 2007, the validation routine of step 10645 would likely indicate conflict. If, at step 10650, the validation is passed, at step 10655, purchase-order-line-activity to purchase-order-deliverable affiliations are stored in a database. If, at step 10650, the validation fails, execution proceeds to step 10660. Execution also proceeds from step 10655 to step 10660.

At step 10660, the user is provided a list display of purchase-order non-deliverable line items that extend beyond an affiliated deliverable due date. At step 10665, the user is presented with options to discard un-validated records, modify the non-deliverable due date, modify the deliverable date, or save the un-validated affiliations. An example of a situation in which the buyer user might want to save the un-validated affiliations would be in the case of labor non-deliverable line items. For example, if a number of project laborers were assigned to a particular project from beginning to end and their work applied to activities from multiple deliverables throughout the project, if, from a purchase-order-record perspective, only one assignment record was created for the laborers, a situation in which one or more of the laborers' duration of employment extends beyond a particular affiliated purchase order deliverable, this apparent conflict could be safely ignored by buyer user. In such cases, the assignments would typically be mapped to multiple deliverable/SOW records.

At step 10670, the user makes a variable disposition selection responsive to the options presented at step 10665. At step 10675, the selected disposition option results in variable work flow models. At step 10680, the user makes the desired changes. At step 10685, the user activates a “save settings” control. From step 10685, execution returns to step 10645. Those having skill in the art will appreciate that the process flow 10600 may be repeated by the user for any un-affiliated purchase order records. Configurations discussed relative to FIG. 106 are stored database tables such as, for example, Tables 134 and 135. The process flow 10600 ultimately results in defined affiliation of project work activity line items to defined supplier deliverable SOWs. The next configuration mode is the integration of purchase order deliverable/SOW records into the framework of the overall project.

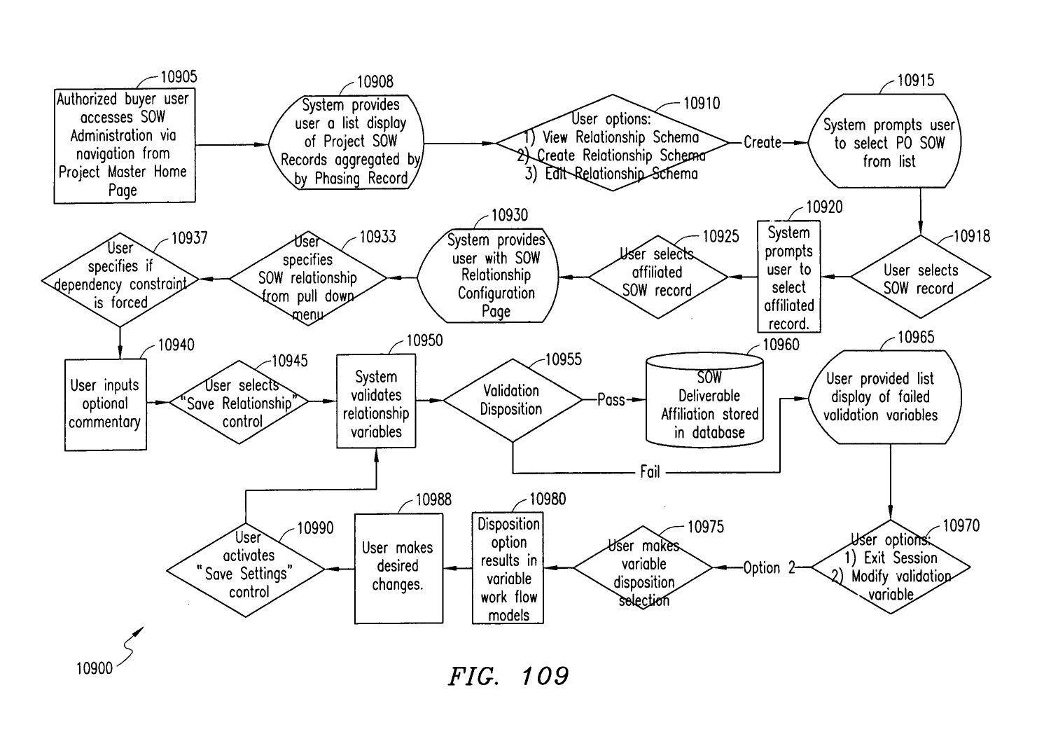

FIG. 107 illustrates a project-phase records-creation process flow 10700 depicting creation of a project phase record and phasing schema. The process flow 10700 is depicted generally at element 10438 of FIG. 104. The flow 10700 begins at step 10705. At step 10705, an authorized buyer user accesses project phasing via navigation from, for example, a project master home page. At step 10710, the system provides the user a list display of project phase records. At step 10715, an assessment is made as to whether such records exist. If it is determined in the negative at step 10715, execution proceeds to step 10720. At step 10720, the user selects a provided “create phase” control. At step 10725, the system provides to the user a phase structure input phase. At step 10730, the system prompts the user to specify the number of project phases. At step 10735, the system provides to the user a list display of project phase records responsive to user input made at step 10730. At step 10740, the user selects the desired phase. At step 10745, the system provides to the user a phase input page. At step 10750, the user completes inputs. At step 10755, the user saves settings. At step 10760, the project phase is stored in a database. At step 10765, the user repeats the preceding steps of the process flow 10700 for all applicable phasing records.

The process flow 10700 depicts a situation in which no project phasing records exist in order to emphasize that the project phasing records could exist as would be the case once a record is created. However, the phasing schema configuration is not necessarily linear and chronologically subsequent to the previous process flows described. For example, a buyer may have a very tight project plan in place prior to initiation of the bidding process and could potentially have these phasing records already set up prior to going out to bid on specific requirements. Conversely, it is not uncommon to establish a phasing plan after bids or to accept the phasing plan of a supplier or group of suppliers working in conjunction with a project manager. Thus, the configuration of the phasing plan is variable and dependent upon the specific project-work scenario encountered, so long as project phasing records are created prior to the process flow of FIG. 108 below. Phasing records are stored in a database table, such as, for example, Table 136.

FIG. 108 illustrates a purchase-order-deliverable to project-phase-affiliation process flow 10800, which is the next logical aggregation/mapping that exists between deliverable/SOW records and project phasing records. These mappings are stored in a database table, such as, for example, Table 137. Upon completion of the process flow 10800, the project work activities (i.e., transactional data) have been affiliated with the project phasing of FIG. 107 in order to facilitate targets to be met within applicable time periods.

Returning to FIG. 108, the process flow 10800 begins at step 10805, at which step an authorized buyer user accesses open project phasing via navigation from, for example, a project master home page. At step 10810, the system provides the user a list display of project phase records. At step 10815, the user selects a desired phase record. At step 10820, the user selects a provided “affiliate deliverables” control. At step 10825, the system provides to the user a list display of unaffiliated purchase order deliverables. At step 10830, the user selects desired purchase order deliverable records via, for example, a radio button. At step 10835, the user saves settings selected at step 10830.

At step 10840, the system prompts the user to complete inputs. At step 10845, the user completes the inputs. At step 10850, the user saves the input settings. Steps 10840-10850 typically relate to pre-defined phase settings such as, for example, phase importance settings. (See, e.g., Table 137) At step 10855, the project phase deliverables are stored in a database. At step 10860, the user repeats the process flow 10800 for all applicable phasing and purchase order deliverable records.

FIG. 109 illustrates a project SOW/deliverable dependency-configuration process flow 10900. The process flow 10900 begins at step 10905, at which step an authorized buyer user accesses SOW administration information via navigation from, for example, a project master home page. At step 10908, the system provides to the user a list display of project SOW records aggregated by phasing record. At step 10910, the user is provided options to view relationship schema, create relationship schema, or edit relationship schema. In other words, at step 10910, the user is prompted regarding whether to create, view, or edit dependencies between the SOW records.

Responsive to selection by the user at step 10910 of the “create relationship schema” option, execution proceeds to step 10915. At step 10915, the system prompts the user to select a purchase order SOW from a list. At step 10918, the user selects a SOW record. At step 10920, the system prompts the user to select an affiliated record. At step 10925, the user selects the affiliated SOW record. At step 10925, selection of affiliated records is depicted as being the selection of one affiliated record. However, there need not necessarily be such a limitation, as functionality could be provided to facilitate selection of a block of records for processing.

At step 10930, the system provides the user with a SOW relationship configuration page. (See, e.g., Table 139, which includes exemplary data elements for a configuration page.) At step 10933, the user specifies a SOW relationship, for example, from a pull down menu. At step 10937, the user specifies whether a dependency constraint is forced, meaning that the dependent SOW record cannot be begun until the SOW record from which it depends has been completed. Specification of forced or unforced constraints implies a possibility of a dependency from one deliverable to another that renders the dependent deliverable impossible to complete, yet does not disallow all activity from taking place. In such a case, there would be no desire to force a constraint. For example, if a deliverable output is a technical maintenance guide that is dependent upon physical infrastructure build of a computer network, it would be prudent to force the constraint, thereby specifying that the dependent deliverable cannot be initiated until completion of the parent deliverable.

At step 10940, the user inputs any optional commentary desired. At step 10945, the user selects a “save relationship” control. At step 10950, the system validates relationship variables using, for example, a completion-date comparison. At step 10955, validation disposition occurs. Responsive to passing validation, execution proceeds to step 10960. At step 10960, the SOW/deliverable affiliation is stored in a database. Responsive to validation failure at step 10955, execution proceeds to step 10965. At step 10965, the user is provided a list display of failed validation variables. At step 10970, the user is presented with options to exit the session or modify a validation variable in order to attempt to re-validate based on the modified variable. Responsive to selection by the user of the modified validation variable option, execution proceeds to step 10975.

At step 10975, the user makes a variable disposition selection. At step 10980, the disposition option results in variable work flow models. At step 10988, the user makes desired changes. At step 10990, the user activates a “save settings” control. From step 10990, execution returns to step 10950. As will be appreciated by those having skill in the art, the user may repeat the process flow 10900 as needed. The dependency configuration steps permit the physical output milestones of the project to be connected and dependencies established. The relationship types, disclosed in exemplary fashion in Table 139, establish SOW critical dependencies. Record storage depicted for the process flow 10900 takes place in a database table, such as, for example, Table 138. The mapping of SOWs between different projects within a project group is analogous, except that the functional user interface presents an expanded view of SOW/deliverable records to include a multiple project record set.

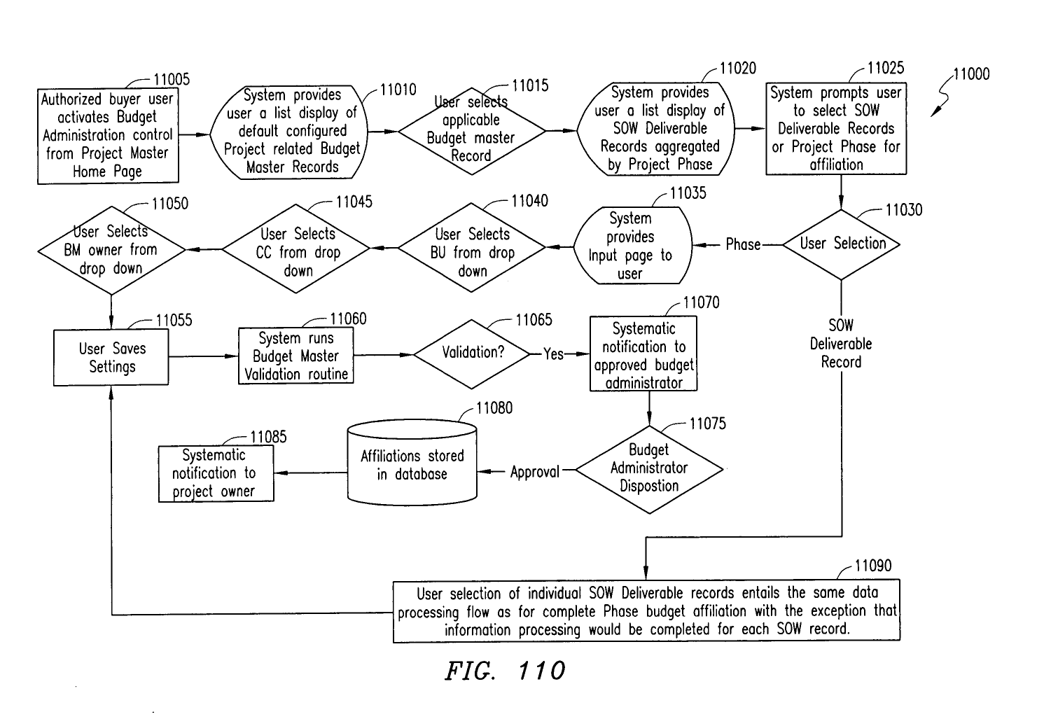

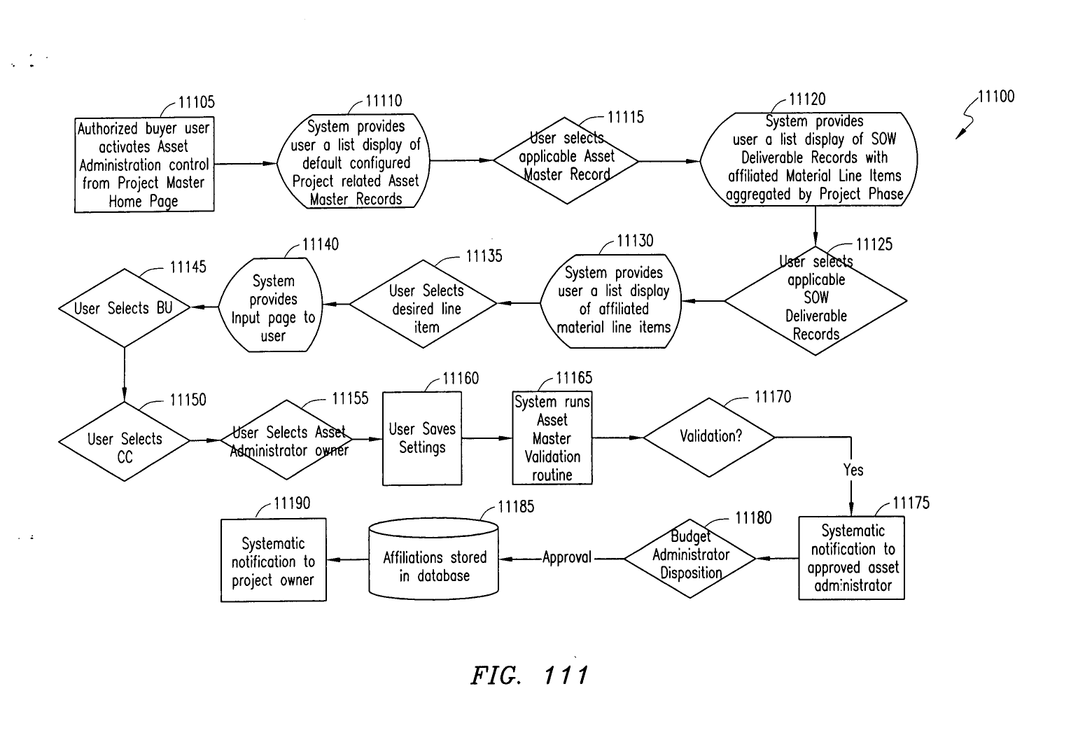

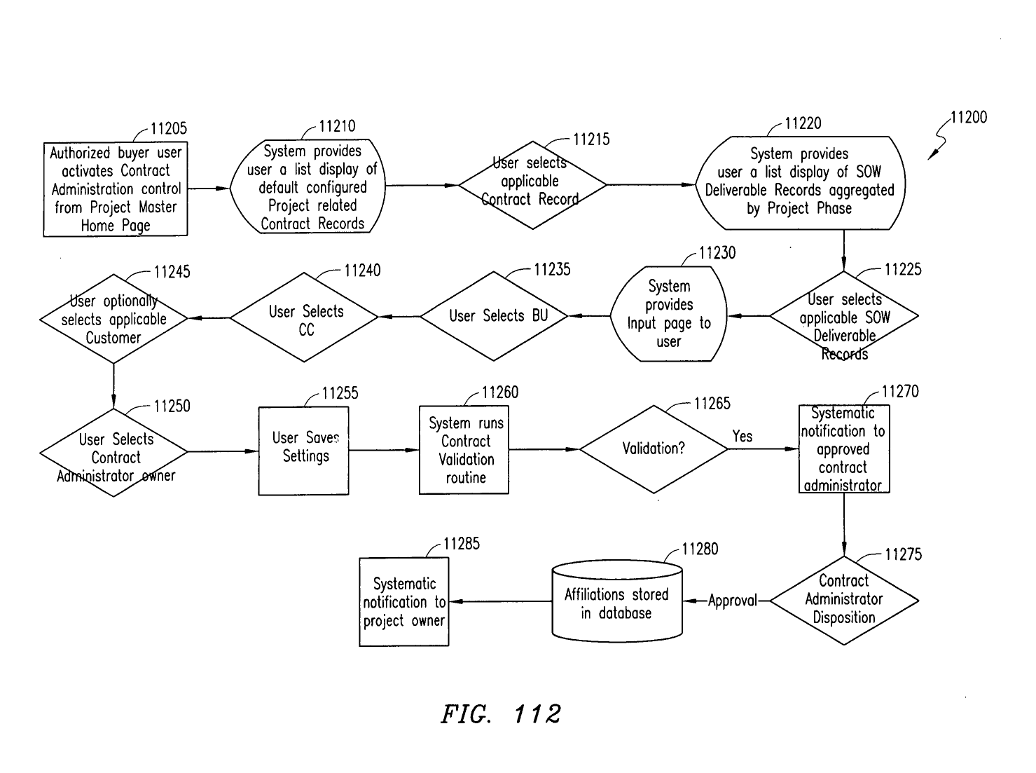

FIG. 110 illustrates an exemplary process flow 11000 that maps the SOW/deliverable records to budget master data records as described generally at step 9345 of FIG. 93. The process flow 11000 begins at step 11005. At step 11005, an authorized buyer user activates a budget administration control from, for example, a project master home page. At step 11010, the system provides to the user a list display of default configured project-related budget master records. At step 11015, the user selects an applicable budget master record. At step 11020, the system provides the user a list display of SOW/deliverable records aggregated by project phase. At step 11025, the system prompts the user to select SOW/deliverable records or project phase for affiliation.

At step 11030, the user makes a selection. Responsive to user selection of a project phase at step 11030, execution proceeds to step 11035. At step 11035, the system provides an input page to the user. At step 11040, the user selects a business unit from, for example, a drop down menu. At step 11045, the user selects a cost center from, for example, a drop down menu. At step 11050, the user selects a budget master record owner from, for example, a drop down menu. At step 11055, the user saves previously-made settings. At step 11060, the system runs a date and/or budget based budget master validation routine. At step 11065, a determination is made as to whether the budget master has been validated. If so determined at step 11065, execution proceeds to step 11070, at which step systematic notification to an approved budget administrator occurs. At step 11075, budget administrator disposition takes place. At step 11080, responsive to approval by the budget administrator at step 11075, affiliations are stored in a database. At step 11085, systematic notification to the project owners occurs. At step 11030, responsive to user selection of SOW/deliverable records for affiliation, execution proceeds to step 11090. At step 11090, user selection of individual SOW/deliverable records entails the same data processing flow as for complete phase budget affiliation, with the exception that information processing is completed for each SOW record. From step 11090, execution returns to step 11055.

The mappings of the process flow 11000 are stored a database table such as, for example, in, Table 140. Though not specifically depicted in FIG. 110, functionality could be made available to split budget allocations for a specific deliverable between multiple business unit and/or cost center entities. Those having skill in the art will appreciate that the process flow 11000 could emanate from multiple directions with a budget administrator or project manager initiating the configuration mapping of the records.

FIG. 111 illustrates an exemplary process flow 11100 that maps SOW/deliverable records to asset master data records. The process flow 11100 begins at step 11105, at which step an authorized buyer user activates an asset administration control from, for example, a project master home page. At step 11110, the system provides to the user a list display of default configured project-related asset master records. At step 11115, the user selects an applicable asset master record. At step 11120, the system provides to the user a list display of SOW/deliverable records with affiliated material line items aggregated by project phase. At step 11125, the user selects applicable SOW/deliverable records. At step 11130, the system provides to the user a list display of affiliated material line items. At step 11135, the user selects a desired line item. At step 11140, the system provides an input page to the user. At step 11145, the user selects a business unit from, for example, a drop down menu. At step 11150, the user selects a cost center from, for example, a drop down menu. At step 11155, the user selects an asset master record administrator owner from, for example, a drop down menu. At step 11160, the user saves the previously-made settings. At step 11165, the system runs a date and/or capital budget based asset master validation routine.

At step 11170, a validation assessment is made. Responsive to a positive validation assessment, execution proceeds to step 11175. At step 11175, systematic notification to an approved asset administrator occurs. At step 11180, budget administrator disposition is undertaken. Responsive to approval at step 11180, execution proceeds to step 11185. At step 11185, affiliations are stored in a database. At step 11190, systematic notification to the project owner occurs. The mappings of the process flow 11100 are stored in a database take, such as, for example, in Table 141.

Like all master data mappings, the process flow 11100 can emanate from either project management or asset management record owners. Those having skill in the art will appreciate that various embodiments may be configured to mandate processing of all material activities defined within project work to ensure asset management visibility and subsequent management thereof. In typical business environments, assets could easily be part of a larger statement of work (i.e., deliverable) that is managed at a contract level. Oftentimes the physical assets are not even defined within the context of a specific contract or asset management system.

FIG. 112 illustrates an exemplary process flow 11200 that maps SOW/deliverable records to contract records. The process flow 11200 begins at step 11205, at which step an authorized buyer user activates a contract administration control from, for example, a project master home page. At step 11210, the system provides to the user a list display of default configured project related contract records. At step 11215, the user selects an applicable contract record. At step 11220, the system provides to the user a list display of SOW/deliverable records aggregated by project phase. At step 11225, the user selects applicable SOW/deliverable records. At step 11230, the system provides an input page to the user. At step 11235, the user selects a business unit from, for example, a drop down menu. At step 11240, the user selects a cost center from, for example, a drop down menu. At step 11245, the user optionally selects an applicable customer from, for example, a drop down menu. At step 11250, the user selects a contract administrator owner from, for example, a drop down menu. At step 11255, the user saves the previously-made settings.

At step 11260, the system runs a contract validation routine. Validation need not be just time-sensitive, but may also be scope-sensitive. Other variables that are sensitive may include, for example, money or services/goods provision types. At step 11265, a determination the contract validation is made. Responsive to a positive validation at step 11265, execution proceeds to step 11270. At step 11270, systematic notification to an approved contract administrator (i.e., configured contract master record owner) occurs. At step 11275, contract administrator disposition occurs. Responsive to approval at step 11275, execution proceeds to step 11280. At step 11280, affiliations are stored in a database. At step 11285, systematic notification to the project owner occurs. The mappings of the process flow 11200 are stored in a database, such as, for example, Table 142. The process flow 11200 may be bi-directional, even though it is not explicitly depicted as such in FIG. 112.

Specification of a downstream client and subsequent contract reference may be used to affiliate multi-level contracts with activities. Such would be the case when, for example, a buyer entity is utilizing an outside supplier, under a contract, to provide services to an ultimate end user, who is under contract for the goods/services with the buyer entity.

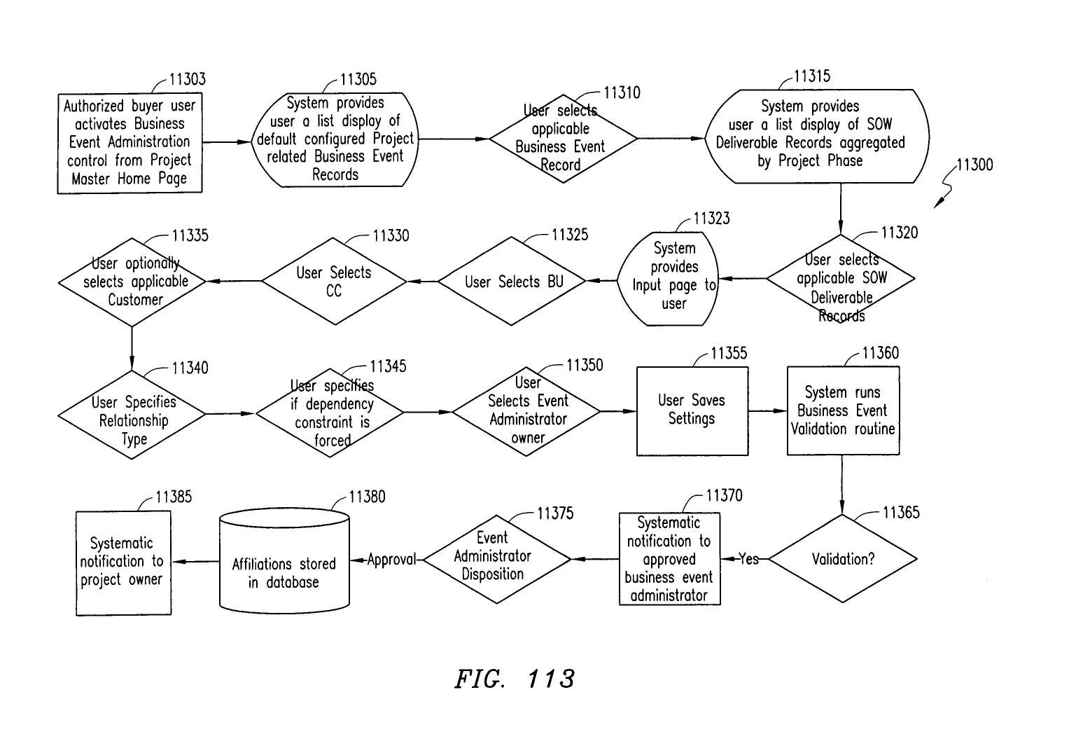

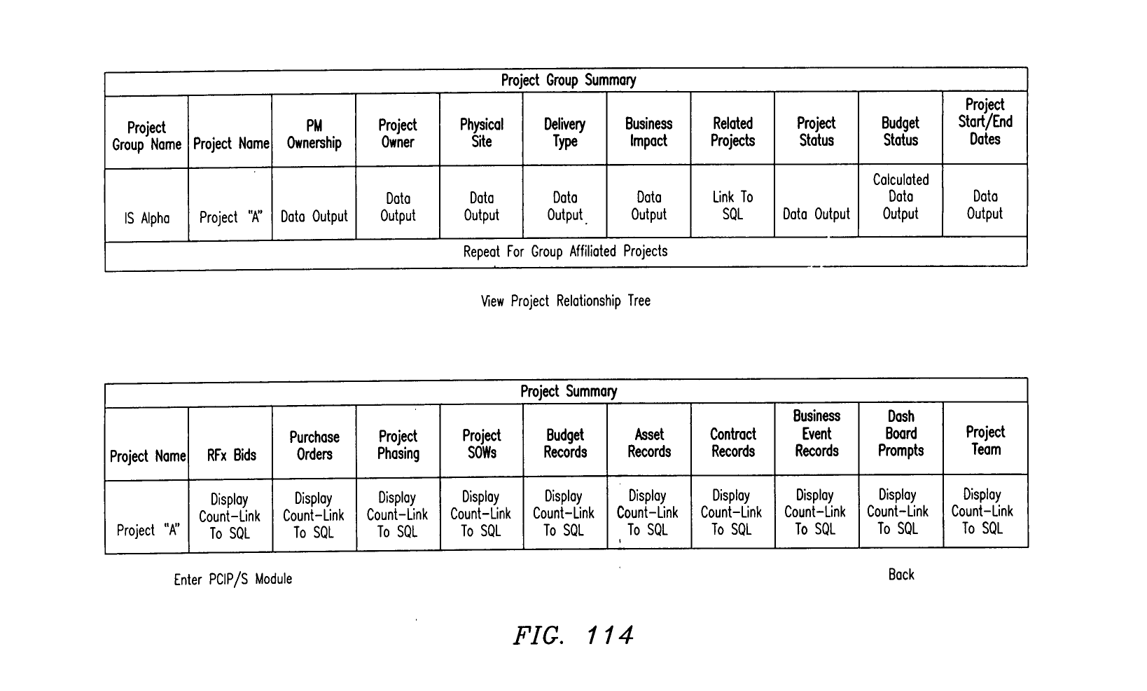

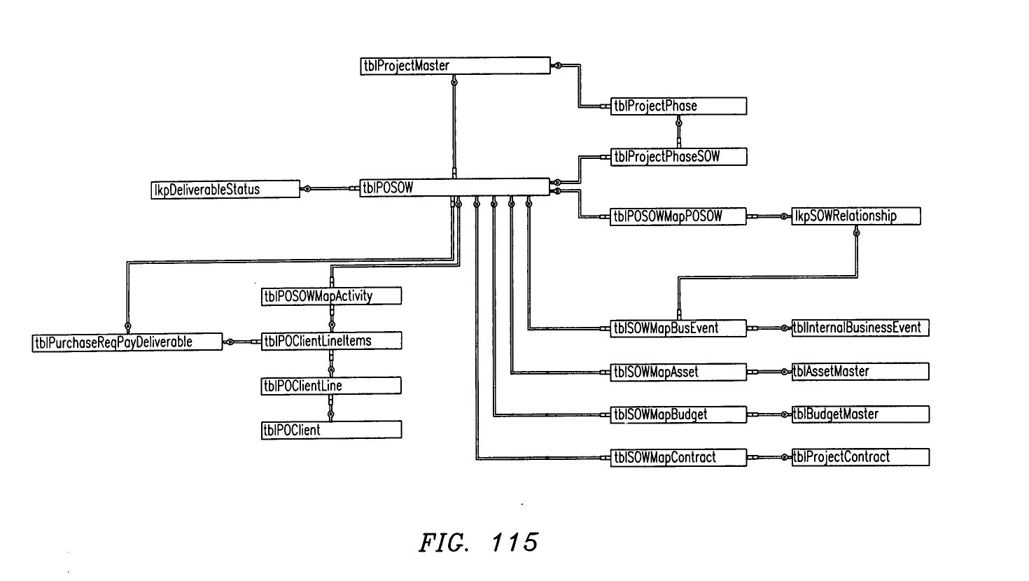

FIG. 113 illustrates a process flow 11300 that maps SOW/deliverable records to business event records. The process flow 11300 begins at step 11303, at which step an authorized buyer user activates business administration control from, for example, a project master home page. At step 11305, the system provides the user a list display of the default configured project-related business-event records. At step 11310, the user selects an applicable business-event record. At step 11315, the system provides the user a list display of SOW/deliverable records aggregated by project phase. At step 11320, the user selects applicable SOW/deliverable records. At step 11323, the system provides an input page to the user. At step 11325, the user selects a business unit from, for example, a drop down menu. At step 11330, the user selects a cost center from, for example, a drop down menu. At step 11335, the user optionally selects an applicable customer from, for example, a drop down menu. At step 11340, the user specifies a relationship type. At step 11345, the user specifies if a dependency constraint is forced. At step 11350, the user selects an event administrative owner from, for example, a drop down menu. At step 11355, the user saves the previously-made settings.

At step 11360, the system runs a business-event validation routine. At step 11365, a determination is made as to whether the validation was positive or not. Responsive to positive validation at step 11365, execution proceeds to step 11370. At step 11370, systematic notification to an approved business event administrator occurs. At step 11375, event administrator disposition occurs. Responsive to approval at step 11375, execution proceeds to step 11380, at which step affiliations are stored in a database. At step 11385, systematic notification to the project owner occurs. The mappings of the process flow 11300 are stored in a database table, such as, for example, Table 143. Those having skill in the art will appreciate that the process flow 11300 may be bi-directional, even though it is not explicitly depicted as such.

Unlike the other master data records (i.e., budget, asset, and contract master records), business events may represent an element of causality; therefore, dependency mapping, as well as validation, is employed. The dependency mapping is analogous to previously-disclosed when mapping SOW to SOW. Because of the open-ended nature of business events, virtually anything happening within a business entity could be tied to projects via the master-data-to-SOW integration.

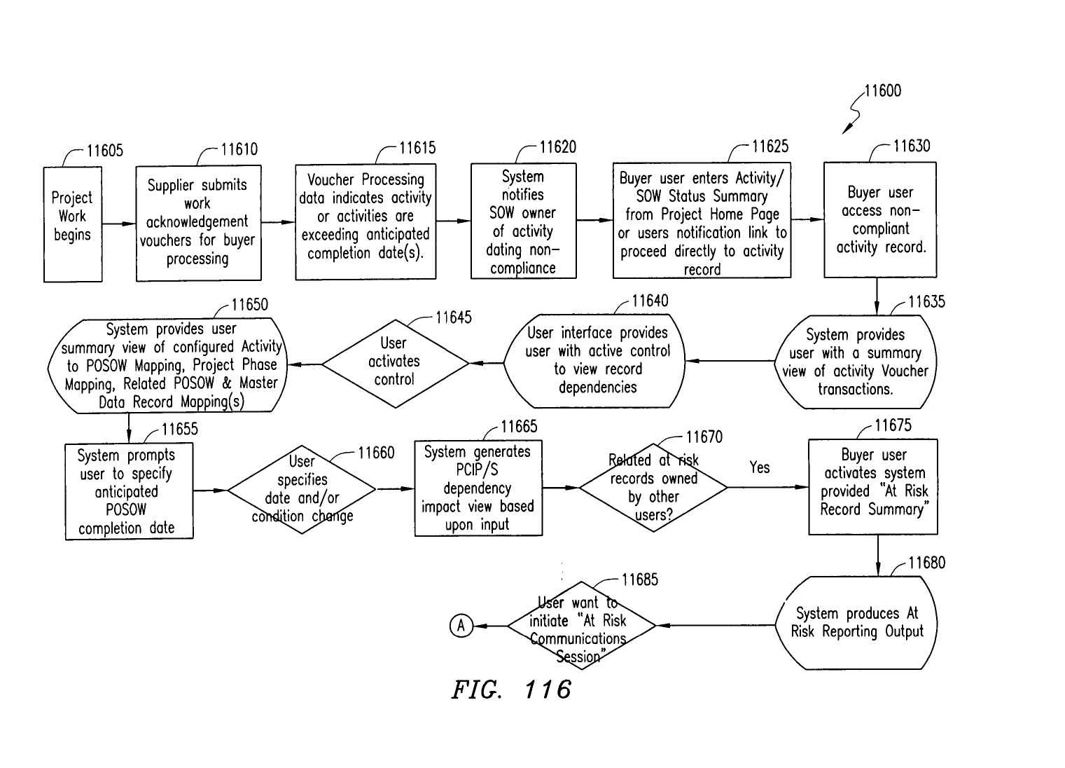

FIG. 114 illustrates an exemplary user interface web page depicting a high-level reporting summary for project groups and project master records. The record affiliation configuration facilitates optimization of views and provision of project work users access to all pertinent details and users those having skill in the art will appreciate that other views could be provided to depict relationships and timing, a data output view being depicted for purposes of simplicity and ease of comprehension.

FIG. 115 illustrates an exemplary supporting database schema that could be used in connection with the process flows discussed above.

Project Commencement and PCIP/S At Risk Summary Reporting Model

Following configuration of dependencies and mapping of business records to specific project work deliverable/SOW records, the project would ultimately commence. The previously-described activities facilitate downstream submission of supplier activity work vouchers. The voucher process is a process by which the supplier submits, to a configured buyer user, a work-performed acknowledgement request. This request may or may not be associated with a billable event.

FIG. 116 illustrates a voucher process flow 11600 that results in identification of at-risk business records and produces an at-risk reporting output as shown generally at steps 9353-9356 of FIG. 93. The process flow 11600 begins at step 11605. At step 11605, project work begins. At step 11610, the supplier submits work-acknowledgment vouchers for buyer processing. At step 11615, voucher processing data indicates one or more activities that are exceeding anticipated completion date(s). At step 11620, the system notifies the SOW owner of activity-dating non-compliance.

At step 11625, the buyer user enters activity/SOW status summary from, for example, a project home page, or uses, for example, a notification link to proceed directly to an activity record. At step 11630, the buyer user accesses the non-compliant activity record. At step 11635, the system provides the user with a summary view of activity voucher transactions. At step 11640, a user interface provides the user with an active control to view record dependencies. At step 11645, the user activates the active control. At step 11650, the system provides the user with a summary view of configured activity to purchase order SOW, mapping, project phase mapping, related purchase order SOW and master data record mapping(s). At step 11650, the user gets access to the big picture where all configured relationships can be displayed. Within this view, there is typically information regarding the nature of the relationships pertinent to the SOW record that the activity in question belongs to.

At step 11655, the system prompts the user to specify an anticipated purchase order SOW completion date. Only at the project SOW ownership level could this take place by an individual that is involved in actual execution of the project. At step 11660, the user specifies a date and/or condition change. If a determination is made that an impact will be made to the purchase order SOW, the user may then establish either a condition or dating modification. In extreme cases, the condition change could be complete failure or cancellation, while in less-extreme cases, perhaps just an extended due date is appropriate.

At step 11665, the system generates a PCIP/S dependency impact view based upon the user input at step 11660. Though not explicitly depicted, there could be the situation where no purchase order SOW impact will result or just a simple administrative issue in which the supplier was tardy in submitting the voucher, even though the activity was actually dating compliant. In such case there would be no change to the impact view and the session could be terminated.

At step 11670, a determination is made whether related at-risk records are owned by other users. Responsive to a positive determination at step 11670, execution proceeds to step 11675, at which step, the buyer user activates a system-provided at-risk record summary. At step 11680, the system produces an at-risk reporting output. At step 11685, the user may select whether to initiate an at-risk communications session.

Although not explicitly indicated in the process 11600, those having skill in the art will appreciate that, in a scenario in which impacts are made to a related purchase order SOW alone (or additional purchase order SOWs owned by the project owner), changes to be made due to risks would not impact any external record dependencies or relationships. In such a scenario, a unilateral record-modification procedure could be employed by which all records could be updated via user-controlled inputs.

PCIP/S at Risk Communications Session

At step 11685, the buyer entity is now armed with the information structure to understand potential impacts to a host of related project and master records. Although possession of this information does not preclude negative impacts from occurring, it does provide visibility, and if used correctly, provides planning opportunities. Those having skill in the art will appreciate that the information may be used in a manner that gives users the visibility and access to data needed to make informed and up-to-date business decisions and maintain information regarding the source of the risks.

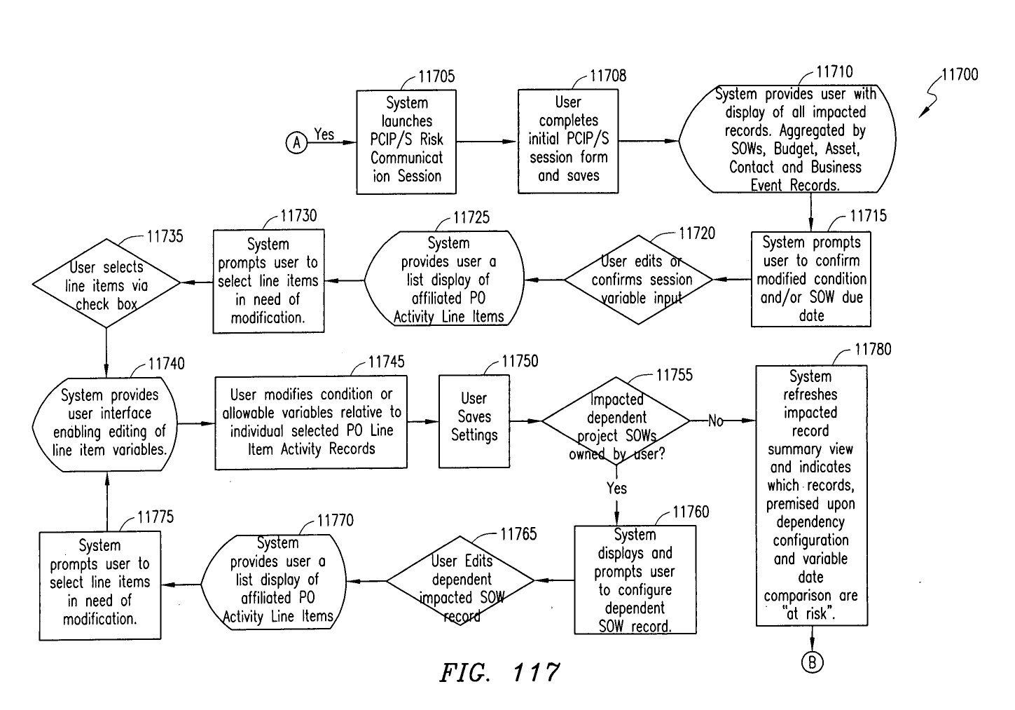

FIGS. 117-119 illustrate PCIP/S risk communications session process flows 11700-11900, including at-risk SOW record owner package configuration and the broadcast of that package to impacted users and impacted users record data processing resulting with a completed record set being submitted back to the issuing user. Referring now to FIG. 117, the process flow 11700 begins at step 11705, which step proceeds from step 11685 of the process flow 11600. At step 11705, the system launches the PCIP/S at-risk communication session. At step 11708, the user completes an initial PCIP/S session form and saves the form. At step 11710, the system provides the user with a display of all impacted records. These records may be aggregated by, for example, SOWs, budget, asset, contract, and business event records. At step 11715, the system prompts the user to confirm modified condition and/or SOW due date. At step 11720, the user edits or confirms session variable input. At step 11725, the system provides the user a list display of affiliated purchase order activity line items. At step 11730, the system prompts the user to select line items in need of modification. At step 11735, the user selects line items via, for example, a check box.

At step 11740, the system provides a user interface enabling editing of line item variables. At step 11745, the user modifies condition or allowable variables relative to the individual selected purchase order line item activity records. At step 11750, the user saves the previously-made settings. Upon completion of the edits to the project work activities, the user may save these settings. These activity record slated modifications are stored in a database table, such as, for example, Table 149.

At step 11755, a determination is made as to whether the impacted dependent project SOWs are owned by the user. If it is determined in the negative at step 11755, the system refreshes the impacted record summary view and indicates which records, premised upon dependency configuration and variable data comparison are at risk. If the determination is in the positive at step 11755, execution proceeds to step 11760. At step 11760, the system displays and prompts the user to configure the dependent SOW record. At step 11765, the user edits the dependent impacted SOW record. At step 11770, the system provides the user a list display of affiliated of purchase order activity line items. At step 11775, the system prompts the user to select line items in need of modification. From step 11775, execution returns to step 11770.

Once the reporting output supports a PCIP/S session, the user launches the PCIP/S session in response to a system prompt/control provided with the output report. After completing a base information input form, at step 11708, the system produces an output view of the complete record set affiliated with the at-risk or failed SOW record at step 11710. The completion of the initial form and saving thereof is stored in a database table, such as, for example, Table 144.

The user is then prompted by the system to confirm the data modifications initially utilized to generate the at risk dependency report. The user can then confirm or modify the original inputs at step 11720.

Because the project work activities have been linked to SOW records, the system is able to provide the user with a list display of all activity records feeding into the SOW. Due to anticipated SOW changes, other project work activity records, as well as the causal activity record may need modification. The selection of these activity records takes place at step 11735.

Upon selection, the system provides the user with an edit interface for each individual selected record. The edit interface may vary based upon the activity itself. For instance, the condition and/or data fields pertinent to a human resource work assignment are typically different than those available for processing another activity, such as, for example, a material delivery. These record modifications are depicted as step 11745.

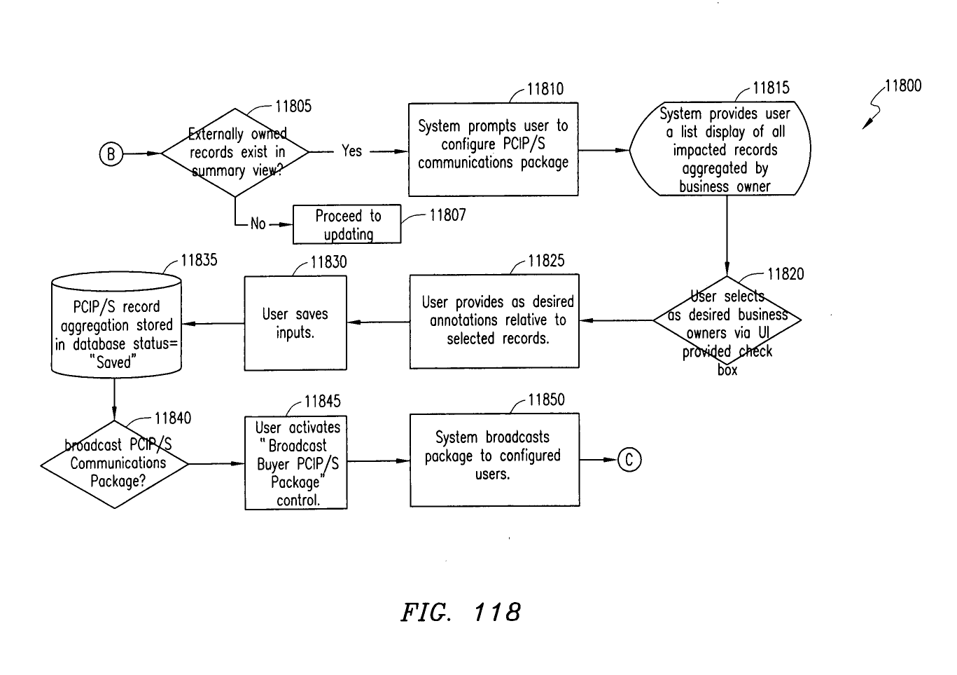

FIG. 118 illustrates a PCIP/S risk communications session process flow 11800 described generally at step 9365 of FIG. 93. The process flow 11800 begins at step 11805, which step proceeds from step 11780. At step 11805, a determination is made whether externally-owned records exist in the summary view. If the determination at step 11805 is in the negative, execution proceeds to step 11807, at which step the flow proceeds to updating at step 11807. If, however, the determination at step 11805 is in the positive, execution proceeds to step 11810. At step 11810, the system prompts the user to configure a PCIP/S communications package by which annotations can be made for as-desired individual user (owner) record sets.

From step 11810, execution proceeds to step 11815, at which step the system provides to the user a list display of all impacted records aggregated by business owner. At step 11820, the user selects as-desired business owners via, for example, a user-interface-provided check box. At step 11825, the user provides as-desired annotations relative to the selected records. At step 11830, the user saves previously-made inputs. At step 11835, the PCIP/S record aggregation is stored in a database with a status of “saved”. At step 11840, the user is prompted regarding whether they want to broadcast the PCIP/S communications package. If the user opts to broadcast the communications package, execution proceeds to step 11845, at which step the user activates a “broadcast buyer PCIP/S package” control. At step 11850, the system broadcasts the package to configured users, with notification typically issuing via e-mail and system-forward updates.

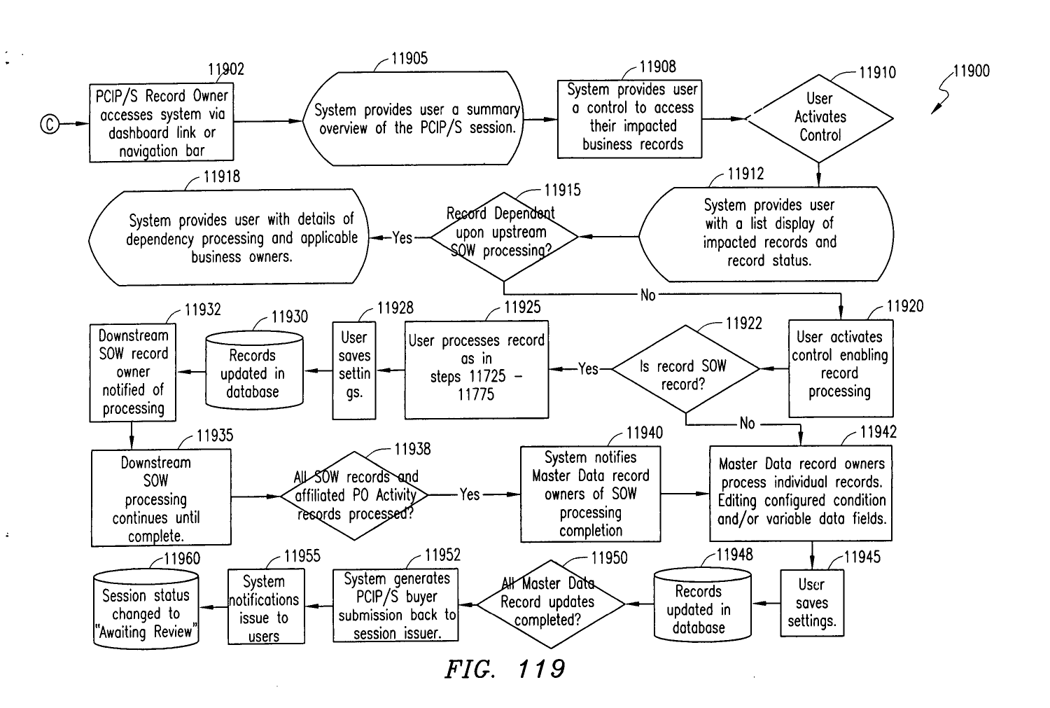

FIG. 119 illustrates the impacted user(s) handling of the PCIP/S information package as generally shown at step 9370 of FIG. 93. The process flow 11900 relative to handling by the impacted user(s) of the PCIP/S information package begins at step 11902, at which step an impacted buyer user accesses the PCIP/S information collection. At step 11905, the system provides to the user a summary overview of the PCIP/S session details, including information such as issuer, date broadcast, and date received. At step 11908, the system provides to the user control to access impacted business records. Although not explicitly depicted, a view of other impacted records belonging to other users may be provided at step 1908 as well in accordance with buyer preferences. At step 11910, the user activates the control. Responsive to control activation at 11910, execution proceeds to step 11912, at which step the system provides the user with a list display of impacted records and record status.

At step 11915, a determination is made as to whether the record is dependent upon upstream SOW processing. Due to the potential of a multi-chain dependent record set, the disposition of a far-downstream record is illogical if the pertinent upstream dependent record(s) have not been processed. If it is so determined in the positive at step 11915, execution proceeds to step 11918. At step 11918, the system provides the user with details of dependency processing and applicable business owners. The record is marked inactive for processing with a status of “awaiting upstream SOW disposition.” If, at step 11915, the determination is in the negative, execution proceeds to step 11920. At step 11920, the user activates a control enabling record processing. At step 11922, a determination is made as to whether the record is an SOW record. If it is so determined at step 11922, execution proceeds to step 11925, at which step the user processes the record as in steps 11725-11775.

From step 11925, execution proceeds to step 11928. At step 11928, the user saves the previously-made settings. At step 11930, records are updated in a database. At step 11932, a downstream SOW record owner(s) are notified of processing as needed. At step 11935, the downstream SOW processing continues until complete. At step 11938, a determination is made whether all SOW records and affiliated purchase order activity records have been processed. If it so determined at step 11938, execution proceeds to step 11940. At step 11940, the system notifies the master data record owners of SOW processing completion. At step 11942, the master record owners process their individual records. Editing of configured condition and/or variable data fields also occurs at step 11942. Step 11942 also executes responsive to a negative determination at step 11922.

From step 11942, execution proceeds to step 11945, at which step the user saves the previously-made settings. At step 11948, records are updated in a database. Master data record disposition settings are stored in a database table, such as, for example, Table 152. As is the case with Table 147, a complex data field ControllableMDDataElements, with a data type of SQL Variant, is used as both the processing storage means for these record settings modifications. This field is an entity type that stores settings in the form of metadata. This data model may include individual database tables representing holding tables for the settings modifications; however, one skilled in the art will recognize this as an alternative database processing mode. At step 11950, a determination is made whether all master data records updates have been completed. Responsive to a positive determination at step 11950, execution proceeds to step 11952. This submission produces systematic notifications to session users and updates the PCIP/S session status in the database to awaiting review. Though not explicitly depicted, the system typically performs validations during all phases of data processing. At step 11952, the system generates a PCIP/S buyer submission back to the session issuer. At step 11955, system notifications issue to users. At step 11960, the session status is changed to “awaiting review.”

Not all records are necessarily modified and, to the extent of buyer preference, various embodiments could operate in various configuration modes that would, for instance, not enforce mandatory dependency-constraint specification or, for instance, facilitate modification to record conditions that would seem illogical from a best-practices perspective. Although entire record sets are typically made available for data processing, the potentially impacted records are not typically cached for processing until the upstream disposition permutations have been completed. Thus, the pre-configuration not only sets the dependencies but also initiates and establishes the work flow within the process.

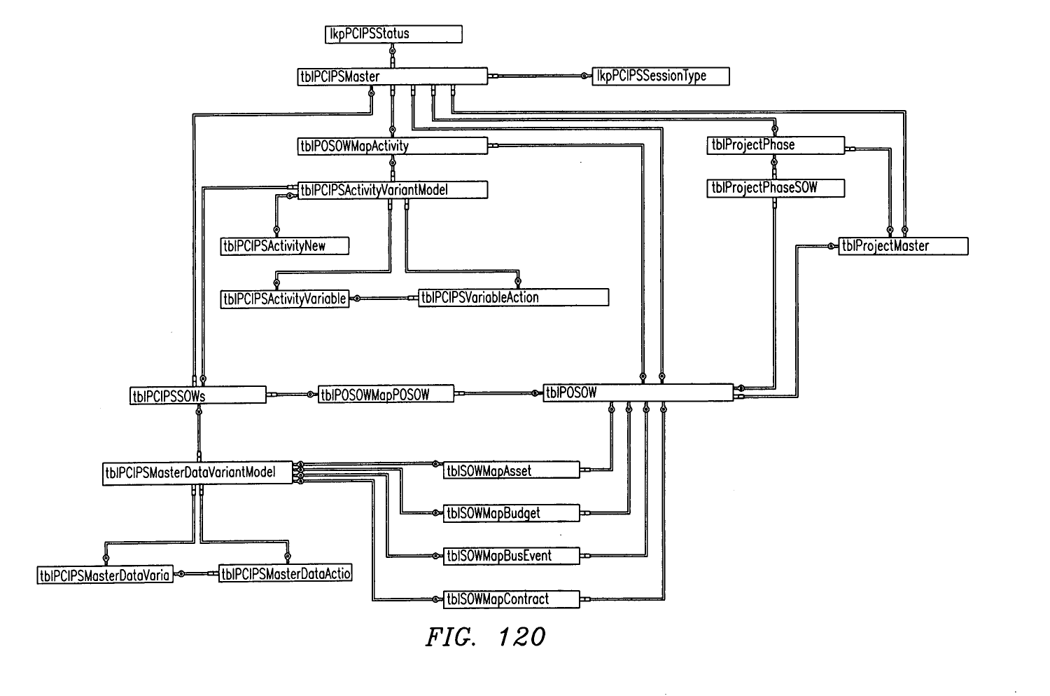

Though not explicitly depicted, the modification of records is typically a collaborative process when the records in question are directly related to the project work activities of a supplier. A bid messaging board that facilitates bi-directional communication between buyers and sellers may be configured and implemented for the PCIP/S session. The messaging board could be used by the buyer to communicate with the supplier regarding any modified terms of project work activities (e.g., pricing, dating, quantities, human resource identities), FIG. 120 is an exemplary database schema that facilitates the PCIP/S communications session.

PCIP/S Supplier Acceptance Package Session

Upon receipt of the buyer PCIP/S at risk communications session inputs, the next phase of the overall method deals with issuance and processing of the acquired inputs by any suppliers impacted by the PCIP/S modifications.

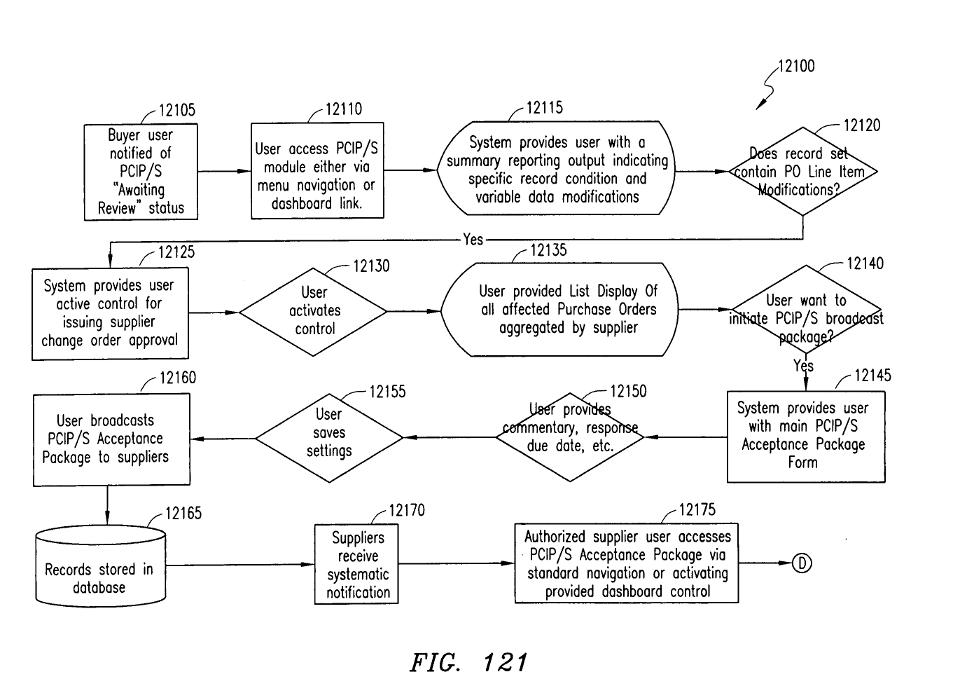

FIG. 121 illustrates a PCIP/S acceptance package session process flow 12100. The process flow 12100 begins at step 12105, at which step a buyer user is notified of PCIP/S “awaiting review” status. At step 12110, the user accesses the PCIP/S module via, for example, menu navigation or a dashboard link. At step 12115, the system provides the user with a summary reporting output indicating specific record condition and variable data modifications. At step 12120, a systematic determination is made relative to the impact on any project work purchase order line items.

Given that purchase order line item modifications are inherent within the record set, at step 12125 the system prompts for the issuance of supplier change order approval. At step 12130, it is presumed that the buyer does not disregard the need for this processing feature. Upon activating the provided control, the system provides the user with a record output summarizing the impacted purchase order records aggregated by supplier at step 12135.

The user is systematically prompted to broadcast/issue the PCIP/S supplier acceptance package. Presuming a positive user action at step 12140, the system provides the user with a main PCIP/S supplier acceptance package web page. The user provides the required basic inputs at step 12150 and, upon the user saving the settings at step 12155, the system broadcasts the PCIP/S supplier acceptance package to applicable suppliers at step 12160 and stores the transactional records in the database at step 12165. Exemplary database tables that could be utilized during this processing phase are shown as Tables 157-161.

Upon broadcast of the PCIP/S supplier acceptance package, the system issues notifications to configured supplier users regarding the pending activity at step 12170. At such time, the authorized supplier user is granted access to session records and utilizes provided navigational controls to access the applicable session records.

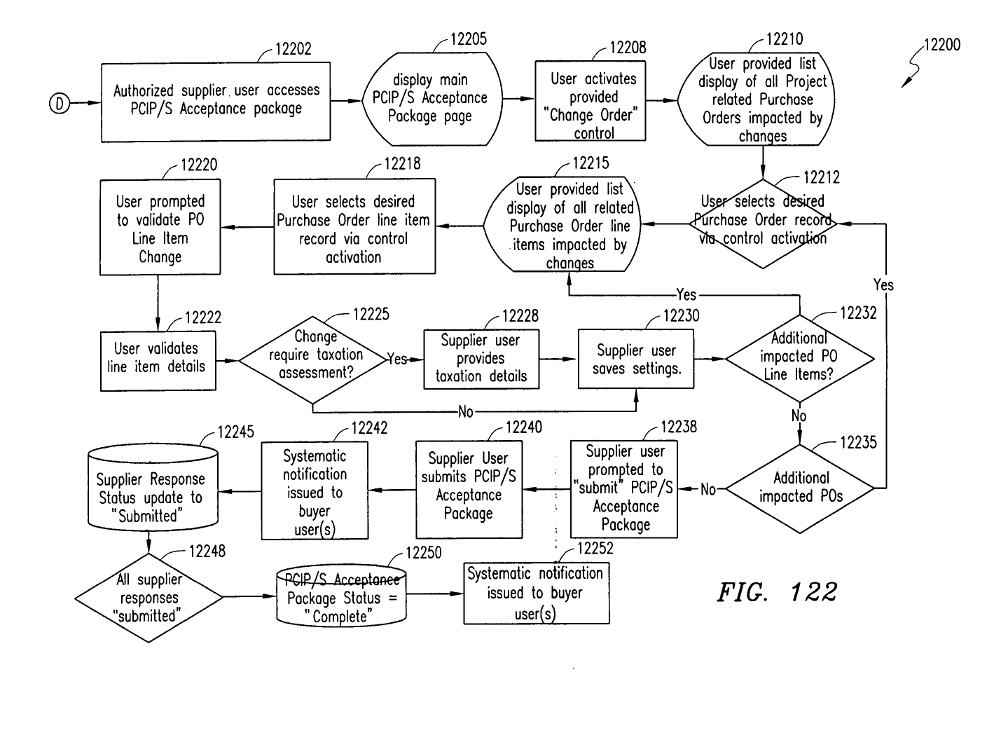

FIG. 122 illustrates a PCIP/S acceptance package session process flow 12200 described generally at step 9375 of FIG. 93. The process flow 12200 begins at step 12202. At step 12202, an authorized supplier user accesses the PCIP/S acceptance package via, for example, a standard navigation or activation of a provided dashboard control. At step 12205, a main PCIP/S acceptance package page is displayed. At step 12208, the user activates a provided change order control, which results in a systematic summary output of any and all affected Purchase Orders at step 12210. At step 12212, the user makes a selection of an individual purchase order for processing, which results in a systematic summary output of impacted Purchase Order Line Items at step 12215. At step 12218, the user selects a specific modified line item for processing. At step 12220, the system provides the user with the purchase order line item details and indicates which data fields have been impacted. The user is prompted to verify the data and or condition change to the activity record.

At step 12222, the supplier user verifies the record modification and proceeds to step 12225, where the system determines, based upon basic configurations, if the data modifications require a supplier taxation assessment. If affirmative, the supplier user provides the required taxation assessment data consisting of input provision of, for example, tax authority, tax threshold amount, tax percent, etc.) At step 12230, the user saves their inputs.

This verification and taxations assessment processing continues until such time that all purchase order line activities and purchase orders are processed at step 12235 and there are no remaining unprocessed records. The user at this point is prompted to submit their inputs back to the Buyer Entity at step 12238. Presuming the logical selection, the supplier user submit back to the buyer entity at step 12240. The system then issues notifications to authorized buyer entity user(s) at step 12242 and updates the PCIP/S supplier acceptance package response to submitted status. This process flow 12200 repeats for all applicable impacted supplier pertinent to the specific PCIP/S supplier acceptance package. Upon submission of all impacted suppliers' responses at step 12248, the PCIP/S supplier acceptance package status is updated to “complete” at step 12250, thereby generating system notifications to authorized Buyer Entity users at step 12252.

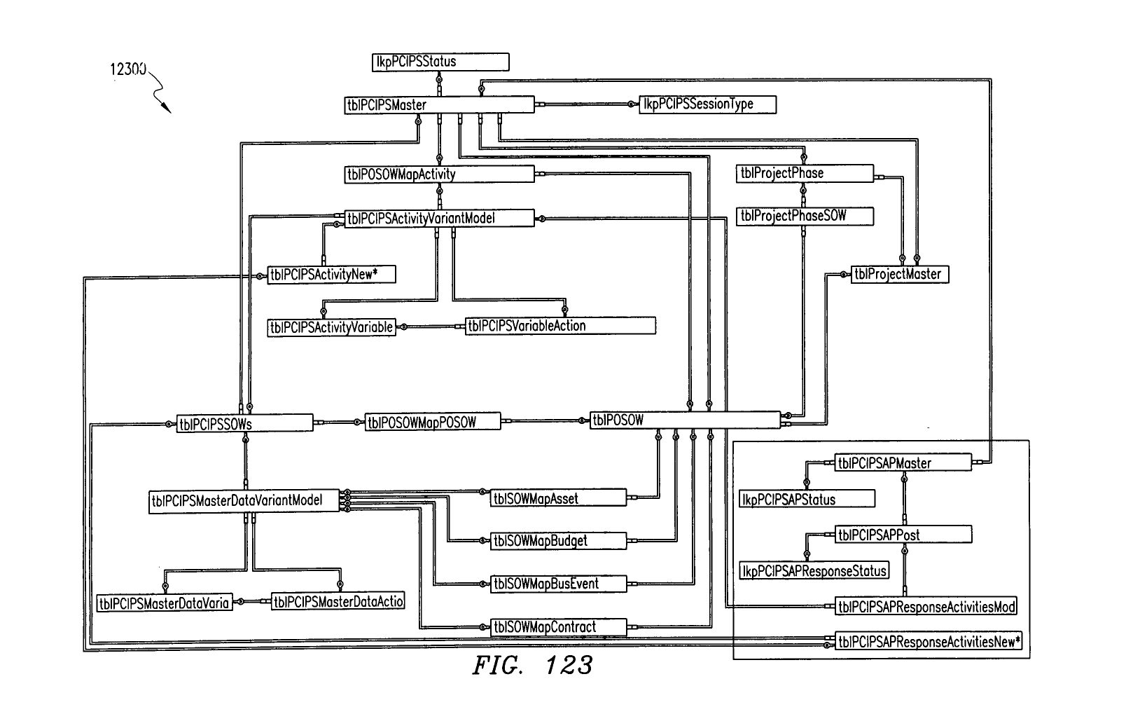

FIG. 123 illustrates a supporting database schema for the PCIP/S system. Those having skill in the art will appreciate that a boxed lower-right section of FIG. 123 illustrates the primary portion the schema of tables discussed above relative to FIGS. 121-122.

PCIP/S Record Modification Integration

Upon receipt of all supplier PCIP/S acceptance package responses, the remaining phase comprises final record set approval and integration of the PCIP/S information.

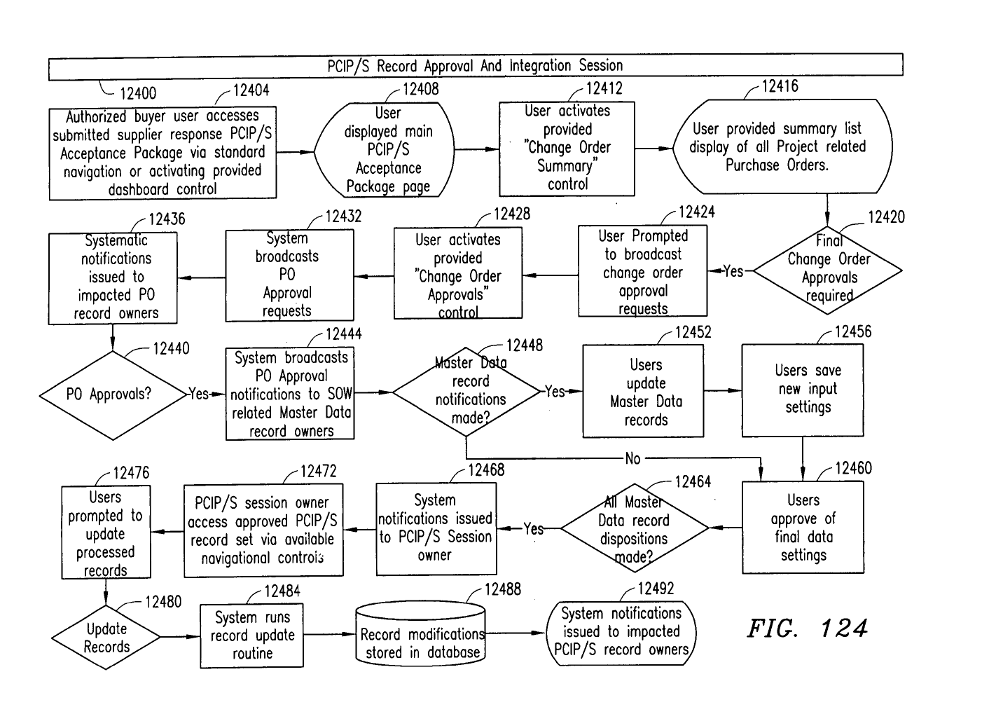

FIG. 124 depicts a PCIP/S record approval and integration session process flow 12400 illustrated generally at steps 9380-9395. The process flow 12400 begins at step 12404, at which step an authorized buyer user accesses a submitted supplier response PCIP/S acceptance package via, for example, standard navigation or dashboard control. At step 12408, the user displays a main PCIP/S acceptance package page. At step 12412, the user activates a provided change order summary control. At step 12416, the user is provided a summary list display of all project related purchase orders. At step 12420, final change order approvals are required. Responsive to the required approvals at step 12420, execution proceeds to step 13424. At step 12424, the user is prompted to broadcast change order approval requests. At step 12428, the user activates provided change order approvals control. At step 12432, the system broadcasts purchase order approval requests. At step 12436, systematic notifications are issued to impacted purchase order record owners. At step 12440, determination is made as to whether purchase order approvals have been made. Responsive to a positive determination at step 12440, execution proceeds to step 12444.

At step 12444, the system broadcasts purchase order approval notifications to statement of work related master data record owners. At step 12448, determination is made whether master data record modifications have been made. Responsive to a positive determination at step 12448, execution proceeds to step 12452, at which step users update master data records. At step 12456, users save new input settings. At step 12460, users approval of final data settings. Responsive to a negative determination at step 12448, execution proceeds to step 12460.

From step 12460, execution proceeds to step 12464. At step 12464, determination is made as to whether all master date record dispositions have been made. Responsive to a positive determination at step 12464, execution proceeds to step 12468. At step 12468, system notifications are issued to the PCIP/S session owner. At step 12472, the PCIP/S session owner accesses approved PCIP/S records set via available navigational control. At step 12476, the users are prompted to update process records. At step 12480, the records are updated. At step 12484, the system runs a record of date routine. At step 12488, record modifications are stored in a database. At step 12492, system notifications are issued to impacted PCIP/S record owners.

Purchase order approvals are transacted first to insure that master data records do not get final approvals or are possibly edited based upon incomplete or non-approved purchase-order data.

Master data processing is secondary to transactional project work data. Master data edit functionality is predicated upon the desire to update any records that might be impacted by the supplier acceptance package response data settings.

TABLE 113
tblProjectGroup (Design View)

| Column | Data Type | Length |
|---|---|---|
| ProjectGroupID | int | 4 |
| ProjectGroupName | varchar | 50 |
| ProjectGroupDesc | varchar | 1000 |
| UserGUID | uniqueidentifier | 16 |
| Record_Date | datetime | 8 |
| PGOwner_ID | sqlvariant | |
| Position_ID | int | 4 |
| DefaultBUGroup | sqlvariant | |
| DefaultCCGroup | sqlvariant | |

TABLE 114
tblProjectMaster (Design View)

| Column | Data Type | Length |
|---|---|---|
| SysProjectCode | uniqueidentifier | 16 |
| UserGUID | uniqueidentifier | 16 |
| ProjectID | int | 4 |
| ProjectCode | varchar | 20 |
| ProjectName | varchar | 50 |
| ProjectDescription | varchar | 500 |
| ProjectGroupID | int | 4 |
| ProjectGroupHierarchy | sqlvariant | 4 |
| PMOwner_ID | uniqueidentifier | 16 |
| Position_ID | int | 4 |
| PMOwnershipID | int | 4 |
| ProjectImpactCodeID | int | 4 |
| Record_Date | datetime | 8 |
| Project_Status_ID | int | 4 |

TABLE 114A
tblProjectGroupHierarchy (Design View)

| Column | Data Type | Length |
|---|---|---|
| ProjectGroupID | int | 4 |
| SysProjectCode | uniqueidentifier | 16 |
| RelatedProjectID | int | 4 |
| ProjectHierarchyID | int | 4 |
| RecordID | uniqueidentifier | 16 |
| PGBundleID | uniqueidentifier | 16 |

TABLE 115
(Design)
lkpProjectHierarchy (Design View)

| Column | Data Type | Length |
|---|---|---|
| ProjectHierarchyID | int | 4 |
| ProjectHierarchyName | varchar | 50 |

(Data)
lkpProjectHierarchy (Data View)

| ProjectHierarchyID | ProjectHierarchyName |
|---|---|
| 1 | Primary |
| 2 | Dependent Child |
| 3 | Independent Child |
| 4 | Parallel Dependent |
| 5 | Parallel Independent |
| 6 | Sister - Independent |
| 7 | Sister - Dependent |

TABLE 116
tblCostCenter (Design View)

| Column | Data Type | Length |
|---|---|---|
| CCID | int | 4 |
| [Dept/Cost_Center] | varchar | 50 |
| BUID | int | 4 |
| BU_Code | nvarchar | 50 |
| Business_Unit_Name | nvarchar | 200 |

TABLE 117
tblProjectMapCC (Design View)

| Column | Data Type | Length |
|---|---|---|
| SysProjectCode | uniqueidentifier | 16 |
| [Dept/Cost_Center] | sqlvariant | |
| ProjectMapCCRecordID | uniqueidentifier | 16 |

TABLE 118
tblBudgetGroup (Design View)

| Column | Data Type | Length |
|---|---|---|
| BudgetGroupID | int | 4 |
| BudgetGroupName | varchar | 50 |
| BudgetGroupDesc | varchar | 500 |
| BudgetGroupDollars | money | 8 |
| BudgetPeriod | sqlvariant | |
| BudgetDrawdown | money | 8 |
| Record_Date | datetime | 8 |
| BGOwner_ID | sqlvariant | |
| Position_ID | int | 4 |
| DefaultBUGroup | sqlvariant | |
| DefaultCCGroup | sqlvariant | |
| UserGUID | uniqueidentifier | 16 |

TABLE 119
tblBudgetMaster (Design View)

| Column | Data Type | Length |
|---|---|---|
| BudgetID | int | 4 |
| BudgetName | varchar | 50 |
| BudgetMasterDesc | varchar | 500 |
| BudgetGroupID | int | 4 |
| DefaultCCGroup | sqlvariant | |
| BudgetMasterPeriod | sqlvariant | |
| BudgetDollars | money | 8 |
| BM_Owner_ID | sqlvariant | |
| Position_ID | int | 4 |
| BudgetDrawdownActual | money | 8 |
| BudgetDrawdownEncumberance | money | 8 |
| Record_Date | datetime | 8 |
| UserGUID | uniqueidentifier | 16 |
| BudgetBundleID | uniqueidentifier | 16 |

TABLE 120
tblProjectMapBudget (Design View)

| Column | Data Type | Length |
|---|---|---|
| BudgetMapProjectID | uniqueidentifier | 16 |
| BudgetID | int | 4 |
| SysProjectCode | uniqueidentifier | 16 |
| EntireProjectSpend | bit | 1 |
| PartialProjectSpend | bit | 1 |
| ProjectSpendPercent | float | 8 |
| PBUserID | sqlvariant | |

TABLE 121
tblInternalBusinessEvent (Design View)

| Column | Data Type | Length |
|---|---|---|
| NPBusEventID | int | 4 |
| NPBusEventName | varchar | 50 |
| NPBusEventDesc | varchar | 500 |
| DefaultBUGroup | sqlvariant | |
| DefaultCCGroup | sqlvariant | |
| NPStartDate | datetime | 8 |
| NPEndDate | datetime | 8 |
| NPBusinessLocation | varchar | 100 |
| Work_Location_Code | numeric | 9 |
| CustomerAffiliations | sqlvariant | |
| NPBusEventImpactCode | int | 4 |
| BE_User_ID | sqlvariant | |
| Position_ID | int | 4 |
| UserGUID | uniqueidentifier | 16 |
| Record_Date | datetime | 8 |

TABLE 122
tblProjectMapBusEvent (Design View)

| Column | Data Type | Length |
|---|---|---|
| NPBusEventID | int | 4 |
| SysProjectCode | uniqueidentifier | 16 |
| ProjectMapBusEventID | uniqueidentifier | 16 |
| BE_User_ID | uniqueidentifier | 16 |

TABLE 123
tblContract (Design View)

| Column | Data Type | Length |
|---|---|---|
| sysDocID | uniqueidentifier | 16 |
| SysDocTypeID | int | 4 |
| ContractReference | varchar | 100 |
| ContractTypeID | int | 4 |
| ContractStartDate | datetime | 8 |
| ContractEndDate | datetime | 8 |
| MaxContractLimit | money | 8 |
| ActivityScope | sqlvariant | |
| SOWForceMajeur | bit | 1 |
| SpecifiedExclusions | bit | 1 |
| SpecifiedExclusionsDesc | sqlvariant | |
| ContractVendorID | int | 4 |
| CustomerID | sqlvariant | 4 |
| CMUserID | sqlvariant | |
| Position_ID | int | 4 |
| DefaultBUGroup | sqlvariant | |
| DefaultCCGroup | sqlvariant | |
| UserGUID | uniqueidentifier | 16 |
| Record_Date | datetime | 8 |

TABLE 124
tblProjectMapContract (Design View)

| Column | Data Type | Length |
|---|---|---|
| sysDocID | sqlvariant | 16 |
| SysProjectCode | uniqueidentifier | 16 |
| ProjectMapContractID | uniqueidentifier | 16 |
| PCUserID | sqlvariant | |

TABLE 125
tblAssetGroup (Design View)

| Column | Data Type | Length |
|---|---|---|
| AssetGroupID | int | 4 |
| AssetGroupName | varchar | 50 |
| AssetGroupDesc | varchar | 500 |
| CapitalAssetBudgetID | sqlvariant | |
| DefaultBUGroup | sqlvariant | |
| DefaultCCGroup | sqlvariant | |
| AGOwner_ID | sqlvariant | |
| Position_ID | int | 4 |
| UserGUID | uniqueidentifier | 16 |
| Record_Date | datetime | 8 |

TABLE 126
tblAssetMaster (Design View)

| Column | Data Type | Length |
|---|---|---|
| AssetMasterID | int | 4 |
| AssetMasterName | varchar | 50 |
| AssetDesc | sqlvariant | |
| AssetGroupID | int | 4 |
| CapitalAssetBudgetID | int | 4 |
| AssetValue | money | 8 |
| PlannedAssetAcquireDate | datetime | 8 |
| DefaultBUGroup | sqlvariant | |
| DefaultCCGroup | sqlvariant | |
| AssetStatusID | int | 4 |
| AMUserID | sqlvariant | |
| Position_ID | int | 4 |
| UserGUID | uniqueidentifier | 16 |
| Record_Date | datetime | 8 |

TABLE 127
tblProjectMapAsset (Design View)

| Column | Data Type | Length |
|---|---|---|
| SysProjectCode | uniqueidentifier | 16 |
| AssetID | int | 4 |
| ProjectMapAssetID | uniqueidentifier | 16 |
| PAUserID | sqlvariant | |

TABLE 128
tblProjectMapRFx (Design View)

| Column | Data Type | Length |
|---|---|---|
| SysProjectCode | uniqueidentifier | 16 |
| RFxOrder_ID | int | 4 |
| ProjMapOrderID | uniqueidentifier | 16 |

TABLE 129
tblProjectMapReq (Design View)

| Column | Data Type | Length |
|---|---|---|
| SysProjectCode | uniqueidentifier | 16 |
| RequisitionID | int | 4 |
| ProjMapReqID | uniqueidentifier | 16 |

TABLE 130
tblPO_Vendor (Design View)

| Column | Data Type | Length |
|---|---|---|
| POIdentityID | int | 4 |
| POIdentity | uniqueidentifier | 16 |
| ClientPONum | varchar | 12 |
| PurchaseReqID | int | 4 |
| POStart | datetime | 8 |
| POEnd | datetime | 8 |
| POApprovedAmount | money | 8 |
| POProjectedAmount | money | 8 |
| CurrencyID | int | 4 |
| POVersion | int | 4 |
| VendorPONum | varchar | 14 |
| VersionEffectiveDate | datetime | 8 |
| POProcessorID | int | 4 |
| ProcessFee | numeric | 9 |
| CurrentStatusID | int | 4 |
| Response_id | int | 4 |
| Order_id | int | 4 |
| Vendor_id | int | 4 |
| PO_RFX_TemplateID | int | 4 |
| PO_Project_Type_ID | int | 4 |
| PODays | int | 4 |
| POStatusID | int | 4 |
| User_id | int | 4 |
| User_type | int | 4 |
| orderGUID | uniqueidentifier | 16 |
| ClientPoSetUpStatus | int | 4 |
| POApprovedTaxAmount | money | 8 |
| PMOwnerShipID | int | 4 |
| ProjectImpactCodeID | int | 4 |
| PODynamicTypeID | int | 4 |
| Po_Modified | datetime | 8 |
| PoApprovedAmount_Modified | datetime | 8 |

TABLE 131
tblPOClient (Design View)

| Column | Data Type | Length |
|---|---|---|
| POClientID | int | 4 |
| POIdentityID | int | 4 |
| POClientIdentity | uniqueidentifier | 16 |
| POIdentity | uniqueidentifier | 16 |
| CreatedDate | datetime | 8 |
| SCETier1PO | char | 1 |
| SCETier2PO | char | 1 |
| RequisitionID | int | 4 |
| POOpenDate | datetime | 8 |
| POCloseDate | datetime | 8 |
| PO$Limit | money | 8 |

TABLE 132
tblPOClientLine (Design View)

| Column | Data Type | Length |
|---|---|---|
| POClientLineIdentityID | int | 4 |
| POClientID | int | 4 |
| POClientLineIdentity | uniqueidentifier | 16 |
| POClientIdentity | uniqueidentifier | 16 |
| PoIdentity | uniqueidentifier | 16 |
| LineName | varchar | 100 |
| Description | varchar | 1000 |
| SortOrder | int | 4 |
| CreatedDate | datetime | 8 |
| PoLineNumber | int | 4 |
| LastModified | datetime | 8 |
| POLineOpenDate | datetime | 8 |
| POLineCloseDate | datetime | 8 |
| POLineMaxCost | money | 8 |
| POLine$Limit | money | 8 |
| Billable | bit | 1 |

TABLE 133
tblPOClientLineItems (Design View)

| Column | Data Type | Length |
|---|---|---|
| POClientLineDetailID | int | 4 |
| POClientLineID | int | 4 |
| POClientLineDetailIdentity | uniqueidentifier | 16 |
| POClientLineIdentity | uniqueidentifier | 16 |
| ActivityType | varchar | 5 |
| EarningCode | varchar | 5 |
| ParentRefGuid | uniqueidentifier | 16 |
| ParentRefTableName | varchar | 200 |
| ActivityGuid | uniqueidentifier | 16 |
| POidentity | uniqueidentifier | 16 |
| ActivityTypeName | varchar | 50 |
| SortOrder | int | 4 |
| CreatedDate | datetime | 8 |
| LastModified | datetime | 8 |
| PRPDeliverableID | int | 4 |
| PRPMaterialBundleID | int | 4 |
| ProjectExpensesID | int | 4 |
| PurchaseReqPayRateID | int | 4 |
| ContractorExpensesBundleID | int | 4 |
| PRPUnitID | int | 4 |

TABLE 134
tblPOSOW (Design View)

| Column | Data Type | Length |
|---|---|---|
| POSOWID | uniqueidentifier | 16 |
| SysProjectCode | uniqueidentifier | 16 |
| PRPDeliverableID | int | 4 |
| SOWName | varchar | 50 |
| SOWDesc | varchar | 1000 |
| DueDate | datetime | 8 |
| Risk_Assessment_Date | datetime | 8 |
| SOWStatusID | int | 4 |
| SOW_Owner_ID | int | 4 |
| PMOwnershipID | int | 4 |
| PhaseID | int | 4 |
| PayDrawDownToDate | money | 8 |
| MaxDrawDown | money | 8 |
| Commentary | varchar | 1000 |
| Create_Date | datetime | 8 |
| User_ID | int | 4 |

TABLE 135
tblPOSOWMapActivity (Design View)

| Column | Data Type | Length |
|---|---|---|
| POSOWID | uniqueidentifier | 16 |
| POClientLineDetailID | int | 4 |
| POSOWMapPOLineItemID | uniqueidentifier | 16 |

TABLE 136
tblProjectPhase (Design View)

| Column | Data Type | Length |
|---|---|---|
| ProPhaseID | uniqueidentifier | 16 |
| SysProjectCode | uniqueidentifier | 16 |
| ProPhaseName | varchar | 50 |
| ProPhaseDesc | varchar | 1000 |
| ProPhaseNumber | numeric | 9 |
| PhasePOInvestment | money | 8 |
| ProjPhaseDueDatePlan | datetime | 8 |
| ProPhaseDueDateTrans | sqlvariant | 8 |
| ProPhaseStatus | int | 4 |
| CreateDate | datetime | 8 |
| UserID | int | 4 |

TABLE 137
tblProjectPhaseSOW (Design View)

| Column | Data Type | Length |
|---|---|---|
| ProPhaseID | uniqueidentifier | 16 |
| POSOWID | uniqueidentifier | 16 |
| POSOWInvestment | money | 8 |
| PhaseCost % | float | 8 |
| PhaseImportance % | float | 8 |
| PhaseCompletionImpact | int | 4 |
| RecordID | uniqueidentifier | 16 |

TABLE 138
tblPOSOWMapPOSOW (Design View)

| Column | Data Type | Length |
|---|---|---|
| POSOWID | uniqueidentifier | 16 |
| RelatedPOSOWID | uniqueidentifier | 16 |
| RelationshipTypeID | int | 4 |
| DependencyConstraint | bit | 1 |
| RelationshipCommentary | varchar | 500 |
| Create_Date | datetime | 8 |
| UserID | int | 4 |
| POSOWMapPOSOWID | uniqueidentifier | 16 |

TABLE 139
(Design)
lkpSOWRelationship (Design View)

| Column | Data Type | Length |
|---|---|---|
| RelationshipTypeID | int | 4 |
| RelationshipName | varchar | 20 |
| RelationshipDesc | varchar | 100 |

(Data)
lkpSOWRelationship (Data View)

| RelationshipTypeID | RelationshipName |
|---|---|
| 1 | Parallel |
| 2 | Tandem |
| 3 | Dependent-Parent |
| 4 | Dependent-Child |

TABLE 140
tblSOWMapBudget (Design View)

| Column | Data Type | Length |
|---|---|---|
| POSOWMapBudget | uniqueidentifier | 16 |
| BudgetID | int | 4 |
| POSOWID | uniqueidentifier | 16 |
| SOWBUserID | uniqueidentifier | 16 |
| CCID | int | 4 |
| BUID | int | 4 |
| ApprovalDisposition | int | 4 |
| DispostionDate | int | 4 |
| SOWBUserCommentary | varchar | 1000 |

TABLE 141
tblSOWMapAsset (Design View)

| Column | Data Type | Length |
|---|---|---|
| POSOWMapAsset | uniqueidentifier | 16 |
| AssetID | int | 4 |
| POSOWID | uniqueidentifier | 16 |
| POSOWMapPOLineItemID | uniqueidentifier | 16 |
| CapitalAssetBudgetID | int | 4 |
| SOWAUserID | uniqueidentifier | 16 |
| CCID | int | 4 |
| BUID | int | 4 |
| ApprovalDisposition | int | 4 |
| DispostionDate | int | 4 |
| SOWAUserCommentary | varchar | 1000 |

TABLE 142
tblSOWMapContract (Design View)

| Column | Data Type | Length |
|---|---|---|
| POSOWMapContract | uniqueidentifier | 16 |
| sysDocID | uniqueidentifier | 16 |
| ContractReference | varchar | 100 |
| POSOWID | uniqueidentifier | 16 |
| ForceMajeur | bit | 1 |
| SpecifiedExlusions | bit | 1 |
| SpecifiedExlusionsDesc | varchar | 1000 |
| SOWCUserID | uniqueidentifier | 16 |
| CustomerID | int | 4 |
| CustomerContractRef | varchar | 50 |
| CCID | int | 4 |
| BUID | int | 4 |
| ApprovalDisposition | int | 4 |
| DispostionDate | int | 4 |
| SOWCUserID | uniqueidentifier | 16 |

TABLE 143
tblSOWMapBusEvent (Design View)

| Column | Data Type | Length |
|---|---|---|
| POSOWID | uniqueidentifier | 16 |
| NPBusEventID | int | 4 |
| SOWMapBusEventID | uniqueidentifier | 16 |
| RelationshipTypeID | int | 4 |
| ForcedConstraint | bit | 1 |
| SOWEUserID | uniqueidentifier | 16 |
| CustomerID | int | 4 |
| CCID | int | 4 |
| BUID | int | 4 |
| SOWEUserID | uniqueidentifier | 16 |

TABLE 144
tblPCIPSMaster (Design View)

| Column | Data Type | Length |
|---|---|---|
| PCIPSSessionID | uniqueidentifier | 16 |
| SessionStatusID | int | 4 |
| SessionTypeID | int | 4 |
| SessionReason | varchar | 1000 |
| SessionBroadcastDate | datetime | 8 |
| SessionCreateDate | datetime | 8 |
| PCIPSUserGUID | uniqueidentifier | 16 |
| SysProjectCode | uniqueidentifier | 16 |
| ProPhaseID | uniqueidentifier | 16 |
| POSOWID | uniqueidentifier | 16 |
| CurrentPOSOWIDStatus | int | 4 |
| ModeledPOSOWStatus | int | 4 |
| CausalPOSOWMapPOLineItemID | uniqueidentifier | 16 |

TABLE 145
(Design)
lkpPCIPSStatus (Design View)

| Column | Data Type | Length |
|---|---|---|
| SessionStatusID | int | 4 |
| SessionStatusName | varchar | 50 |
| SessionStatusDesc | varchar | 500 |

(Data)
lkpPCIPSStatus (Data View)

| SessionStatusID | SessionStatusName |
|---|---|
| 1 | Saved |
| 2 | Broadcasted |
| 3 | AwaitingBusOwnerResponse |
| 4 | AwaitingReview |
| 5 | Reviewed |
| 6 | Approved |
| 7 | AwaitingIntegration |
| 8 | Integrated |
| 9 | Closed |

TABLE 146
(Design)
lkpPCIPSSessionType (Design View)

| Column | Data Type | Length |
|---|---|---|
| SessionTypeID | int | 4 |
| SessionTypeName | varchar | 50 |
| SessionTypeDesc | varchar | 500 |

(Data)
lkpPCIPSSessionType (Data View)

| SessionTypeID | SessionTypeName |
|---|---|
| 1 | Model |
| 2 | Modification |

TABLE 147
tblPCIPSSOWs (Design View)

| Column | Data Type | Length |
|---|---|---|
| PCIPSSessionID | uniqueidentifier | 16 |
| CausalImpactSOWID | uniqueidentifier | 16 |
| UpstreamPOSOWID | uniqueidentifier | 16 |
| RelatedSOWID | uniqueidentifier | 16 |
| RelationshipTypeID | int | 4 |
| ForcedConstraint | bit | 1 |
| SOWMapSOWID | uniqueidentifier | 16 |
| PCIPSSOWMapID | uniqueidentifier | 16 |
| UPSSOWOwnerID | uniqueidentifier | 16 |
| UPSSOWOwnerCommentary | varchar | 1000 |
| PCIPSSOWImpactBundleID | uniqueidentifier | 16 |
| PCIPSBResponseStatus | int | 4 |
| AvailableProcessingDate | datetime | 8 |
| FinalDispositionDate | datetime | 8 |
| MDueDate | datetime | 8 |
| MRisk_Assessment_Date | datetime | 8 |
| MSOWStatusID | int | 4 |
| MProPhaseID | uniqueidentifier | 16 |
| MMaxDrawDown | money | 8 |
| UpstreamOwnerCommentary | varchar | 1000 |
| OwnerCommentary | varchar | 1000 |

TABLE 148
(Design)
lkpPCIPSSPResponseStatus (Design View)

| Column | Data Type | Length |
|---|---|---|
| ResponseStatusID | int | 4 |
| ResponseStatusName | varchar | 50 |

(Data)
lkpPCIPSSPResponseStatus (Data View)

| SessionTypeID | SessionTypeName |
|---|---|
| 1 | Broadcast |
| 2 | AwaitingUpstreamSOWDisposition |
| 3 | AvailableForProcessing |
| 4 | TemporarySave |
| 5 | Approved |
| 6 | Submitted |

TABLE 149
tblPCIPSActivityVariantModel (Design View)

| Column | Data Type | Length |
|---|---|---|
| PCIPSSessionID | uniqueidentifier | 16 |
| PCIPSSOWImpactBundleID | uniqueidentifier | 16 |
| POSOWMapPOLineItemID | uniqueidentifier | 16 |
| ActivityTypeID | int | 4 |
| ControllableDataElements | sql_variant | |
| POChange | bit | 1 |
| VariableTypeMods | sql_variant | |
| VariableActionMods | sql_variant | |
| UserID | uniqueidentifier | 16 |
| ModificationDate | datetime | 8 |
| PCIPSActivityModID | uniqueidentifier | 16 |
| POChange$ | money | 8 |

TABLE 150
tblPCIPSActivityNew (Design View)

| Column | Data Type | Length |
|---|---|---|
| PCIPSSOWImpactBundleID | uniqueidentifier | 16 |
| PCIPSActivityModID | uniqueidentifier | 16 |
| ActivityTypeID | int | 4 |
| ControllableDataElements | sql_variant | |
| POChange$ | money | 8 |
| PCIPSNewActivityID | uniqueidentifier | 16 |
| POClientLineIdentityID | int | 4 |

TABLE 151
(Design)
tblPCIPSActivityVariable (Design View)

| Column | Data Type | Length |
|---|---|---|
| VariableTypeID | int | 4 |
| VariableTypeDesc | varchar | 25 |

(Data)
tblPCIPSActivityVariable (Data View)

| VariableTypeID | VariableTypeDesc |
|---|---|
| 1 | Time |
| 2 | Location |
| 3 | Quantity |
| 4 | Cost |
| 5 | Resource |
| 6 | Administrative |

TABLE 152
(Design)
tblPCIPSVariableAction (Design View)

| Column | Data Type | Length |
|---|---|---|
| VariableActionID | int | 4 |
| VariableActionDesc | varchar | 50 |
| VariableTypeID | int | 4 |

(Data)
tblPCIPSVariableAction (Data View)

| VariableActionID | VariableActionDesc | VariableTypeID |
|---|---|---|
| 1 | ModifyStartDate | 1 |
| 2 | ModifyEndDate | 1 |
| 3 | ModifyDueDate | 1 |
| 4 | ModifyDeliveryDate | 1 |
| 5 | ModifySchedule | 1 |
| 6 | ChangeWorkLocation | 2 |
| 7 | ChangeDeliveryLocation | 2 |
| 8 | ChangeAdministrativeLocation | 2 |
| 9 | ModifyFacilityAccess | 2 |
| 10 | IncreaseQuantity | 3 |
| 11 | DecreaseQuantity | 3 |
| 12 | StaggerDelivery | 3 |
| 13 | ConsolidateDelivery | 3 |
| 14 | CancelDelivery | 3 |
| 15 | IncreaseUnitCost | 4 |
| 16 | DecreaseUnitCost | 4 |
| 17 | IncreaseAggregateThreshold | 4 |
| 18 | DecreaseAggregateThreshold | 4 |
| 19 | ApplySupplierBonus | 4 |
| 20 | ApplySupplierPenalty | 4 |
| 21 | ApplyWarehousingCharge | 4 |
| 22 | CancelAssignment | 5 |
| 23 | EngageNewResource | 5 |
| 24 | AdministrativePOChange | 6 |

TABLE 153
tblPCIPSMasterDataVariantModel (Design View)

| Column | Data Type | Length |
|---|---|---|
| PCIPSSessionID | uniqueidentifier | 16 |
| CausalImpactSOWID | uniqueidentifier | 16 |
| UpstreamPOSOWID | uniqueidentifier | 16 |
| RelatedSOWID | uniqueidentifier | 16 |
| RelationshipTypeID | int | 4 |
| ForcedConstraint | bit | 1 |
| SOWMapMasterDataID | uniqueidentifier | 16 |
| SOWOwnerID | uniqueidentifier | 16 |
| SOWOwnerCommentary | varchar | 1000 |
| MDRecordOwnerID | uniqueidentifier | 16 |
| MDRecordOwnerCommentary | varchar | 1000 |
| ControllableMDDataElements | sql_variant | |
| ResponseStatusID | int | 4 |
| MDVariableTypeMods | sql_variant | |
| MDVariableActionMods | sql_variant | |
| PCIPSMDRecordID | uniqueidentifier | 16 |
| FinalAppovalDate | datetime | 8 |
| EditedMDDataElements | sql_variant | |

TABLE 154
(Design)
tblPCIPSMasterDataVariable (Design View)

| Column | Data Type | Length |
|---|---|---|
| MDVariableTypeID | int | 4 |
| MDVariableTypeDesc | varchar | 25 |

(Data)
tblMasterDataVariable (Data View)

| MDVariableTypeID | MDVariableTypeDesc |
|---|---|
| 1 | Time |
| 2 | Location |
| 3 | Quantity |
| 4 | Cost |
| 5 | Legal |
| 6 | Administrative |

TABLE 155
(Design)
tblPCIPSMasterDataAction (Design View)

| Column | Data Type | Length |
|---|---|---|
| VariableActionID | int | 4 |
| VariableActionDesc | varchar | 25 |
| VariableTypeID | int | 4 |

(Data)
tblPCIPSMasterDataAction (Data View)

| VariableActionID | Variable Action Desc | VariableTypeID |
|---|---|---|
| 1 | CancelBusinessEvent | 1 |
| 2 | CancelPlannedAssetAcquisition | 1 |
| 3 | ModifyBudgetPeriod | 1 |
| 4 | ModifyContractPeriod | 1 |
| 5 | ModifyEndDate | 1 |
| 6 | ModifyPlannedAcquisitionDate | 1 |
| 7 | ModifyStartDate | 1 |
| 8 | ModifyBusinessEventLocation | 2 |
| 9 | DecreaseAssetQuantity | 3 |
| 10 | IncreaseAssetQuantity | 3 |
| 11 | DecreaseAssetCost | 4 |
| 12 | DecreaseBudgetDollars | 4 |
| 13 | DecreaseContractDollars | 4 |
| 14 | IncreaseAssetCost | 4 |
| 15 | IncreaseBudgetDollars | 4 |
| 16 | IncreaseContractDollars | 4 |
| 17 | ModifyContractExclusions | 5 |
| 18 | TerminateContract | 5 |
| 19 | ModifyBusinessUnit | 6 |
| 20 | ModifyCapitalBudgetID | 6 |
| 21 | ModifyCostCenter | 6 |
| 22 | ModifyCustomerAffilliations | 6 |

TABLE 156
tblPCIPSAPMaster (Design View)

| Column | Data Type | Length |
|---|---|---|
| PCIPSSessionID | uniqueidentifier | 16 |
| PCIPS_APSessionID | uniqueidentifier | 16 |
| PCIPS_APSessionStatusID | int | 4 |
| CreateDate | datetime | 8 |
| APSessionBroadcastDate | datetime | 8 |
| APSessionReason | varchar | 1000 |
| APSessionResponseDueDate | datetime | 8 |
| BuyerOwnerID | uniqueidentifier | 16 |

TABLE 157
lkpPCIPSAPStatus (Design View)

| Column | Data Type | Length |
|---|---|---|
| PCIPS_APSessionStatusID | int | 4 |
| PCIPS_APSessionStatusName | varchar | 50 |

TABLE 158
tblPCIPSAPPost (Design View)

| Column | Data Type | Length |
|---|---|---|
| PCIPS_AP_PostID | uniqueidentifier | 16 |
| PCIPS_APSessionID | uniqueidentifier | 16 |
| VendorID | int | 4 |
| VendorContactID | sql_variant | |
| PCIPS_AP_PostDate | datetime | 8 |
| PCIPS_APResponseStatusID | int | 4 |
| PCIPS_APResponseDate | datetime | 8 |

TABLE 159
lkpPCIPSAPResponseStatus (Design View)

| Column | Data Type | Length |
|---|---|---|
| PCIPS_APResponseStatusID | int | 4 |
| PCIPS_APResponseStatusName | varchar | 50 |

TABLE 160
tblPCIPSAPResponseActivitiesMod (Design View)

| Column | Data Type | Length |
|---|---|---|
| PCIPS_AP_PostID | uniqueidentifier | 16 |
| PCIPSActivityModID | uniqueidentifier | 16 |
| POSOWMapPOLineItemID | uniqueidentifier | 16 |
| ControllableDataElements | sql_variant | |
| SupplierChangeOrderDisposition | bit | 1 |
| POClientLineDetailIdentity | uniqueidentifier | 16 |
| vcVendorContactGUID | uniqueidentifier | 16 |
| ModActivity$ | money | 8 |
| Taxation$ | money | 8 |
| POChange$ | money | 8 |
| PCIPSAPModLineID | uniqueidentifier | 16 |

TABLE 161
tblPCIPSAPResponseActivitiesNew (Design View)

| Column | Data Type | Length |
|---|---|---|
| PCIPSAPModLineID | uniqueidentifier | 16 |
| PCIPSSOWImpactBundleID | uniqueidentifier | 16 |
| PCIPSNewActivityID | uniqueidentifier | 16 |
| ControllableDataElements | sql_variant | |
| POClientLineIdentityID | uniqueidentifier | 16 |
| vcVendorContactGUID | uniqueidentifier | 16 |
| NewActivity$ | money | 8 |
| nTaxation$ | money | 8 |
| nPOChange$ | money | 8 |

Those skilled in the art will appreciate that, in addition to the systems and methodologies described herein, the present invention is directed to the computer databases, software applications, programs, protocols, routines, and instructions (collectively “computer programming instructions”) that may be used to implement the above-described features and functions. Computer programming instructions preferably are stored within memory, and may be received or transmitted via a communications interface.

As will be recognized by those skilled in the art, the innovative concepts described in the present application can be modified and varied over a wide range of applications. Accordingly, the scope of patented subject matter should not be limited to any of the specific exemplary teachings discussed, but is instead defined by the following claims.

What is claimed is:

1. A project-work administrative management method comprising:
receiving, from a buyer, project-administration configurations;
storing transactional project work data relating to project work to be performed for the buyer by a supplier;
receiving, from the buyer, configuration of project statement-of-work (SOW) records;
processing a project change in plan/scope record set of the buyer;
processing a project change in plan/scope record set of the supplier; and
creating an integrated project change in plan/scope record set using the record set of the buyer and the record set of the supplier.

2. The method of claim 1, wherein the project-administrative configurations comprise:
a project record set;
a budget record set;
an asset record set;
a contract master record;
a non-project business event record; and
wherein at least one of the project record set, the budget record set, and the asset record set comprises a plurality of tiered records.

3. The method of claim 1, wherein the step of storing the transactional project work data comprises;
providing a buyer-issued RFx bid to the supplier;
providing a supplier response to the RFx bid;
receiving a buyer acceptance of the supplier response to the RFx bid;
generating at least one purchase order based on elements of the buyer-accepted supplier response to the RFx bid;
providing supplier work acknowledgement vouchers to the buyer in response to project work services provided; and
receiving buyer disposition of the supplier work acknowledgement vouchers; and
performing financial processing of approved supplier work acknowledgement vouchers.

4. The method of claim 3, further comprising utilizing RFx bid items to establish project work activities.

5. The method of claim 4, wherein the step of utilizing the RFx bid items to establish project work activities comprises;
utilizing RFx bid items adapted to acquire and process data relative to at least one of the following transactional data object types:
human resource assignments;
human resource labor types;
human resource rate types;
human resource expense types;
materials;
miscellaneous project expenses;
unit/piece-work-based deliverables;
fixed-price deliverables; and
utilizing at least one deliverable RFx bid item type.

6. The method of claim 3, wherein the supplier response to the buyer RFx bid comprises:
data applicable to the RFx bid items; and
data applicable to at least one deliverable project work activity.

7. The method of claim 3, wherein the buyer acceptance of the supplier RFx bid response comprises;
acceptance of supplier RFx bid response elements applicable to buyer project work activities; and
acceptance of supplier RFx bid response elements comprising at least one deliverable project work activity.

8. The method of claim 3, wherein the step of generating at least one purchase order comprises integrating accepted supplier RFx bid response element data into a purchase order;

9. The method of claim 8, wherein the step of integrating the accepted RFx bid response element data into the purchase order comprises:
creating a purchase order;
establishing purchase order lines; and
affiliating the RFx bid response element data with the purchase order lines to establish project work transactional data.

10. The method of claim 1, wherein the configuration of the project SOW records comprises:
designating purchase order deliverable records as SOW records;
configuration of purchase order line items, the purchase order line items comprising non-deliverable project work activities affiliated with deliverable output work activities;
configuration of project phases;
configuration of SOW record dependencies; and
configuration of SOW record master data affiliations.

11. The method of claim 1 wherein the step of processing the project change in plan/scope record set of the buyer comprises;
generating a project SOW dependency and master record affiliation output;
wherein the project is depicted in terms of enterprise-wide connectivity;
broadcasting a project at-risk communications package;
receiving a project at-risk communications package response; and
processing the project at-risk communications package response.

12. The method of claim 1, wherein the step of processing the the project change in plan/scope record set of the supplier comprises;
creating a project change in plan/scope acceptance package;
broadcasting the project change in plan/scope acceptance package;
processing the broadcasted project change in plan/scope acceptance package; and
receiving completion of the broadcasted project change in plan/scope acceptance package.

13. The method of claim 1, wherein the step of creating the integrated project change in plan/scope record set comprises:
receiving at least one project change in plan/scope change order;
processing the at least one project change in plan/scope change order;
processing at least one master data record responsive to approval of the at least one project change in plan/scope change order; and
updating at least one processed master data record.

14. A project-work-portfolio administrative-record-set creation method, the method comprising:
creating project portfolio record sets; and
creating budget portfolio record sets; and
creating asset portfolio record sets; and
creating contract master records; and
creating non-project business event records.

15. The method of claim 14 wherein the step of creating project portfolio record sets comprises:
creating a project group record adapted to store project-group-attributes, buyer-organization, and business-ownership responsibility data;
creating at least one project master record adapted to store buyer-project data;
storing an association between the project group record and the at least one project master record;
storing applicable dependency relationships among the at least one project master records affiliated within a project group; and
storing default buyer organizational and business-ownership data applicable to the project master as a constraint of default project group data.

16. The method of claim 14, wherein creating budget portfolio record sets further comprises:
creating a budget group record adapted to store buyer organization, business-ownership responsibility, and financial data.
creating at least one budget master record adapted to store buyer-budget data;
storing an association between the budget group record and the at least one budget master record; and
storing default buyer organizational, business-ownership, and financial data applicable to the budget master record as a constraint of default budget-group data.

17. The method of claim 14, wherein creating asset portfolio record sets further comprises:
creating an asset group record adapted to store buyer organization, business-ownership responsibility, and financial data;
creating at least one asset master record adapted to store buyer asset data;
storing an association between the asset group record and the at least one asset master record; and
storing default buyer organizational, business ownership, and financial data applicable to the asset master as a constraint of asset group data.

18. The method of claim 14, wherein the creation of contract master records further comprises:
creating a contract master record adapted to store buyer organization, business-ownership responsibility, financial, and contract data applicable to a buyer contract.

19. The method of claim 14, further comprising creating at least one non-project business event record adapted to store buyer organization, business ownership responsibility, and business event data.

20. The method of claim 15, wherein the step of creating at least one project master record further comprises at least one of:
affiliating each of the at least one project master record with at least one budget master record;
affiliating each of the at least one project master record with at least one asset master record;
affiliating each of the at least one project master record with at least one contract master record; and
affiliating each of the at least one project master record with at least one business event master record.

21. A method of configuring project SOW deliverable records, the method comprising:
associating non-deliverable project-work-activity purchase-order line items with at least one purchase order line deliverable type record;
specifying attribute data relative to the purchase-order deliverable record;
creating at least one project work phasing record;
specifying attribute data relative to the at least one project phasing record;
configuring purchase-order deliverable record dependencies; and
configuring purchase-order deliverable record affiliations to master data records.

22. The method of claim 21, wherein the step of creating at least one project work phasing record comprises affiliating the at least one project phasing record with a master project record.

23. The method of claim 21, wherein the step of creating at least one project phasing record comprises affiliating purchase order deliverable records with the at least one project phasing record.

24. The method of claim 21, wherein the step of configuring purchase-order deliverable record dependencies comprises establishing relationships between purchase order deliverable records within a project.

25. The method of claim 24, wherein the step of establishing relationships between purchase order deliverable records within the project comprises:
specifying a dependency relationship type between related purchase order deliverable records; and
specifying whether a downstream dependent purchase order deliverable record completion status is constrained by a completion status of a related purchase order deliverable record.

26. The method of claim 21, wherein the step of configuring purchase-order deliverable record dependencies comprises establishing relationships between purchase order deliverable records in multiple projects within a project group.

27. The method of claim 26, wherein the step of establishing relationships between purchase order deliverable records within multiple projects comprises;
specifying a dependency relationship type between related purchase order deliverable records; and
specifying whether a downstream dependent purchase order deliverable record completion status is constrained by a completion status of the related purchase order deliverable record.

28. The method of claim 21, wherein the step of configuring purchase-order deliverable record affiliations to master data records comprises at least one of:
affiliating purchase order deliverable records with at least one budget master record mapped to a project master record; and
affiliating purchase order deliverable records containing at least one material record with at least one asset master record mapped to the project master record; and
affiliating purchase order deliverable records with at least one contract master record mapped to the project master record; and
affiliating purchase order deliverable records with at least one business event master record mapped to the project master record.

29. The method of claim 28, wherein the step of configuring purchase-order deliverable record affiliations to master data records comprises:
specifying attribute data applicable to the purchase-order-deliverable-record-to-master-data-record affiliations; and
specifying buyer personnel having responsibility for the purchase-order-deliverable-record-to-master-data-record affiliations.

30. The method of claim 29, further comprising:
storing configured purchase-order-deliverable-record-to-master-data-record affiliations and SOW record dependencies in a database;
notifying buyer personnel responsible for purchase-order-deliverable records and master data records of purchase-order deliverable record affiliations stored in the database; and
providing the notified buyer personnel access to their respective record affiliation details.

31. A method of assessing a project change in plan/scope, the method comprising:
performing a project-deliverable dependency and master-record affiliation analysis in response to buyer disposition of supplier-submitted project-work acknowledgement vouchers;
identifying purchase-order deliverable SOW records that are out of compliance relative to a scheduled completion date;
receiving selection of at least one out-of-compliance deliverable record;
generating a project at-risk communications session;
broadcasting a project at-risk communications package;
receiving a project at-risk communications package response; and
processing the project at-risk communications package response.

32. The method of claim 31, further comprising, responsive to the selection of the at least one out-of-compliance deliverable record:
generating an at-risk deliverable output including potentially-impacted deliverable and master data records affiliated with the selected out-of-compliance deliverable record;
identifying at-risk deliverable records affiliated with the selected out-of-compliance deliverable record; and
receiving modification of either status or completion date of an identified at-risk deliverable record.

33. The method of claim 32, further comprising, responsive to the modification:
generating an updated model of master data records and deliverable records impacted by the at-risk deliverable record; and
identifying buyer personnel responsible for the deliverable records impacted by the at-risk deliverable record; and
initiating an at-risk communications session.

34. The method of claim 31, wherein the step of generating the project at-risk communications session comprises:
creating a project at-risk communications session record set;
providing access, by a project-at-risk-communications-session owner, to purchase-order project-work-activity line items affiliated with the at least one out-of-compliance deliverable record; and
storing settings responsive to purchase-order project-work-activity line item modifications.

35. The method of claim 34, further comprising, responsive to the storing step, presenting to the project-at-risk-communications-session owner impacted business records aggregated by buyer personnel responsibility wherein the user interface being adapted to issue a broadcast to affected personnel.

36. The method of claim 31, wherein the step of processing the project at-risk communications package response comprises:
displaying deliverable-record upstream or downstream dependencies;
displaying the status of affiliated deliverable records;
enabling deliverable record modification; and
enabling master data record modification.

37. The method of claim 36, further comprising storing deliverable record modifications.

38. The method of claim 37, further comprising, responsive to the step of storing deliverable record modifications:
validating deliverable completion dating relative to dependent deliverable records;
providing buyer personnel with a successful-validation notification in response to there being no affiliated deliverable-record completion-dating conflicts; and
updating a project at-risk communications package response status code to complete.

39. The method of claim 37, further comprising, responsive to the step of validating deliverable completion dating:
providing an unsuccessful-validation notification in response to at least one affiliated deliverable-record completion-dating conflict;
updating a project at-risk communications package response status code to conflicted; and
displaying specific conflicted affiliated deliverable record details;
modifying conflicted record details responsive to user input.

40. The method of claim 38, further comprising, responsive to updating the project at-risk communications package response status code to complete, prompting for submission of project at-risk communications package response record updates to a project-at-risk-communications-session owner.

41. The method of claim 40, further comprising, responsive to submission of project at-risk communications package response record updates to the project-at-risk-communications-session owner:
validating completion status of all project at-risk communications package responses;
determining if communications package response record updates included purchase order changes; and
notifying downstream deliverable record owners of submitted project at-risk communication responses.

42. The method of claim 41, further comprising, responsive to the step of validating completion status for all communications package responses, setting a project at-risk communications session status code to awaiting review.

43. The method of claim 42, further comprising, responsive to there being no purchase order line item modifications within the communications package responses:
providing the project-at-risk-communications-session owner with an adapted user interface via which deliverable record and master data record modifications can be integrated to active enterprise data; and
updating the active enterprise data with the deliverable record and master data record modifications responsive to project-at-risk-communications-session owner action.

44. A method of processing of a project change in plan/scope, the method comprising:
creating a project change in plan/scope acceptance package;
broadcasting the project change in plan/scope acceptance package;
processing the broadcasted project change in plan/scope acceptance package to completion; and
providing the completed broadcasted project change in plan/scope acceptance package.

45. The method of claim 44, wherein the step of creating a project change in plan/scope acceptance package comprises:
creating a project change in plan/scope acceptance package record adapted to store attribute information; and
assigning to the change in plan/scope acceptance package record a status code of open.

46. The method of claim 44, wherein the step of broadcasting the project change in plan/scope acceptance package comprises:
presenting impacted purchase order records aggregated by supplier responsibility; and
providing a user interface adapted to broadcast the acceptance package.

47. The method of claim 44, wherein the step of processing the broadcasted project change in plan/scope acceptance package comprises:
notifying applicable supplier personnel of pending project change in plan/scope acceptance package data processing; and
wherein the data processing for a given supplier personnel is limited to that supplier personnel's individual impacted purchase order line item record set.

48. The method of claim 44, wherein the step of processing the project change in plan/scope acceptance package to completion responsive to broadcast receipt comprises:
providing to supplier personnel the impacted purchase order line item records;
receiving supplier personnel impacted purchase order line item record approval; and
storing an approval transaction responsive to the record approval.

49. The method of claim 48, wherein the step of processing the broadcasted project change in plan/scope acceptance package to completion comprises:
determining whether at least one impacted purchase order line item record requires supplier taxation assessment;
storing taxation assessment data responsive to a determination that at least one impacted purchase order line item record requires supplier taxation assessment; and
updating a project change in plan/scope acceptance package status code to indicate completeness responsive to a determination that taxation assessment data for all impacted purchase order line item records has been stored.

50. The method of claim 44, wherein the step of providing the completed broadcasted project change in plan/scope acceptance package comprises:
notifying a buyer project change in plan/scope session owner of the project change in plan/scope package response;
notifying relevant buyer personnel record owners of purchase order line item records of the project change in plan/scope acceptance package response; and
validating the status of the project change in plan/scope acceptance package response.

51. The method of claim 50, wherein the step of validating comprises:
notifying the buyer project change in plan/scope session owner of completion of the project change in plan/scope acceptance package response;
modifying the project change in plan/scope acceptance package status to indicate approval.

52. A method of creating an integrated project change in plan/scope record set, the method comprising:
creating at least one project change in plan/scope change order;
processing the at least one project change in plan/scope change order;
processing at least one master data record responsive to approval of the at least one project change in plan/scope change order;
updating at least one processed master data record; and
activating all project change in plan/scope record modifications.

53. The method of claim 52, wherein the step of creating at least one project change in plan/scope change order comprises:
aggregating modified project work purchase order records by responsible buyer personnel record owners; and
initiating of change order approval requests; and
broadcasting the change order approval requests.

54. The method of claim 53, wherein the step of broadcasting the change order approval requests comprises:
notifying responsible purchase order record owner buyer personnel of pending change order approval requests;
responsive to the responsible purchase order record owner buyer personnel input, processing the change order approval request; and
wherein, for a given buyer personnel, the buyer personnel change order approval processing is limited to purchase order records for which that buyer personnel is a responsible record owner.

55. The method of claim 54, wherein the step of processing the change order approval request comprises:
modifying the status of the change order approval request to indicate approval;
storing a change order approval request transaction in a database; and
notifying a buyer project change in plan/scope session owner of the change order approval.

56. The method of claim 52, wherein the step of processing at least one master data record comprises;
providing, to a buyer project change in plan/scope session owner, project master data records affiliated with an affiliated approved change order and aggregated by applicable buyer personnel record owner; and
issuing notifications to buyer personnel responsible for the project master data records affiliated with the approved change order that the affiliated project master data records are available for additional processing.

57. The method of claim 56, wherein the step of issuing notifications to buyer personnel responsible for master data records affiliated with an approved change order comprises:
providing the buyer personnel with a user interface adapted to permit modifications to be made to the master data records; and
storing input settings responsive to record modification.

58. The method of claim 57, further comprising, responsive to the step of storing input settings responsive to record modification:
notifying the buyer session owner of saved master data record input settings;
determining whether all master data records affiliated with all change orders have been stored;
modifying the project change in plan/scope session status to indicate integration still needs be performed responsive to all master data records affiliated with all change orders being stored.

59. The method of claim 52, wherein the step of activating comprises:
performing an update procedure by which the record modifications become active;
storing the record modifications as active enterprise data responsive to the update procedure; and
notifying buyer personnel of the record modifications.

60. A computer system for project-work administration, the computer system comprising:
an interface adapted to receive project-administration configurations and transactional project work data relating to project work to be performed for a buyer by a supplier;
a database system for storing the received project-administration configurations and the transactional project work data; and
a server connected to the interface and connected to the database system; and
wherein the server is adapted to:
determine purchase-order deliverable data of the transactional project work data that are out of compliance relative to a scheduled completion date;
responsive to the determination, generate a project at-risk communications session using the transactional project work data and the project-administration configurations; and
process a project at-risk communications package response.

61. An article of manufacture for project-work administrative management, the article of manufacture comprising:
at least one computer readable medium;
processor instructions contained on the at least one computer readable medium, the processor instructions configured to be readable from the at least one computer readable medium by at least one processor and thereby cause the at least one processor to operate as to:
receive, from a buyer, project-administration configurations;
store transactional project work data relating to project work to be performed for the buyer by a supplier;
receive, from the buyer, configuration of project statement-of-work (SOW) records;
process a project change in plan/scope record set of the buyer;
process a project change in plan/scope record set of the supplier; and
create an integrated project change in plan/scope record set using the record set of the buyer and the record set of the supplier.
